(19) United States
(12) Patent Application Publication
(10) Pub. No.: US 2013/0083276 A1
(43) Pub. Date: Apr. 4, 2013

(54) PRINTING SHEET FOR PRINTING STEREO PICTURE, STEREO PICTURE PRINT, METHOD OF MANUFACTURING STEREO PICTURE PRINT, AND METHOD OF PROVIDING STEREO PICTURE

(71) Applicant: FUJIFILM Corporation, Tokyo (JP)

(72) Inventors: Nobutaka IWAHASHI, Minami-ashigara-shi (JP); Shinichi MORISHIMA, Minami-ashigara-shi (JP); Keita TAKAHASHI, Minami-ashigara-shi (JP)

(73) Assignee: FUJIFILM CORPORATION, Tokyo (JP)

(21) Appl. No.: 13/685,065

(22) Filed: Nov. 26, 2012

Related U.S. Application Data
(63) Continuation of application No. PCT/JP2011/062164, filed on May 27, 2011.

(30) Foreign Application Priority Data
May 28, 2010 (JP) 2010-122728
May 28, 2010 (JP) 2010-122729
Jul. 29, 2010 (JP) 2010-170602
Oct. 28, 2010 (JP) 2010-242855

(51) Int. Cl. G03B 35/14; G02B 27/22

(52) U.S. Cl. CPC G03B 35/14; G02B 27/2235
USPC 349/117; 359/463; 347/110

(57) ABSTRACT

Provided is a stereo picture print having reduced crosstalk and ghost images. The printing sheet for printing a stereo picture comprises, in sequence: a light-transmissive image receiving layer; a linearly polarizing layer; and a retardation layer, wherein the retardation layer is formed by fixing in an aligned state a composition containing a compound having refractive index anisotropy and is patterned into a first domain and a second domain which have different in-plane slow axes or have different in-plane retardations.

The present application is a continuation of PCT/JP2011/062164 filed on May 27, 2011.

The present application claims the benefit of priority from Japanese Patent Application No. 122728/2010, filed on May 28, 2010, Japanese Patent Application No. 122729/2010, files on May 28, 2010, Japanese Patent Application No. 170602/2010, files on Jul. 29, 2010, and Japanese Patent Application No. 242855/2010 filed on Oct. 28, 2010 the contents of which are herein incorporated by reference in their entirety.

### BACKGROUND OF THE INVENTION

1. Field of the Invention

The present invention relates to a stereo picture print for displaying a stereo picture, a printing sheet for the stereo picture print, a method of manufacturing the stereo picture print, and a method of providing the stereo picture print for an observer.

2. Description of the Related Art

Various methods of manufacturing stereo picture prints have been proposed. For example, JP-A-5-210182 proposes a method of manufacturing stereo picture prints, in which left-eye pixels and right-eye pixels are arrayed in a predetermined pattern, a polarizing film is provided on tops of the left-eye and right-eye pixels, a quarter-wavelength plate is laminated on the polarizing film, and an angle defined by the polarizing axis of the polarizing film and the slow axis of the quarter-wavelength plate is +45° for a left eye and −45° for a right eye.

### SUMMARY OF THE INVENTION

According to the conventional method, an observer wearing circular polarization glasses can perceive an image on the stereo picture print as a deep stereo picture. The observer, however, may also observe crosstalk and/or ghost images in the stereo picture, which should be solved.

An object of the present invention, which has been made in light of the problem, is to reduce crosstalk and ghost images in a stereo picture print. More specifically, an object of the invention is to provide a stereo picture print having reduced crosstalk and ghost images, a stereo picture printing sheet for printing a stereo picture, a method of manufacturing the stereo picture print, and a method of providing the stereo picture print.

Through various investigations, the inventor has been discovered that desirable right-eye and left-eye pixels cannot be drawn on planar sheets having certain properties in the conventional method described above, resulting in crosstalk and ghost images. The inventor has conducted further investigations based on this findings, and finally completed the invention.

Specifically, means for solving the problem are as follows:

[1] A printing sheet for printing a stereo picture comprising, in sequence:

a light-transmissive image receiving layer;

a linearly polarizing layer; and

a retardation layer,

wherein the retardation layer is formed by fixing in an aligned state a composition containing a compound having refractive index anisotropy and is patterned into a first domain and a second domain which have different in-plane slow axes or have different in-plane retardations.

[2] The printing sheet according to [1], wherein the retardation layer is formed by applying the composition by any one of coating, blowing, and dropping.
[3] The printing sheet according to [1] or [2], wherein the light-transmissive image receiving layer is formed by any one of coating, blowing, and dropping.
[4] The printing sheet according to any one of [1] to [3], wherein the light-transmissive image receiving layer is an image forming layer capable of receiving an image by silver halide photography, thermal transfer, or ink jetting.
[5] The printing sheet according to any one of [1] to [4], wherein the retardation layer comprises a quarter-wave plate, the in-plane slow axes of the first and second domains defining an angle of 90 degrees, each of the in-plane slow axes of the first and second domains and the polarization axis of the linearly polarizing layer defining an angle of ±45 degrees.
[6] The printing sheet according to any one of [1] to [4], wherein the in-plane retardation of the first domain of the retardation layer is 0, the in-plane retardation of the second domain of the retardation layer corresponds to a half wavelength, and the polarization axis of the linearly polarizing layer and the in-plain slow axis of the second domain define an angle of 45 degrees.
[7] The printing sheet according to any one of [1] to [6], wherein the linearly polarizing layer comprises a coat-type linearly polarizing layer formed by coating a liquid crystal composition containing a dichroic dye.
[8] The printing sheet according to any one of [1] to [7], wherein the retardation layer is obtained by curing a liquid crystal composition.
[9] The retardation layer according to [8], wherein the retardation layer is obtained by curing a liquid crystal composition, and alignment of the liquid crystal is controlled by a pattern-exposed light aligning film.
[10] The printing sheet according to any one of [1] to [9], further comprising a protective layer between the linearly polarizing layer and the retardation layer, the protective layer protecting the linearly polarizing layer and having an in-plane retardation Re(550) at a wavelength of 550 nm of 0 to 10 nm.
[11] The printing sheet according to [10], wherein the absolute of the sum of the retardations Rth(550) in the thickness direction at a wavelength of 550 nm of the protective layer and the retardation layer is 20 nm or less.
[12] The printing sheet according to anyone of [1] to [11], wherein the light-transmissive image receiving layer comprises an image receiving layer capable of receiving an image by silver halide photography and comprises a blue-sensitive emulsion layer, a green-sensitive emulsion layer, and a red-sensitive emulsion layer.
[13] The printing sheet according to any one of [1] to [11], wherein the light-transmissive image receiving layer comprises an image receiving layer capable of receiving an image by thermal transfer and at least one dye receiving polymer.
[14] The printing sheet according to any one of [1] to [11], wherein the light-transmissive image receiving layer comprises an image receiving layer capable of receiving an image by ink jetting and comprises a water-soluble polymer and an inorganic fine particle.
[15] The printing sheet according to any one of [1] to [14], wherein the linearly polarizing layer comprises at least one dichroic dye of the group consisting of dichroic dyes represented by Formulae (I), (II), (II), (IV), and (V):

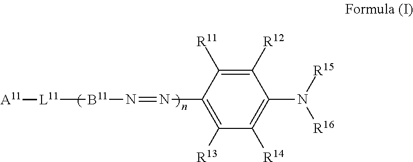

where R¹¹ to R¹⁴ each independently represent a hydrogen atom or a substituent; R¹⁵ and R¹⁶ each independently represent an alkyl group that optionally has a hydrogen atom or a substituent; L¹¹ represents —N═N—, —CH═N—, —N═CH—, —C(═O)O—, —OC(═O)—, or —CH═CH—; A¹¹ represents a phenyl group that optionally has a substituent, a naphthyl group that optionally has a substituent, or a divalent aryl hydrocarbon or divalent aryl heterocyclic group that optionally has a substituent; B¹¹ represents a divalent aryl hydrocarbon or divalent aryl heterocyclic group that optionally has a substituent; and n represents an integer of 1 to 5, where B¹¹'s may be the same or different when n is 2 or more;

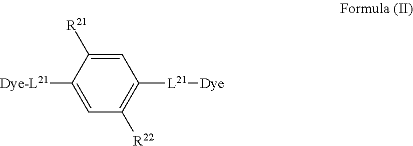

where R²¹ and R²² each represent a hydrogen atom, an alkyl group, an alkoxy group, or a substituent represented by -L²²-Y, provided that at least one of R²¹ and R²² represents a group other than the hydrogen atom; L²² represents an alkylene group, where one CH₂ group or two or more joining CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— where R represents a hydrogen atom or a C₁₋₄ alkyl group; Y represents a hydrogen atom, a hydroxy group, an alkoxy group, a carboxyl group, a halogen atom, or a polymerizable group; L²¹'s each represent a linker selected from the group consisting of an azo group (—N═N—), carbonyloxy group (—C(═O)O—), oxycarbonyl group (—O—(═O)—), an imino group (—N═CH—), and vinylene group (—C═C—); Dye represents an azo dye residue represented by Formula (IIa):

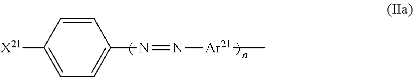

wherein * represents a linker to L²¹; X²¹ represents a hydroxyl group, a substituted or nonsubstituted alkyl group, a substituted or nonsubstituted alkoxy group, a nonsubstituted amino group, or a nono- or dialkylamino group; Ar²¹ represents an aryl hydrocarbon or aryl heterocyclic group that optionally has a substituent; n represents an integer of 1 to 3 where two Ar²¹'s may be the same or different when n is 2 or more;

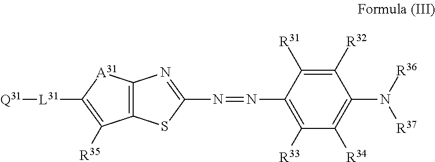

where R³¹ to R³⁵ each independently represent a hydrogen atom or a substituent; R³⁶ and R³⁷ each independently represent a hydrogen atom or an alkyl group that optionally has a substituent; Q³¹ represents an aryl hydrocarbon, aryl heterocyclic, or cyclohexane ring group that optionally has a substituent; L³¹ represents a divalent linker; and A³¹ represents an oxygen or sulfur atom;

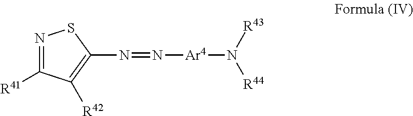

where R⁴¹ and R⁴² each represents a hydrogen atom or substituent or are optionally be joined to each other to form a ring; Ar⁴ represents a divalent aryl hydrocarbon or divalent aryl heterocyclic ring that is optionally substituted; R⁴³ and R⁴⁴ each represent a hydrogen atom or an alkyl group that is optionally substituted or are optionally be joined to each other to form a ring; and

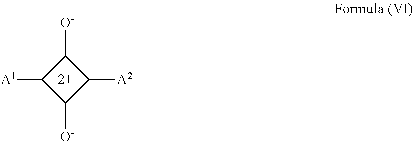

where A¹ and A² each independently represent a substituted or unsubstituted hydrocarbon or heterocyclic group.
[16] The printing sheet according to any one of [1] to [15], wherein the distance d between the retardation layer and the image receiving layer is 500 μm or less.
[17] The printing sheet according to any one of [1] to [16], wherein the ratio (d/p) of the distance d between the retardation layer and the image receiving layer to the distance p between pattern border lines of the first and second domains is 3 or less.
[18] A stereo picture print comprising:

the printing sheet according to any one of [1] to [17]; and

a left-eye image and a right-eye image formed on the light-transmissive image receiving layer of the printing sheet, the left-eye image and the right-eye image having parallax,

pixels constituting the left-eye image and pixels constituting the left-eye image are formed positions corresponding to the first domain and the second domain, respectively, of the retardation layer of the printing sheet.

[19] The stereo picture print according to [18], further comprising a reflective layer not cancelling unpolarized light, the reflective layer being disposed on a side opposite to a viewer side of an observer.
[20] A method of manufacturing a stereo picture print, comprising:

forming a left-eye image and a right-eye image having parallax by LightJet printing on the light-transmissive image receiving layer according to any one of [1] to [13] such that the left-eye image and the right-eye image correspond to positions of the first domain and the second domain, respectively, of the printing sheet.

[21] A method of manufacturing a stereo picture print, comprising:

overlaying a thermal transfer sheet comprising a dye on the printing sheet according to any one of [1] to [12] and [14];

heating the thermal transfer sheet with a thermal head generating heat controlled by electrical signals to transfer a left-eye image and a right-eye image having parallax onto positions corresponding to the first and second domain, respectively, of the retardation layer of the printing sheet through transfer of the dye.

[22] A method of manufacturing a stereo image print, comprising:

forming a left-eye image and a right-eye image having parallax onto the light-transmissive image receiving layer of the printing sheet according to any one of [1] to [12] and [15], the positions of the left-eye image and the right-eye image corresponding to the first domain and second domain, respectively, of the retardation layer of the printing sheet.

[23] A method of providing a stereo picture, comprising:

providing a stereo picture print according to any one of [18] or [19];

displaying the stereo picture print for an observer wearing a polarizing glass for a left eye and a polarizing glass for a right eye, the polarizing glasses comprising circularly polarizing lenses reverse to each other or linearly polarizing lenses having orthogonal polarization axes.

According to the invention, a stereo picture print having reduced crosstalk and ghost images can be provided.

### BRIEF DESCRIPTION OF THE DRAWINGS

FIG. 1 is an exemplary schematic sectional view of a first embodiment of a stereo picture printing sheet of the invention.

FIG. 2 is a schematic view used for explanation of the relationship between slow axes of quarter-wavelength layers usable in the first embodiment of the stereo picture printing sheet of the invention.

FIG. 3 is an exemplary schematic sectional view of a second embodiment of the stereo picture printing sheet of the invention.

FIG. 4 is a schematic view used for explanation of the relationship between slow axes of quarter-wavelength layers usable in the second embodiment of the stereo picture printing sheet of the invention.

FIG. 5 is another exemplary schematic sectional view of each of the first and second embodiments of the stereo picture printing sheet of the invention.

FIG. 6 is another exemplary schematic sectional view of each of the first and second embodiments of the stereo picture printing sheet of the invention.

FIG. 7 is another exemplary schematic sectional view of each of the first and second embodiments of the stereo picture printing sheet of the invention.

FIG. 8 is another exemplary schematic sectional view of each of the first and second embodiments of the stereo picture printing sheet of the invention.

FIG. 9 is another exemplary schematic sectional view of each of the first and second embodiments of the stereo picture printing sheet of the invention.

FIG. 10 is another exemplary schematic sectional view of each of the first and second embodiments of the stereo picture printing sheet of the invention.

FIG. 11 is another exemplary schematic sectional view of each of the first and second embodiments of the stereo picture printing sheet of the invention.

FIG. 12 is another exemplary schematic sectional view of each of the first and second embodiments of the stereo picture printing sheet of the invention.

FIGS. 13A and 13B are schematic views illustrating exemplary exposure masks usable in manufacturing of the first embodiment of the stereo picture printing sheet of the invention.

FIGS. 14A to 14F are schematic views illustrating a flow of an exemplary method of forming a patterned retardation layer usable in the second embodiment of the stereo picture printing sheet of the invention.

FIGS. 15A and 15B are schematic views illustrating exemplary exposure masks usable in manufacturing of the second embodiment of the stereo picture printing sheet of the invention.

FIG. 16 is another exemplary schematic sectional view of the second embodiment of the stereo picture printing sheet of the invention.

FIG. 17 is a schematic sectional view of an exemplary stereo picture print of the invention.

FIG. 18 is a schematic sectional view of a stereo picture print produced in Example.

FIG. 19 is a schematic sectional view of a stereo picture print produced in Example.

### BEST MODE FOR CARRYING OUT THE INVENTION

The present invention will now be described in detail. Throughout the specification, a numerical range represented by “to” refers to a range including numerical values before and after “to” as the lower and upper limits.

In this specification, Re(λ) refers to a value of a retardation in plane (nm) at a wavelength λ (nm), and Rth(λ) refers to a value of a retardation along the thickness direction (nm) at a wavelength λ (nm). If a retardation value is shown without any wavelength value, it refers to a retardation value at a wavelength of 550 nm. The retardation in plane (Re(λ)) is measured with KOBRA-21ADH or WR (available from Oji Scientific Instruments) in such a manner that light having a wavelength λ (nm) is incident on a film in a normal direction to the film. The value of retardation along the thickness direction (Rth(λ)) is calculated on the basis of the Re(λ) value and a plurality of retardation values measured with obliquely incident light.

Throughout the specification, “patterning” refers to formation of two or more regions, in which the light axes (including slow axis) have different directions, on a film (layered) object, or a state of having the regions.

In the specification, “crosstalk” and “ghost image” refer to image perception as a double image and image perception as an image other than a target image, respectively, in the case where left and right images are imperfectly separated.

### 1. Stereo Picture Printing Sheet

The invention relates to a stereo picture printing sheet, in which a light-transmissive image receiving layer, a linearly polarizing layer, and a retardation layer are provided in this order, and the retardation layer is patterned into first and second domains having different in-plane slow-axis directions or different retardations in plane.

The printing sheet of the invention includes the light-transmissive image receiving layer, and thus allows formation of left-eye and right-eye images having a high color density and high parallax. As a result, crosstalk and ghost images can be reduced compared with the conventional printing sheet without the image receiving layer. Furthermore, in an embodiment where the printing sheet includes a dye-image receivable, image receiving layer formed by, for example, a coating, the thickness of the printing sheet can be reduced, leading to a further reduction in crosstalk and ghost images. Furthermore, in an embodiment where the printing sheet includes an image receiving layer that can receive images formed by thermal transfer, inkjetting, or silver halide photography (particularly, LightJet printing), the left-eye and right-eye images having a high color density and high parallax can be readily formed at desired positions corresponding to a pattern of the retardation layer through controlling a thermal head, an inkjet head, or laser light for image drawing.

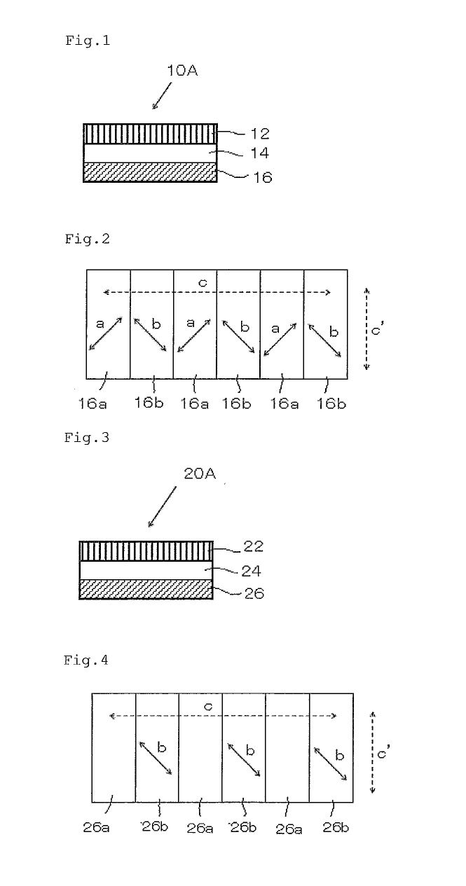

In a first embodiment of the stereo picture printing sheet of the invention, the retardation layer is patterned as a quarter-wavelength layer, in which the in-plane slow axis of a first domain and the in-plane slow axis of a second domain define 90°, and in-plane slow axis of a first domain and the in-plane slow axis of a second domain define angles of +45° and −45°, respectively, with respect to the polarization axis of the linearly polarizing layer. FIG. 1 illustrates a schematic sectional view of an exemplary stereo picture printing sheet of the embodiment. A printing sheet 10A illustrated in FIG. 1 includes a light-transmissive image receiving layer 12, a linearly polarizing layer 14, and a quarter-wavelength layer 16 in this order. The quarter-wavelength layer 16 is patterned into first domains 16a and second domains 16b, of which the slow axes define an angle of 90°. For example, as illustrated in FIG. 2, the slow axis a of the first domain 16a is in a direction of −45°, and the slow axis b of the second domain 16b is in a direction of +45°, thus the slow axes a and b defining an angle of 90°. Furthermore, the slow axes a and b of the first and second domains 16a and 16b define angles of +45° and −45°, respectively, with respect to the polarization axis of the linearly polarizing layer 14. For example, as illustrated by broken lines in FIG. 2, in either case where the linearly polarizing layer 14 has a polarization axis c in a direction of 0° or a polarization axis c′ in a direction of 90°, the above-described relationship is satisfied.

Although FIG. 2 illustrates an embodiment where the first and second domains 16a and 16b each have a stripe pattern, the invention should not be limited thereto.

An image is formed in the light-transmissive image receiving layer 12 by a known technique, and an observer views the image through the quarter-wavelength layer 16. Thus, one image at a position corresponding to the first domain 16a is incident on an eye of the observer as a circularly polarized image in a direction determined by the slow axis a, and the other image at a position corresponding to the second domain 16b is incident on the other eye of the observer as a circularly polarized image in a direction determined by the slow axis b. The slow axes a and b are orthogonal to each other. When the observer views the image through circular polarization glasses including left and right polarizing lenses, which have axes aligned in correspondence to the first and second domains, the circularly polarized images through the first and second domains 16a and 16b are incident on left and right eyes, respectively. In addition, pixels constituting left-eye and right-eye images having parallax are printed at the positions corresponding to the first and second domains 16a and 16b of the light-transmissive image receiving layer 12. Consequently, the observer perceives the left-eye and right-eye images as a stereo picture through the circular polarization glasses worn by the observer.

In a second embodiment of the stereo picture printing sheet of the invention, the retardation layer is patterned such that the first domain has a retardation of 0, and the second domain has a retardation of half wavelength, and the polarization axis of the linearly polarizing layer has an angle of 45° with respect to the in-plane slow axis of the second domain. FIG. 3 illustrates a schematic sectional view of an exemplary printing sheet of the embodiment. A printing sheet 20A illustrated in FIG. 3 includes a light-transmissive image receiving layer 22, a linearly polarizing layer 24, and a retardation layer 26 in this order. The retardation layer 26 is patterned into first domains 26a having an Re of 0 nm and second domains 26b having an Re of half wavelength. The slow axis b of the second domain 26b is in a direction of +45°, and defines an angle of 45° with respect to the polarization axis of the linearly polarizing layer 24, For example, as illustrated by broken lines in FIG. 4, in either case where the linearly polarizing layer 24 has a polarization axis c in a direction of 0° or a polarization axis c′ in a direction of 90°, the above-described relationship is satisfied.

An image is formed in the light-transmissive image receiving layer 22 by one of the various techniques, and an observer views the image through the retardation layer 26. Thus, an image at a position corresponding to the first domain 26a is incident on one eye of the observer as a linearly polarized image determined by a direction of the polarization axis c of the linearly polarizing layer 24, and another image at a position corresponding to the second domain 26b is incident on the other eye of the observer as a linearly polarized image having a polarization axis orthogonal to the polarization axis of the image at the position corresponding to the first domain 26a due to the half-wavelength retardation of the second domain 26b. The observer views the linearly polarized images through worn circular polarization glasses including linear polarizing lenses having axes aligned in correspondence to the first and second domains. Thus, the polarized images from the first and second domains 26a and 26b are incident on left and right eyes, respectively, of the observer. In addition, pixels constituting left-eye and right-eye images having parallax are printed at the positions corresponding to the first and second domains 26a and 26b, respectively, of the light-transmissive image receiving layer 22. Consequently, the observer perceives the left-eye and right-eye images as a stereo picture through the worn polarization glasses.

In the stereo picture printing sheet of the invention, the left-eye and right-eye images formed in the image receiving layer preferably have substantially the same patterns as those of the first and second domains of the retardation layer, respectively. In addition, the patterns of the left-eye and right-eye images formed on the printing sheet preferably have substantially equal areas in a plane of the printing sheet. In addition, the left-eye and right-eye regions are each preferably distributed uniformly over the entire area of the printing sheet plane without being localized in part of the plane. The sensitivity to resolution of human eyes is low in a vertical direction and high in a horizontal direction; hence, a preferred pattern has a high horizontal resolution. In addition, binocular parallax providing depth perception corresponds to horizontal positional shift of an object to be viewed between the visual fields of left and right eyes. Thus, high horizontal resolution is also preferred from the viewpoint of providing stereoscopy exhibiting smooth depth perception.

Although the first and second domains have the stripe patterns in the embodiments illustrated in FIGS. 1 and 3, respectively, the domain pattern is not limited thereto. Specific examples of the pattern include a horizontal stripe, an oblique stripe, a vertical stripe, and a checker. Preferred are patterns of a horizontal stripe, oblique stripe, and checker, more preferred are patterns of a horizontal stripe, an oblique stripe having an angle of 45° or less with respect to the horizontal direction, and a checker, further preferred are patterns of a horizontal stripe, an oblique stripe having an angle of 30° or less with respect to the horizontal direction, and most preferred pattern is a horizontal stripe. The interval between the pattern boundaries is preferably 10 μm to 5 mm, more preferably 30 μm to 2 mm, further preferably 50 μm to 1 mm, and most preferably 100 μm to 500 μm. If the interval is excessively large, the pattern is readily viewed as a black pattern by an eye on a side where the region between the boundaries is perceived as black display, leading to degradation in image quality. In contrast, if the interval is excessively small, slight pattern misalignment between a polarizer and the printing sheet generates noticeable crosstalk.

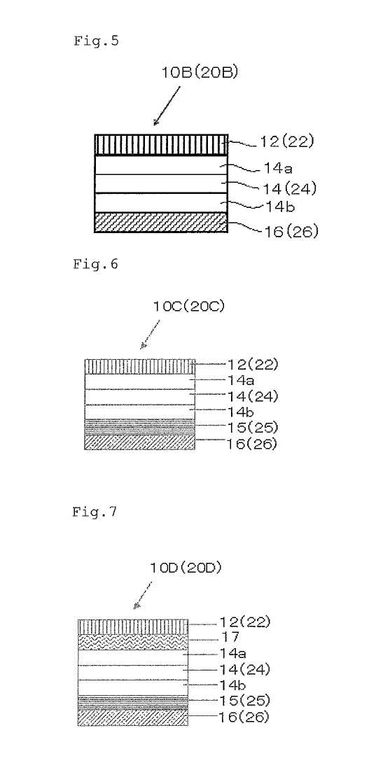

FIGS. 5 to 12 illustrate schematic sectional views of other exemplary printing sheets of the first and/or second embodiments. The same components as those in FIGS. 1 and 3 are designated by the same numerals, and detailed description thereof is omitted.

A printing sheet 10B (or 20B) illustrated in FIG. 5 includes protective layers 14a and 14b protecting the linearly polarizing layer 14 (or 24). Polyvinyl alcohol (PVA) films, which are commonly used as linearly polarizing films, are highly hygroscopic. Hence, a PVA film is protected by other polymer films on its two sides in order to improve durability. In the exemplary printing sheet illustrated in FIG. 5, the linearly polarizing layer 14 (or 24) is protected by the protective layers 14a and 14b composed of a polymer film. In some cases, however, the protective layer 14b disposed between the linearly polarizing layer 14 (or 24) and the quarter-wavelength layer 16 (or the retardation layer 26) has a high retardation. This results in a variation in a circular polarization state of the circularly polarized image that is incident on eyes of an observer from each of the first and second domains 16a and 16b (or 26a and 26b), resulting in crosstalk and ghost images. Hence, the protective layer 14b preferably has a low retardation. Specifically, its retardation in plane Re (550) at a wavelength of 550 nm is preferably 0 to 10 nm, and more preferably 5 nm or less.

The Rth of the protective layer 14b also affects the circular polarization state of the circularly polarized image, and may cause crosstalk and ghost images; hence, the absolute value of the total Rth of the quarter-wavelength layer 16 and the protective layer 14b is preferably 20 nm or less, and more preferably 5 nm or less.

FIG. 6 illustrates a schematic sectional view of another exemplary printing sheet of each of the first and second embodiments.

FIG. 6 illustrates a printing sheet 10C (or 20C) in an embodiment where the quarter-wavelength layer 16 (or the retardation layer 26) is formed by curing a curable liquid-crystalline component. Specifically, the quarter-wavelength layer 16 (or the retardation layer 26) is formed in such a manner that alignment of the curable liquid-crystalline component is controlled by an underlying alignment layer 15 (or 25) composed of an alignment film, and the controlled alignment is fixed. The alignment layer 15 may be a light aligning film that exhibits orientation regulation by light irradiation, and has an alignment axis determined by the direction of incident light, or may be a rubbing alignment film that exhibits orientation regulation by rubbing, and has an alignment axis typically determined by the rubbed direction.

An exemplary light aligning film used as the alignment layer 15 of the printing sheet 10C is subjected to pattern exposure and thus includes first photo-aligned domains and second photo-aligned domains, of which the alignment axes define an angle of 90°.

An exemplary rubbing alignment film used as the alignment layer 15 of the printing sheet 10C is subjected to mask rubbing and thus includes first rubbing-aligned domains and second rubbing-aligned domains, of which the alignment axes define an angle of 90°.

In some rubbing alignment films, the orientation regulation varies or is lost in response to a variation in temperature. Such a rubbing alignment film may also be used as the alignment layer 15 (or 25). Specifically, an alignment layer 15 of a unidirectionally rubbed film exhibiting orientation regulation that varies with a variation in temperature can be used for formation of a quarter-wavelength layer 16 including the first and second domains having the orthogonal in-plane slow axes. For example, the orientation regulation varying with a variation in temperature can be achieved by adjusting affinity between two or more of an alignment film material, liquid crystal, and an alignment control agent. Consequently, the slow axis of liquid crystal can be aligned either orthogonally or parallel to a rubbing direction. The slow axis of the liquid crystal is brought into an orthogonal alignment state at a temperature of T₁° C., and that the alignment state is then fixed at a predetermined pattern by ultraviolet irradiation through a photomask, and then any unirradiated region is brought into a parallel alignment state at a temperature of T₂° C. (T₁<T₂). In addition, such a state is fixed by ultraviolet irradiation, resulting in the formation of the patterned quarter-wavelength layer including the first and second domains having the orthogonal in-plane slow axes. This exemplary alignment film is described in detail below.

In another exemplary unidirectionally rubbed film usable as the alignment layer 15 of the printing sheet 10C, the rubbing alignment film is a patterned alignment control layer including first alignment control regions and second alignment control regions, which have different compositions and have alignment control surfaces that exhibit different alignment control functions and are alternately arranged. In addition, the major axes of liquid crystal can be controlled to be orthogonally aligned in the planes parallel to the respective alignment control surfaces of the first and second alignment control regions. This exemplary alignment film is also described in detail below.

An exemplary alignment layer 25 of the printing sheet 20C includes a unidirectionally rubbed film that loses the orientation regulation in response to a variation in temperature. The liquid crystal is brought into an orthogonal or horizontal alignment state at a temperature of T₁° C., and that the alignment state is then fixed at a predetermined pattern by ultraviolet irradiation with a photomask, and then any unirradiated region is brought into an isotropic-phase state at a temperature of T₃° C. (T₁<T₃). In addition, such a state is fixed by ultraviolet irradiation, resulting in the formation of a retardation layer patterned into a second domains 26b having an Re of half wavelength.

FIG. 7 illustrates a schematic sectional view of another exemplary printing sheet of each of the first and second embodiments. FIG. 7 illustrates a printing sheet 10D (or 20D) in an embodiment where the surface of the protective layer 14a of the linearly polarizing layer 14 (or 24) is aligned with the image receiving layer 12 (or 22), and then the aligned layers are bonded together with an adhesive agent, and thus an adhesive agent layer 17 is provided between the protective layer 14a and the image receiving layer 12 (or 22).

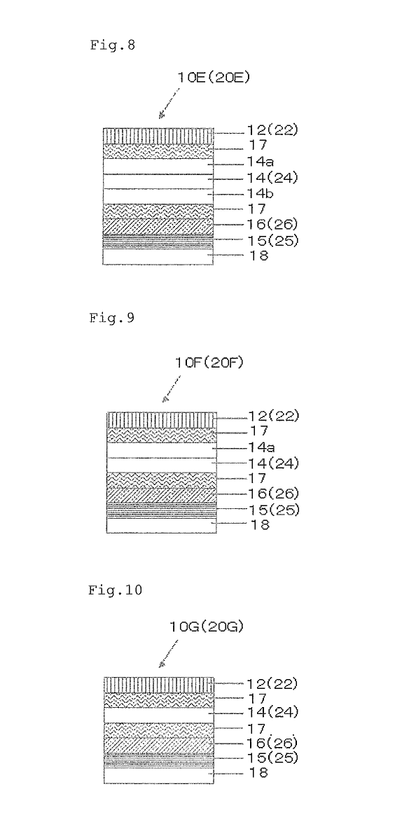

FIG. 8 illustrates a schematic sectional view of another exemplary printing sheet of each of the first and second embodiments. FIG. 8 illustrates a printing sheet 10E or 20E) in an embodiment where an alignment layer 15 (or 25) is formed on a transparent support 18, a patterned quarter-wavelength layer 16 (or retardation layer 26) is formed by means of the alignment control function of the alignment layer 15 (or 25) to prepare a laminate, and the surface of the patterned quarter-wavelength layer 16 (or retardation layer 26) of the laminate is bonded to the protective layer 14b of the linearly polarizing layer 14 (or 24) with an adhesive agent. Specifically, an adhesive agent layer 17 is provided between the protective layer 14b and the patterned quarter-wavelength layer 16 (or the retardation layer 26), and between the protective layer 14a and the image receiving layer 12 (or 22).

The transparent support 18 used in the embodiment is composed of the same material as a material usable for the protective layers 14a and 14b of the linearly polarizing layer described below, in which the preferred range of the composition of the material is also the same.

FIG. 9 illustrates a schematic sectional view of another exemplary printing sheet of each of the first and second embodiments. FIG. 9 illustrates a printing sheet 10F (or 20F) in an embodiment where an alignment layer 15 (or 25) is formed on a transparent support 18, a patterned quarter-wavelength layer 16 (or retardation layer 26) is formed by means of the alignment control function of the alignment layer 15 (or 25) to prepare a laminate, and the surface of the patterned quarter-wavelength layer 16 (or retardation layer 26) of the laminate is directly bonded to the surface of the linearly polarizing layer 14 with an adhesive agent. An adhesive agent layer 17 is provided between the linearly polarizing layer 14 (or 24) and the patterned quarter-wavelength layer 16 (or retardation layer 26). As described below, the embodiment has an advantage in a further reduction in crosstalk due to a short laminating distance between the patterned quarter-wavelength layer 16 (or the retardation layer 26) and the image receiving layer 12.

FIG. 10 illustrates a schematic sectional view of another exemplary printing sheet of each of the first and second embodiments. FIG. 10 illustrates a printing sheet 10G (or 20G) in an embodiment where any surface has no protective layer thereon, and the surface of the linearly polarizing layer 14 (or 24) is bonded to the surface of the image receiving layer 12 with an adhesive agent. This embodiment allows a further reduction in the laminating distance between the patterned quarter-wavelength layer 16 (or the retardation layer 26) and the image receiving layer 12, leading to a further reduction in crosstalk.

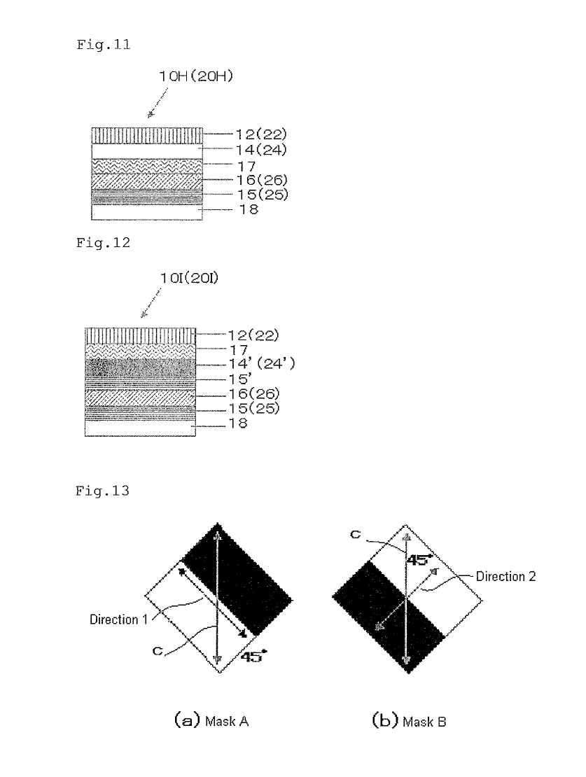

FIG. 11 illustrates a schematic sectional view of another exemplary printing sheet of each of the first and second embodiments. FIG. 11 illustrates a printing sheet 10H (or 20H) in an embodiment where the image receiving layer 12 (or 22) is directly formed on the surface of the linearly polarizing layer 14 (or 24) by a coating, for example.

FIG. 12 illustrates a schematic sectional view of another exemplary printing sheet of each of the first and second embodiments. FIG. 12 illustrates a printing sheet 10I (or 20I) in an embodiment where an alignment layer 15′ is formed on the surface of the patterned quarter-wavelength layer 16 (or retardation layer 26), and a polarization material such as a liquid crystal composition containing a dichroic dye is provided on the surface of the alignment layer 15′ by, for example, coating, so that a coating-type polarization layer 14′ (or 24′) is formed by means of the alignment control function of the alignment layer 15′. The alignment layer 15′ may be a light aligning film that exhibits the orientation regulation by light irradiation, and has an alignment axis determined by the direction of light irradiation, or may be a rubbing alignment film that exhibits the orientation regulation by rubbing, and has an alignment axis typically determined by the rubbed direction.

The printing sheets 10C to 10I or 20C to 20I illustrated in FIGS. 6 to 12 each include the alignment layer 15 or 15′ of which the orientation regulation is used to form the quarter-wavelength layer 16 including the first domains 16a and the second domains 16b, or form the retardation layer 26 including the first domains 26a and the second domains 26b. An exemplary method of preparing the light aligning film 15 for forming the quarter-wavelength layer 16 is as follows.

A light aligning composition is applied onto the surface of the linearly polarizing layer 14 to form a film. The applied light aligning composition is irradiated with linearly polarized light with a wire grid. Specifically, as illustrated in FIG. 13A, a wire grid polarizer is disposed in direction 1 defining an angle of 45° with respect to the polarization axis c of the linearly polarizing layer 14, and the light aligning composition is exposed to light through a mask A (the black portion represents a light-shielding portion, and the white portion represents a light-transmissive region in the drawing, and the same holds true for a mask B). As illustrated in FIG. 13B, a wire grid polarizer is then disposed in direction 2 defining an angle of 45° with respect to the polarization axis c of the linearly polarizing layer 14, and the light aligning composition is then exposed to light through a mask B. This enables the formation of first and second, orthogonal photo-aligned domains having alignment axes in directions of ±45°. A curable liquid crystalline composition is then aligned onto the light aligning film. Thus, liquid crystal on each of the first photo-aligned domains aligns in accordance with the alignment axis of the domain, and liquid crystal on each of the second photo-aligned domains aligns in accordance with the alignment axis of the domain. Each of the alignment states is fixed through a curing reaction. As a result, the quarter-wavelength layer 16 as shown in FIG. 2 can be formed, which includes the first and second domains 16a and 16b having the slow axes a and b defining an angle of 90°, and defining +45° and −45°, respectively, with respect to the polarization axis c of the linearly polarizing layer 14.

The printing sheet of this embodiment has the quarter-wavelength layer formed of the light aligning film. The quarter-wavelength layer has the slow axes, which define 90° and define +45° and −45°, respectively, with respect to the polarization axis of the linearly polarizing layer, formed by pattern exposure enabling position alignment to be relatively readily controlled. As a result, axis shift (for example, axis shift between the slow axes of the quarter-wavelength layer, and axis shift between the slow axis and the polarization axis of the linearly polarizing layer) is reduced, resulting in reductions in crosstalk and ghost images in a stereo picture formed on the printing sheet of this embodiment.

The printing sheet of the invention may be configured such that each layer is not fixed but is removable. For example, the printing sheet may be configured as follows. The light-transmissive image receiving layer or the laminate including that is temporarily removed from other components of the printing sheet. A stereo picture is then formed thereon through image formation by, for example, a LightJet technique and development. The light-transmissive image receiving layer or the laminate is then combined with other components and laminated in a predetermined order again.

The components of the printing sheet of the invention are now described in detail.

Light-Transmissive Image Receiving Layer:

The image receiving layer according to the invention can transmit light. Specifically, the image receiving layer preferably has a light transmittance of 70% or more, more preferably 80% or more, and most preferably 90% or more. The image receiving layer in the invention is preferably formed as a dye-image receivable layer by one of coating, spraying, and dropping. This allows formation of an image having a higher color density, and reduced crosstalk and ghosts. Throughout the specification, the “image receiving layer” refers to an image receivable layer that can receive images including a dye, i.e., refers to a layer that receives photosensitive emulsions of red, green, and blue to form an image by, for example, LightJet printing, such as a reversal film, a layer that receives a dye image to be transferred as in thermal transfer, and a layer that receives deposited dye drops to form an image as in inkjetting. The image receiving layer preferably used in the invention can receive images formed by silver halide photography (particularly, LightJet printing), thermal transfer, or inkjetting. In each case, left-eye and right-eye images having a high color density and parallax can be readily formed at desired positions corresponding to a pattern of the retardation layer through control of laser light, a thermal head, or an inkjet head for image drawing.

[Image Receiving Layer Capable of Receiving Images Formed by Silver Halide Photography]

The image receiving layer that can receive images formed by silver halide photography is preferably used in the invention. In particular, a reversal film that can receive images formed by the LightJet printing is preferably used. Use of the reversal film enables left-eye and right-eye images to be formed at a high image density each at accurate positions corresponding to the first and second domains of the retardation layer on the basis of digitalized image data through controlling, for example, laser light, resulting in reductions in crosstalk and ghost images. Use of the image receiving layer, which can receive images formed by the inkjetting or the thermal transfer described later, also contributes to reductions in crosstalk and ghost images. Use of the reversal film, however, provides not only the effect of the reduction in crosstalk and ghost images, but also an unexpected improvement in a sense of depth. As a possible reason for this, human eyes are sensitive to horizontal resolution. An image is drawn onto the image receiving layer, which can receive images formed by the silver halide photography, by the LightJet printing with laser light, and is then developed. Such an image provides continuous non-textured grayscale compared with images drawn by the inkjetting and the thermal transfer, in halftone dot grayscale. A possible reason for this is as follows: since a stereo picture becomes a higher grayscale image having a smoother sense of depth with a higher lateral (horizontal) resolution; hence, a stereo picture having a higher sense of depth is achieved in this embodiment by the image receiving layer that can receive images formed by the silver halide photography.

The image receiving layer usable in this embodiment, which can receive images formed by the silver halide photography, preferably includes a reversal film. Various reversal films can be selectively used. In particular, a reversal film, onto which images can be drawn by LightJet drawing on the basis of digital data, is preferred. The reversal film to be used preferably has a high optical density (OD) of specifically 3 or more. The printing sheets for the inkjetting and the thermal transfer each have an OD of about 1.2, and the reversal film preferably has a higher OD than that.

An example of the image receiving layer, which can receive images formed by the silver halide photography, usable in this embodiment is a full-color silver halide reversal film, onto which laser drawing can be performed by the LightJet printing, including a blue photosensitive emulsion layer, a green photosensitive emulsion layer, and a red photosensitive emulsion layer on a light-transmissive support. This example is described in detail in JP-A-10-232470 and JP-A-2002-40604, which can be used in the invention. In addition, commercially available products may be used, including, for example, Fujichrome Velvia 50 Professional RVP50, Fujichrome T64 Professional, Fujichrome PROVIA 100F Professional, Fujichrome PROVIA 400X Professional, Fujichrome ASTIA 100F Professional, Fujichrome SensiaIII 100, Fujichrome Velvia 100F Professional, Fujichrome Velvia 100 Professional, and Fujichrome TREBI 100C.

Thermal Transfer Image-Receiving Layer

In the present invention, any image-receiving layer (thermal transfer image-receiving layer) can be used for receiving an image by thermal transfer without limitation. A variety of thermal transfer image-receiving layers can be used. The main component of the image-receiving layer is preferably a resin (dye receiving polymer) that is easily dyed for receiving the dye from a transfer ink sheet and maintaining the formed image during the thermal transfer. Examples of the material for the thermal transfer image-receiving layer include polyester resins, polycarbonate resins, vinyl chloride resins, and cellulose resins. The thermal transfer image-receiving layer containing a polymer having a repeating unit represented by Formula [1] shown below is preferred because of its excellent transfer sensitivity and image retention. The polymer may be contained in the form of latex.

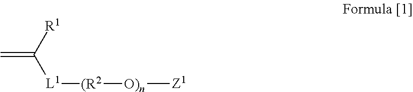

In Formula [1], R¹ represents a hydrogen atom, a halogen atom, or a methyl group; L¹ represents a divalent linker; R² represents an alkylene group having 1 to 5 carbon atoms; n represents an integer of 1 to 40; and Z¹ represents a hydrogen atom or a linear, branched, or cyclic aliphatic hydrocarbon group having 1 to 30 carbon atoms. The alkylene group represented by R² and the aliphatic hydrocarbon group represented by Z¹ may have substituents. When n is an integer of 2 or more, the two or more R²'s may be the same as or different from each other.

The halogen atom represented by R¹ is preferably a chlorine or fluorine atom.

The divalent linker represented by L¹ may be any linker and is preferably a single bond, —O—, —C(═O)—, —NR¹¹— (wherein, R¹¹ represents a hydrogen atom or an alkyl, cycloalkyl, aryl, or aralkyl group), —S—, —SO₂—, —P(═O)(OR¹²)— (wherein, R¹² represents an alkyl, cycloalkyl, aryl, or aralkyl group), an alkylene group, an arylene group, or a divalent linker formed by combining two or more of these linkers, more preferably a group represented by —C(═O)—X— or an optionally substituted phenylene group, and most preferably a group represented by —C(═O)—X—, wherein X represents an oxygen atom, a sulfur atom, or)-N(R⁰)—, wherein R⁰ represents a hydrogen atom or a substituent (the substituent is preferably an alkyl, cycloalkyl, aryl, or heterocyclic group and more preferably Rc described below). L¹ is most preferably —C(═O)—O—.

The alkylene group represented by R² may be linear or branched and is preferably linear. The number of carbon atoms is preferably two to four.

n is preferably an integer of 1 to 30, more preferably an integer of 1 to 20, and most preferably an integer of 1 to 10.

Examples of the aliphatic hydrocarbon group represented by Z¹ include alkyl groups, alkenyl groups, alkynyl groups, cycloalkyl groups, cycloalkenyl groups, and cycloalkynyl groups. Preferred are alkyl groups, alkenyl groups, cycloalkyl groups, and cycloalkenyl groups; more preferred are alkyl groups and cycloalkyl groups; and most preferred are alkyl groups.

Preferably, the alkenyl group and the alkynyl group each have 2 to 30 (preferably 2 to 20) carbon atoms, the cycloalkyl group has 3 to 30 (preferably 5 to 20) carbon atoms, and the cycloalkynyl group has 6 to 30 (preferably 6 to 20) carbon atoms, whereas the alkyl group more preferably has 1 to 20 carbon atoms.

Z¹ is preferably a hydrogen atom or an aliphatic group in the preferred range described above and more preferably a hydrogen atom or an alkyl group.

The substituents and the “optional” substituents shown in individual formulae including Formula [1] in the present invention will now be described.

In the present invention, though the substituent may be any one, substituents selected from the following group of substituents are preferred.

Group of Substituents

The group of substituents includes alkyl groups (alkyl groups preferably having 1 to 20 carbon atoms, more preferably 1 to 12 carbon atoms, and most preferably 1 to 8 carbon atoms; and examples thereof include methyl, ethyl, isopropyl, t-butyl, n-octyl, n-decyl, n-hexadecyl, cyclopropyl, cyclopentyl, and cyclohexyl groups), alkenyl groups (alkenyl groups preferably having 2 to 20 carbon atoms, more preferably 2 to 12 carbon atoms, and most preferably 2 to 8 carbon atoms; and examples thereof include vinyl, aryl, 2-butenyl, and 3-pentenyl groups), alkynyl groups (alkynyl groups preferably having 2 to 20 carbon atoms, more preferably 2 to 12 carbon atoms, and most preferably 2 to 8 carbon atoms; and examples thereof include propargyl and 3-pentynyl groups), aryl groups (aryl groups preferably having 6 to 30 carbon atoms, more preferably 6 to 20 carbon atoms, and most preferably 6 to 12 carbon atoms; and examples thereof include phenyl, p-methylphenyl, and naphthyl groups), substituted or unsubstituted amino groups (amino groups preferably having 0 to 20 carbon atoms, more preferably 0 to 10 carbon atoms, and most preferably 0 to 6 carbon atoms; and examples thereof include an unsubstituted amino group and methylamino, dimethylamino, diethylamino, and aniline groups); alkoxy groups (alkoxy groups preferably having 1 to 20 carbon atoms, more preferably 1 to 16 carbon atoms, and most preferably 1 to 10 carbon atoms; and examples thereof include methoxy, ethoxy, and butoxy groups), alkoxycarbonyl groups (alkoxycarbonyl groups preferably having 2 to 20 carbon atoms, more preferably 2 to 16 carbon atoms, and most preferably 2 to 10 carbon atoms; and examples thereof include methoxycarbonyl and ethoxycarbonyl groups), acyloxy groups (acyloxy groups preferably having 2 to 20 carbon atoms, more preferably 2 to 16 carbon atoms, and most preferably 2 to 10 carbon atoms; and examples thereof include acetoxy and benzoyloxy groups), acylamino groups (acylamino groups preferably having 2 to 20 carbon atoms, more preferably 2 to 16 carbon atoms, and most preferably 2 to 10 carbon atoms; and examples thereof include acetylamino and benzoylamino groups), alkoxycarbonylamino groups (alkoxycarbonylamino groups preferably having 2 to 20 carbon atoms, more preferably 2 to 16 carbon atoms, and most preferably 2 to 12 carbon atoms; and examples thereof include a methoxycarbonylamino group), aryloxycarbonylamino groups (aryloxycarbonylamino groups preferably having 7 to 20 carbon atoms, more preferably 7 to 16 carbon atoms, and most preferably 7 to 12 carbon atoms; and examples thereof include a phenyloxycarbonylamino group), sulfonylamino groups (sulfonylamino groups preferably having 1 to 20 carbon atoms, more preferably 1 to 16 carbon atoms, and most preferably 1 to 12 carbon atoms; and examples thereof include methanesulfonylamino and benzenesulfonylamino groups), sulfamoyl groups (sulfamoyl groups preferably having 0 to 20 carbon atoms, more preferably 0 to 16 carbon atoms, and most preferably 0 to 12 carbon atoms; and examples thereof include sulfamoyl, methylsulfamoyl, dimethylsulfamoyl, and phenylsulfamoyl groups), carbamoyl groups (carbamoyl groups preferably having 1 to 20 carbon atoms, more preferably 1 to 16 carbon atoms, and most preferably 1 to 12 carbon atoms; and examples thereof include an unsubstituted carbamoyl group and methylcarbamoyl, diethylcarbamoyl, and phenylcarbamoyl groups); alkylthio groups (alkylthio groups preferably having 1 to 20 carbon atoms, more preferably 1 to 16 carbon atoms, and most preferably 1 to 12 carbon atoms; and examples thereof include methylthio and ethylthio groups), arylthio groups (arylthio groups preferably having 6 to 20 carbon atoms, more preferably 6 to 16 carbon atoms, and most preferably 6 to 12 carbon atoms; and examples thereof include a phenylthio group), sulfonyl groups (sulfonyl groups preferably having 1 to 20 carbon atoms, more preferably 1 to 16 carbon atoms, and most preferably 1 to 12 carbon atoms; and examples thereof include mesyl and tosyl groups), sulfinyl groups (sulfinyl groups preferably having 1 to 20 carbon atoms, more preferably 1 to 16 carbon atoms, and most preferably 1 to 12 carbon atoms; and examples thereof include methanesulfinyl and benzenesulfinyl groups), ureido groups (ureido groups preferably having 1 to 20 carbon atoms, more preferably 1 to 16 carbon atoms, and most preferably 1 to 12 carbon atoms; and examples thereof include an unsubstituted ureido group and methylureido and phenylureido groups), phosphoric amido groups (phosphoric amido groups preferably having 1 to 20 carbon atoms, more preferably 1 to 16 carbon atoms, and most preferably 1 to 12 carbon atoms; and examples thereof include diethylphosphoric amide and phenylphosphoric amide groups), a hydroxy group, a mercapto group, halogen atoms (e.g., fluorine, chlorine, bromine, and iodine atoms), a cyano group, a sulfo group, a carboxyl group, a nitro group, a hydroxamic acid group, a sulfino group, a hydrazino group, an imino group, heterocyclic groups (heterocyclic groups preferably having 1 to 30 carbon atoms and more preferably 1 to 12 carbon atoms; and examples thereof include heterocyclic groups having hetero atoms such as nitrogen, oxygen, and sulfur atoms, e.g., imidazolyl, pyridyl, quinolyl, furyl, piperidyl, morpholino, benzoxazolyl, benzimidazolyl, and benzthiazolyl groups), and silyl groups (silyl groups preferably having 3 to 40 carbon atoms, more preferably 3 to 30 carbon atoms, and most preferably 3 to 24 carbon atoms; and examples thereof include trimethylsilyl and triphenylsilyl groups).

These substituents may be further substituted by these substituents. When a substituent is substituted by two or more substituents, the substituents may be the same or different and may be bonded to each other to form a ring, if possible.

The monomer represented by Formula [1] is preferably a monomer represented by Formula [2]:

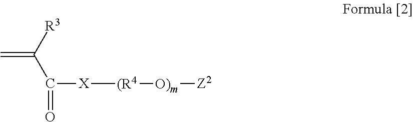

In Formula [2], R³ represents a hydrogen atom, a halogen atom, or a methyl group; X represents an oxygen atom, a sulfur atom, or —N(Rc)—, wherein Rc represents a hydrogen atom or an optionally substituted alkyl or cycloalkyl group having 1 to 8 carbon atoms; R⁴ represents an alkylene group having 1 to 5 carbon atoms; m represents an integer of 1 to 40; and Z² represents a hydrogen atom or a linear, branched, or cyclic aliphatic hydrocarbon group having 1 to 30 carbon atoms. The alkyl or cycloalkyl group represented by Rc, the alkylene group represented by R⁴, and the aliphatic hydrocarbon group represented by Z² may have substituents. When m is an integer of 2 or more, the two or more R⁴'s may be the same as or different from each other.

R³, R⁴, m, and Z² are respectively synonymous with R¹, R², n, and Z¹ in Formula [1], and the preferred ranges thereof are also the same.

X is preferably an oxygen atom. The alkyl group represented by Rc preferably has 3 to 8 carbon atoms, and the cycloalkyl group represented by Rc preferably has 3 to 8 carbon atoms.

The monomer represented by Formula [1] or [2] is more preferably a monomer represented by Formula [3]:

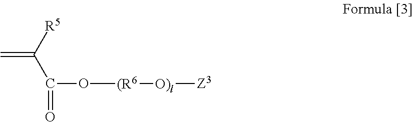

In Formula [3], R⁵ represents a hydrogen atom, a halogen atom, or a methyl group; R⁶ represents an alkylene group having 2 to 4 carbon atoms; l represents an integer of 1 to 40; and Z³ represents a hydrogen atom or a linear, branched, or cyclic aliphatic hydrocarbon group having 1 to 20 carbon atoms. The alkylene group represented by R⁶ and the aliphatic hydrocarbon group represented by Z³ may have substituents. When l is an integer of 2 or more, the two or more R⁴'s may be the same as or different from each other.

R⁵, R⁶, and l are respectively synonymous with R¹, R², and n in Formula [1], and the preferred ranges thereof are also the same. Z³ is the same as preferred examples of Z¹ in Formula [1].

Preferable examples of the monomers represented by Formulae [1] to [3] include compounds disclosed in paragraphs [0035] to [0037] of JP-A-2008-105397 and in paragraphs [0030] to [0033] of JP-A-2008-105398.

The monomers represented by Formulae [1] to [3] are commercially available as Blemmer series manufactured by NOF Corporation and Aronics series manufactured by Toagosei Co., Ltd., and these commercial products may also be used.

The polymer having a repeating unit derived from a monomer represented by Formula [1], [2], or [3] may be a copolymer with a different monomer. Examples of the different monomer include monomers disclosed in paragraphs [0039] to [0042] of JP-A-2008-105397, and the preferable examples are also the same. Specific examples of the polymer include polymers disclosed in paragraphs [0043] to [0047] of JP-A-2008-105397. Furthermore, as described above, such a polymer may be contained in the thermal transfer image-receiving layer as polymer latex. The polymer latex is also preferably a copolymer of a monomer represented by Formula [1], [2], or [3] with a different monomer. Examples of the different monomer constituting the polymer latex include the monomers disclosed in paragraphs [0035] to [0048] of JP-A-2008-105398, and the preferable examples are also the same. Furthermore, preferable examples of the polymer latex include copolymers disclosed in paragraphs [0053] to [0057] of JP-A-2008-105398, and the details of the polymer latex are as in the embodiment disclosed in paragraphs [0049] to [0051] of JP-A-2008-105398.

The image-receiving layer may contain at least one different polymer and/or polymer latex, in combination with the polymer having a repeating unit of the monomer represented by Formula [1] and the polymer latex. Examples of the different polymer and/or different polymer latex that can be used in combination include those disclosed in paragraphs [0049] to [0074] of JP-A-2008-105397 and in paragraphs to [0075] of JP-A-2008-105398.

The image-receiving layer can be formed by applying a coating composition of which main component polymer is a polymer having a repeating unit of the monomer represented by Formula [1] to a surface, and drying the coating film. The coating composition may be prepared using an organic solvent (e.g., methyl ethyl ketone or toluene), and if possible, a solvent mixture of water and an organic solvent may be used. The coating composition may contain one or more additives such as an ultraviolet absorber, a release agent, and an antioxidant, in combination with the main component polymer. The ultraviolet absorber and the antioxidant are added for improving the durability of the image-receiving layer. The release agent is added for preventing thermal fusion with the thermal transfer sheet laminated during the formation of an image. Examples of the release agent include silicone oils, phosphate ester plasticizers, and fluorine compounds. In particular, the silicone oils are preferred. The silicone oils are preferably modified silicone oils such as epoxy-modified, alkyl-modified, amino-modified, carboxyl-modified, alcohol-modified, fluorine-modified, alkyl aralkyl polyether-modified, epoxy/polyether-modified, and polyether-modified silicone oils. Among these silicone oils, reaction products of a vinyl-modified silicone oil and a hydrogen-modified silicone oil are preferred. The amount of the release agent is preferably 0.2 to 30 parts by mass of the amount of the main component polymer.

The image receiving layer can be formed through application of the coating composition onto a surface of an appropriate component followed by drying the applied coating composition. The application can be performed by any typical coating technique, for example, extrusion die coating, air doctor coating, bread coating, rod coating, knife coating, squeeze coating, reverse roll coating, or bar coating. The coating composition may be applied in any coating density. The preferred coating density typically ranges from 0.5 to 10 g/m² (on the basis of solid content). The image receiving layer for thermal transfer may have any thickness. The preferred thickness typically ranges from 1 to 20 μm.

The image receiving layer for thermal transfer may be a laminate of two or more layers, for example, a laminate of an image receiving layer containing the above-described polymer and an intermediate layer. In this embodiment, the intermediate layer is preferably disposed between the image receiving layer and the linearly polarizing layer. The intermediate layer prevents degradation of the linearly polarizing layer and other layers below the image receiving layer caused by heat from a thermal head during thermal transfer, regulates charging, improves adhesion, or improves printing sensitivity. The intermediate layer is described in detail in paragraphs [0085] to of JP-A-2008-105397 as a reference.

Two or more intermediate layers may be formed depending on the intended use. In a preferred embodiment having the intermediate layer, an image receiving layer and at least one intermediate layer are formed through simultaneous application by dual-layer coating followed by drying.

[Inkjet Image Receiving Layer]

Any image receiving layer (inkjet image receiving layer), which can receive an image by inkjetting, is usable in the present invention. Various inkjet image receiving layers can be appropriately selected. The inkjet image receiving layer is preferably composed of a material to be readily dyed in order to receive a dye in an ink drop deposited by inkjetting, and to maintain a formed image. In particular, a preferred image receiving layer includes a composition containing inorganic fine particles and water-soluble resin. This embodiment is now described in detail.

The image receiving layer containing inorganic fine particles and water-soluble resin can be formed through application of a solution (hereinafter, often referred to as “image-receiving-layer formation solution”) containing inorganic fine particles and water-soluble resin onto a surface of an appropriate component followed by drying the applied solution. The image-receiving-layer formation solution can be applied by any typical coating technique as in the application of the coating composition for formation of the thermal-transfer image receiving layer, such as extrusion die coating, air doctor coating, bread coating, rod coating, knife coating, squeeze coating, reverse roll coating, or bar coating.

In such coating, a basic solution having a pH of 7.1 or more is preferably added to the relevant coating layer during the application of the image-receiving-layer formation solution, or before the image receiving layer exhibits decreasing drying in the midway of the drying process. In other words, the image receiving layer is preferably manufactured through introduction of the basic solution having a pH of 7.1 or more before the applied layer exhibits constant rate drying.

The basic solution having a pH of 7.1 or more may contain a cross-linking agent and/or other agents if necessary. The basic solution having a pH of 7.1 or more is used as an alkaline solution to accelerate the hardening of the image receiving layer. The pH of the basic solution is preferably 7.5 or more, and more preferably 7.9 or more. If the pH is close to an acidic side, the water-soluble resin insufficiently reacts with the cross-linking agent, often causing bronzing and/or defects such as crazing in the image receiving layer

For example, the basic solution having a pH of 7.1 or more can be prepared by adding a metal compound (for example, 1 to 5%), a basic compound (for example, 1 to 5%), and p-toluenesulfonic acid (for example, 0.5 to 3%) into deionized water, and agitating the components. The unit “%” for each component refers to mass percent of the solid content.

The above-described “before the applied layer exhibits decreasing drying” commonly refers to a period for several minutes immediately after application of the coating solution, during which the applied layer exhibits “constant rate drying” where the content of a solvent (dispersion medium) in the applied layer decreases in proportion to time. The period of the “constant rate drying” is described in Kagakukougaku Binran (Chemical Engineering Handbook), pp. 707 to 712, issued by Maruzen Company, Limited, 1978, for example.

As described above, the image-receiving-layer formation solution is applied and then dried over a certain period before exhibiting the decreasing drying. In the certain period, the drying process is typically performed at 40 to 180° C. for 0.5 to 10 min, preferably 0.5 to 5 min. Although the drying time varies depending on the coating density, it is commonly within the above-described range.

The thickness of the image receiving layer after drying of the image-receiving-layer formation solution must be determined in relation to the porosity of the layer so that the image receiving layer has sufficient capacity to absorb all ink drops. For example, if the amount of ink is 8 nL/mm² at a porosity of 60%, the layer must have a thickness of about 15 μm or more. In light of this point, a preferred thickness of the image receiving layer is 10 to 50 μm.

The pore size of the image receiving layer is preferably 0.005 to 0.030 μm, and more preferably 0.01 to 0.025 μm in median size.

The porosity and the pore median size can be measured with a mercury porosimeter (BORESIZER 9320-PC2, available from Shimadzu Corp.).

(Inorganic Fine Particle)

Examples of the inorganic fine particle include fine silica particles, colloidal silica, titanium dioxide, barium sulfate, calcium silicate, zeolite, kaolinite, halloysite, mica, talc, calcium carbonate, magnesium carbonate, calcium sulfate, boehmite, and quasi-boehmite. In particular, fine silica particles are preferred.

The fine silica particles have a large specific surface area, and have high ink absorbance and retention characteristics. In addition, the fine silica particles have a low refractive index. Thus, the image receiving layer can be highly transparent through dispersion of the fine silica particles into an appropriate agglomeration size, leading to high color density and excellent chromogenicity. Such a transparent image receiving layer is advantageous to achieve high color density and excellent chromogenicity and glossiness.

The average primary particle size of the inorganic fine particles is preferably 20 nm or less, more preferably 15 nm or less, and most preferably 10 nm or less. An average primary particle size of 20 nm or less effectively improves the ink absorption characteristics of the image receiving layer, and improves the glossiness of the surface of the image receiving layer.

The specific BET surface area of the inorganic fine particles is preferably 200 m²/g or more, more preferably 250 m²/g or more, and most preferably 380 m²/g or more. The specific surface area of the inorganic fine particles of 200 m²/g or more improves the transparency of the image receiving layer, achieving high printing density.

The BET method in the present invention is a measurement of the surface area of powder by means of gas phase adsorption, in which the total surface area of a one-gram sample, namely, specific surface area, is determined from an adsorption isotherm. Nitrogen gas is typically used as adsorption gas. In the commonest method, the amount of adsorbed gas is determined from a variation in pressure or volume of the gas. The Brunauer-Emmett-Teller equation is most famous as an equation expressing a multimolecular adsorption isotherm, which is called BET equation and widely used for determination of surface area. The amount of adsorbed gas is determined from the BET equation, and is then multiplied by the area occupied by one absorbed molecule on a surface, so that the surface area is determined.

In particular, the fine silica particles have silanol groups on their surfaces, and the particles readily adhere to one another by hydrogen bonds between the silanol groups, or adhere to one another via the silanol groups and the water-soluble resin. As a result of the effects of such adhesion, at an average primary particle size of 20 nm or less as described above, the image receiving layer can have a high porosity and high transparency which can significantly improve the ink absorption characteristics.

Typically, the fine silica particles are roughly classified into wet-process particles and dry-process (gas-phase-process) particles depending on their manufacturing processes. In the mainstream of the wet process, active silica is produced by acid decomposition of silicate, and the active silica is appropriately polymerized to be aggregated and precipitated to produce hydrous silica. In the mainstream of the gas phase process, anhydrous fine silica particles are produced by high-temperature gas-phase hydrolysis (flame hydrolysis) of silica halide, or by heating, deoxidizing, and vaporizing silica sand and coke with arc in an electric furnace, and oxidizing the vapored silica in air (arc process). The “gas-phase silica” refers to the anhydrous fine silica particles produced by that gas phase process.

The gas-phase silica has different properties from the hydrous silica in, for example, density of the silanol groups on a surface and porosity, and is suitable for formation of a three-dimensional structure having high porosity. The reason for this is assumed as follows. With hydrous silica, the density of the silanol groups on the surfaces of the fine particles is as high as, 5 to 8/nm², and thus the fine silica particles readily aggregate densely. With gas-phase silica, the density of the silanol groups on the surfaces of the fine particles is as low as, 2 to 3/nm², and thus the fine silica particles thinly flocculate, resulting in a highly porous structure.

In the invention, preferred is gas-phase fine silica particles (anhydrous silica) produced by a dry process, and more preferred is fine silica particles having a density of the silanol groups on the surfaces thereof of 2 to 3/nm². The most preferred inorganic fine particles usable in the invention are gas-phase silica particles having a specific BET surface area of 200 m²/g or more.

Water-Soluble Resins

Examples of the water-soluble resins include polyvinyl alcohol resins containing hydroxy hydrophilic groups, such as polyvinyl alcohol (PVA), acetaldehyde-modified polyvinyl alcohols, cationically-modified polyvinyl alcohols, anionically-modified polyvinyl alcohols, silanol-modified polyvinyl alcohols, and polyvinyl acetals; cellulosic resins, such as methyl cellulose (MC), ethyl cellulose (EC), hydroxyethyl cellulose (HEC), carboxymethyl cellulose (CMC), hydroxypropyl cellulose (HPC), hydroxyethylmethyl cellulose, and hydroxypropylmethyl cellulose; chitin; chitosan; starch; resins containing ether bonds, such as polyethylene oxide (PEO), polypropylene oxide (PPO), and polyvinyl ether (PVE); and resins containing carbamoyl groups such as polyacrylamide (PAAM), polyvinyl pyrrolidone (PVP), and polyacrylic hydrazide.

Examples of the water soluble resins further include resins containing carboxylic groups and/or their salts as dissociating groups, such as polyacrylic acid, polymaleic acid, arginic acid, and gelatins.

Among them, particularly preferred are polyvinyl alcohol resins. Examples of the polyvinyl alcohol resins include those described in JP-B-04-52786, JP-B-05-67432, JP-B-07-29479, Japanese Patent No. 2537827, JP-B-07-57553, Japanese Patent No. 2502998, Japanese Patent No. 3053231, JP-A-63-176173, Japanese Patent No. 2604367, JP-A-07-276787, JP-A-09-207425, JP-A-11-58941, JP-A-2000-135858, JP-A-2001-205924, JP-A-2001-287444, JP-A-62-278080, JP-A-09-39373, Japanese Patent No. 2750433, JP-A-2000-158801, JP-A-2001-213045, JP-A-2001-328345, JP-A-08-324105, and JP-A-11-348417.

Examples of the water-soluble resins other than polyvinyl alcohol resins include those described in paragraphs [0011] to [0014] in JP-A-11-165461.

These water-soluble resins may be used alone or in combination of two or more.

The content of the water-soluble resins used in the present invention is preferably 9 to 40 mass %, more preferably 12 to 33 mass %, based on the total solid mass of the image receiving layer.

The inorganic fine particles and the water-soluble resins which are main components of the image receiving layer may be each composed of a single component or a mixture of different components.

The selection of the water-soluble resins combined with the inorganic fine particles is critical in order to retain transparency to improve the color concentrations of the image. The water-soluble resins preferably include polyvinyl alcohol resins, more preferably polyvinyl alcohol resins with a saponification number of 70 to 100%, still more preferably polyvinyl alcohol resins with a saponification number of 80 to 99.5%.

The polyvinyl alcohol resins may be used in combination with water-soluble resins other than the polyvinyl alcohol resins. When it is used in combination, the content of the polyvinyl alcohol resin is preferably 50 mass % or more, more preferably 70 mass % or more of the total mass of the water-soluble resins.

The mass ratio of the inorganic fine particles (x) to the water-soluble resins (y) (PB ratio (x:y)) strongly affects the film structure and strength of the image receiving layer as well. That is, the porosity, pore volume, and surface area (per unit mass) tend to increase, while the density and strength tend to decrease as the mass ratio (PB ratio) increases.

The mass ratio (PB ratio (x:y)) of the image receiving layer in the present invention is preferably 1.5:1 to 10:1, in order to prevent a decrease in the film strength and cracking during drying caused by too large a PB ratio, and to prevent a decrease in the ink absorbability caused by reduced porosity resulting from the blocking of the pores with the resin, which is more likely to occur when the PB ratio is too small.

The image receiving layer should have sufficient film strength since stress may be applied to a photographic paper passing through a carrying system of an image-recording devices. Furthermore, the image receiving layer should have sufficient film strength to prevent cracking, peeling and other damage during the cutting of a photographic paper into sheets. Given these considerations, the mass ratio (x:y) is more preferably 5:1 or less, while in order to, for example, assure sufficient ink absorbability for inkjet printers, the mass ratio is more preferably 2:1 or more.

When, for example, an aqueous dispersion containing vapor-phase silica with a primary particle size of 20 nm or less and a water-soluble resin in a mass ratio (x:y) of 2:1 to 5:1 is applied to a support and subsequently dried, a three-dimensional network structure containing secondary particles of the silica fine particles as the network chains can be easily formed, resulting in the formation of translucent porous films with an average pore diameter of 30 nm or less, a porosity of 50 to 80%, a specific pore volume of 0.5 ml/g or more, specific surface area of 100 m²/g or higher.

The dispersion for forming the image receiving layer can be prepared, for example, as in the following.

When vapor-phase silica is used as the inorganic fine particles, a dispersion for forming the image receiving layer can be prepared by adding vapor-phase silica and a dispersant to water (for example 10 to 20 mass % vapor-phase silica in water), dispersing the mixture using a counter-collision high-pressure homogenizer (for example, “Ultimizer” manufactured by Sugino Machine Ltd.) at a high pressure of 120 MPa (preferably 100 to 200 MPa), followed by the addition of a boron compound, a PVA solution (for example, about one-third of the vapor-phase silica in mass), and other components with stirring. The resulting dispersion for forming the image receiving layer is in a homogeneous sol state, can be applied to a support to form a porous image receiving layer with a three-dimensional network structure.

An aqueous dispersion can be obtained by mixing the vapor-phase silica and the dispersant, followed by division of the particles in the mixture into smaller particles with an average diameter of 50 to 300 nm using a dispersing machine. While known different dispersing machines, such as high-speed rotary dispersing machines, media agitating dispersing machines (e.g., ball mills and sand mills), ultrasound dispersing machines, colloid mill dispersing machines, and high-pressure dispersing machines can be used for obtaining the aqueous dispersion, preferably colloid mill dispersing machines and high-pressure dispersing machines, more preferably counter-collision high-pressure dispersing machines and orifice-passage high-pressure dispersing machines are used in order to efficiently disperse lumps formed by aggregated fine particles during the operation.

The solvent used for the above preparation may be water, organic solvents, or combination thereof. Examples of the organic solvents that can be used for this application include alcohols, such as methanol, ethanol, n-propanol, i-propanol and methoxypropanol; ketones, such as acetone and methyl ethyl ketone; and other solvents, such as tetrahydrofuran, acetonitrile, ethyl acetate, and toluene.

The usable dispersant may be cationic polymers. Examples of the cationic polymers include the aforementioned organic mordants, dyeing polymers, and polyimine. Silane coupling agents can also be preferably used as the dispersant.

The amount of the dispersant added is preferably 0.1 mass % to 30 mass %, more preferably 1 mass % to 10 mass %, based on the mass of the fine particles.

The inkjet image receiving layer of the present invention may contain a variety of known additives as required, such as cross-linkers, acids, UV absorbers, antioxidants, fluorescence enhancers, monomers, polymerization initiators, polymerization inhibitors, anti-exudation agents, preservatives, viscosity stabilizers, antifoams, surfactants, antistatic agents, matting agents, anti-curl agents, and water resistant agents.

Preferred cross-linkers for the water-soluble resins, especially for polyvinyl alcohols, are boron compounds. Examples of the boron compounds include, borax, boric acid, borates such as orthoborates (e.g., InBO₃, ScBO₃, YBO₃, LaBO₃, Mg₃(BO₃)₂, and Co₃(BO₃)₂) diborates (e.g., Mg₂B₂O₅, and Co₂B₂O₅), metaborates (e.g., LiBO₂, Ca(BO₂)₂, NaBO₂, and KBO₂), tetraborates(e.g., Na₂B₄O₇.10H₂O), and pentaborates (e.g., K₂B₅O₈.4H₂O, Ca₂B₆O₁₁.7H₂O, and CsB₅O₅). Among these compounds, preferred are borax, boric acid, and borates in terms of their high cross-link reaction rates. Especially preferred is boric acid.

The cross-linkers usable for the water-soluble resins may be compounds other than boron compounds. Examples of the compounds other than boron compounds include aldehydes, such as formaldehyde, glyoxal, and glutaraldehyde; ketones, such as diacetyl and cyclopentanedione; activated halogen compounds, such as bis(2-chloroethylurea)-2-hydroxy-4,6-dichloro-1,3,5-triazine and 2,4-dichloro-6-s-triazine sodium salt; activated vinyl compounds, such as divinylsulfonic acid, 1,3-vinylsulfonyl-2-propanol, N,N′-ethylenebis(vinylsulfonylacetamide), and 1,3,5-triacryloyl-hexahydro-s-triazine; N-methylol compounds, such as dimethylolurea and methyloldimethylhydantoin; melamine resins, such as methylolmelamine and alkylated methylol melamine; epoxy resins; isocyanates, such as 1,6-hexamethylene diisocyanate; aziridines described in the specifications of U.S. Pat. Nos. 3,017,280 and 2,983,611; carboxylmides described in the specification of U.S. Pat. No. 3,100,704; epoxy compounds, such as glycerol triglycidyl ether; ethyleneimino compounds, such as 1,6-hexamethylene-N,N′-bis(ethyleneurea); halogenated carboxyaldehydes, such as mucochloric acid, and mucophenoxychloric acid; dioxanes, such as 2,3-dihydroxydioxane; metal-containing compounds, such as titanium lactate, aluminum sulphate, chromium alum, potassium alum, zirconyl acetate, and chromium acetate; polyamines, such as tetraethylenepentamine; hydrazides, such as dihydrazide adipate; and small molecules or polymers containing two or more oxazoline moieties.

The cross-linkers can be used alone or in combination of two or more.

The amount of the cross-linkers used is preferably 1 to 50 mass %, more preferably 5 to 40 mass %, based on the mass of the water-soluble resin.

The image receiving layer of the present invention may contain an acid. The surface pH of the image receiving layer is adjusted to 3 to 8, preferably 5 to 7.5, by adding an acid. The addition of acid is preferred to improve anti-yellowing property of white background. The measurement of the surface pH values is performed according to method A (application method) of measuring the surface pH defined by Japan Technical Association of the Pulp and Paper Industry (J. TAPPI). The measurement can be performed using an equivalent to method A, namely a measurement kit “MPC model” from Kyoritsu Chemical-Check Lab., Corp.

Examples of the acid include formic, acetic, glycolic, oxalic, propionic, malonic, succinic, adipic, maleic, malic, tartaric, citric, benzoic, phthalic, isophthalic, glutaric, gluconic, lactic, aspartic, glutamic, and salicylic acids; metal salicylates (Zn, Al, Ca, and Mg salts); methanesulfonic, itaconic, benzenesulfonic, toluenesulfonic, trifluoromethanesulfonid, styrenesulfonic, trifluoroacetic, barbituric, acrylic, methacrylic, cinnamic, 4-hydroxybenzoic, aminobenzoic, naphthalenedisulfonic, hydroxybenzenesulfonic, toluenesulfinic, benzenesulfinic, sulfanilic, sulfamic, alpha-resorcinic, beta-resorcinic, gamma-resorcinic, and gallic acids; phloroglucin; sulfosalicylic, ascorbic, erythorbic, and bisphenolic acids; hydrochloric, nitric, sulfuric, phosphoric, polyphosphoric, boric, and boronic acids. The amount of these acids added may be determined such that the surface pH value of the image receiving layer is 3 to 8.

The acids may be used in the form of metal salts (e.g., sodium, potassium, calcium, cesium, zinc, copper, iron, aluminum, zirconium, lanthanum, yttrium, magnesium, strontium, and cerium salts) or amine salts (e.g., salts of ammonia, triethylamine, tributylamine, piperazine, 2-methylpiperazine, polyallylamine).

The image receiving layer of the present invention preferably contains storage improvers, such as UV absorbers, antioxidants, and anti-exudation agents.

Examples of the UV absorbers, antioxidants, and anti-exudation agents include alkylated phenols (including hindered phenols), alkylthiomethylphenols, hydroquinones, alkylated hydroquinones, tocopherols, thiodiphenyl ethers, compounds having two or more thioether bonds, bisphenols, O—, N—, and S-benzyl compounds, hydroxybenzyl compounds, triazines, phosphonates, acylaminophenols, esters, amides, ascorbic acid, amine antioxidants, 2-(2-hydroxyphenyl)benzotriazoles, 2-hydroxybenzophenones, acrylates, water-soluble or hydrophobic metal salts, organometallic compounds, metal complexes, hindered amines (including TEMPO), 2-(2-hydroxyphenyl)-1,3,5-triazines, metal deactivators, phosphites, phosphonites, hydroxyamines, nitrones, peroxide scavengers, polyamide stabilizers, polyethers, basic costabilizers, nucleating agents, benzoflanones, indolinones, phosphines, polyamines, thioureas, ureas, hydrazides, amidines, saccharides, hydroxybenzoic acids, dihydroxybenzoic acids, and trihydroxybenzoic acids.

Among these compounds, preferred are alkylated phenols, compounds having two or more thioether bonds, bisphenols, ascorbic acid, amine antioxidants, water-soluble or hydrophobic metal salts, organometallic compounds, metal complexes, hindered amines, hydroxyamines, polyamines, thioureas, hydrazides, hydroxybenzoic acids, dihydroxybenzoic acids, and trihydroxybenzoic acids.

The storage improvers can be added to the dispersion for preparing the image receiving layer, and can be used alone or in combination of two or more. The storage improvers can be water-soluble, dispersed, polymer-dispersed, emulsified, oil droplet for use, or they may be microcapsulated for use. The amount of the storage improvers used in the image receiving layer of the present invention is preferably 0.01 to 10 g/m².

When vapor-phase silica is used as the inorganic fine particles, the surface of the silica may be treated with a silane coupling agent in order to improve its dispersibility. Preferred coupling agents each have one or more organic functionalities (e.g., vinyl, amino (primary, secondary, and tertiary aminos, and quaternary ammonium), epoxy, mercapto, chloro, alkyl, phenyl, and ester groups), in addition to a coupling moiety.

The image receiving layer of the present invention preferably contains a high-boiling point organic solvent in order to prevent it from curling. The high-boiling organic solvent is an water-soluble or hydrophobic organic compound with a boiling point of 150° C. or higher at normal pressure. The organic solvent may be liquid or solid at room temperature, and may be a small molecule or a polymer.

Examples of the storage improvers include aromatic carboxylic acid esters (e.g., dibutyl phthalate, diphenyl phthalate, and phenyl benzoate), aliphatic carboxylic acid esters (dioctyladipate, dibutyl sebacate, methyl stearate, dibutyl maleate, dibutyl fumarate, and triethyl acetylcitrate), phosphoric acid esters (e.g., trioctyl phosphate, and tricresyl phosphate), epoxidized compounds (e.g., epoxidized soybean oil, and epoxidized aliphatic acid methyl esters), alcohols (e.g., stearyl alcohol, ethylene glycol, propylene glycol, diethylene glycol, triethylene glycol, glycerin, diethylene glycol monobutyl ether, triethylene glycol monobutyl ether, glycerin monomethyl ether, 1,2,3-butanetriol, 1,2,4-butanetriol, 1,2,4-pentanetriol, 1,2,6-hexanetriol, 1,2-hexanediol, thiodiglycol, triethanolamine, and polyethylene glycol), vegetable oils (e.g., soybean oil, and sunflower oil), and higher aliphatic carboxylic acids (e.g., linoleic acid, and oleic acid).

Among these compounds, preferred are diethylene glycol monobutyl ether, triethylene glycol monobutyl ether, and 1,2-hexanediol in order to improve ink absorption speed and to prevent a decrease in the density of the printed image.

The image receiving layer of the present invention may contain a dispersion of polymer fine particles. The objects of the use of the dispersion of polymer fine particles is to improve the physical properties of the film, such as size stabilization, curl prevention, adhesion prevention, and film cracking prevention. Dispersions of polymer fine particles are described in JP-A-62-245258, JP-A-62-1316648, and JP-A-62-110066. It is noted that polymer fine particles with a low glass transition temperature (40° C. or below) in the image receiving layer prevent cracking and curling of the layer.

Linearly Polarizing Layer

The photographic paper of the present invention has a linearly polarizing layer. Any linearly polarizing layer that can linearly polarize light scillating in any direction such as natural sunlight can be selected as required. The single layer transmittance of the polarizing layer is preferably 30% or more, more preferably 35% or more, most preferably 40% or more. A single layer transmittance less than 30% results in a marked decrease in light utilization efficiency. The optical density of the absorption axis of the polarizing layer is preferably 1 or more, more preferably 1.5 or more, most preferably 2 or more. The Optical density of the absorption axis of the polarizing layer less than 1 results in a marked decrease in polarization, leading to cross-talk and formation of ghost images.

The wavelength band preferably ranges from 400 to 800 nm in terms of converting visible light to polarized light. Although the polarizing layer may have any thickness depending on purposes, the thickness is preferably 0.01 to 2 micrometers, more preferably 0.05 to 2 micrometers in terms of improved optical properties, reduced parallax error, and easiness of fabrication.

There are no restrictions on the materials of the linearly polarizing layer, and fabrication methods thereof. Examples of the linearly polarizing layer favorably include iodine polarizing plates, dye polarizing plates using dichroic dyes, and polyene polarizing plates. Among these materials, iodine and dye polarizing plates can be fabricated by stretching polyvinyl alcohol films followed by the adsorption of iodine or dichroic dyes on the stretched film.

The following linearly polarizing films, which have relatively high polarization, can also be used for the linearly polarizing layers of the present invention, in addition to the stretching types of polarizing plates described above. Preferred examples of the linearly polarizing layers include linearly polarizing plates using polymeric cholesteric liquid crystals described in JP-A-2000-352611; guest-host type linear polarizing plates using uniaxially oriented liquid crystals containing dichroic dyes described in JP-A-11-101964, JP-A-2006-161051, JP-A-2007-199237, JP-T-2002-527786, JP-T-2006-525382, JP-T-2007-536415, JP-T-2008-547062, and Japanese Patent No. 3335173; wire grid polarizing plates using grids of metals such as aluminum described in JP-A-55-95981; polarizing plates consisting of polymers or liquid crystals in which carbon nanotubes are dispersed and arranged, described in JP-A-2002-365427; polarizing plates consisting of polymers in which metal fine particles are dispersed and arranged, described in JP-A-2006-184624; polyvinylene linearly polarizing plates described in JP-A-11-248937, JP-T-10-508123, JP-T-2005-522726, JP-T-2005-522727, and JP-T-2006-522365; polarizing plates consisting of lyotropic liquid crystalline dyes represented by (chromogens) (SO₃M)ₙ described in JP-A-07-261024, JP-A-08-286029, JP-A-2002-180052, JP-A-2002-90526, JP-A-2002-357720, JP-A-2005-154746, JP-A-2006-47966, JP-A-2006-48078, JP-A-2006-98927, JP-A-2006-193722, JP-A-2006-206878, JP-A-2006-215396, JP-A-2006-225671, JP-A-2006-328157, JP-A-2007-126628, JP-A-2007-133184, JP-A-2007-145995, JP-A-2007-186428, JP-A-2007-199333, JP-A-2007-291246, JP-A-2007-302807, JP-A-2008-9417, JP-T-2002-515075, JP-T-2006-518871, JP-T-2006-508034, JP-T-2006-531636, JP-T-2006-526013, and JP-T-2007-512236; and polarizing plates consisting of dichroic dyes described in JP-A-08-278409 and JP-A-11-305036. Cholesteric liquid crystals usually circularly polarizes light, while they can linearly polarize light when combined with quarter-wavelength layers. The quarter-wavelength layer is preferably formed from a composition containing at least one liquid crystalline compound, and preferably formed by rendering a composition containing at least one liquid crystalline compound having a polymerizing group to a liquid crystalline phase, and then curing the phase by heat and/or irradiating with UV light. Preferred are iodine polarizing plates, dye polarizing plates using dichroic dyes, polarizing plates consisting of lyotropic liquid crystalline dyes, and polarizing plates consisting of dichroic dyes in terms of polarization.

Among these linearly polarizing layers, preferred are those of coating types formed by applying a liquid crystalline composition containing a dichroic dye, in terms of the ability of preparing thin films. Utilization of linearly polarizing layers accomplishing a high dichroic ratio with a thin film provides clear three dimensional images. A linearly polarizing layer composed of a liquid crystal composition containing a dichroic dye will now be described in detail.

[Dichroic Pigment]

The “dichroic dye” used for formation of an embodiment of the linearly polarizing layer refers to a dye having different absorbances depending on directions. In addition, the “dichroism” or “dichroic ratio” represents a ratio of the absorbance of polarized light in an absorption axis direction to the absorbance of polarized light in a polarization axis direction when a dichroic dye layer is composed of a dichroic dye composition. The dichroic dye used for formation of the linearly polarizing layer preferably has liquid crystallinity. The liquid crystal composition containing a dichroic dye (hereinafter, often referred to as “dichroic dye composition”) used for formation of the linearly polarizing layer may contain a liquid-crystalline non-coloring low-molecular compound, the proportion of which is preferably 30 mass % or less, more preferably 20 mass % or less, further preferably 10 mass % or less, and most preferably 5 mass % or less. Specifically, the dichroic dye molecules in the liquid crystal composition usable in the invention preferably align by its self alignment function or in conjunction with another dye, and function as a dichroic dye layer after being fixed to the aligned state. For example, a composition containing a non-coloring liquid crystal compound as a main component in addition to the dichroic dye can be used to prepare a so-called gest-host (GH) composition, in which the molecules of the dichroic dye are aligned along the aligned molecules of the liquid crystal compound to achieve a predetermined dichroic ratio. The above-described embodiment, however, advantageously achieves a higher dichroic ratio than that in the embodiment of the GH composition. The composition used in the invention contains a small or null amount of liquid-crystalline non-coloring low-molecular compound, thereby achieving a high dye concentration. As a result, the thickness of the linearly polarizing layer can be reduced.

In another preferred embodiment, the linearly polarizing layer formed of the liquid crystal composition has a diffraction peak in X-ray diffractometry due to a periodic structure in a direction perpendicular to an alignment axis, in which the period indicated by one diffraction peak is 3.0 to 15.0 Å, and the intensity of the diffraction peak has no maximum within a range of ±70° with respect to a normal to a film in a plane perpendicular to the alignment axis.

The alignment axis refers to a direction in which the linearly polarizing layer exhibits the largest absorbance to linearly polarized light, and typically corresponds to the aligned direction. For example, if a film contains a dichroic dye composition that is fixedly aligned in a horizontal direction, the alignment axis is in a plane of the film, and is along an aligned direction corresponding to a rubbed direction if a rubbing aligned film is used in the invention, or corresponding to a direction in which a light aligned film exhibits the largest double refraction index in response to irradiation thereof with light if the light aligning film is used in the present invention.

The azo dichroic dye forming the dichroic dye layer includes a rod molecule having a high aspect ratio (ratio of the length of molecular major axis to the length of molecular minor axis), and has a transition moment absorbing visible light in a direction substantially corresponding to the major axis direction of the molecules (see non-patent literature, Dichroic Dyes for Liquid Crystal Displays). As a result, at a smaller angle on average defined by the molecular major axis of the dichroic dye and the alignment axis or a smaller variation in the angle, the dichroic dye layer exhibits a higher dichroic ratio.

The linearly polarizing layer preferably exhibits a diffraction peak corresponding to a period in a direction perpendicular to the alignment axis. For example, the period corresponds to an intermolecular distance in the minor axis direction of the molecules of the dichroic dye aligned with the molecular major axis along the alignment axis direction. In the invention, the period is preferably within a range of 3.0 to 15.0 Å, more preferably 3.0 to 10.0 Å, further preferably 3.0 to 6.0 Å, and most preferably 3.3 to 5.5 Å.

In another preferred linearly polarizing layer, when the intensity distribution of a diffraction peak is measured within a range of ±70° with respect to a normal direction to a film in a plane perpendicular to the alignment axis, the diffraction peak exhibits no local maximum. If the intensity of the diffraction peak exhibits a local maximum in this measurement, molecular packing has anisotropy in the direction perpendicular to the alignment axis, i.e., the direction of the molecular minor axis. Such an aggregated state specifically includes a crystal, a hexatic phase, and a crystalline phase (see non-patent literature, “Ekisho Binran (Handbook of Liquid Crystal)”). If packing has anisotropy, discontinuous packing causes domains and grain boundaries, often leading to occurrence of haze, alignment disorder in every domain, and/or depolarization. The linearly polarizing layer has no anisotropy in packing in a direction perpendicular to the alignment axis, resulting in the formation of a uniform film without domains and grain boundaries. Such an aggregated state specifically includes, but not limited to, a nematic phase, a smectic A phase, and a supercooled state thereof. In another embodiment, the linearly polarizing layer may have a plurality of different aggregated states that collectively exhibit the above-described distinctive diffraction peak.

The dichroic dye layer is typically irradiated with light incident perpendicular or approximately perpendicular to a film; hence, it preferably has a high dichroic ratio in an in-plane direction. Thus, a preferred dichroic dye layer has a periodic structure in the in-plane direction, and exhibits a diffraction peak corresponding to the periodic structure.

The linearly polarizing layer preferably exhibits a diffraction peak corresponding to a period in a direction parallel to the alignment axis. In particular, adjacent molecules in the direction perpendicular to the alignment axis preferably form layers laminated in the direction parallel to the alignment axis. Such an aggregated state is similar to a smectic phase that is more orderly than the nematic phase, resulting in a high dichroic ratio. For example, the period includes a period corresponding to the molecular length or twice the molecular length, which ranges from 3.0 to 50.0 Å, preferably 10.0 to 45.0 Å, more preferably 15.0 to 40.0 Å, and most preferably 25.0 to 35.0 Å.

The diffraction peak exhibited by the linearly polarizing layer preferably has a half value width of 1.0 Å or less.

The half value width is determined as follows: the peak intensity is determined with reference to a baseline within one diffraction peak in X-ray diffractometry, two points, each indicating half the peak intensity, are taken on both sides of the peak, and the half value width is determined from a difference between the periods corresponding to the two points.

The dichroic dye layer exhibiting a diffraction peak, of which the half value width is 1.0 Å or less, in X-ray diffractometry is assumed to exhibit a high dichroic ratio by the following reason.

If the angle defined by the molecular major axis of the dichroic dye and the alignment axis greatly varies, the intermolecular distance also greatly varies. Thus, if the dichroic dye layer has a periodic structure, the value of the period also varies. This results in broadening of a diffraction peak appearing in X-ray diffractometry, leading to a large half value width.

In contrast, a sharp diffraction peak having a half value width of less than a predetermined value indicates a small variation in the intermolecular distance and a small angle on average defined by the molecular major axis of the dichroic dye and the alignment axis, i.e., highly orderly alignment, resulting in a high dichroic ratio.

In the invention, the half value width of the diffraction peak is 1.0 Å or less, preferably 0.90 Å or less, more preferably 0.70 Å or less, and most preferably 0.50 Å or less, and preferably 0.05 Å or more. At a half value width exceeding the upper limit, a variation in the intermolecular distance of the dichroic dye increases, leading to disorderly alignment of the dichroic dye. At a half value width falling below the lower limit, alignment distortion readily occurs, which causes domains and grain boundaries to be formed, often leading to occurrence of haze, alignment disorder in every domain, and/or depolarization.

The period and the half value width of the diffraction peak of the dichroic dye layer are determined from an X-ray diffraction profile measured by an X-ray diffractometer for film characterization (“ATX-G” in-plane optical system, available from Rigaku Corporation) or an equivalent apparatus. The X-ray diffractometry of the linearly polarizing layer by the invention is performed by the following procedure, for example.

Omnidirectional in-plane measurement of the linearly polarizing layer is performed at every 15°. While the angle at which a peak is observed is fixed, the direction corresponding to high peak intensity in a substrate plane is determined through so-called φ scan where a sample is rotated in a plane parallel to a substrate for measurement. The peak obtained in the in-plane measurement in the determined direction can be used to determine the period and the half value width.

The linearly polarizing layer is preferably formed from a dichroic dye composition containing at least one azo dichroic dye showing nematic liquid crystalline properties.

The dichroic dye composition in the present invention most preferably contain at least one azo dye represented by Formula (I), (II), (III), or (IV). The dichroic dyes represented by Formulae (I) to (IV) preferably show nematic liquid crystallinity.

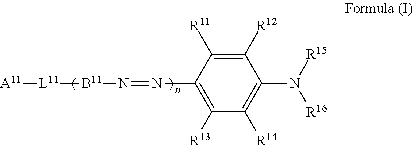

In the formula, R¹¹ to R¹⁴ respectively represent a hydrogen atom or a substituent; R¹⁵ and R¹⁶ respectively represent a hydrogen atom or an optionally-substituted alkyl; L¹ represents —N═N—, —CH═N—, —N═CH—, —C(═O)O— or —OC(═O)—; A¹¹ represents an optionally-substituted phenyl, an optionally-substituted naphthyl, or an optionally-substituted aromatic heterocyclic group; B¹¹ represents an optionally-substituted divalent aromatic hydrocarbon group or an optionally-substituted divalent aromatic heterocyclic group; n is an integer from 1 to 5, and B¹ may be same or different when n is equal to or more than 2.

Examples of the substituent represented by R¹¹-R¹⁴ respectively include alkyls (preferably C₁₋₂₀, more preferably C₁₋₁₂ and even more preferably C₁₋₈ alkyls such as methyl, ethyl, isopropyl, tert-butyl, n-octyl, n-decyl, n-hexadecyl, cyclopropyl, cyclopentyl and cyclohexyl), alkenyls (preferably C₂₋₂₀, more preferably C₂₋₁₂ and even more preferably C₂₋₈ alkenyls such as vinyl, allyl, 2-butenyl and 3-pentenyl), alkynyls (preferably C₂₋₂₀, more preferably C₂₋₁₂ and even more preferably C₂₋₈ alkynyls such as propargyl and 3-pentynyl), aryls (preferably C₆₋₃₀, more preferably C₆₋₂₀ and even more preferably C₆₋₁₂ aryls such as phenyl, 2,6-diethyl phenyl, 3,5-ditrifluoromethyl phenyl, naphthyl and biphenyl), substituted or non-substituted aminos (preferably C₀₋₂₀, more preferably C₀₋₁₀ and even more preferably C₀₋₆ aminos such as non-substituted amino, ethylamino, dimethylamino, diethylamino and anilino), alkoxys (preferably C₁₋₂₀, more preferably C₁₋₁₀ and even more preferably C₁₋₆ alkoxys such as methoxy, ethoxy and butoxy), oxycarbonyls (preferably C₂₋₂₀, more preferably C₂₋₁₅ and even more preferably C₂₋₁₀ oxycarbonyls such as methoxycarbonyl, ethoxycarbonyl and phenoxycarbonyl), acyloxys (preferably C₂₋₂₀/more preferably C₂₋₁₀ and even more preferably C₂₋₆ acyloxys such as acetoxy and benzoyloxy), acylaminos (preferably C₂₋₂₀, more preferably C₂₋₁₀ and even more preferably C₂₋₆ acylaminos such as acetylamino and benzoylamino), alkoxycarbonylaminos (preferably C₂₋₂₀, more preferably C₂₋₁₀ and even more preferably C₂₋₆ alkoxycarbonylaminos such as methoxycarbonylamino), aryloxycarbonylaminos (preferably C₇₋₂₀, more preferably C₇₋₁₆ and even more preferably C₇₋₁₂ aryloxycarbonylaminos such as phenyloxycarbonylamino), sulfonylaminos (preferably C₁₋₂₀, more preferably C₁₋₁₀ and even more preferably C₁₋₆ sulfonylaminos such as methane sulfonylamino and benzene sulfonylamino), sulfamoyls (preferably C₀₋₂₀, more preferably C₀₋₁₀ and even more preferably C₀₋₆ sulfamoyls such as non-substituted sulfamoyl, methyl sulfamoyl, dimethyl sulfamoyl and phenyl sulfamoyl), carbamoyls (preferably C₁₋₂₀, more preferably C₁₋₁₀ and even more preferably C₁₋₆ carbamoyls such as non-substituted carbamoyl, methyl carbamoyl, diethyl carbamoyl and phenylcarbamoyl), alkylthios (preferably C₁₋₂₀, more preferably C₁₋₁₀ and even more preferably C₁₋₆ alkylthios such as methylthio and ethylthio), arylthios (preferably C₆₋₂₀, more preferably C₆₋₁₆ and even more preferably C₆₋₁₂ arylthios such as phenylthio), sulfonyls (preferably C₁₋₂₀, more preferably C₁₋₁₀ and even more preferably C₁₋₆ sulfonyls such as mesyl and tosyl), sulfinyls (preferably C₁₋₂₀, more preferably C₁₋₁₀ and even more preferably C₁₋₆ sulfinyls such as methane sulfinyl and benzene sulfinyl), ureidos (preferably C₁₋₂₀, more preferably C₁₋₁₀ and even more preferably C₁₋₆ ureidos such as non-substituted ureido, methyl ureido and phenyl ureido), amide phosphate group (preferably C₁₋₂₀, more preferably C₁₋₁₀ and even more preferably C₁₋₆ amide phosphate group such as diethyl amide phosphate and phenyl amide phosphate), hydroxy, mercapto, halogen atoms (for example, fluorine atom, chlorine atom, bromine atom and iodine atom), cyano, nitro, hydroxamic group, imino (—CH═N— or —N═CH—), azo group, heterocyclic group (preferably C₁₋₃₀ and more preferably C₁₋₁₂ heterocyclic group having at least one hetero atom selected from nitrogen atom, oxygen atom, sulfur atom and so on including imidazolyl, pyridyl, quinolyl, furyl, piperidyl, morpholino, benzoxazolyl, benzoimidazolyl and benzothiazolyl), and silyl group (preferably C₃₋₄₀, more preferably C₃₋₃₀ and even more preferably C₃₋₂₄ silyl group such as trimethyl silyl and triphenyl silyl.

These substituents may have one or more substituents. Two or more substituents may be same or different. And they may combine to form a ring.

Preferable examples of R¹¹ to R¹⁴ include a hydrogen atom, alkyl, alkoxy and a halogen atom, more preferably a hydrogen atom, alkyl and alkoxy, and even more preferably a hydrogen atom and methyl.

The optionally-substituted alkyl represented by R¹⁵ or R¹⁶ is preferably a C₁₋₂₀ more preferably C₁₋₁₂ and even more preferably C₁₋₈ alkyl such as methyl, ethyl and n-octyl. Examples of the substituent of the alkyl represented by R¹⁵ or R¹⁶ include those exemplified above as a substituent of any of to R¹⁴. When R¹⁵ or R¹⁶ represents an alkyl, it may combine with R¹² or R¹⁴ to form a ring. Preferably, R¹⁵ and R¹⁶ represent a hydrogen atom or alkyl respectively; and more preferably, R¹⁵ and R¹⁵ represent a hydrogen atom, methyl or ethyl respectively.

In the formula, A¹¹ represents an optionally-substituted phenyl, an optionally-substituted naphthyl or an optionally-substituted aromatic heterocyclic group.

The substituent of the phenyl or the naphthyl may be any substituent having at least one group capable of enhancing the solubility or the nematic liquid crystallinity of the azo compound, any substituent having at least one electron-releasing or electron-attracting group capable of controlling the hue of the azo dye, or any substituent having at least one polymerizable group capable of fixing the alignment of the azo compound. And specific examples thereof include those exemplified above as a substituent of any of R¹¹ to R¹⁴. Preferable examples of the substituent include optionally-substituted alkyls, optionally-substituted alkenyls, optionally-substituted alkynyls, optionally-substituted aryls, optionally-substituted alkoxys, optionally-substituted oxycarbonyls, optionally-substituted acyloxys, optionally-substituted acylaminos, optionally-substituted aminos, optionally-substituted alkoxycarbonylaminos, optionally-substituted sulfonylaminos, optionally-substituted sulfamoyls, optionally-substituted carbamoyls, optionally-substituted alkylthios, optionally-substituted sulfonyls, optionally-substituted ureidos, nitro, hydroxy, cyano, imino, azo and halogen atoms; more preferable examples of the substituent include optionally-substituted alkyls, optionally-substituted alkenyls, optionally-substituted aryls, optionally-substituted alkoxys, optionally-substituted oxycarbonyls, optionally-substituted acyloxys, nitro, imino and azo. Among these substituents, regarding each of those having a carbon atom(s), the preferable range of the number of carbon atoms therein is same as that of the substituent represented by each of R¹¹ to R¹⁴.

The phenyl or the naphthyl may have 1 to 5 substituents selected from the above described examples; and preferably, the phenyl or the naphthyl may have one substituent selected from the above described examples. Regarding the phenyl, preferably, it has one substituent selected from the above described examples at a para-position with respect to L¹.

The aromatic heterocyclic group may be preferably derived from a monocyclic or bicyclic hetero-ring. The atom, embedded in the aromatic heterocyclic group, other than a carbon atom may be a nitrogen, sulfur or oxygen atom. Two or more hetero atoms embedded in the aromatic heterocyclic group may be same or different from each other. Examples of the aromatic heterocyclic group include pyridyl, quinolyl, thiophenyl, thiazolyl, benzothiazolyl, thiadiazolyl, quinolonyl, naphthalimidoyl, and thienothiazolyl.

Preferably, the aromatic heterocyclic group is pyridyl, quinolyl, thiazolyl, benzothiazolyl, thiadiazolyl, or thienothiazolyl; and more preferably, the aromatic heterocyclic group is pyridyl, benzothiazolyl, or thienothiazolyl.

Preferably, A¹¹ represents optionally-substituted phenyl, pyridyl, benzothiazolyl, or thienothiazolyl.

In the formula, B¹¹ represents an optionally-substituted divalent aromatic hydrocarbon group or an optionally-substituted divalent aromatic heterocyclic group. In the formula, n is an integer from 1 to 4, and B¹¹ may be same or different when n is equal to or more than 2.

Preferable examples of the aromatic hydrocarbon group include phenyl and naphthyl. Preferable examples of the substituent of the aromatic hydrocarbon group include optionally-substituted alkyls, optionally-substituted alkoxys, hydroxy, nitro, halogen atoms, optionally-substituted aminos, optionally-substituted acylaminos and cyano. Among these, optionally-substituted alkyls, optionally-substituted alkoxys and halogen atoms are more preferable; and methyl and halogen atoms are even more preferable.

The aromatic heterocyclic group may be preferably derived from a monocyclic or bicyclic hetero-ring. The atom, embedded in the aromatic heterocyclic group, other than a carbon atom may be a nitrogen, sulfur or oxygen atom. Two or more hetero atoms embedded in the aromatic heterocyclic group may be same or different from each other. Examples of the aromatic heterocyclic group include pyridyl, quinolyl, isoquinolyl, benzothiadiazole, phthalimide, and thienothiazole. Among these, thienothiazole is more preferable.

Examples of the substituent of the aromatic heterocyclic group include alkyls such as methyl and ethyl; alkoxys such as methoxy and ethoxy; aminos such as non-substituted amino and methyl amino; acetylaminos, acylaminos, nitro, hydroxy, cyano and halogen atoms. Among these substituents, regarding each of those having a carbon atom(s), the preferable range of the number of carbon atoms therein is same as that of the substituent represented by each of R¹¹ to R¹⁴.

Preferable examples of the azo dye include those represented by any one of formulas (Ia) to (Ib).

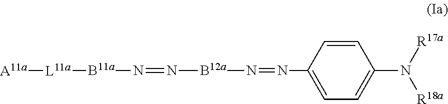

In the formula, R^{17a} and R^{18a} respectively represent a hydrogen atom, methyl or ethyl; L^{11a} represents —N═N—, —N═CH—, —O(C═O)— or —CH═CH—; A^{11a} represents a group (Ia-I) or (Ia-II); and B^{11a} and B^{12a} respectively represent a group (Ia-IV), (Ia-V) or (Ia-VI).

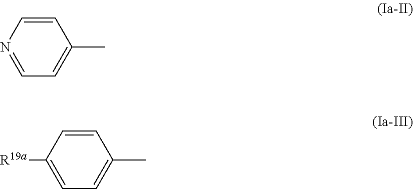

In the formula, R^{19a} represent an optionally-substituted alkyl, an optionally-substituted aryl, an optionally-substituted alkoxy, an optionally-substituted oxycarbonyl, or an optionally-substituted acyloxy.

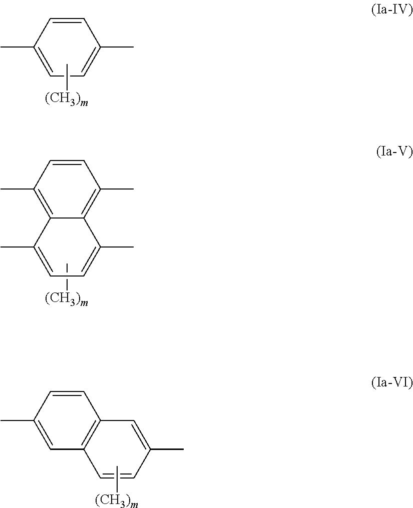

In the formulas, m represents an integer of from 0 to 2.

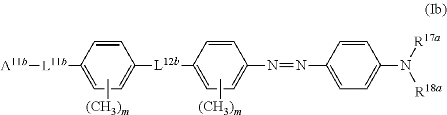

In the formula, R^{17b} and R^{18b} respectively represent a hydrogen atom, methyl or ethyl; L^{11b} represents —N═N— or —(C═O)O—; L^{12b} represents —N═CH—, —(C═O)O— or —O(C═O)—; A^{11b} represents a group (Ib-II) or (Ib-III); and m represents an integer of from 0 to 2.

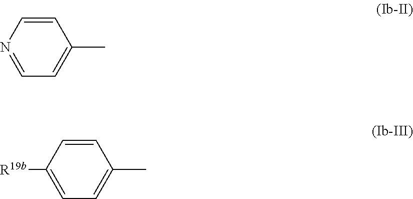

In the formula, R^{19b} represents an optionally-substituted alkyl, an optionally-substituted aryl, an optionally-substituted alkoxy, an optionally-substituted oxycarbonyl, or an optionally-substituted acyloxy.

Examples of the substituent of each of the groups in formulas (Ia), and (Ib) include those exemplified above as a substituent of any of R¹¹ to R¹⁴. Among these substituents, regarding each of those (such as alkyls) having a carbon atom(s), the preferable range of the number of carbon atoms therein is same as that of the substituent represented by each of R¹¹ to R¹⁴.

The compound represented by formulas (Ia), and (Ib) may have one or more polymerizable groups as a substituent. Using the compound having one or more polymerizable groups may contribute to improvement in hardenability. Examples of the polymerizable group include an unsaturated polymerizable group, epoxy group and aziridinyl group; an unsaturated polymerizable group is preferable; and an ethylene unsaturated polymerizable group is more preferable. Examples of the ethylene unsaturated polymerizable group include an acryloyl group and a methacryloyl group.

Preferably, the polymerizable group(s) exists at the molecular end, that is, preferably, the polymerizable group(s) exists as a substituent of R¹⁵ and/or R¹⁶ or as a substituent of A¹¹ in formula (I).

Examples of the compound represented by formula (I) include, but are not limited to, those described below.

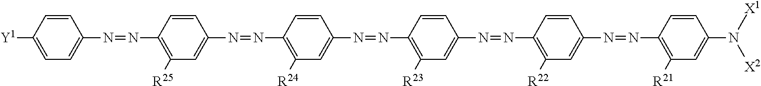

| No. | X¹ | X² | R²¹ | R²² | R²³ | R²⁴ | R²⁵ | Y¹ |
|---|---|---|---|---|---|---|---|---|
| A-1 | —C₂H₅ | —C₂H₅ | —H | —CH₃ | —H | —H | —H | —C₄H₉ |
| A-2 | —C₂H₅ | —C₂H₅ | —H | —CH₃ | —CH₃ | —CH₃ | —H | —C₄H₉ |
| A-3 | —CH₃ | —CH₃ | —H | —CH₃ | —H | —H | —H | —C₄H₉ |

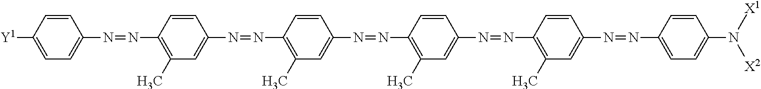

| No. | X¹ | X² | Y¹ |
|---|---|---|---|
| A-4 | —C₂H₅ | —C₂H₅ | 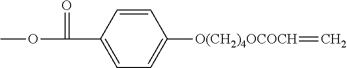 |
| A-5 | —C₂H₅ | —C₂H₅ | 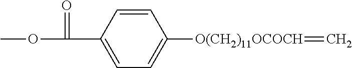 |

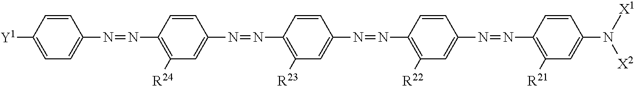

| No. | X¹ | X² | R²¹ | R²² | R²³ | R²⁴ | Y¹ |
|---|---|---|---|---|---|---|---|
| A-9 | —C₂H₅ | —C₂H₅ | —H | —CH₃ | —H | —H | —C₄H₉ |
| A-10 | —C₂H₅ | —C₂H₅ | —CH₃ | —CH₃ | —H | —H | —C₄H₉ |
| A-11 | —C₂H₅ | —C₂H₅ | —H | —CH₃ | —CH₃ | —CH₃ | —C₄H₉ |
| A-15 | —C₂H₅ | —C₂H₅ | —H | —CH₃ | —CH₃ | —CH₃ | 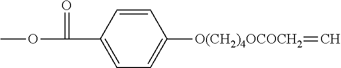 |

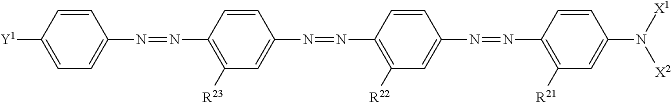

| No. | X¹ | X² | R²¹ | R²² | R²³ | Y¹ |
|---|---|---|---|---|---|---|
| A-16 | —C₂H₅ | —C₂H₅ | —H | —CH₃ | —H | —C₄H₉ |
| A-17 | —C₂H₅ | —C₂H₅ | —H | —CH₃ | —CH₃ | —C₄H₉ |
| A-18 | —C₂H₅ | —C₂H₅ | —H | —CH₃ | —H | 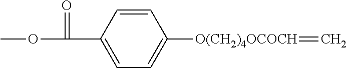 |
| A-19 | —C₂H₅ | —C₂H₅ | —H | —CH₃ | —H | 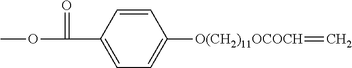 |
| A-24 | —C₂H₅ | —C₂H₅ | —OCH₃ | —CH₃ | —H | —C₄H₉ |
| A-25 | —C₂H₅ | —C₂H₅ | —H | —CH₃ | —CH₃ | 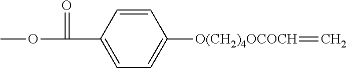 |

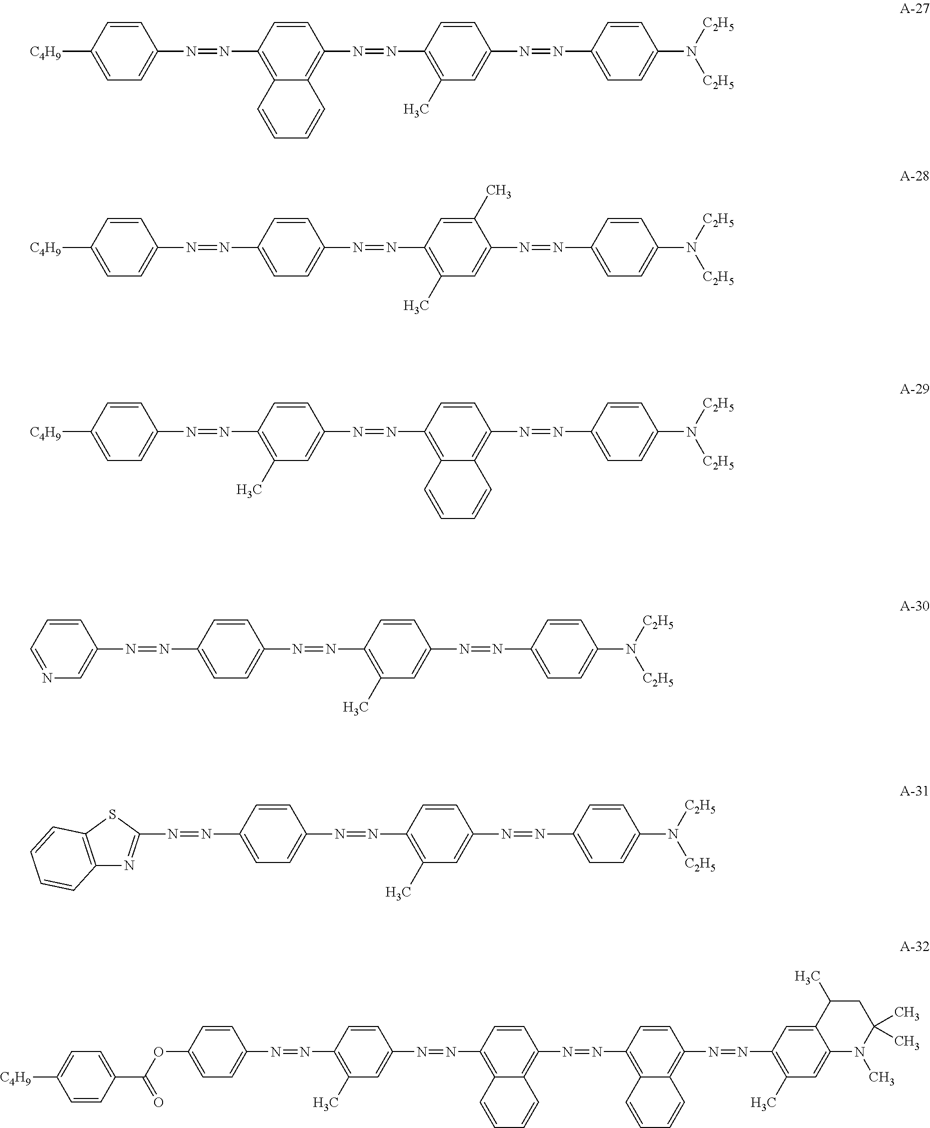

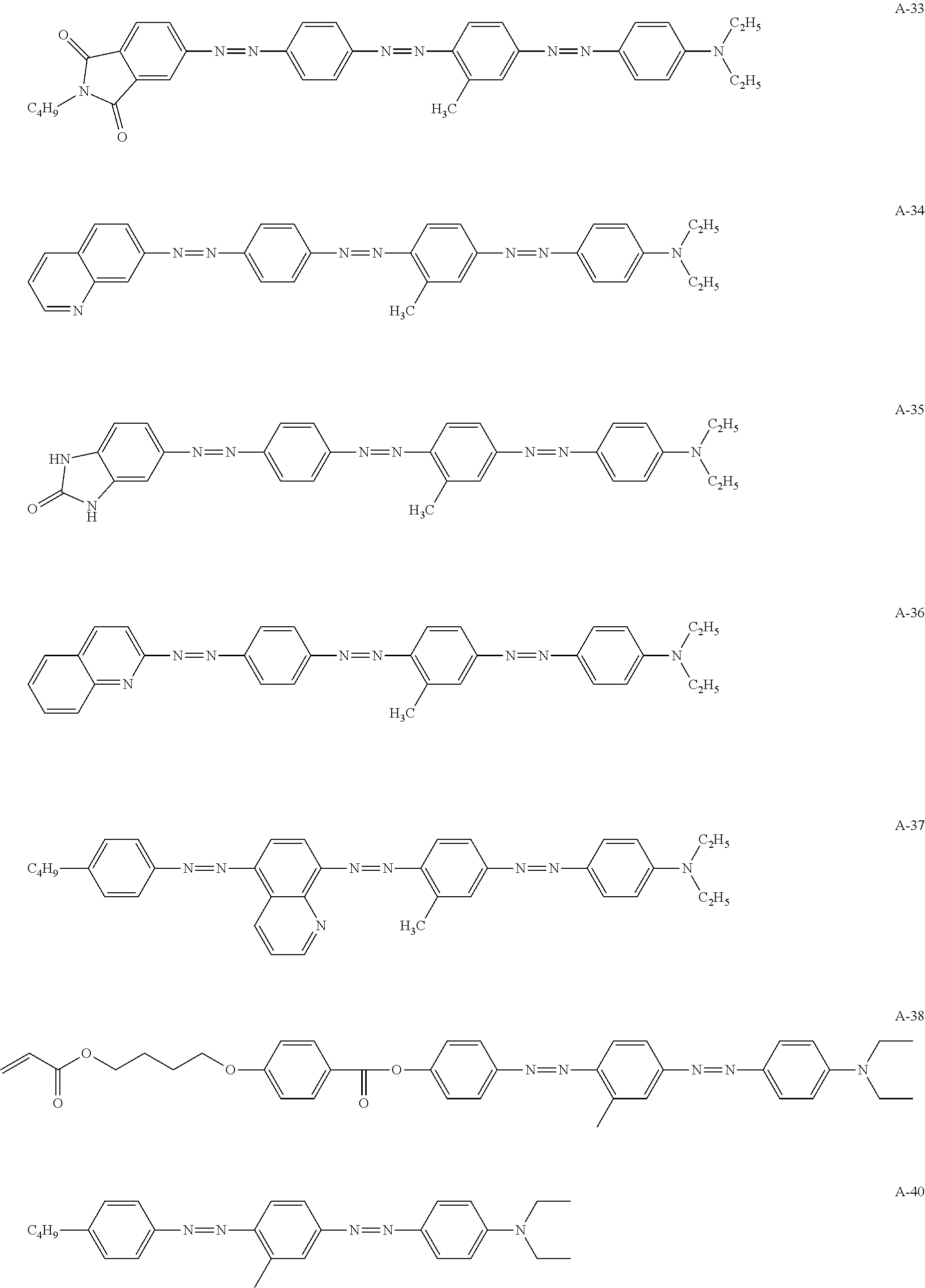

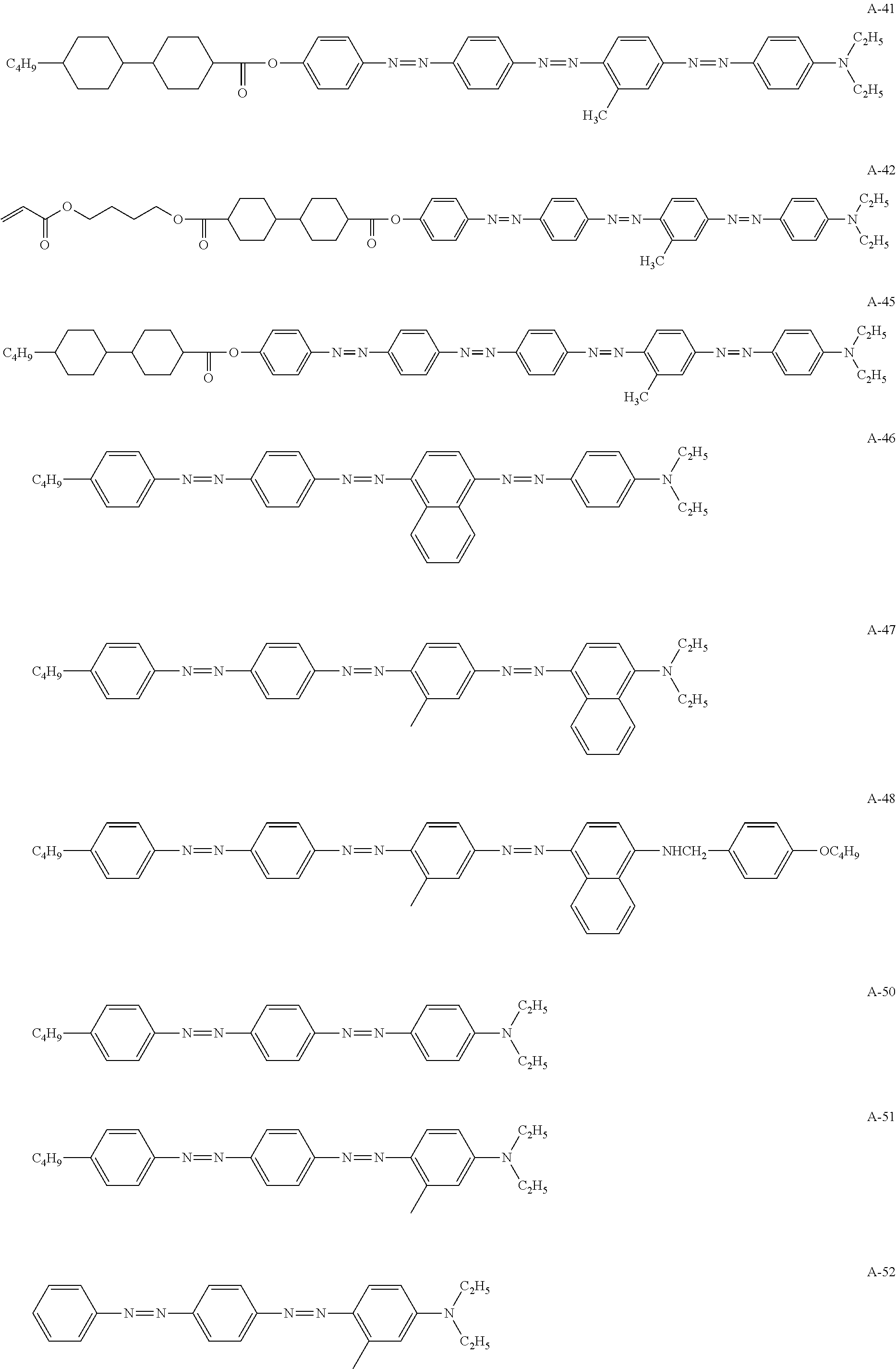

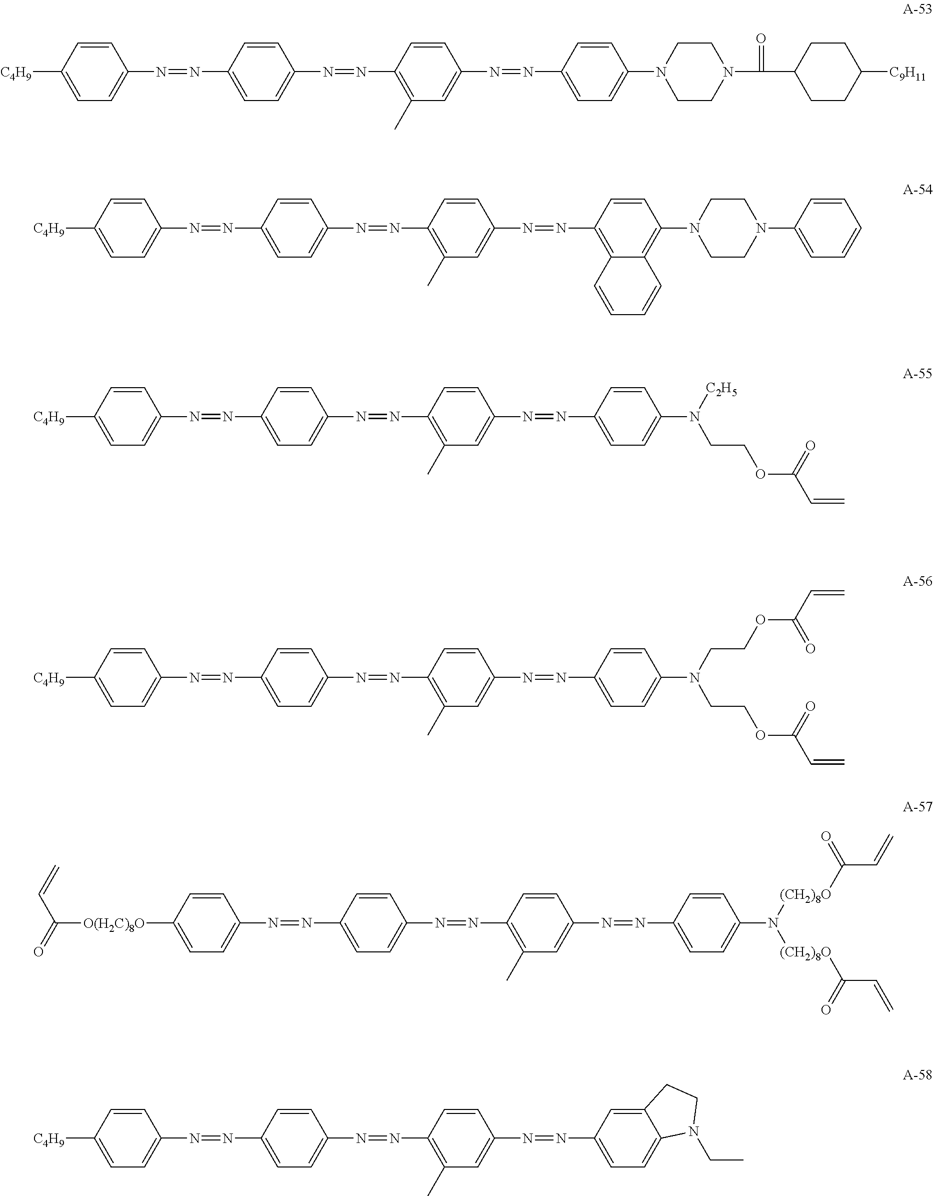

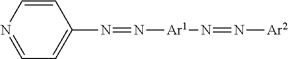

| compound | Ar¹ | Ar² |
|---|---|---|
| B-1 | 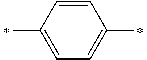 | 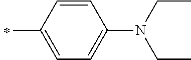 |
| B-2 | 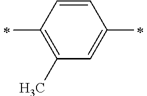 | 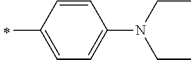 |
| B-3 | 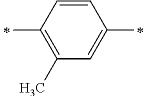 | 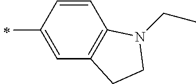 |

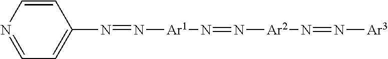

| compound | Ar¹ | Ar² | Ar³ |
|---|---|---|---|
| B-4 | 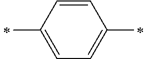 | 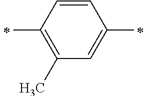 | 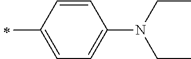 |
| B-5 | 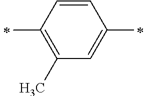 | 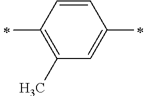 | 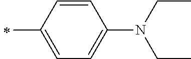 |
| B-6 | 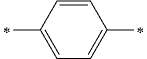 | 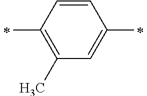 | 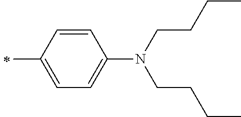 |
| B-7 | 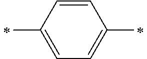 | 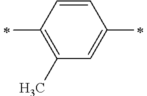 | 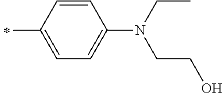 |
| B-8 | 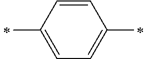 | 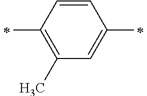 | 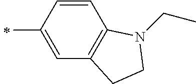 |
| B-9 | 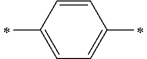 | 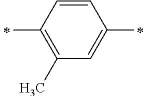 | 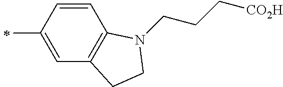 |

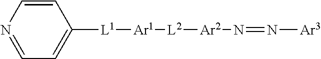

| compound | L¹ | Ar¹ | L² | Ar² | Ar³ |
|---|---|---|---|---|---|
| B-10 | 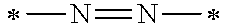 | 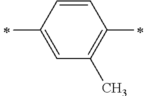 | 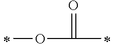 | 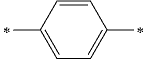 | 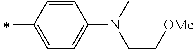 |
| B-11 | 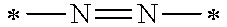 | 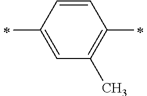 | 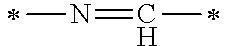 | 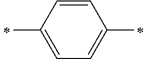 | 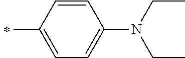 |
| B-12 | 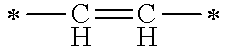 | 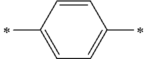 | 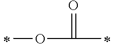 | 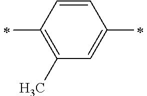 | 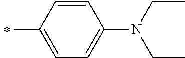 |

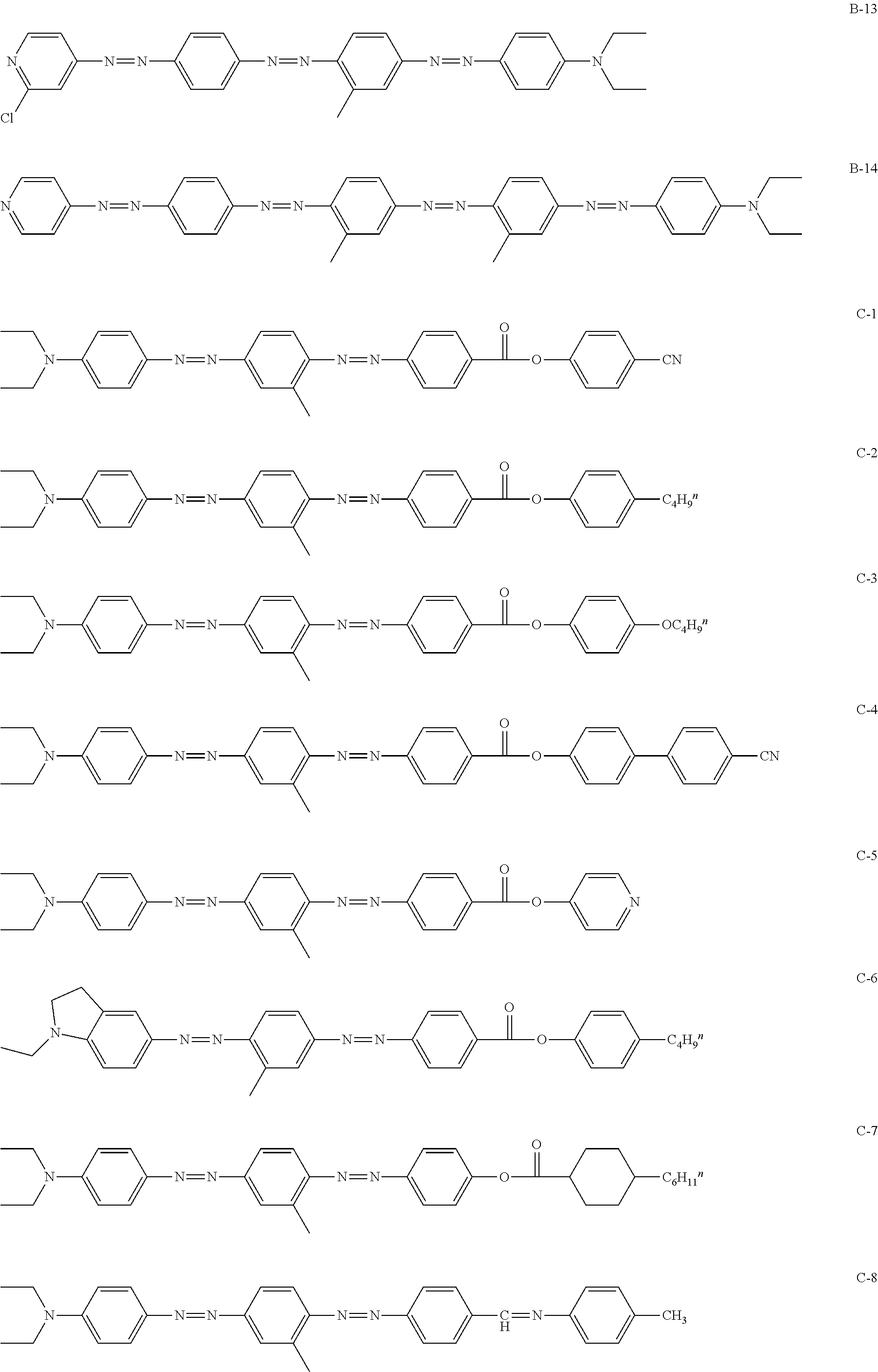

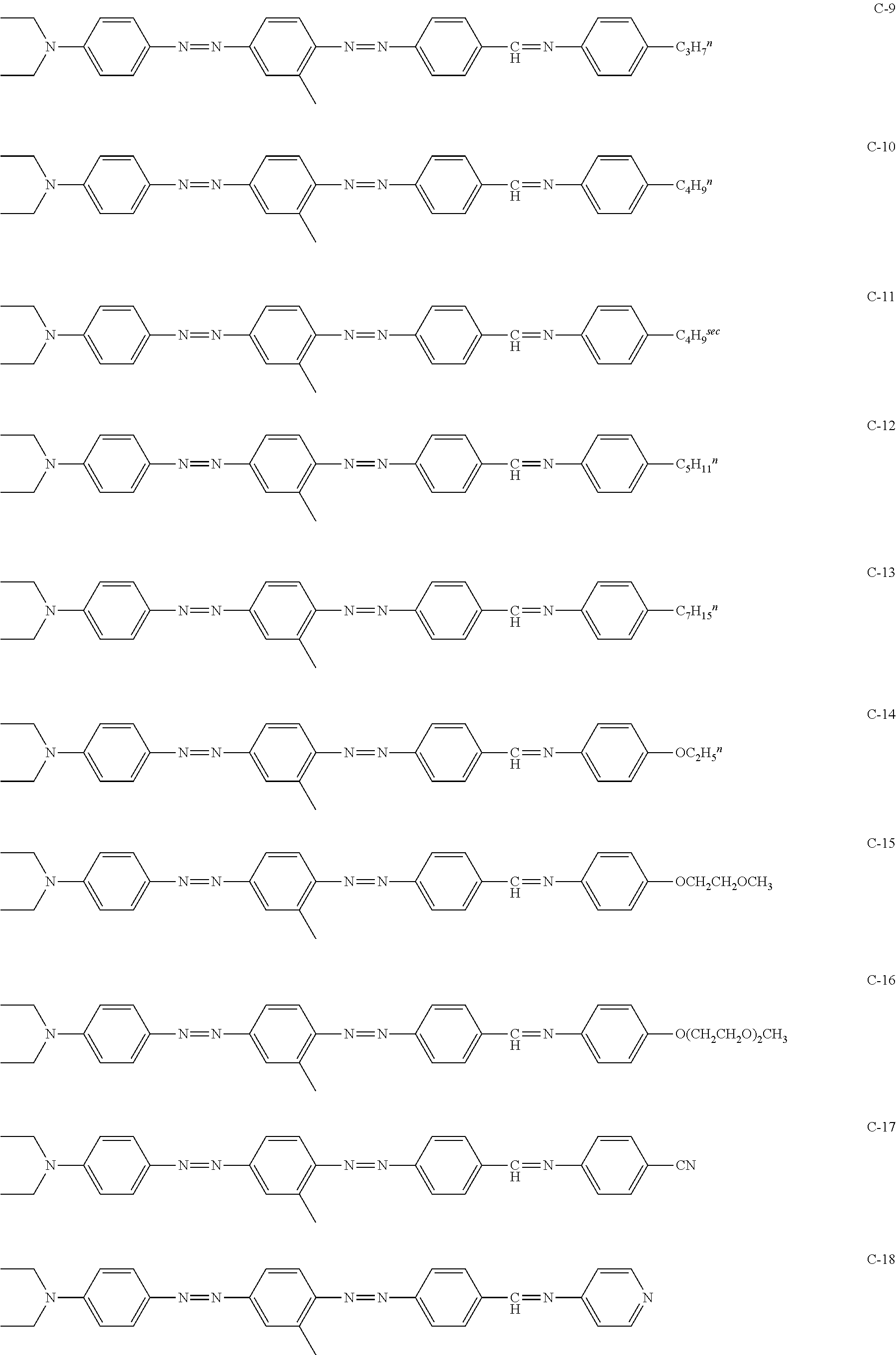

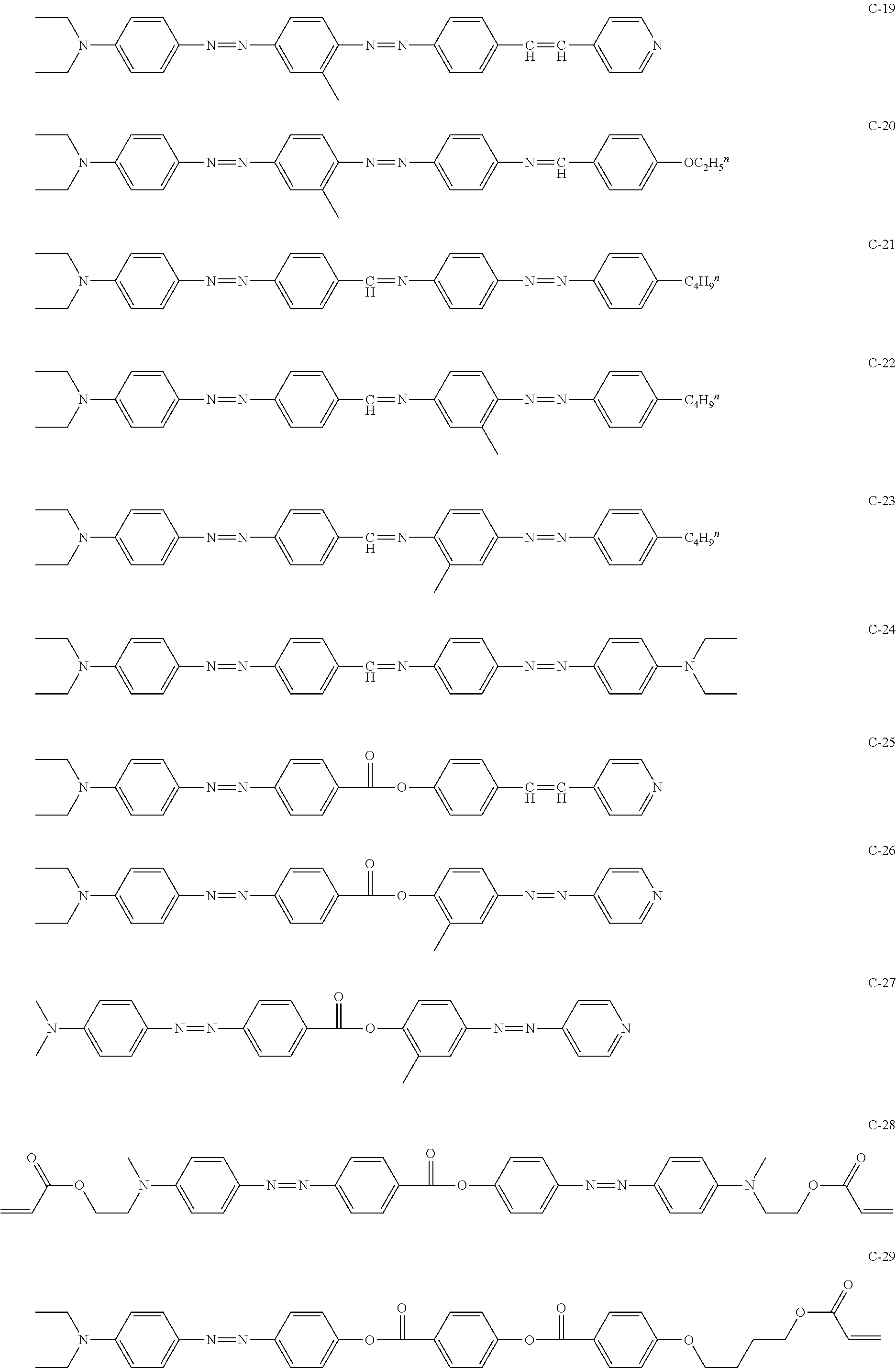

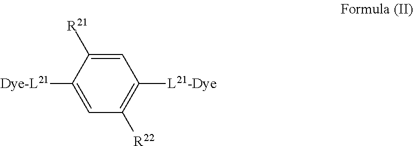

In Formula (II), R²¹ and R²² each represent a hydrogen atom, an alkyl group, an alkoxy group, or a substituent represented by -L²²-Y, provided that at least one of R²¹ and R²² represents a group other than a hydrogen atom. L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group.

In particular, when one of R²¹ and R²² is a hydrogen atom or a short-chain substituent of about C₁ to C₄ and the other of R²¹ and R²² is a long-chain substituent of about C₅ to C₃₀, the solubility of the compound is advantageously further improved. It is generally known that expression of liquid crystallinity is highly affected by the molecular shape, the anisotropy of polarizability, etc. This is described in detail in, for example, Ekisho Binran (Handbook of Liquid Crystal) (Maruzen, 2000). A rod-like liquid crystal molecular skeleton is typically composed of a rigid mesogen and a flexible terminal chain in the molecular long axis direction. The lateral substituents in the molecular short axis direction corresponding to R²¹ and R²² in Formula (II) are generally small substituents that do not inhibit rotation of the molecule or are not provided. As examples having lateral substituents designed so as to provide features, those having stabilized smectic phases by introducing hydrophilic (e.g., ionic) lateral substituents are known, whereas there are almost no examples expressing stable nematic phases. In particular, there is no known example in which solubility is improved without lowering the degree of alignment order through introduction of a long-chain substituent into a specific substitution position of rod-like liquid crystal molecule expressing a nematic phase.

Examples of the alkyl group represented by each of R²¹ and R²² include C₁ to C₃₀ alkyl groups. Examples of the short-chain alkyl group preferably have C₁ to C₉, more preferably C₁ to C₄. Examples of the long-chain alkyl group preferably have C₅ to C₃₀, more preferably C₁₀ to C₃₀, and most preferably C₁₀ to C₂₀.

Examples of the alkoxy group represented by each of R²¹ and R²² include C₁ to C₃₀ alkoxy groups. Examples of the short-chain alkoxy group preferably have C₁ to C₉, and more preferably C₁ to C₃. Examples of the long-chain alkoxy group preferably have C₅ to C₃₀, more preferably C₁₀ to C₃₀, and most preferably C₁₀ to C₂₀.

Among the substituents represented by -L²²-Y being represented by each of R²¹ and R²², the alkylene group represented by L²² is preferably a C₅ to C₃₀, more preferably C₁₀ to C₃₀, and most preferably C₁₀ to C₂₀ alkylene group. One CH₂ group or two or more nonadjacent CH₂ groups present in the alkylene group may be each substituted by one or more groups selected from the group of divalent groups consisting of —O—, —COO—, —OCO—, —OCOO—, —NRCOO—, —OCONR—, —CO—, —S—, —SO₂—, —NR—, —NRSO₂—, and —SO₂NR— (R represents a hydrogen atom or an alkyl group having 1 to 4 carbon atoms). The CH₂ group may be substituted by two or more groups selected from the group of divalent groups. Furthermore, the CH₂ bonding to Y at the terminal of L²² may be substituted by any one of the divalent groups mentioned above. In addition, the CH₂ bonding to the phenyl group at the end of L²² may be substituted by any one of the divalent groups mentioned above.

In particular, from the viewpoint of increasing the solubility, preferably, L²² is an alkyleneoxy group or contains an alkyleneoxy group, and more preferably, L²² is a polyethyleneoxy group represented by —(OCH₂CH₂)ₚ— (wherein p represents an integer of 3 or more, preferably 3 to 10, and more preferably 3 to 6) or contains a polyethyleneoxy group.

Examples of -L²²- are shown below, but the present invention is not limited thereto. In the following formulae, q represents an integer of 1 or more, preferably 1 to 10, and more preferably 2 to 6; and r represents an integer of 5 to 30, preferably 10 to 30, and more preferably 10 to 20. —(OCH₂CH₂)ₚ—

—(OCH₂CH₂)ₚ—O—(CH₂)_{q}—
(OCH₂CH₂)ₚ—OC(═O)(CH₂)_{q}—
—(OCH₂CH₂)ₚ—OC(═O)NH—(CH₂)_{q}—
—O(CH₂)ᵣ—
—(CH₂)ᵣ—

Among the substituents represented by -L²²-Y being represented by each of R²¹ and R²², Y represents a hydrogen atom, a hydroxy group, an alkoxy group (preferably a C₁ to C₁₀ alkoxy group, more preferably a C₁ to C₅ alkoxy group), a carboxyl group, a halogen atom, or a polymerizable group.

Depending on the combination of L²² and Y, the terminal of -L²²-Y can function as a substituent that enhances the intermolecular interaction of, for example, a carboxyl group, an amino group, or an ammonium group or also can function as a leaving group such as a sulfonyloxy group or a halogen atom.

Furthermore, the terminal of -L²²-Y may be a substituent that forms a covalent bond with any other molecule, such as a crosslinkable group or a polymerizable group, e.g., a polymerizable group such as —O—C(═O)CH═CH₂ or —O—C(═O)C(CH₃)═CH₂.

When the composition is used as a material for a cured film, Y is preferably a polymerizable group (however, even if the compound of Formula (II) does not have a polymerizable group, the alignment of the compound can be fixed with a polymerizable compound in combination with the compound of Formula (II) and polymerizing the polymerizable compound). The polymerization is preferably addition polymerization (including ring-opening polymerization) or condensation polymerization. That is, the polymerizable group is preferably a functional group capable of undergoing addition polymerization or condensation polymerization. The examples of the polymerizable group represented by the formulae mentioned above include an acrylate group represented by Formula (M-1) and a methacrylate group represented by Formula (M-2).

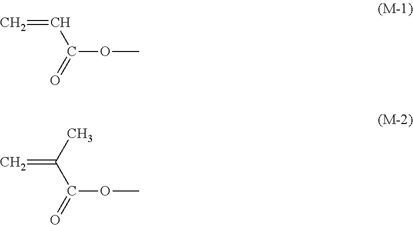

Another preferred polymerizable group is a ring-opening polymerizable group. For example, the ring-opening polymerizable group is preferably a cyclic ether group, more preferably an epoxy group or an oxetanyl group, and most preferably an epoxy group.

In formula (II), each L²¹ represents a linker selected from the group consisting of an azo group (—N═N—), a carbonyloxy group (—C(═O)O—), an oxycarbonyl group (—O—C(═O)—), an imino group (—N═CH—), and a vinylene group (—C═C—). In particular, a vinylene group is preferable.

In formula (II), each Dye represents an azo dye residue represented by Formula (IIa):

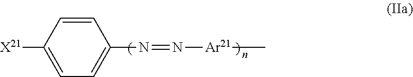

In formula (IIa), * represents a bonding site to L²¹; X²¹ represents a hydroxy group, a substituted or unsubstituted alkyl group, a substituted or unsubstituted alkoxy group, an unsubstituted amino group, or a mono- or dialkylamino group; each Ar²¹ represents an optionally substituted aromatic hydrocarbon ring or aromatic heterocyclic group; and n represents an integer of 1 to 3, and when n is an integer of 2 or more, the two or more Ar²¹'s may be the same as or different from each other.

The alkyl group represented by X²¹ is preferably a C₁ to C₁₂ alkyl group and more preferably a C₁ to C₆ alkyl group. Specific examples thereof include a methyl group, an ethyl group, a propyl group, and a butyl group. The alkyl group may have a substituent, and examples of the substituent include a hydroxy group, a carboxyl group, and a polymerizable group. Preferable examples of the polymerizable group are the same as those of the polymerizable group represented by Y.

The alkoxy group represented by X²¹ is preferably a C₁ to C₂₀ alkoxy group, more preferably a C₁ to C₁₀ alkoxy group, and most preferably a C₁ to C₆ alkoxy group. Specific examples thereof include a methoxy group, an ethoxy group, a propyloxy group, a butoxy group, a pentaoxy group, a hexaoxy group, a heptaoxy group, and an octaoxy group. The alkoxy group may have a substituent, and examples of the substituent include a hydroxy group, a carboxyl group, and a polymerizable group. Preferable examples of the polymerizable group are the same as those of the polymerizable group represented by Y.

The substituted or unsubstituted amino group represented by X²¹ is preferably a C₀ to C₂₀ amino group, more preferably a C₀ to C₁₀ amino group, and most preferably a C₀ to C₆ amino group. Specific examples thereof include an unsubstituted amino group, a methylamino group, a dimethylamino group, a diethylamino group, a methylhexylamino group, and an anilino group.

In particular, X²¹ is preferably an alkoxy group.

In Formula (IIa), Ar²¹ represents an optionally substituted aromatic hydrocarbon ring or aromatic heterocyclic group. Examples of the aromatic hydrocarbon ring group and the aromatic heterocyclic group include a 1,4-phenylene group, a 1,4-naphthylene group, a pyridine ring group, a pyrimidine ring group, a pyrazine ring group, a quinoline ring group, a thiophene ring group, a thiazole ring group, a thiadiazole ring group, and a thienothiazole ring group. In particular, a 1,4-phenylene group, a 1,4-naphthylene group, and a thienothiazole ring group are preferred, and a 1,4-phenylene group is most preferred.

The optional substituent of Ar²¹ is preferably an alkyl group having 1 to 10 carbon atoms, a hydroxy group, an alkoxy group having 1 to 10 carbon atoms, or a cyano group, and more preferably an alkyl group having 1 or 2 carbon atoms or an alkoxy group having 1 or 2 carbon atoms.

n is preferably an integer of 1 or 2 and more preferably an integer of 1.

Examples of the compound represented by Formula (II) include compounds represented by Formula (IIb). Symbols in Formula (IIb) are respectively synonymous with those in Formula (II), and the preferred ranges thereof are also the same.

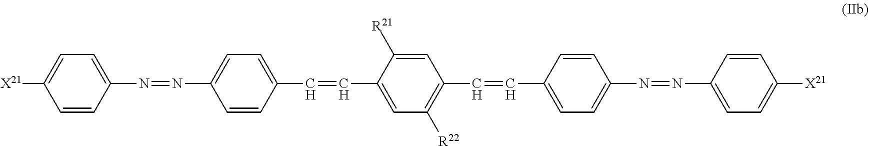

In Formula (IIb), X²¹'s may be the same as or different from each other and preferably represent C₁₋₁₂ alkoxy groups; R²¹ and R²² are preferably different from each other. Preferably, one of R²¹ and R²² is a hydrogen atom or a C₁ to C₄ short-chain substituent (e.g., an alkyl group, an alkoxy group, or a substituent represented by -L²²-Y), and the other of R²¹ and R²² is a C₅ to C₃₀ long-chain substituent (e.g., an alkyl group, an alkoxy group, or a substituent represented by -L²²-Y). Alternatively, each of R²¹ and R²² is preferably a substituent represented by and L²² is an alkyleneoxy group or contains an alkyleneoxy group.

Specific examples of the compound represented by Formula (III) are shown below, but the present invention is not limited thereto.

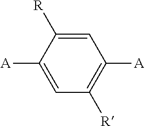

| | A | |
|---|---|---|
| A2-1 | 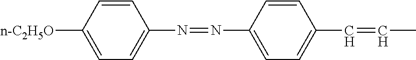 | |
| A2-2 | 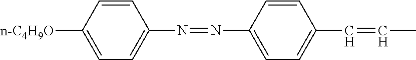 | |
| A2-3 | 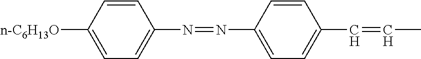 | |
| A2-4 | 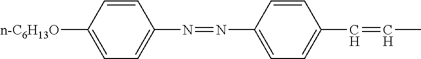 | |
| A2-5 | 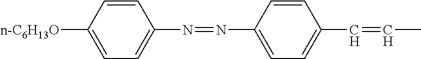 | |
| A2-6 | 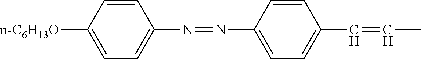 | |
| A2-7 | 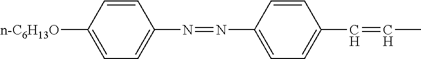 | |
| A2-8 | 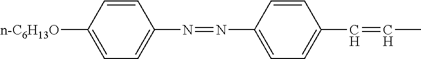 | |
| A2-9 | 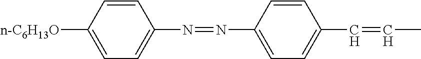 | |
| A2-10 | 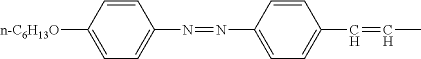 | |
| A2-11 | 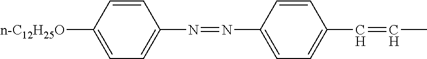 | |
| A2-12 | 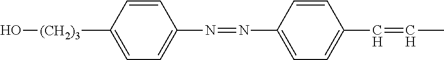 | |
| A2-13 | 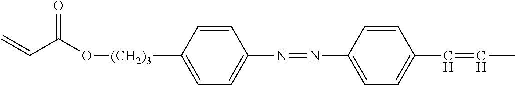 | |
| A2-14 | 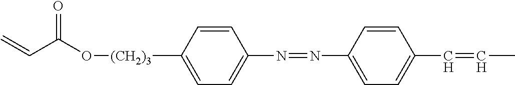 | |
| | R | R′ |
| A2-1 | MeO | —(OCH₂CH₂)₃—OMe |
| A2-2 | MeO | —(OCH₂CH₂)₃—OMe |
| A2-3 | MeO | —(OCH₂CH₂)₃—OMe |
| A2-4 | MeO | —(OCH₂CH₂)₃—OH |
| A2-5 | MeO | —(OCH₂CH₂)₆—OH |
| A2-6 | MeO | 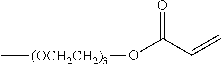 |
| A2-7 | MeO | 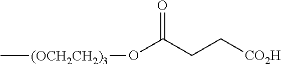 |
| A2-8 | MeO | 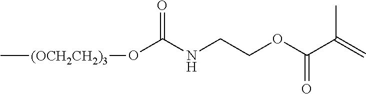 |
| A2-9 | MeO | —OC₁₈H₃₇-n |
| A2-10 | —(OCH₂CH₂)₃—OMe | —(OCH₂CH₂)₃—OMe |
| A2-11 | MeO | —(OCH₂CH₂)₃—OMe |
| A2-12 | MeO | —(OCH₂CH₂)₃—OH |
| A2-13 | MeO | 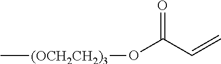 |
| A2-14 | MeO | —(OCH₂CH₂)₃—OMe |

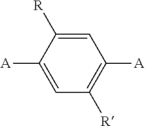

| | A | R | R′ |
|---|---|---|---|
| A2-15 | 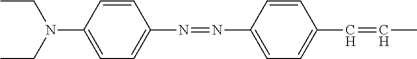 | MeO | —(OCH₂CH₂)₃—OH |
| A2-16 | 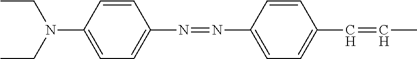 | MeO | —OC₁₈H₃₇-n |
| A2-17 | 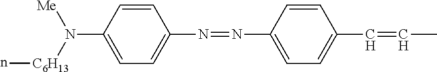 | MeO | —(OCH₂CH₂)₃—OH |
| A2-18 | 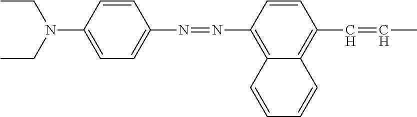 | MeO | —(OCH₂CH₂)₃—OH |
| A2-19 | 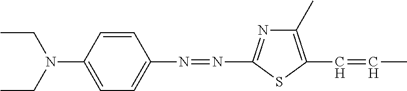 | MeO | —(OCH₂CH₂)₃—OH |
| A2-20 | 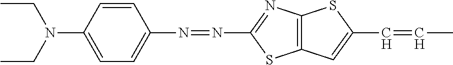 | MeO | —(OCH₂CH₂)₃—OH |
| A2-21 | 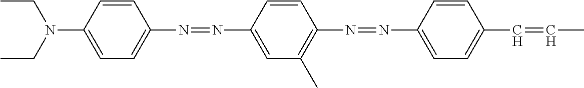 | MeO | —(OCH₂CH₂)₃—OH |
| A2-22 | 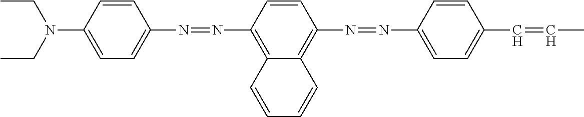 | MeO | —(OCH₂CH₂)₃—OH |
| A2-23 | 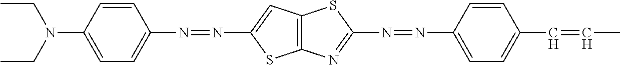 | MeO | —(OCH₂CH₂)₃—OH |

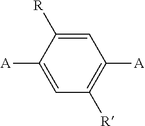

| | A | R | R′ |
|---|---|---|---|
| A2-24 | 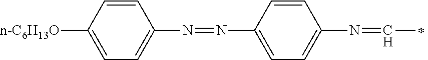 | MeO | *—(OCH₂CH₂)₃—OH |
| A2-25 | 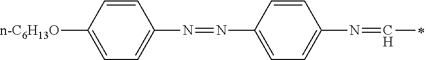 | MeO | *—OC₁₂H₂₅-n |
| A2-26 | 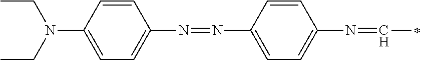 | MeO | *—(OCH₂CH₂)₃—OH |
| A2-27 | 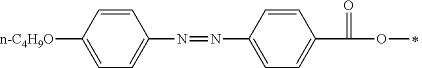 | MeO | *—(OCH₂CH₂)₆—OH |
| A2-28 | 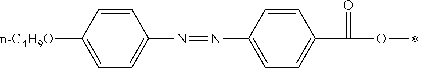 | H | *—OC₁₈H₃₇-n |
| A2-29 | 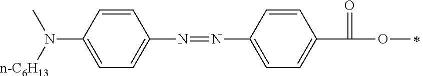 | MeO | *—(OCH₂CH₂)₃—OMe |
| A2-30 | 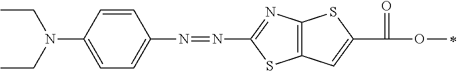 | MeO | *—(OCH₂CH₂)₃—OH |
| A2-31 | 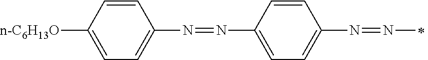 | MeO | *—(OCH₂CH₂)₃—OH |
| A2-32 | 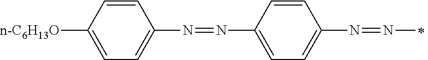 | MeO | *—(OCH₂CH₂CH₂)₃—OH |
| A2-33 | 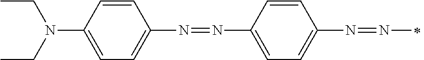 | MeO | *—(OCH₂CH₂)₃—OMe |
| A2-34 | 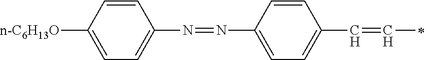 | MeO | MeO |

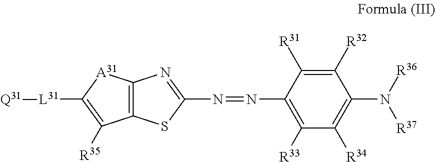

In Formula (III), R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom.

Examples of the substituents represented by R³¹ to R³⁵ are the same as those of the substituents represented by R¹¹ to R¹⁴ in Formula (I), and are preferably hydrogen atoms, alkyl groups, alkoxy groups, and halogen atoms, more preferably hydrogen atoms, alkyl groups, and alkoxy groups, and most preferably hydrogen atoms and methyl groups.

In formula (III), the optionally substituted alkyl group represented by R³⁶ or R³⁷ is preferably an alkyl group having 1 to 20 carbon atoms, more preferably 1 to 12 carbon atoms, and most preferably 1 to 8 carbon atoms, for example, a methyl group, an ethyl group, or an n-octyl group. The substituents of the alkyl group represented by R³⁶ or R³⁷ are synonymous with those of the groups represented by R³¹ to R³⁵. When R³⁶ and R³⁷ represent alkyl groups, the alkyl groups may be bonded to each other to form a ring structure. When R³⁶ or R³⁷ represents an alkyl group, the alkyl group may be bonded to R³² or R³⁴ to form a ring structure.

In particular, the group represented by R³⁶ or R³⁷ is preferably a hydrogen atom or an alkyl group, and more preferably a hydrogen atom, a methyl group, or an ethyl group.

In formula (III), Q³¹ represents an optionally substituted aromatic hydrocarbon group (preferably having 1 to 20 carbon atoms, more preferably 1 to 10 carbon atoms, e.g., a phenyl group or a naphthyl group), an optionally substituted aromatic heterocyclic group, or an optionally substituted cyclohexane ring group.

The optional substituent of the group represented by Q³¹ is preferably a group for enhancing the solubility of the azo compound or enhancing the nematic liquid crystallinity, a group having an electron-donating property or an electron-withdrawing property for adjusting color tone as a dye, or a group having a polymerizable group for fixing alignment. Specific examples thereof are synonymous with the substituents represented by R³¹ to R³⁵. Preferred examples of the substituent include optionally substituted alkyl groups, optionally substituted alkenyl groups, optionally substituted alkynyl groups, optionally substituted aryl groups, optionally substituted alkoxy groups, optionally substituted oxycarbonyl groups, optionally substituted acyloxy groups, optionally substituted acylamino groups, optionally substituted amino groups, optionally substituted alkoxycarbonylamino groups, optionally substituted sulfonylamino groups, optionally substituted sulfamoyl groups, optionally substituted carbamoyl groups, optionally substituted alkylthio groups, optionally substituted sulfonyl groups, optionally substituted ureido groups, a nitro group, a hydroxy group, a cyano group, an imino group, an azo group, and halogen atoms. More preferably, the substituent is an optionally substituted alkyl group, an optionally substituted alkenyl group, an optionally substituted aryl group, an optionally substituted alkoxy group, an optionally substituted oxycarbonyl group, an optionally substituted acyloxy group, a nitro group, an imino group, or an azo group. Among these substituents, in each substituent having carbon atoms, the preferred range of the number of the carbon atoms is the same as that of the number of carbon atoms of the substituent represented by R³¹, R³², R³³, R³⁴, or R³⁵.

The aromatic hydrocarbon group, the aromatic heterocyclic group, or the cyclohexane ring group may have one to five substituents mentioned above, preferably, one substituent. When Q³¹ is a phenyl group, the phenyl group preferably has one substituent at the para-position with respect to L³¹. When Q³¹ is a cyclohexane ring group, the cyclohexane ring group preferably has one substituent at the 4-position with respect to L³¹ so as to form a trans configuration.

The aromatic heterocyclic group represented by Q³¹ is preferably a group derived from a monocyclic or bicyclic heterocycle. Examples of the atom other than carbon constituting the aromatic heterocyclic group include nitrogen, sulfur, and oxygen atoms. When the aromatic heterocyclic group has multiple ring-constituting atoms other than carbon, these atoms may be the same or different. Specific examples of the aromatic heterocyclic group include a pyridyl group, a quinolyl group, a thiophenyl group, a thiazolyl group, a benzothiazolyl group, a thiadiazolyl group, a quinolonyl group, a naphthalimidoyl group, and a thienothiazolyl group.

The aromatic heterocyclic group is preferably a pyridyl group, a quinolyl group, a thiazolyl group, a benzothiazolyl group, a thiadiazolyl group, or a thienothiazolyl group, more preferably a pyridyl group, a benzothiazolyl group, a thiadiazolyl group, or a thienothiazolyl group, and most preferably a pyridyl group, a benzothiazolyl group, or a thienothiazolyl group.

In particular, the group represented by Q³¹ is preferably an optionally substituted phenyl, naphthyl, pyridyl, benzothiazolyl, thienothiazolyl, or cyclohexane ring group, and more preferably an optionally substituted phenyl, pyridyl, benzothiazolyl, or cyclohexane ring group.

In formula (III), the linker represented by L³¹ is, for example, a single bond, an alkylene group (preferably having 1 to 20 carbon atoms, more preferably 1 to 10 carbon atoms, and most preferably 1 to 6 carbon atoms, e.g., a methylene group, an ethylene group, a propylene group, a butylene group, a pentylene group, or a cyclohexane-1,4-diyl group), an alkenylene group (preferably having 2 to 20 carbon atoms, more preferably 2 to 10 carbon atoms, and most preferably 2 to 6 carbon atoms, e.g., an ethenylene group), an alkynylene group (preferably having 2 to 20 carbon atoms, more preferably 2 to 10 carbon atoms, and most preferably 2 to 6 carbon atoms, e.g., an ethynylene group), an alkyleneoxy group (preferably having 1 to 20 carbon atoms, more preferably 1 to 10 carbon atoms, and most preferably 1 to 6 carbon atoms, e.g., a methyleneoxy group), an amido group, an ether group, an acyloxy group (—C(═O)O—), an oxycarbonyl group (—OC(═O)—), an imino group (—CH═N— or —N═CH—), a sulfoamido group, a sulfonic acid ester group, an ureido group, a sulfonyl group, a sulfinyl group, a thioether group, a carbonyl group, a —NR— group (wherein, R represents a hydrogen atom, an alkyl group, or an aryl group), an azo group, an azoxy group, or a divalent linker formed by combining two or more of these linkers and having 0 to 60 carbon atoms.

In particular, the group represented by L³¹ is preferably a single bond, an amido group, an acyloxy group, an oxycarbonyl group, an imino group, an azo group, or an azoxy group, and more preferably an azo group, an acyloxy group, an oxycarbonyl group, or an imino group.

In formula (III), A³¹ represents an oxygen atom or a sulfur atom, and preferably a sulfur atom.

The compound represented by Formula (III) may have a polymerizable group as a substituent. The compound having a polymerizable group is preferred because of its enhanced film hardening ability. Examples of the polymerizable group include unsaturated polymerizable groups, epoxy groups, and aziridinyl groups. The polymerizable group is preferably an unsaturated polymerizable group and most preferably an ethylenically unsaturated polymerizable group. Examples of the ethylenically unsaturated polymerizable group include acryloyl groups and methacryloyl groups.

The polymerizable group is preferably positioned at the molecular terminal. That is, in formula (III), the polymerizable group is preferably present as a substituent for R³⁶ and/or R³⁷ and as a substituent for Q¹.

Among the compounds represented by formula (III), particularly preferred are compounds represented by Formula (IIIa):

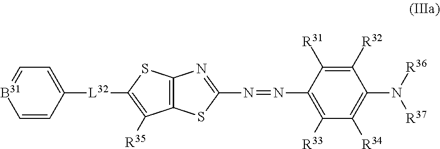

In Formula (IIIa), R³¹ to R³⁵ are synonymous with those in formula (III), respectively, and the preferred ranges thereof are also the same. B³¹ represents a nitrogen atom or an optionally substituted carbon atom; L³² represents an azo group, an acyloxy group (—C(═O)O—), an oxycarbonyl group (—OC(═O)—), or an imino group.

In formula (IIIa), R³⁵ preferably represents a hydrogen atom or a methyl group, and more preferably a hydrogen atom.

In formula (IIIa), when B³¹ is a carbon atom, the optional substituent of the carbon atom is synonymous with that of Q³¹ in formula (III), and the preferred range of the substituent is also the same.

In Formula (IIIa), L³² represents an azo group, an acyloxy group, an oxycarbonyl group, or an imino group, preferably an azo group, an acyloxy group, or an oxycarbonyl group, and most preferably an azo group.

Specific examples of the compound represented by Formula (III) are shown below, but the present invention is not limited to these specific examples.

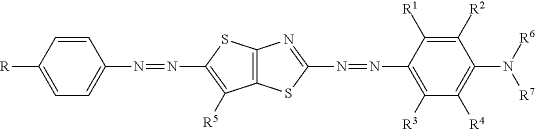

| No. | R¹ | R² | R³ | R⁴ | R⁵ | R⁶ | R⁷ | R |
|---|---|---|---|---|---|---|---|---|
| A3-1 | —H | —H | —H | —H | —H | —C₂H₅ | —C₂H₅ | —C₄H₉ |
| A3-2 | —H | —H | —H | —H | —H | —C₂H₅ | —C₂H₅ | —C₆H₁₃ |
| A3-3 | —H | —H | —H | —H | —H | —C₂H₅ | —C₂H₅ | —C₇H₁₅ |
| A3-4 | —H | —H | —H | —H | —H | —C₂H₅ | —C₂H₅ | —OC₄H₉ |
| A3-5 | —H | —H | —H | —H | —H | —C₂H₅ | —C₂H₅ | —CF₃ |
| A3-6 | —H | —H | —H | —H | —H | —C₂H₅ | —C₂H₅ | —OH |
| A3-7 | —H | —H | —H | —H | —H | —C₂H₅ | —C₂H₅ | —CN |
| A3-8 | —H | —H | —H | —H | —H | —C₂H₅ | —C₂H₅ | —NO₂ |
| A3-9 | —H | —H | —H | —H | —H | —C₂H₅ | —C₂H₅ | —F |
| A3-10 | —H | —H | —H | —H | —H | —C₂H₅ | —C₂H₅ | —Br |
| A3-11 | —H | —H | —H | —H | —H | —C₂H₅ | —C₂H₅ | —I |
| A3-12 | —H | —H | —H | —H | —H | —CH₃ | —H | —C₄H₉ |
| A3-13 | —H | —H | —H | —H | —H | —CH₃ | —CH₃ | —C₄H₉ |
| A3-14 | —H | —H | —H | —H | —H | —CH₃ | —C₆H₁₃ | —C₄H₉ |
| A3-15 | —H | —H | —H | —H | —H | —CH₃ | —CH₂CH₂OH | —C₄H₉ |
| A3-16 | —H | —H | —H | —H | —H | —CH₃ | —CH₂CH₂OCH₃ | —C₄H₉ |
| A3-17 | —H | —H | —H | —H | —H | —CH₃ | —CH₂CH₂OCOCH═CH₂ | —C₄H₉ |
| A3-18 | —H | —H | —H | —H | —H | —CH₃ | —CH₂CH₂CN | —C₄H₉ |
| A3-19 | —H | —H | —H | —H | —H | —CH₂CH₂OCOCH═CH₂ | —CH₂CH₂OCOCH═CH₂ | —C₄H₉ |
| A3-20 | —CH₃ | —H | —H | —H | —H | —C₂H₅ | —C₂H₅ | —C₄H₉ |
| A3-21 | —F | —H | —H | —H | —H | —C₂H₅ | —C₂H₅ | —C₄H₉ |
| A3-22 | —Cl | —H | —H | —H | —H | —C₂H₅ | —C₂H₅ | —C₄H₉ |
| A3-23 | —OH | —H | —H | —H | —H | —C₂H₅ | —C₂H₅ | —C₄H₉ |
| A3-24 | —OCH₃ | —H | —H | —H | —H | —C₂H₅ | —C₂H₅ | —C₄H₉ |
| A3-25 | —H | —OCH₃ | —OCH₃ | —H | —H | —C₂H₅ | —C₂H₅ | —C₄H₉ |
| A3-26 | —H | —H | —H | —H | —CH₃ | —C₂H₅ | —C₂H₅ | —C₄H₉ |

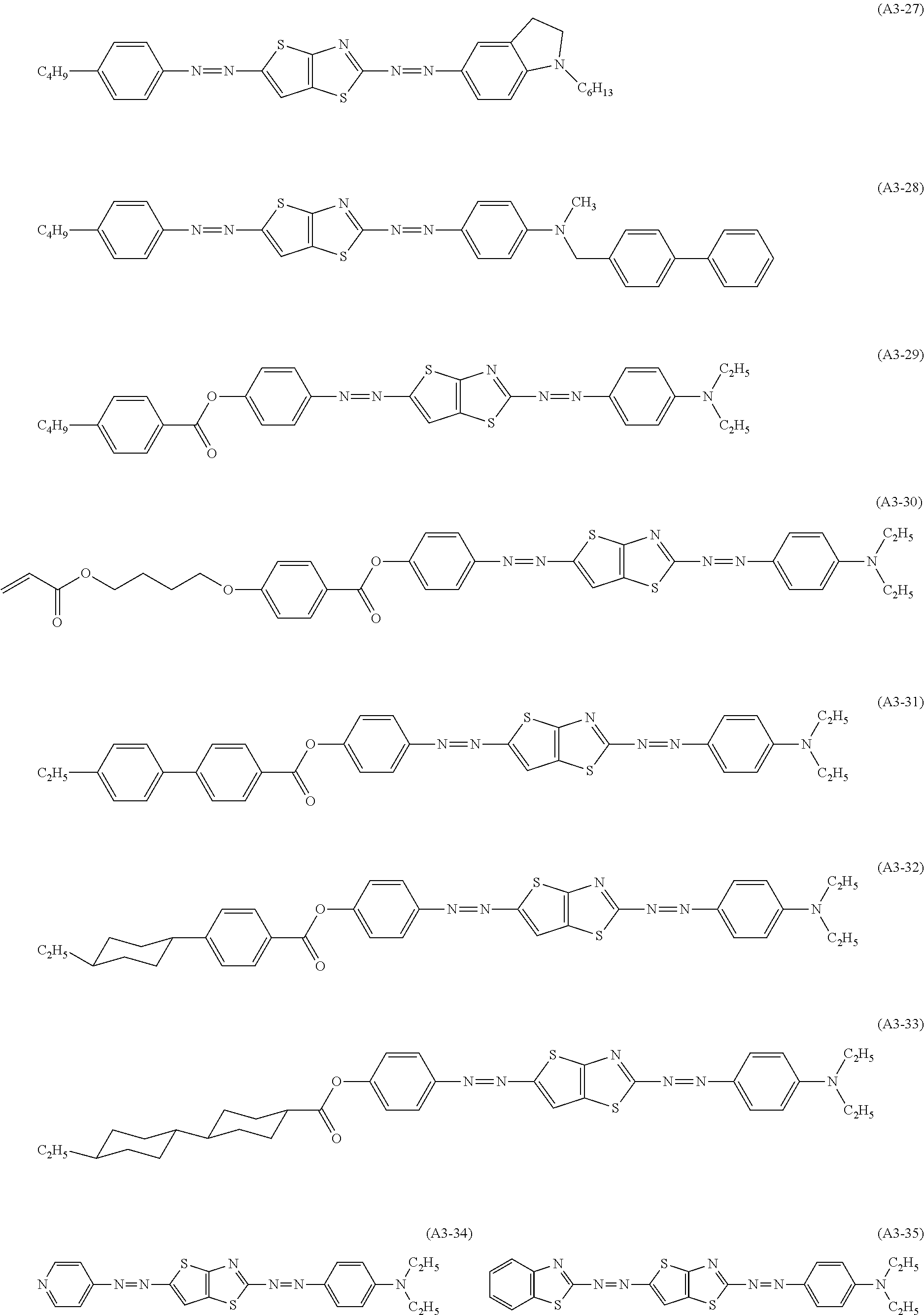

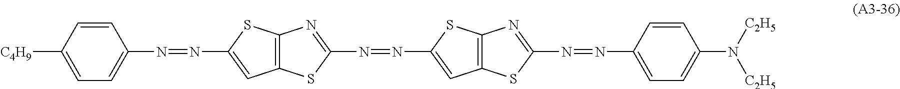

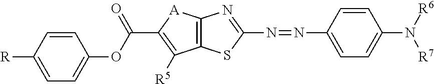

| No. | A | R⁵ | R⁶ | R⁷ | R |
|---|---|---|---|---|---|
| A3-37 | S | —H | —C₂H₅ | —C₂H₅ | —C₄H₉ |
| A3-38 | S | —H | —C₂H₅ | —C₂H₅ | —C₇H₁₅ |
| A3-39 | S | —H | —C₂H₅ | —C₂H₅ | —CN |
| A3-40 | S | —H | —C₂H₅ | —C₂H₅ | —Br |
| A3-41 | S | —CH₃ | —C₂H₅ | —C₂H₅ | —C₄H₉ |
| A3-42 | S | —H | —CH₃ | —CH₃ | —C₄H₉ |
| A3-43 | O | —H | —C₂H₅ | —C₂H₅ | —C₄H₉ |

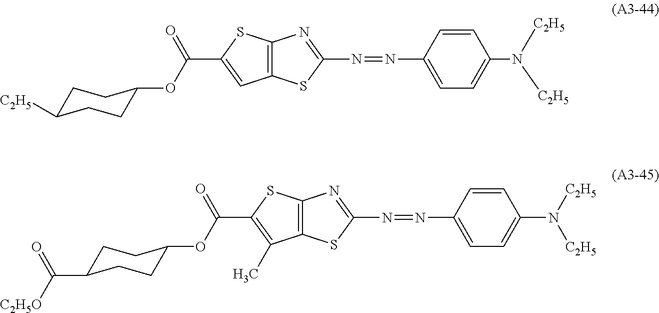

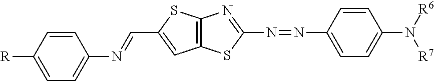

| No. | R⁶ | R⁷ | R |
|---|---|---|---|
| A3-46 | —C₂H₅ | —C₂H₅ | —C₄H₉ |
| A3-47 | —C₂H₅ | —C₂H₅ | —OC₄H₉ |
| A3-48 | —C₂H₅ | —C₂H₅ | —CF₃ |
| A3-49 | —C₂H₅ | —C₂H₅ | —F |
| A3-50 | —CH₃ | —CH₃ | —C₄H₉ |

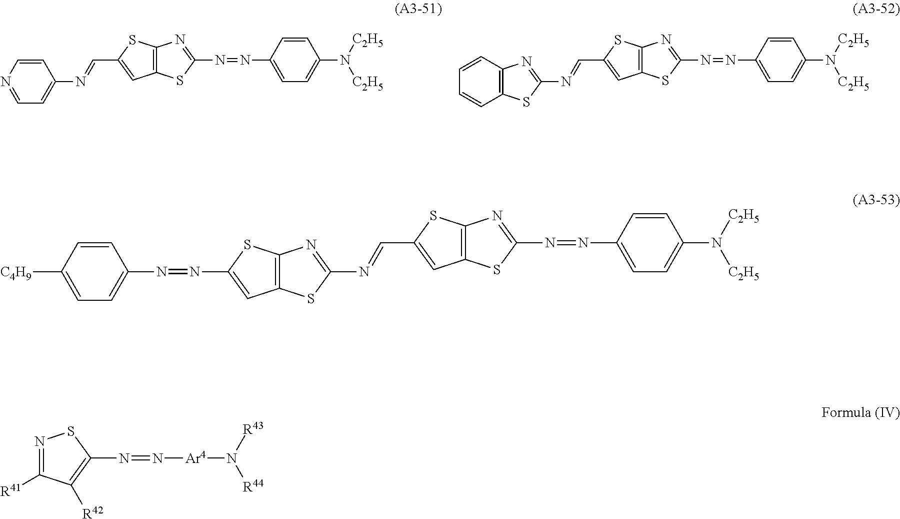

In Formula (IV), R⁴¹ and R⁴² each represent a hydrogen atom or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a ring.

In Formula (IV), examples of the substituent represented by each of R⁴¹ and R⁴² are the same as those of the substituent represented by each of R¹¹ to R¹⁴ in Formula (I). R⁴¹ and R⁴² are each preferably a hydrogen atom, an alkyl group, an alkoxy group, a halogen atom, a cyano group, a nitro group, or a sulfo group, more preferably a hydrogen atom, an alkyl group, a halogen atom, a cyano group, or a nitro group, more preferably a hydrogen atom, an alkyl group, or a cyano group, and most preferably a hydrogen atom, a methyl group, or a cyano group.

It is also preferred that R⁴¹ and R⁴² form a ring, in particular, form an aromatic hydrocarbon group or an aromatic heterocyclic group. The aromatic heterocyclic group is preferably derived from a monocyclic or bicyclic heterocycle. Examples of the atom other than carbon constituting the aromatic heterocyclic group include nitrogen, sulfur, and oxygen atoms. When the aromatic heterocyclic group has multiple ring-constituting atoms other than carbon, these atoms may be the same or different. Specific examples of the aromatic heterocyclic group include a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, and a thienothiazole ring.

The cyclic group formed by R⁴¹ and R⁴² bonded to each other is preferably a benzene ring, a naphthalene ring, a pyridine ring, a pyrazine ring, a pyrimidine ring, or a pyridazine ring, more preferably a benzene ring or a pyridine ring, and most preferably a pyridine ring.

The cyclic group formed by R⁴¹ and R⁴² bonded to each other may have a substituent. The range of the substituent is the same as that of the group represented by R¹ or R², and the preferred range thereof is also the same.

Examples of the compound represented by Formula (IV) include compounds represented by Formula (IV′):

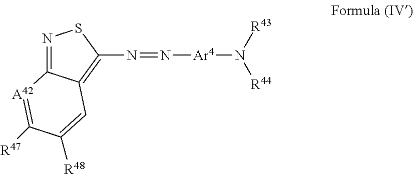

In Formula (IV′), symbols identical with those in Formula (IV) synonymous with those in Formula (IV), and preferred ranges thereof are also the same. A⁴² represents N or CH, and R⁴⁷ and R⁴⁸ each represent a hydrogen atom or a substituent. One of R⁴⁷ and R⁴⁸ is preferably a substituent. It is also preferred that both of R⁴⁷ and R⁴⁸ be substituents other than hydrogen atoms. Preferable examples of the substituent are the same as those of the substituent represented by R⁴¹ or A⁴². That is, the substituent is preferably an alkyl group, an alkoxy group, a halogen atom, a cyano group, a nitro group, or a sulfo group, more preferably an alkyl group, a halogen atom, a cyano group, or a nitro group, more preferably an alkyl group or a cyano group, and most preferably a methyl group or a cyano group. For example, compounds in which one of R⁴⁷ and R⁴⁸ is an alkyl group having 1 to 4 carbon atoms and the other is a cyano group are also preferable.

In formula (IV′), the aromatic heterocyclic group represented by Ar⁴ is preferably a group derived from a monocyclic or bicyclic heterocycle. Examples of the atom other than carbon constituting the aromatic heterocyclic group include nitrogen, sulfur, and oxygen atoms. When the aromatic heterocyclic group has multiple ring-constituting atoms other than carbon, these atoms may be the same or different. Specific examples of the aromatic heterocyclic group include a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, and a thienothiazole ring.

The group represented by Ar⁴ is preferably a benzene ring, a naphthalene ring, a pyridine ring, a pyrazine ring, a pyrimidine ring, a pyridazine ring, a quinoline ring, or a thiophene ring, more preferably a benzene ring, a naphthalene ring, a pyridine ring, or a thiophene ring, and most preferably a benzene ring.

Ar⁴ may have a substituent, and the range of the substituent is the same as that of the group represented by R⁴¹ or R⁴².

The optional substituent of Ar⁴ is preferably an alkyl group, an alkoxy group, or a halogen atom, more preferably a hydrogen atom, an alkyl group, or an alkoxy group, and most preferably a methyl group. Unsubstituted Ar⁴ is also preferred.

The bonding of Ar⁴ with the amino group is preferably parallel to the bonding of Ar⁴ with the azo group, from the viewpoint of enhancing the molecular linearity to obtain a larger molecular length and a higher aspect ratio. For example, when Ar⁴ has a 6-membered ring bonded to the azo group and the amino group, the amino group is preferably bonded to the 4-position with respect to the azo group. When Ar⁴ has a 5-membered ring bonded to the azo group and the amino group, the amino group is preferably bonded to the 3-position or 4-position with respect to the azo group.

In formula (IV′), the range of the alkyl group represented by R⁴³ or R⁴⁴ is the same as that of the alkyl group represented by R⁴¹ or R⁴². The alkyl group may have a substituent, and examples of the substituent are the same as those of the substituent represented by R⁴¹ or R⁴². When R⁴³ and R⁴⁴ represent optionally substituted alkyl groups, R⁴³ and R⁴⁴ may be bonded to each other to form a heterocycle. Furthermore, if possible, R⁴³ or R⁴⁴ may be bonded to the optional substituent of Ar⁴ to form a ring.

R⁴³ and R⁴⁴ are preferably bonded to each other to form a ring. The ring is preferably a 6-membered ring or a 5-membered ring, and more preferably a 6-membered ring. The cyclic group may contain a constituent atom other than carbon, in addition to carbon atoms. Examples of the constituent atom other than carbon include nitrogen, sulfur, and oxygen atoms. When the cyclic group has two or more ring-constituting atoms other than carbon, these atoms may be the same or different.

Specific examples of the cyclic group formed from R⁴³ and R⁴⁴ include a 3-pyrroline ring, a pyrrolidine ring, a 3-imidazoline ring, an imidazolidine ring, a 4-oxazoline ring, an oxazolidine ring, a 4-thiazoline ring, a thiazolidine ring, a piperidine ring, a piperazine ring, a morpholine ring, a thiomorpholine ring, an azepane ring, and an azocane ring.

The cyclic group formed from R⁴³ and R⁴⁴ is preferably a pyrrolidine ring, a piperidine ring, a piperazine ring, or a morpholine ring, more preferably a piperidine ring or a piperazine ring, and most preferably a piperazine ring.

The cyclic group formed from R⁴³ and R⁴⁴ may have a substituent, and the range of the substituent is the same as that of the group represented by R⁴¹ and R⁴². The cyclic group preferably has one rigid linear substituent, and the bonding of the cyclic group with the substituent is preferably parallel to the bonding of the cyclic group with Ar⁴, from the viewpoint of enhancing molecular linearity to obtain a larger molecular length and a higher aspect ratio.

Among the dichroic dyes represented by Formula (IV), particularly preferred are dichroic dyes represented by Formula (IVa):

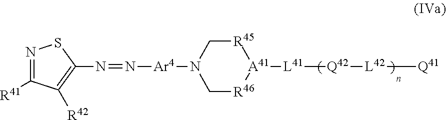

In formula (IVa), R⁴¹ and R⁴² each represent a hydrogen atom or a substituent or may be bonded to each other to form a ring; Ar⁴ represents an optionally substituted divalent aromatic hydrocarbon or aromatic heterocyclic group; A⁴¹ represents a carbon atom or a nitrogen atom; L⁴¹, L⁴², R⁴⁵, and R⁴⁶ each represent a single bond or a divalent linker; Q⁴¹ represents an optionally substituted cyclic hydrocarbon group or heterocyclic group; Q⁴² represents an optionally substituted divalent cyclic hydrocarbon group or heterocyclic group; and n represents an integer of 0 to 3, and when n is an integer of 2 or more, the two or more L⁴²'s may be the same as or different from each other, and the two or more Q⁴²'s may be the same as or different from each other.

In formula (IVa), the ranges of the groups represented by R⁴¹ and R⁴² are the same as those of the groups represented by R⁴¹ and R⁴² in Formula (IV), and the preferred ranges are also the same.

In formula (IVa), the ranges of the divalent aromatic hydrocarbon group and the aromatic heterocyclic group represented by Ar⁴ are the same as those of the groups represented by Ar⁴ in Formula (IV), and the preferred ranges are also the same.

In formula (IVa), A⁴¹ is preferably a nitrogen atom.

In formula (IVa), the linker represented by L⁴¹, L⁴², R⁴⁵, or R⁴⁶ is, for example, an alkylene group (preferably having 1 to 20 carbon atoms, more preferably 1 to 10 carbon atoms, and most preferably 1 to 6 carbon atoms, e.g., a methylene group, an ethylene group, a propylene group, a butylene group, a pentylene group, or a cyclohexane-1,4-diyl group), an alkenylene group (preferably having 2 to 20 carbon atoms, more preferably 2 to 10 carbon atoms, and most preferably 2 to 6 carbon atoms, e.g., an ethenylene group), an alkynylene group (preferably having 2 to 20 carbon atoms, more preferably 2 to 10 carbon atoms, and most preferably 2 to 6 carbon atoms, e.g., an ethynylene group), an alkyleneoxy group (preferably having 1 to 20 carbon atoms, more preferably 1 to 10 carbon atoms, and most preferably 1 to 6 carbon atoms, e.g., a methyleneoxy group), an amido group, an ether group, an acyloxy group (—C(═O)O—), an oxycarbonyl group (—OC(═O)—), an imino group (—CH═N— or —N═CH—), a sulfoamido group, a sulfonic acid ester group, an ureido group, a sulfonyl group, a sulfinyl group, a thioether group, a carbonyl group, a —NR— group (wherein, R represents a hydrogen atom, an alkyl group, or an aryl group), an azo group, an azoxy group, or a divalent linker formed by combining two or more of these linkers and having 0 to 60 carbon atoms.

The linker represented by L⁴¹ is preferably a single bond, an alkylene group, an alkenylene group, an alkyleneoxy group, an oxycarbonyl group, an acyl group, or a carbamoyl group, more preferably a single bond or an alkylene group, and most preferably a single bond or an ethylene group.

The linker represented by L⁴² is preferably a single bond, an alkylene group, an alkenylene group, an oxycarbonyl group, an acyl group, an acyloxy group, a carbamoyl group, an imino group, an azo group, or an azoxy group, more preferably a single bond, an oxycarbonyl group, an acyloxy group, an imino group, an azo group, or an azoxy group, and most preferably a single bond, an oxycarbonyl group, or an acyloxy group.

The linker represented by R⁴⁵ or R⁴⁶ is preferably a single bond, an alkylene group, an alkenylene group, an alkyleneoxy group, or an acyl group, more preferably a single bond or an alkylene group, and most preferably a single bond or a methylene group.

In formula (IVa), the number of constituent atoms of the ring formed by the nitrogen atom, the methylene groups, R⁴⁵, R⁴⁶, and A⁴¹ is determined by R⁴⁵ and R⁴⁶. For example, when both R⁴⁵ and R⁴⁶ are single bonds, a 4-membered ring is formed; when one of R⁴⁵ and R⁴⁶ is a single bond and the other is a methylene group, a 5-membered ring is formed; and both R⁴⁵ and R⁴⁶ are methylene groups, a 6-membered ring is formed.

In formula (IVa), the ring formed by the nitrogen atom, the methylene groups, R⁴⁵, R⁴⁶, and A⁴¹ is preferably a 6-membered ring or a 5-membered ring and more preferably a 6-membered ring.

In formula (IVa), the group represented by Q⁴¹ is preferably an aromatic hydrocarbon group (preferably having 1 to 20 carbon atoms and more preferably 1 to 10 carbon atoms, e.g., a phenyl group or a naphthyl group), an aromatic heterocyclic group, or a cyclohexane ring group.

The aromatic heterocyclic group represented b Y Q⁴¹ is preferably a group derived from a monocyclic or bicyclic heterocycle. Examples of the atoms other than carbon constituting the aromatic heterocyclic group include nitrogen, sulfur, and oxygen atoms. When the aromatic heterocyclic group has two or more ring-constituting atoms other than carbon, these atoms may be the same or different. Specific examples of the aromatic heterocyclic group include a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, and a thienothiazole ring.

The group represented by Q⁴¹ is preferably a benzene ring, a naphthalene ring, a pyridine ring, a pyrazine ring, a pyrimidine ring, a pyridazine ring, a thiazole ring, a benzothiazole ring, a thiadiazole ring, a quinoline ring, a thienothiazole ring, or a cyclohexane ring, more preferably a benzene ring, a naphthalene ring, a pyridine ring, a thiazole ring, a benzothiazole ring, a thiadiazole ring, or a cyclohexane ring, and most preferably a benzene ring, a pyridine ring, or a cyclohexane ring.

Q⁴¹ may have a substituent, and the range of the substituent is the same as that of the group represented by R⁴¹ or R⁴².

The optional substituent of Q⁴¹ is preferably an optionally substituted alkyl group, an optionally substituted alkenyl group, an optionally substituted alkynyl group, an optionally substituted aryl group, an optionally substituted alkoxy group, an optionally substituted oxycarbonyl group, an optionally substituted acyloxy group, an optionally substituted acylamino group, an optionally substituted amino group, an optionally substituted alkoxycarbonylamino group, an optionally substituted sulfonylamino group, an optionally substituted sulfamoyl group, an optionally substituted carbamoyl group, an optionally substituted alkylthio group, an optionally substituted sulfonyl group, an optionally substituted ureido group, a nitro group, a hydroxy group, a cyano group, an imino group, an azo group, or a halogen atom, and more preferably an optionally substituted alkyl group, an optionally substituted alkenyl group, an optionally substituted aryl group, an optionally substituted alkoxy group, an optionally substituted oxycarbonyl group, an optionally substituted acyloxy group, a nitro group, an imino group, or an azo group. Among these substituents, in each substituent having carbon atoms, the preferred range of the number of the carbon atoms is the same as that of the number of carbon atoms of the substituent represented by R⁴¹ or R⁴².

Q⁴¹ preferably has one substituent, and the bonding of Q⁴¹ with the substituent is preferably parallel to the bonding of Q⁴¹ with L⁴¹ or L⁴², from the viewpoint of enhancing molecular linearity to obtain a larger molecular length and a higher aspect ratio. In particular, when n represents 0, it is preferable that Q⁴¹ have a substituent at the above-mentioned position.

In formula (IVa), Q⁴² represents an optionally substituted divalent cyclic hydrocarbon group or heterocyclic group.

The divalent cyclic hydrocarbon group represented by Q⁴² may be aromatic or non-aromatic. Preferable examples of the divalent cyclic hydrocarbon group include aromatic hydrocarbon groups (preferably having 1 to 20 carbon atoms and more preferably 1 to 10 carbon atoms, e.g., a phenyl group and a naphthyl group) and cyclohexane ring groups.

The divalent cyclic heterocyclic group represented by Q⁴² also may be aromatic or non-aromatic. The heterocyclic group is preferably a group derived from a monocyclic or bicyclic heterocycle. Examples of the atoms other than carbon constituting the aromatic heterocyclic group include nitrogen, sulfur, and oxygen atoms. When the heterocyclic group has two or more ring-constituting atoms other than carbon, these atoms may be the same or different. Specific examples of the heterocyclic group include a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring, a 3-pyrroline ring, a pyrrolidine ring, a 3-imidazoline ring, an imidazolidine ring, a 4-oxazoline ring, an oxazolidine ring, a 4-thiazoline ring, a thiazolidine ring, a piperidine ring, a piperazine ring, a morpholine ring, a thiomorpholine ring, an azepane ring, and an azocane ring.

The group represented by Q⁴² is preferably a benzene ring, a naphthalene ring, a pyridine ring, a pyrazine ring, a pyrimidine ring, a pyridazine ring, a piperidine ring, a piperazine ring, a quinoline ring, a thiophene ring, a thiazole ring, a benzothiazole ring, a thiadiazole ring, a quinolone ring, a naphthalimide ring, a thienothiazole ring, or a cyclohexane ring, more preferably a benzene ring, a naphthalene ring, a pyridine ring, a piperidine ring, a piperazine ring, a thiazole ring, a thiadiazole ring, or a cyclohexane ring, and most preferably a benzene ring, a cyclohexane ring, or a piperazine ring.

Q⁴² may have a substituent, and the range of the substituent is the same as that of the group represented by R⁴¹ or R⁴².

The range of the optional substituent of Q⁴² is the same as that of the substituent represented by Ar⁴, and the preferred range thereof is also the same.

The bonding of Q⁴² with L⁴² is preferably parallel to the bonding of Q⁴² with L⁴¹ or another L⁴², from the viewpoint of enhancing molecular linearity to obtain a larger molecular length and a higher aspect ratio.

In formula (IVa), n represents an integer of 0 to 3, preferably 0 to 2, more preferably 0 or 1, and most preferably 1.

Among the dichroic dyes represented by Formula (IVa), particularly preferred are dichroic dyes represented by Formula (IVb):

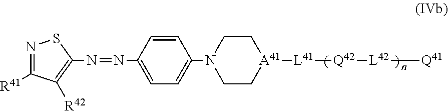

In formula (IVb), R⁴¹ and R⁴² each represent a hydrogen atom or a substituent; A⁴¹ represents a carbon atom or a nitrogen atom; L⁴¹ and L⁴² each represent a single bond or a divalent linker; Q⁴¹ represents an optionally substituted cyclic hydrocarbon group or heterocyclic group; Q⁴² represents an optionally substituted divalent cyclic hydrocarbon group or heterocyclic group; and n represents an integer of 0 to 3, and when n is an integer of 2 or more, the two or more L⁴²'s may be the same as or different from each other, and the two or more Q⁴²'s may be the same as or different from each other.

In Formula (IVb), the ranges of the groups represented by R⁴¹, R⁴², L⁴¹, L⁴², Q⁴¹, and Q⁴² are the same as those of the groups represented by R⁴¹, R⁴², L⁴¹, L⁴², Q⁴¹, and Q⁴² in Formula (IV), and preferred ranges thereof are also the same.

In formula (IVb), A⁴¹ is preferably a nitrogen atom.

Specific examples of the compound represented by Formula (IV) are shown below, but the present invention is not limited to these specific examples.

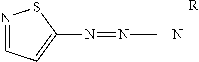

| No. | Ar | R³ | R⁴ |
|---|---|---|---|
| A4-1 | 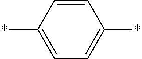 [SMILES: *c1ccc(*)cc1] | —CH₃ | —CH₂Ph |
| A4-2 | 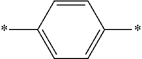 [SMILES: *c1ccc(*)cc1] | —CH₃ | —C₁₂H₂₅ |
| A4-3 | 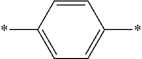 [SMILES: *c1ccc(*)cc1] | —CH₃ | —(CH₂CH₂O)₃CH₃ |
| A4-4 | 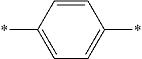 [SMILES: *c1ccc(*)cc1] | —CH₃ | —CH₂CH₂OCH₂Ph |
| A4-5 | 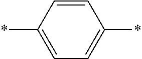 [SMILES: *c1ccc(*)cc1] | —H | —CH₂Ph |
| A4-6 | 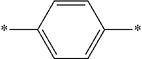 [SMILES: *c1ccc(*)cc1] | —C₂H₅ | —CH₂Ph |
| A4-7 | 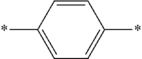 [SMILES: *c1ccc(*)cc1] | 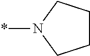 [SMILES: *N1CCCC1] | |
| A4-8 | 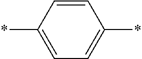 [SMILES: *c1ccc(*)cc1] | 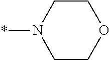 [SMILES: *N1CCOCC1] | |
| A4-9 | 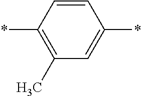 [SMILES: *c1ccc(*)c(C)c1] | —CH₃ | —CH₂Ph |
| A4-10 | 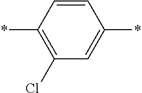 [SMILES: *c1ccc(*)c(Cl)c1] | —CH₃ | —CH₂Ph |
| A4-11 | 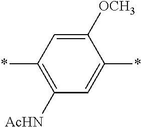 [SMILES: *c1cc(OC)c(*)cc1NC(C)=O] | —CH₃ | —CH₂Ph |
| A4-12 | 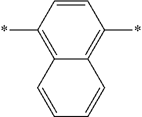 [SMILES: *c1ccc(*)c2ccccc12] | —CH₃ | —CH₂Ph |
| No. | Ar | R3 | R4 |
| A4-13 | 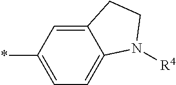 | | —CH₂Ph |
| A4-14 | 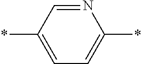 [SMILES: *c1ccc(*)nc1] | —CH₃ | —CH₂Ph |
| A4-15 | 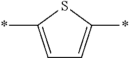 [SMILES: *c1ccc(*)s1] | —CH₃ | —CH₂CH₂OCH₂Ph |

| | | |
|---|---|---|
| A4-16 | 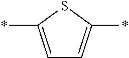 [SMILES: *c1ccc(*)s1] | 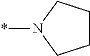 [SMILES: *N1CCCC1] |
| A4-17 | 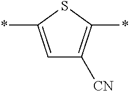 [SMILES: *c1cc(C#N)c(*)s1] | 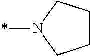 [SMILES: *N1CCCC1] |

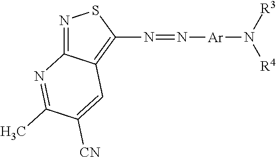

| No. | Ar | R³ | R⁴ |
|---|---|---|---|
| A4-18 | 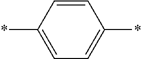 [SMILES: *c1ccc(*)cc1] | —CH₃ | —CH₂Ph |
| A4-19 | 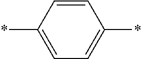 [SMILES: *c1ccc(*)cc1] | 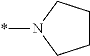 [SMILES: *N1CCCC1] | |
| A4-20 | 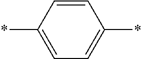 [SMILES: *c1ccc(*)cc1] | 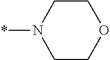 [SMILES: *N1CCOCC1] | |
| A4-21 | 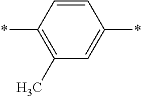 [SMILES: *c1ccc(*)c(C)c1] | —C₂H₅ | —C₂H₅ |
| A4-22 | 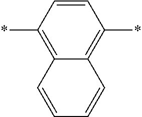 [SMILES: *c1ccc(*)c2ccccc12] | —C₂H₅ | —C₂H₅ |
| A4-23 | 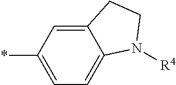 | | —CH₂Ph |
| A4-24 | 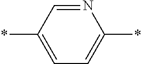 [SMILES: *c1ccc(*)nc1] | —CH₃ | —CH₂Ph |

| | | |
|---|---|---|
| A4-25 | 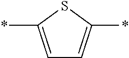 [SMILES: *c1ccc(*)s1] | 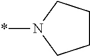 [SMILES: *N1CCCC1] |

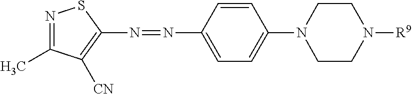

| No. | R⁹ |
|---|---|
| A4-26 | —C₅H₁₁ |
| A4-27 | —C₁₂H₂₅ |
| A4-28 | —CH₂CH(C₂H₅)C₄H₉ |
| A4-29 | —(CH₂CH₂O)₃CH₃ |
| A4-30 | —COOC₈H₁₇ |
| A4-31 | —C(═O)C₁₁H₂₃ |
| A4-32 | CONHC₈H₁₇ |

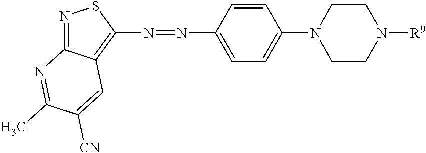

| No. | R⁹ |
|---|---|
| A4-33 | —C₅H₁₁ |
| A4-34 | —C₁₂H₂₅ |
| A4-35 | —CH₂CH(C₂H₅)C₄H₉ |
| A4-36 | —(CH₂CH₂O)₃CH₃ |
| A4-37 | —COOC₈H₁₇ |
| A4-38 | —C(═O)C₁₂H₂₅ |
| A4-39 | CONHC₈H₁₇ |

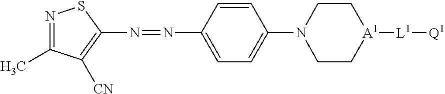

| No. | A¹ | L¹ | Q¹ |
|---|---|---|---|
| A4-40 | 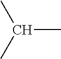 | — | —Ph |
| A4-41 | 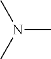 | — | —Ph |
| A4-42 | 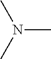 | — | 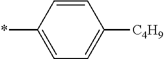 |
| A4-43 | 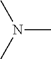 | — | 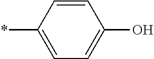 [SMILES: *c1ccc(O)cc1] |
| A4-44 | 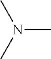 | — | 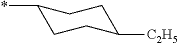 [SMILES: *C1CCC(CC)CC1] |
| A4-45 | 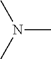 | —COO— | 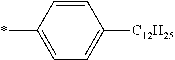 |
| A4-46 | 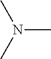 | —COOCH₂— | —Ph |
| A4-47 | 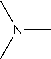 | —CONH— | 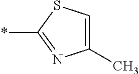 [SMILES: *c1nc(C)cs1] |
| A4-48 | 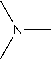 | —CONH— | 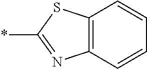 [SMILES: *c1nc2ccccc2s1] |
| A4-49 | 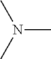 | —CO— | 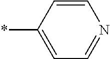 [SMILES: *c1ccncc1] |
| A4-50 | 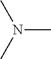 | —CO— | 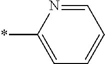 [SMILES: *c1ccccn1] |
| A4-51 | 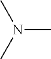 | —CH₂CH₂— | —Ph |
| A4-52 | 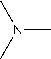 | —CH₂CH₂O— | 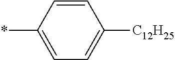 |
| A4-53 | 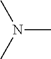 | —CH₂CH₂OCO— | 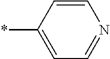 [SMILES: *c1ccncc1] |
| A4-54 | 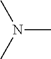 | —CH₂CH₂OCO— | 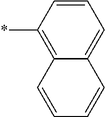 [SMILES: *c1cccc2ccccc12] |
| A4-55 | 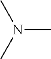 | —CH₂CH₂OCO— | 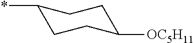 |

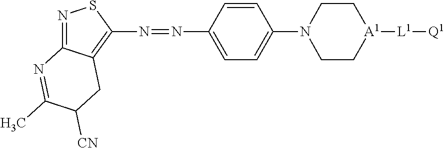

| No. | A¹ | L¹ | Q¹ |
|---|---|---|---|
| A4-56 | 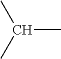 | — | —Ph |
| A4-57 | 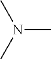 | — | —Ph |
| A4-58 | 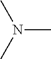 | — | 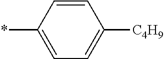 |
| A4-59 | 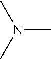 | — | 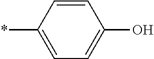 [SMILES: *c1ccc(O)cc1] |
| A4-60 | 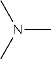 | — | 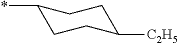 [SMILES: *C1CCC(CC)CC1] |
| A4-61 | 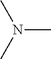 | —COO— | 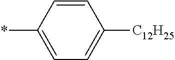 |
| A4-62 | 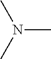 | —COOCH₂— | —Ph |
| A4-63 | 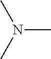 | —CONH— | 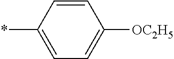 [SMILES: *c1ccc(OCC)cc1] |
| A4-64 | 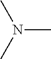 | —CONH— | 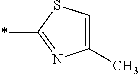 [SMILES: *c1nc(C)cs1] |
| A4-65 | 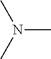 | —CONH— | 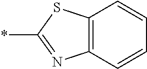 [SMILES: *c1nc2ccccc2s1] |
| A4-66 | 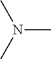 | —CO— | 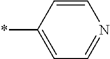 [SMILES: *c1ccncc1] |
| A4-67 | 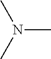 | —CO— | 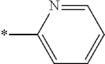 [SMILES: *c1ccccn1] |
| A4-68 | 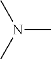 | —CH₂CH₂— | —Ph |
| A4-69 | 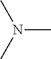 | —CH₂CH₂O— | 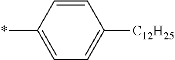 |
| A4-70 | 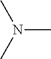 | —CH₂CH₂OCO— | 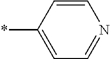 [SMILES: *c1ccncc1] |
| A4-71 | 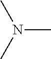 | —CH₂CH₂OCO— | 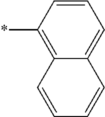 [SMILES: *c1cccc2ccccc12] |
| A4-72 | 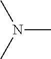 | —CH₂CH₂OCO— | 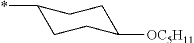 |

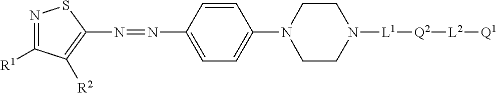

| No. | R¹ | R² | L¹ | Q² | L² | Q¹ |
|---|---|---|---|---|---|---|
| A4-73 | —CH₃ | —CN | — | 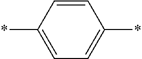 [SMILES: *c1ccc(*)cc1] | — | —Ph |
| A4-74 | —CH₃ | —CN | — | 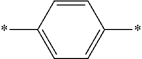 [SMILES: *c1ccc(*)cc1] | — | 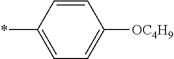 |
| A4-75 | —CH₃ | —CN | — | 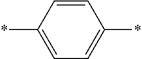 [SMILES: *c1ccc(*)cc1] | —COO— | 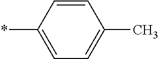 [SMILES: *c1ccc(C)cc1] |
| A4-76 | —CH₃ | —CN | — | 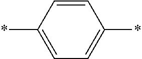 [SMILES: *c1ccc(*)cc1] | —COO— | 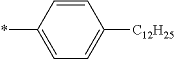 |
| A4-77 | —CH₃ | —CN | — | 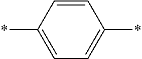 [SMILES: *c1ccc(*)cc1] | —COO— | 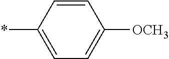 [SMILES: *c1ccc(OC)cc1] |
| A4-78 | —CH₃ | —CN | — | 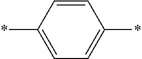 [SMILES: *c1ccc(*)cc1] | —COOCH₂— | —Ph |
| A4-79 | —CH₃ | —CN | — | 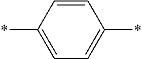 [SMILES: *c1ccc(*)cc1] | —CONH— | 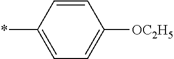 [SMILES: *c1ccc(OCC)cc1] |
| A4-80 | —CH₃ | —CN | — | 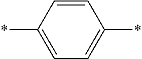 [SMILES: *c1ccc(*)cc1] | —CONH— | 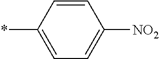 [SMILES: *c1ccc([N+](=O)[O-])cc1] |
| A4-81 | —CH₃ | —CN | — | 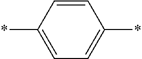 [SMILES: *c1ccc(*)cc1] | —CONH— | 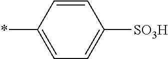 [SMILES: *c1ccc(S(=O)(=O)O)cc1] |
| A4-82 | —CH₃ | —CN | — | 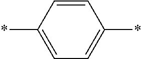 [SMILES: *c1ccc(*)cc1] | —OCO— | 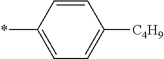 |
| A4-83 | —CH₃ | —CN | — | 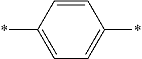 [SMILES: *c1ccc(*)cc1] | —OCO— | 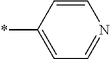 [SMILES: *c1ccncc1] |
| A4-84 | —CH₃ | —CN | — | 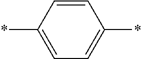 [SMILES: *c1ccc(*)cc1] | —NHCO— | 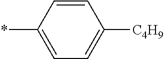 |
| A4-85 | —CH₃ | —CN | — | 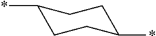 [SMILES: *C1CCC(*)CC1] | —OCO— | 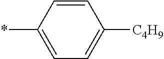 |

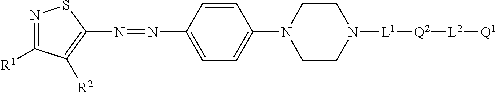

| No. | R¹ | R² | L¹ | Q² | L² | Q¹ |
|---|---|---|---|---|---|---|
| A4-86 | —CH₃ | —CN | —COO— | 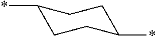 [SMILES: *C1CCC(*)CC1] | —OCO— | 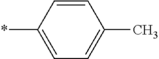 [SMILES: *c1ccc(C)cc1] |
| A4-87 | —CH₃ | —CN | —COO— | 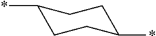 [SMILES: *C1CCC(*)CC1] | —COO— | 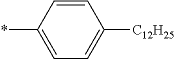 |
| A4-88 | —CH₃ | —CN | —CO— | 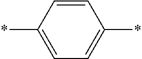 [SMILES: *c1ccc(*)cc1] | — | —Ph |
| A4-89 | —CH₃ | —CN | —CO— | 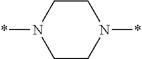 [SMILES: *N1CCN(*)CC1] | —COO— | 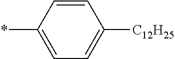 |
| A4-90 | —CH₃ | —CN | —CH₂CH₂— | 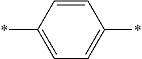 [SMILES: *c1ccc(*)cc1] | —OCO— | 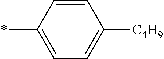 |
| A4-91 | —CH₃ | —CN | —CH₂CH₂— | 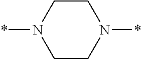 [SMILES: *N1CCN(*)CC1] | — | —Ph |
| A4-92 | —CH₃ | —CN | —CH₂CH₂— | 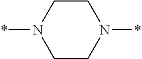 [SMILES: *N1CCN(*)CC1] | —COO— | 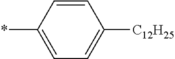 |
| A4-93 | —CH₃ | —CN | —CH₂CH₂— | 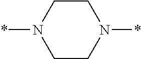 [SMILES: *N1CCN(*)CC1] | —CO— | 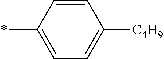 |
| A4-94 | —CH₃ | —CN | —CH₂CH₂— | 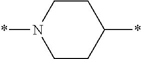 [SMILES: *C1CCN(*)CC1] | — | —Ph |
| A4-95 | —CH₃ | —CN | —CH₂CH₂O— | 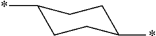 [SMILES: *C1CCC(*)CC1] | —OCO— | 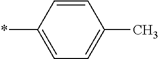 [SMILES: *c1ccc(C)cc1] |
| A4-96 | —CH₃ | —CN | —CH₂CH₂OCO— | 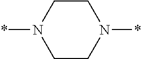 [SMILES: *N1CCN(*)CC1] | —COO— | 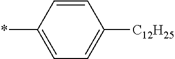 |
| A4-97 | —CH₃ | —H | —CH₂CH₂OCO— | 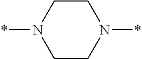 [SMILES: *N1CCN(*)CC1] | — | —Ph |
| A4-98 | —H | —H | —CH₂CH₂OCO— | 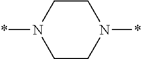 [SMILES: *N1CCN(*)CC1] | — | —Ph |
| A4-99 | —H | —Cl | —CH₂CH₂OCO— | 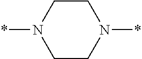 [SMILES: *N1CCN(*)CC1] | — | —Ph |
| A4-100 | —H | —SO₃H | —CH₂CH₂OCO— | 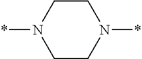 [SMILES: *N1CCN(*)CC1] | — | —Ph |
| A4-101 | —H | —NO₂ | —CH₂CH₂OCO— | 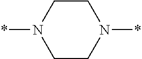 [SMILES: *N1CCN(*)CC1] | — | —Ph |

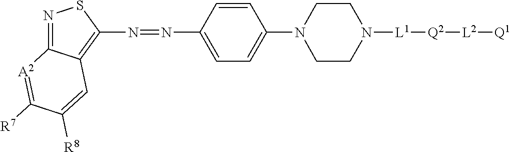

| No. | A² | R⁷ | R⁸ | L¹ | Q² | L² | Q¹ |
|---|---|---|---|---|---|---|---|
| A4-102 | —N═ | —CH₃ | —CN | — | 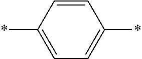 [SMILES: *c1ccc(*)cc1] | — | —Ph |
| A4-103 | —N═ | —CH₃ | —CN | — | 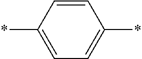 [SMILES: *c1ccc(*)cc1] | — | 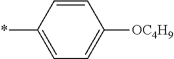 |
| A4-104 | —N═ | —CH₃ | —CN | — | 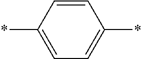 [SMILES: *c1ccc(*)cc1] | —COO— | 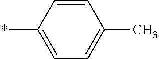 [SMILES: *c1ccc(C)cc1] |
| A4-105 | —N═ | —CH₃ | —CN | — | 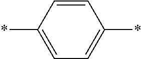 [SMILES: *c1ccc(*)cc1] | —COO— | 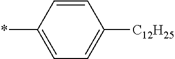 |
| A4-106 | —N═ | —CH₃ | —CN | — | 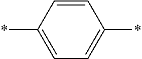 [SMILES: *c1ccc(*)cc1] | —COO— | 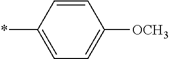 [SMILES: *c1ccc(OC)cc1] |
| A4-107 | —N═ | —CH₃ | —CN | — | 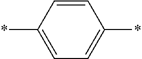 [SMILES: *c1ccc(*)cc1] | —COOCH₂— | —Ph |
| A4-108 | —N═ | —CH₃ | —CN | — | 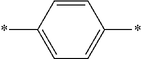 [SMILES: *c1ccc(*)cc1] | —CONH— | 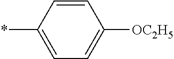 [SMILES: *c1ccc(OCC)cc1] |
| A4-109 | —N═ | —CH₃ | —CN | — | 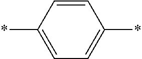 [SMILES: *c1ccc(*)cc1] | —CONH— | 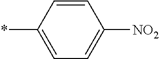 [SMILES: *c1ccc([N+](=O)[O-])cc1] |
| A4-110 | —N═ | —CH₃ | —CN | — | 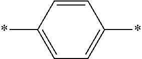 [SMILES: *c1ccc(*)cc1] | —CONH— | 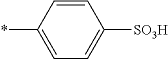 [SMILES: *c1ccc(S(=O)(=O)O)cc1] |
| A4-111 | —N═ | —CH₃ | —CN | — | 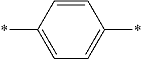 [SMILES: *c1ccc(*)cc1] | —OCO— | 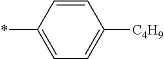 |
| A4-112 | —N═ | —CH₃ | —CN | — | 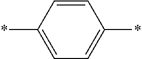 [SMILES: *c1ccc(*)cc1] | —OCO— | 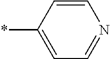 [SMILES: *c1ccncc1] |
| A4-113 | —N═ | —CH₃ | —CN | — | 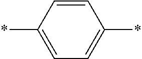 [SMILES: *c1ccc(*)cc1] | —NHCO— | 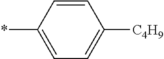 |
| A4-114 | —N═ | —CH₃ | —CN | — | 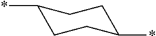 [SMILES: *C1CCC(*)CC1] | —OCO— | 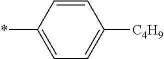 |
| A4-115 | —N═ | —CH₃ | —CN | —COO— | 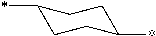 [SMILES: *C1CCC(*)CC1] | —OCO— | 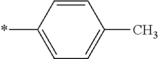 [SMILES: *c1ccc(C)cc1] |
| A4-116 | —N═ | —CH₃ | —CN | —COO— | 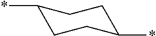 [SMILES: *C1CCC(*)CC1] | —COO— | 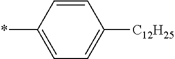 |
| A4-117 | —N═ | —CH₃ | —CN | —CO— | 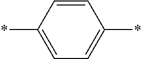 [SMILES: *c1ccc(*)cc1] | — | —Ph |
| A4-118 | —N═ | —CH₃ | —CN | —CO— | 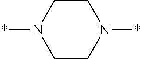 [SMILES: *N1CCN(*)CC1] | —COO— | 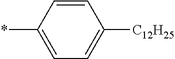 |
| A4-119 | —N═ | —CH₃ | —CN | —CH₂CH₂— | 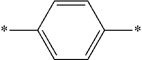 [SMILES: *c1ccc(*)cc1] | —OCO— | 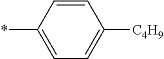 |
| A4-120 | —N═ | —CH₃ | —CN | —CH₂CH₂— | 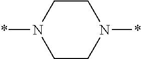 [SMILES: *N1CCN(*)CC1] | — | —Ph |

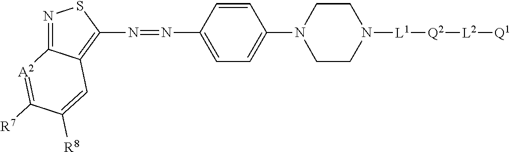

| No. | A² | R⁷ | R⁸ | L¹ | Q² | L² | Q¹ |
|---|---|---|---|---|---|---|---|
| A4-121 | —N═ | —CH₃ | —CN | —CH₂CH₂— | 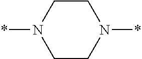 [SMILES: *N1CCN(*)CC1] | —COO— | 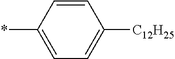 |
| A4-122 | —N═ | —CH₃ | —CN | —CH₂CH₂— | 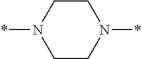 [SMILES: *N1CCN(*)CC1] | —CO— | 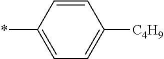 |
| A4-123 | —N═ | —CH₃ | —CN | —CH₂CH₂— | 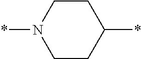 [SMILES: *C1CCN(*)CC1] | — | —Ph |
| A4-124 | —N═ | —CH₃ | —CN | —CH₂CH₂O— | 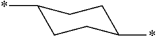 [SMILES: *C1CCC(*)CC1] | —OCO— | 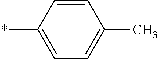 [SMILES: *c1ccc(C)cc1] |
| A4-125 | —N═ | —CH₃ | —CN | —CH₂CH₂OCO— | 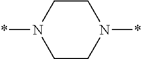 [SMILES: *N1CCN(*)CC1] | —COO— | 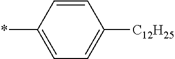 |
| A4-126 | —N═ | —CH₃ | —H | —CH₂CH₂— | 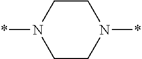 [SMILES: *N1CCN(*)CC1] | — | —Ph |
| A4-127 | —N═ | —H | —H | —CH₂CH₂— | 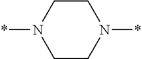 [SMILES: *N1CCN(*)CC1] | — | —Ph |
| A4-128 | —N═ | —H | —Cl | —CH₂CH₂— | 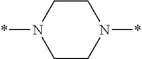 [SMILES: *N1CCN(*)CC1] | — | —Ph |
| A4-129 | —N═ | —H | —SO₃H | —CH₂CH₂— | 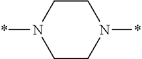 [SMILES: *N1CCN(*)CC1] | — | —Ph |
| A4-130 | —N═ | —H | —NO₂ | —CH₂CH₂— | 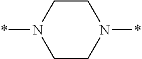 [SMILES: *N1CCN(*)CC1] | — | —Ph |
| A4-131 | —CH═ | —CH₃ | —CN | —CH₂CH₂— | 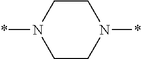 [SMILES: *N1CCN(*)CC1] | — | —Ph |
| A4-132 | —CH═ | —CH₃ | —H | —CH₂CH₂— | 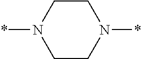 [SMILES: *N1CCN(*)CC1] | — | —Ph |
| A4-133 | —CH═ | —H | —H | —CH₂CH₂— | 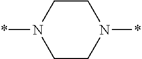 [SMILES: *N1CCN(*)CC1] | — | —Ph |
| A4-134 | —CH═ | —H | —Cl | —CH₂CH₂— | 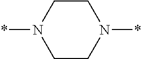 [SMILES: *N1CCN(*)CC1] | — | —Ph |
| A4-135 | —CH═ | —H | —SO₃H | —CH₂CH₂— | 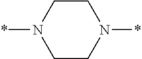 [SMILES: *N1CCN(*)CC1] | — | —Ph |
| A4-136 | —CH═ | —H | —NO₂ | —CH₂CH₂— | 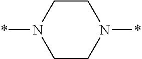 [SMILES: *N1CCN(*)CC1] | — | —Ph |

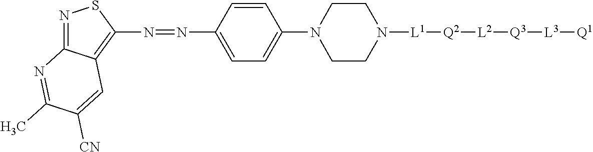

| No. | L¹ | Q² | L² | Q³ | L³ | Q¹ |
|---|---|---|---|---|---|---|
| A4-137 | — | 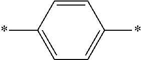 [SMILES: *c1ccc(*)cc1] | — | 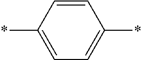 [SMILES: *c1ccc(*)cc1] | —COO— | 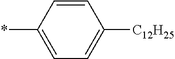 |
| A4-138 | — | 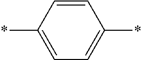 [SMILES: *c1ccc(*)cc1] | —COO— | 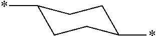 [SMILES: *C1CCC(*)CC1] | —OCO— | 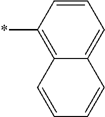 [SMILES: *c1cccc2ccccc12] |
| A4-139 | — | 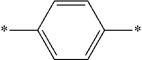 [SMILES: *c1ccc(*)cc1] | —OCO— | 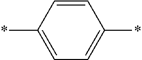 [SMILES: *c1ccc(*)cc1] | —CONH | 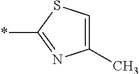 [SMILES: *c1nc(C)cs1] |
| A4-140 | —CH₂CH₂— | 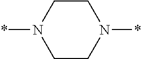 [SMILES: *N1CCN(*)CC1] | —COO— | 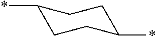 [SMILES: *C1CCC(*)CC1] | —OCO— | 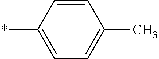 [SMILES: *c1ccc(C)cc1] |
| A4-141 | —CH₂CH₂— | 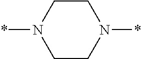 [SMILES: *N1CCN(*)CC1] | — | 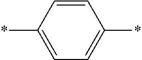 [SMILES: *c1ccc(*)cc1] | —N═N— | 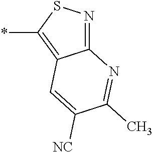 [SMILES: *c1snc2nc(C)c(C#N)cc12] |
| A4-142 | —COO— | 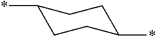 [SMILES: *C1CCC(*)CC1] | —OCO— | 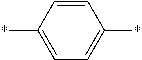 [SMILES: *c1ccc(*)cc1] | — | —Ph |

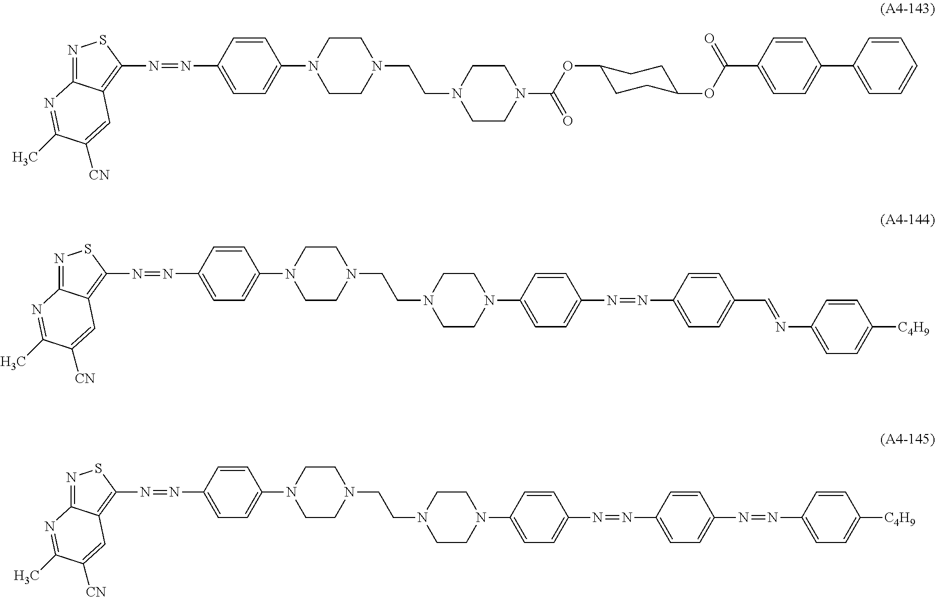

The compound (azo dye) represented by Formula (I), (II), (III), or (IV) can be synthesized by reference to the processes described in “Dichroic Dyes for Liquid Crystal Display” (A. V. Ivashchenko, published by CRC, 1994), “Sosetsu Gosei Senryo (Review of Synthetic Dyes)” (written by Hiroshi Horiguchi, published by Sankyo Publishing Co., Ltd., 1968) and documents cited therein.

The azo dye represented by Formula (I), (II), (III), or (IV) according to the present invention can be easily synthesized in accordance with the process described in, for example, Journal of Materials Chemistry, (1999), 9(11), pp. 2755-2763.

As apparent from its molecular structure, the azo dye represented by Formula (I), (II), (III), or (IV) has a planar and highly linear molecular shape, has a rigid core portion and a flexible side-chain portion, and also has a polar amino group at the terminal of the molecular long axis of the azo dye. Consequently, the azo dye represented by Formula (I), (II), (III), or (IV) itself can easily exhibit liquid crystallinity, especially nematic liquid crystallinity.

Thus, in the present invention, the dichroic dye composition containing at least one dichroic dye represented by Formula (I), (II), (III), or (IV) has liquid crystallinity.

Furthermore, the azo dye represented by Formula (I), (II), (III), or (IV) has high molecular flatness to cause a strong intermolecular interaction to facilitate the association of the molecules.

The dichroic dye composition containing the azo dye represented by Formula (I), (II), (III), or (IV) not only exhibits high absorbance in a wide visible wavelength region by the formation of the association, but also has liquid crystallinity, specifically, nematic liquid crystallinity. Accordingly, for example, a high degree of molecular alignment can be achieved through a lamination process such as coating over the surface of a polyvinyl alcohol alignment film treated by rubbing. The linearly polarizing layer formed from the dichroic dye composition containing the azo dye represented by Formula (I), (II), (III), or (IV) therefore exhibits a high polarization property, and a printing paper having such a layer can provide a clear stereoscopic image without crosstalk or ghost images.

The preferred (D) of the dichroic dye composition is 18 or more.

The azo dye represented by Formula (I), (II), (III), or (IV) has liquid crystallinity to exhibit a nematic liquid crystal phase preferably at 10 to 300° C. and more preferably at 100 to 250° C.

The dichroic dye composition preferably contains one or more azo dyes represented by Formula (I), (II), (III), or (IV). In order to form a linearly polarizing layer with a high dichroic ratio, the polarizing layer is preferably formed from a black dichroic dye composition. In addition, the azo dye represented by Formula (Ia) is a magenta azo dye, the azo dyes represented by Formulae (Ib) and (II) are yellow or magenta azo dyes, and the azo dyes represented by Formulae (III) and (IV) are cyan azo dyes. The black composition may be prepared by mixing these dyes.

Furthermore, the dichroic dye may be any dye other than the azo dyes represented by Formula (I), (II), (III), or (IV). The dye other than the azo dyes represented by Formula (I), (II), (III), or (IV) is also preferably selected from compounds exhibiting liquid crystallinity. Examples of such a dye include cyanine dyes, azo metal complexes, phthalocyanine dyes, pyrylium dyes, thiopyrylium dyes, azulenium dyes, squarylium dyes, quinone dyes, triphenylmethane dyes, and triarllylmethane dyes. Among them, squarylium dyes are preferable. In particular, those described in “Dichroic Dyes for Liquid Crystal Display” (A. V. Ivashchenko, published by CRC, 1994) can also be used.

In particular, the squarylium dyes that can be used in the present invention are preferably represented by Formula (VI):

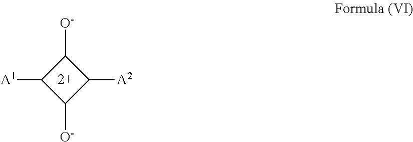

In Formula (VI), A¹ and A² each independently represent a substituted or unsubstituted hydrocarbon ring group or heterocyclic group.

The hydrocarbon ring group is preferably a 5 to 20-membered monocyclic or condensed ring group. The hydrocarbon ring group may be an aromatic ring or a non-aromatic ring. Carbon atoms constituting the hydrocarbon ring may be substituted by atoms other than hydrogen atoms. For example, one or more carbon atoms constituting the hydrocarbon ring may be C═O, C═S, or C═NR(R represents a hydrogen atom or a C₁₋₁₀ alkyl group). Furthermore, one or more carbon atoms constituting the hydrocarbon ring may have substituents, and specific examples of the substituents can be selected from the Substituent Group G described below. Examples of the hydrocarbon ring group include, but not limited to, the following groups.

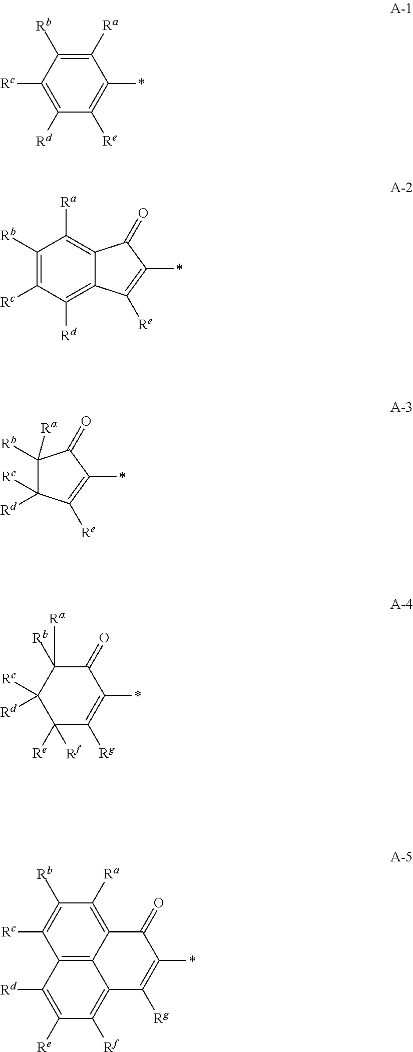

In Formulae A-1 to A-5, * represents a bonding site to the squarylium skeleton; R^{a} to R^{g} each represent a hydrogen atom or a substituent, and if possible, R^{a} to R^{g} may be bonded to one another to form a ring structure. The substituent may be selected from the Substituent Group G described below.

In particular, the following examples are preferred.

Preferable substituents represented by Formula A-1 have R^{c} representing —N(R^{c1})(R^{c2}) wherein R^{c1} and R^{c2} each represent a hydrogen atom or a substituted or unsubstituted alkyl group having 1 to 10 carbon atoms, and have R^{b} and R^{d} representing hydrogen atoms. That is, they are groups represented by Formula A-1a shown below.

Preferable substituents represented by Formula A-2 have R^{e} representing a hydroxy group. That is, they are groups represented by Formula A-2a shown below.

Preferable substituents represented by Formula A-3 have R^{e} representing a hydroxy group and have R^{c} and R^{d} representing hydrogen atoms. That is, they are groups represented by Formula A-3a shown below.

Preferable substituents represented by Formula A-4 have R^{g} representing a hydroxy group and have R^{a}, R^{b}, R^{e}, and R^{f} representing hydrogen atoms. That is, they are groups represented by Formula A-4-a shown below.

Preferable substituents represented by Formula A-5 have R^{g} representing a hydroxy group. That is, they are groups represented by Formula A-5a shown below.

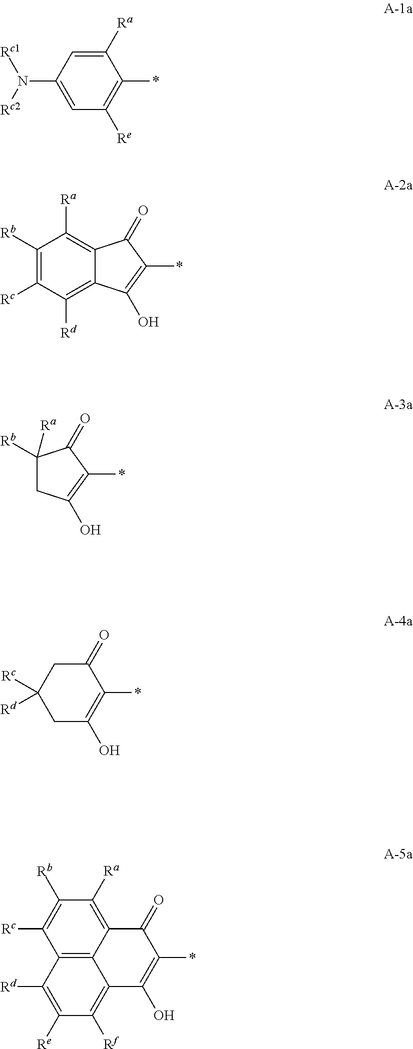

In Formula A-1a, R^{c1} and R^{c2} each independently represent a hydrogen atom or a substituted or unsubstituted alkyl group having 1 to 10 carbon atoms; other symbols in Formula A-1a are synonymous with those in Formulae A-1 to A-5. Examples of the substituent for the alkyl group include those in the Substituent Group G described below, and a preferred range thereof is also the same. When R^{c1} and R^{c2} represent substituted or unsubstituted alkyl groups, R^{c1} and R^{c2} may be bonded to each other to form a nitrogen-containing heterocyclic group. Furthermore, at least one of R^{c1} and R^{c2} may be bonded to a carbon atom of the benzene ring in formula A-1a to form a condensed ring. For example, the substituent may be one represented by Formula A-1b or A-1c:

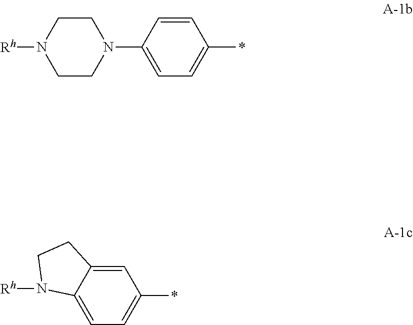

In Formulae A-1b and A-1c, * represents a bonding site to the squarylium skeleton, and R^{h} represents a hydrogen atom or a substituent. Examples of the substituent include those in the Substituent Group G described below. R^{h} is preferably a substituent containing one or more benzene rings.

The heterocyclic group is preferably a 5 to 20-membered monocyclic or condensed ring group. The ring-constituting atoms of the heterocyclic group include at least one of nitrogen, sulfur, and oxygen atoms. Furthermore, the ring-constituting atoms of the heterocyclic group may include one or more carbon atoms. The hetero or carbon atoms constituting the heterocyclic ring may be substituted by atoms other than hydrogen atoms. For example, one or more sulfur atoms constituting the heterocyclic ring may be S═O or S(O)₂, and one or more carbon atoms constituting the heterocyclic ring may be C═O, C═S, or C═NR(R represents a hydrogen atom or a C₁₋₁₀ alkyl group). Furthermore, the heterocyclic group may be an aromatic ring or a non-aromatic ring. One or more hetero atoms and/or carbon atoms constituting the heterocyclic group may have substituents, and specific examples of the substituent may be selected from the Substituent Group G described below. Examples of the heterocyclic group include, but not limited to, the following groups.

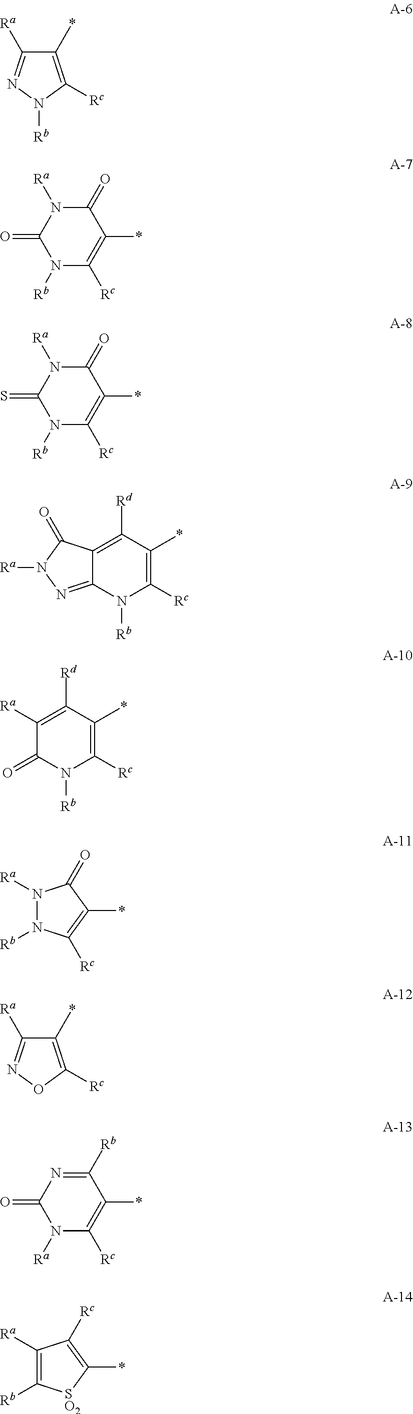

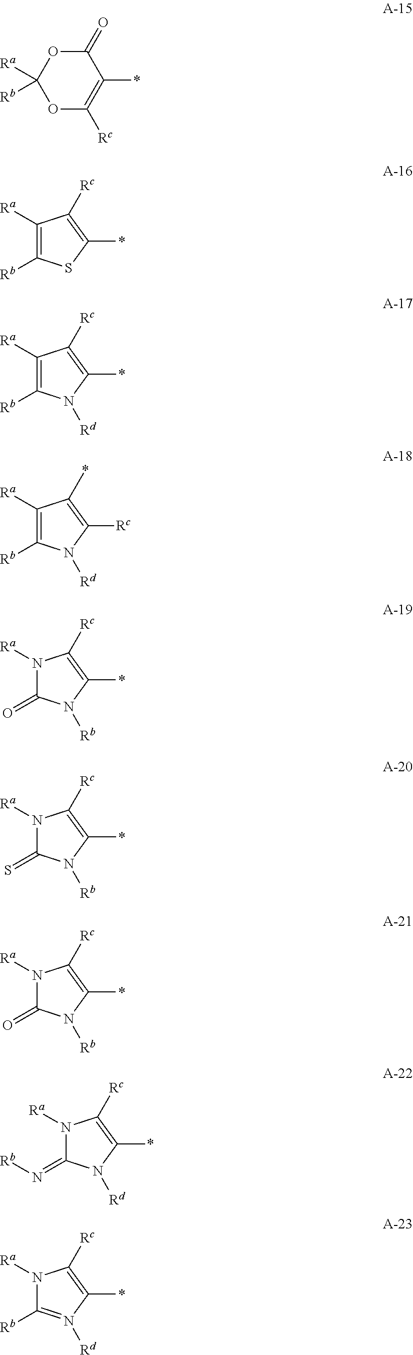

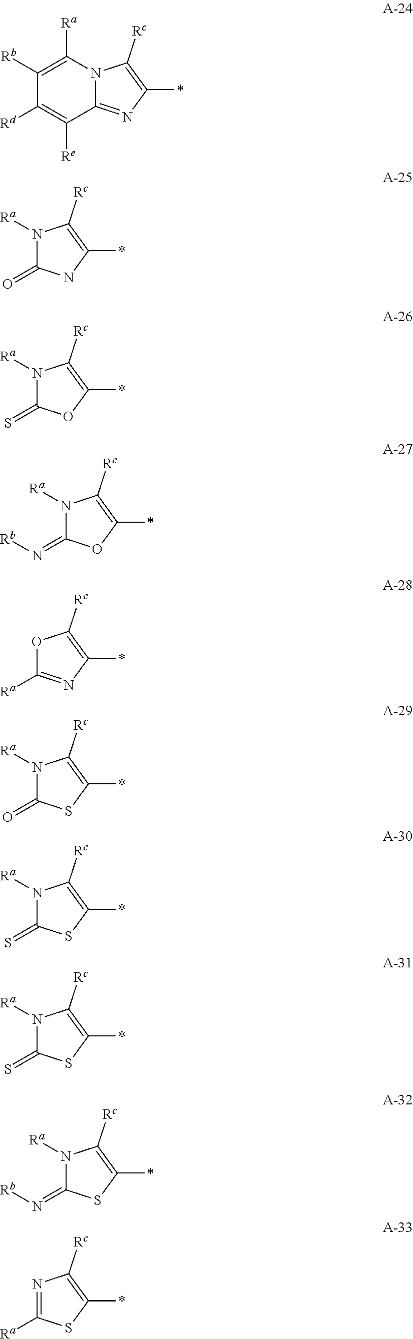

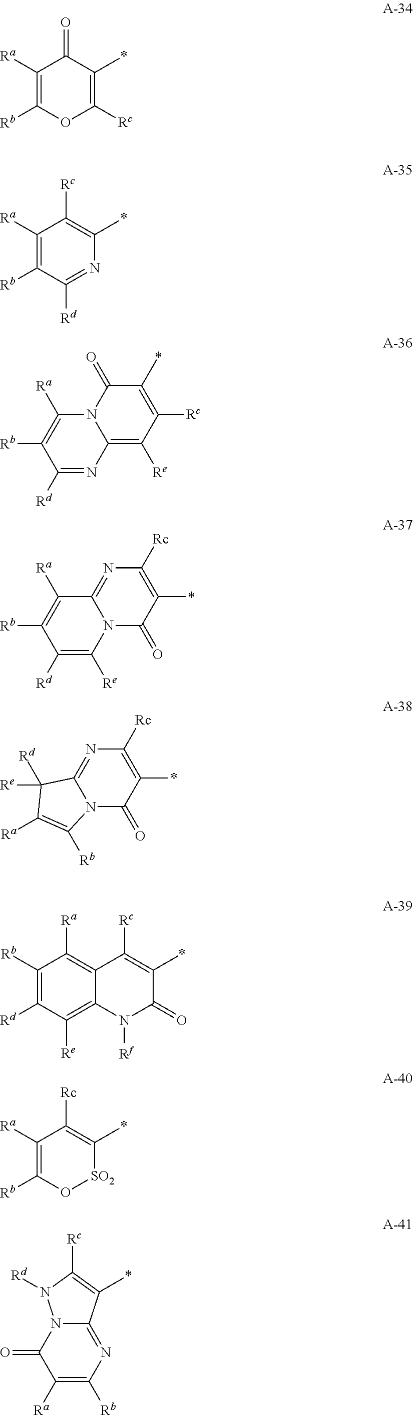

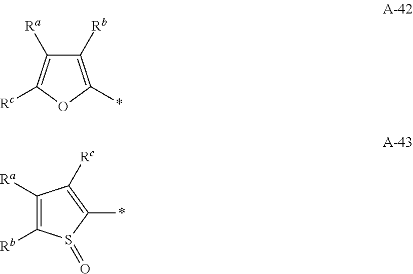

In the formulae, * represents a bonding site to the squarylium skeleton, R^{a} to R^{f} each represent a hydrogen atom or a substituent, and if possible, R^{a} to R^{f} may be bonded to one another to form a ring structure. The substituent may be selected from the Substituent Group G described below.

In Formulae A-6 to A-43, R^{c} preferably represents a hydroxy group (OH) or a sulfhydryl group (SH).

The hydrocarbon ring group is preferably one represented by Formula A-1, A-2, or A-4, more preferably one represented by Formula A-1a, A-2a, or A-4-a, more preferably one represented by Formula A-1 or A-2, more preferably one represented by Formula A-1a or A-2a, and most preferably one represented by Formula A-1a. In particular, preferred is a hydrocarbon ring group represented by A-1a having R^{a} and R^{e} each representing a hydrogen atom or a hydroxy group.

The preferable heterocyclic group is one represented by Formula A-6, A-7, A-8, A-9, A-10, A-11, A-14, A-24, A-34, A-37, or A-39, in particular, one represented by Formula A-6, A-7, A-8, A-9, A-11, A-14, A-34, or A-39. In these formulae, R^{c} is more preferably a hydroxy group (OH) or a sulfhydryl group (SH).

In Formula (VI), in particular, at least one of A¹ and A² is preferably a substituent represented by Formula A-1 (more preferably A-1a).

The hydrocarbon ring group and the heterocyclic group may each have one or more substituents, and examples of the substituents include those in Substituent Group G below.

Substituent Group G:

Substituent Group G consists of substituted or unsubstituted linear, branched, or cyclic alkyl groups having 1 to 18 carbon atoms (preferably 1 to 8 carbon atoms) (e.g., methyl, ethyl, propyl, isopropyl, n-butyl, isobutyl, sec-butyl, t-butyl, cyclohexyl, methoxyethyl, ethoxycarbonylethyl, cyanoethyl, diethylaminoethyl, hydroxyethyl, chloroethyl, acetoxyethyl, and trifluoromethyl); substituted or unsubstituted aralkyl groups having 7 to 18 carbon atoms (preferably 7 to 12 carbon atoms) (e.g., benzyl and carboxybenzyl); substituted or unsubstituted alkenyl groups having 2 to 18 carbon atoms (preferably 2 to 8 carbon atoms) (e.g., vinyl); substituted or unsubstituted alkynyl groups having 2 to 18 carbon atoms (preferably 2 to 8 carbon atoms) (e.g., ethynyl); substituted or unsubstituted aryl groups having 6 to 18 carbon atoms (preferably 6 to 10 carbon atoms) (e.g., phenyl, 4-methylphenyl, 4-methoxyphenyl, 4-carboxyphenyl, and 3,5-dicarboxyphenyl); substituted or unsubstituted acyl groups having 2 to 18 carbon atoms (preferably 2 to 8 carbon atoms) (e.g., acetyl, propionyl, butanoyl, and chloroacetyl); substituted or unsubstituted alkyl or arylsulfonyl groups having 1 to 18 carbon atoms (preferably 1 to 8 carbon atoms) (e.g., methanesulfonyl and p-toluenesulfonyl); alkylsulfinyl groups having 1 to 18 carbon atoms (preferably 1 to 8 carbon atoms) (e.g., methanesulfinyl, ethanesulfinyl, and octanesulfonyl); alkoxycarbonyl groups having 2 to 18 carbon atoms (preferably 2 to 8 carbon atoms) (e.g., methoxycarbonyl and ethoxycarbonyl); aryloxycarbonyl groups having 7 to 18 carbon atoms (preferably 7 to 12 carbon atoms) (e.g., phenoxycarbonyl, 4-methylphenoxycarbonyl, and 4-methoxyphenylcarbinyl); substituted or unsubstituted alkoxy groups having 1 to 18 carbon atoms (preferably 1 to 8 carbon atoms) (e.g., methoxy, ethoxy, n-butoxy, and methoxyethoxy); substituted or unsubstituted aryloxy groups having 6 to 18 carbon atoms (preferably 6 to 10 carbon atoms) (e.g., phenoxy and 4-methoxyphenoxy); alkylthio groups having 1 to 18 carbon atoms (preferably 1 to 8 carbon atoms) (e.g., methylthio and ethylthio); arylthio groups having 6 to 10 carbon atoms (e.g., phenylthio);

substituted or unsubstituted acyloxy groups having 2 to 18 carbon atoms (preferably 2 to 8 carbon atoms) (e.g., acetoxy, ethylcarbonyloxy, cyclohexylcarbonyloxy, benzoyloxy, and chloroacetyloxy); substituted or unsubstituted sulfonyloxy groups having 1 to 18 carbon atoms (preferably 1 to 8 carbon atoms) (e.g., methanesulfonyloxy); substituted or unsubstituted carbamoyloxy groups having 2 to 18 carbon atoms (preferably 2 to 8 carbon atoms) (e.g., methylcarbamoyloxy and diethylcarbamoyloxy); unsubstituted amino and substituted amino groups having 1 to 18 carbon atoms (preferably 1 to 8 carbon atoms) (e.g., methylamino, dimethylamino, diethylamino, anilino, methoxyphenylamino, chlorophenylamino, morpholino, piperidino, pyrrolidino, pyridylamino, methoxycarbonylamino, n-butoxycarbonylamino, phenoxycarbonylamino, methylcarbamoylamino, phenylcarbamylamino, ethylthiocarbamoylamino, methylsulfamoylamino, phenylsulfamoylamino, acetylamino, ethylcarbonylamino, ethylthiocarbonylamino, cyclohexylcarbonylamino, benzoylamino, chloroacetylamino, methanesulfonylamino, and benzenesulfonylamino);
substituted or unsubstituted carbamoyl groups having 1 to 18 carbon atoms (preferably 1 to 8 carbon atoms) (e.g., unsubstituted carbamoyl, methylcarbamoyl, ethylcarbamoyl, n-butylcarbamoyl, t-butylcarbamoyl, dimethylcarbamoyl, morpholinocarbamoyl, and pyrrolidinocarbamoyl); unsubstituted sulfamoyl and substituted sulfamoyl groups having 1 to 18 carbon atoms (preferably 1 to 8 carbon atoms) (e.g., methylsulfamoyl and phenylsulfamoyl); halogen atoms (e.g., fluorine, chlorine, and bromine); a hydroxy group; a nitro group; a cyano group; a carboxyl group; and heterocyclic groups (e.g., oxazole, benzoxazole, thiazole, benzothiazole, imidazole, benzimidazole, indolenine, pyridine, sulfolane, furan, thiophene, pyrazole, pyrrole, chromane, and coumarin).

Examples of the dichroic squarylium dye represented by Formula (VI) include, but not limited to, the following exemplary compounds.

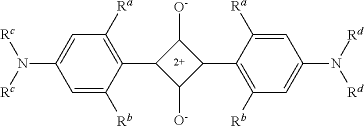

| No. | R^{a} | R^{b} | R^{c} | R^{d} |
|---|---|---|---|---|
| VI-1 | H | H | CH₃ | CH₃ |
| VI-2 | H | H | C₂H₅ | C₂H₅ |
| VI-3 | H | H | CH₃ | C₂H₅ |
| VI-4 | OH | H | CH₃ | CH₃ |
| VI-5 | OH | H | C₂H₅ | C₂H₅ |
| VI-6 | OH | H | CH₃ | C₂H5 |
| VI-7 | OH | OH | CH₃ | CH₃ |
| VI-8 | OH | OH | C₂H₅ | C₂H₅ |
| VI-9 | OH | OH | CH₃ | C₂H₅ |
| VI-10 | OH | CH3 | CH₃ | CH₃ |

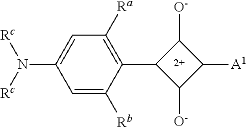

| No. | R^{a} | R^{b} | R^{c} | A |
|---|---|---|---|---|
| VI-11 | H | H | CH₃ | 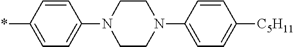 |
| VI-12 | H | H | C₂H₅ | 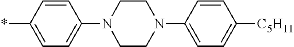 |
| VI-13 | OH | H | C₂H₅ | 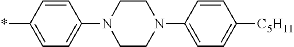 |
| VI-14 | OH | H | C₂H₅ | 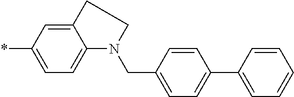 [SMILES: *c1ccc2c(c1)CCN2Cc1ccc(-c2ccccc2)cc1] |
| VI-15 | OH | H | C₂H₅ | 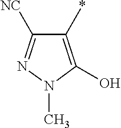 [SMILES: *c1c(C#N)nn(C)c1O] |
| VI-16 | OH | H | C₂H₅ | 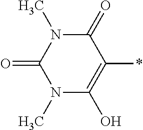 [SMILES: *c1c(O)n(C)c(=O)n(C)c1=O] |
| VI-17 | OH | H | C₂H₅ | 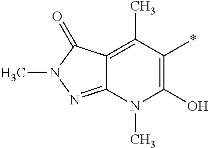 [SMILES: *c1c(C)c2c(=O)n(C)nc-2n(C)c1O] |
| VI-18 | OH | H | C₂H₅ | 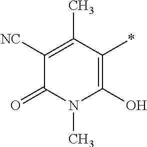 [SMILES: *c1c(C)c(C#N)c(=O)n(C)c1O] |
| VI-19 | OH | H | C₂H₅ | 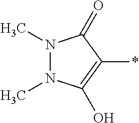 [SMILES: *c1c(O)n(C)n(C)c1=O] |
| VI-20 | OH | H | C₂H₅ | 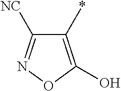 [SMILES: *c1c(C#N)noc1O] |
| VI-21 | OH | H | C₂H₅ | 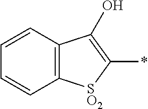 [SMILES: *C1=C(O)c2ccccc2S1(=O)=O] |
| VI-22 | OH | H | C₂H₅ | 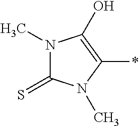 [SMILES: *c1c(O)n(C)c(=S)n1C] |
| VI-23 | OH | H | C₂H₅ | 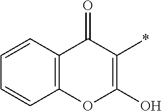 [SMILES: *c1c(O)oc2ccccc2c1=O] |
| VI-24 | OH | H | C₂H₅ | 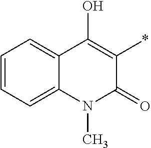 [SMILES: *c1c(O)c2ccccc2n(C)c1=O] |
| VI-25 | H | H | C₂H₅ | 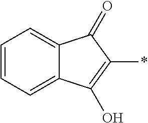 [SMILES: *C1=C(O)c2ccccc2C1=O] |
| VI-26 | H | H | C₂H₅ | 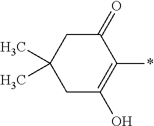 [SMILES: *C1=C(O)CC(C)(C)CC1=O] |

The dichroic squarylium dye represented by Formula (VI) can be readily synthesized in accordance with the disclosure of Journal of Chemical Society, Perkin Trans. 1 (2000), 599-603 and Synthesis (2002), No. 3, 413-417.

In the dichroic dye used in the present invention, the direction of a transition moment and the longitudinal molecular axis preferably define an angle of 0 to 20°, more preferably 0° to 15°, further preferably from 0 to 10°, and still further preferably 0 to 5°. The term “longitudinal molecular axis” herein refers to an axis that links two atoms in a compound at the maximum interatomic distance therebetween. The direction of the transition moment can be determined by molecular orbital calculation, and the angle defined by the calculated direction of the transition moment and the longitudinal molecular axis can also be determined.

The dichroic dye used in the present invention preferably has a rigid linear structure. In particular, the molecular length is preferably not less than 17 Å, more preferably not less than 20 Å, and further preferably not less than 25 Å. The aspect ratio is preferably not less than 1.7, more preferably not less than 2, and further preferably not less than 2.5. This structure enables satisfactory uniaxial alignment, so that a dichroic dye layer and stereo picture print with high polarization performance can be produced.

The term “molecular length” herein refers to the sum of the van der Waals radii of the two atoms at the opposite ends and the maximum interatomic distance in a compound. The term “aspect ratio” is defined as the ratio of molecular length to molecular width, and the term “molecular width” refers to the sum of the van der Waals radii of the two atoms at the opposite ends and the maximum interatomic distance when constituent atoms are projected to a plane orthogonal to the longitudinal molecular axis.

The dichroic dye composition is primarily composed of at least one dye selected from the dyes represented by Formulae (I), (II), (III), (IV), and (VI). In particular, the content of the dye represented by Formula (I), (II), (III), (IV), or (VI) is preferably not less than 80% by mass, and especially preferably not less than 90% by mass relative to the total dye content. The upper limit of the content of such a dye is 100% by mass, in other words, all the dyes to be contained may consist of the dyes represented by Formulae (I), (II), (III), (IV), and (VI).

The content of at least one dichroic dye selected from the dichroic dyes represented by Formulae (I), (II), (III), (IV), and (VI) in the dichroic dye composition is preferably not less than 20% by mass, and more preferably not less than 30% by mass relative to the total solid content other than a solvent content. The upper limit thereof is not particularly limited; however, in an embodiment in which other additives, such as the surfactant described below, are contained, the content of at least one dichroic dye selected from the dichroic dyes represented by Formulae (I), (II), (III), (IV), and (VI) in the dichroic dye composition is preferably not more than 95% by mass, and more preferably not more than 90% by mass relative to the total solid content other than a solvent content, so that the benefits of the additives can be developed.

The dichroic dye composition preferably exhibits thermotropic liquid crystalline properties, in particular, the preferred dichroic dye composition is thermally transferred into a liquid crystal phase to exhibit liquid crystalline properties. The dichroic dye composition is in a nematic liquid crystal phase preferably at 10 to 300° C., more preferably 100 to 250° C. In particular, the dichroic dye composition is preferably in a smectic A liquid crystal phase in a temperature region lower than that of a nematic liquid crystal phase, and the preferred temperature range is from 10 to 200° C., more preferably 50 to 200° C.

In the case where a coating solution composed of the dichroic dye composition is applied onto an alignment film, the molecules of the dichroic dye composition are aligned at a tilt angle with respect to the alignment film at the interface to the alignment film and aligned at a tilt angle with respect to the air interface at the interface to air. The coating solution composed of the dichroic dye composition of the present invention is applied onto the surface of the alignment film, and then the molecules of the dichroic dye composition are uniformly aligned (monodomain alignment), which enables desirable horizontal alignment.

The dichroic dye layer formed by horizontally aligning the molecules of the dichroic dye and fixing the alignment state may be utilized as a stereo picture print.

The term “tilt angle” herein refers to an angle defined by the longitudinal direction of the molecular axis of the dichroic dye and the interface (the interface to an alignment film or the air interface). Decreasing the tilt angle at the side of the alignment film to some extent for horizontal alignment preferably enables a linear polarizing layer having a high dichroic ratio to be provided. The tilt angle at the side of the alignment film is preferably in the range of 0 to 10°, more preferably 0 to 5°, further preferably 0 to 2°, and still further preferably 0 to 1°. In addition, the tilt angle at the side of the air interface is preferably in the range of 0 to 10°, more preferably 0 to 5°, and further preferably 0 to 2°.

In general, the tilt angle of the dichroic dye at the side of the air interface can be adjusted by selecting any other optional compound (e.g., horizontal alignment agents disclosed in JP-A-2005-99248, JP-A-2005-134884, JP-A-2006-126768, and JP-A-2006-267183), which can provide a desirable horizontal alignment state.

The tilt angle of the dichroic dye at the side of the alignment film can be controlled, for instance, with the aid of an agent for controlling the tilt angle with respect to an alignment film.

The dichroic dye composition may contain one or more additives in addition to the dichroic dye. The dichroic dye composition may contain non-liquid crystal multifunctional monomers having radical polymerizable groups, polymerization initiators, anti-weathering agents, anti-cissing agents, saccharides, and agents having at least one of an antifungal function, an antibacterial function, and a sterilization function.

Alignment Film

In an embodiment in which the linear polarizing layer is composed of a liquid crystal composition containing the dichroic dye, an alignment film is preferably used in the production of the linear polarizing layer. Any alignment film which enables the molecules of the dichroic dye to be aligned in a predetermined state on the alignment film can be used. The alignment film can be formed by various procedures such as rubbing a surface of a film composed of an organic compound (preferably a polymer), obliquely depositing an inorganic compound, forming a layer having microgrooves, and accumulating an organic compound (e.g., ω-tricosanoic acid, dioctadecylmethylammonium chloride, or methyl stearate) by a Langmuir-Blodgett technique (LB film). Alignment films having an alignment effect under an electric or magnetic field or by irradiation with light are also known. Among them, in the present invention, preferred alignment films are a rubbed alignment film prepared by a rubbing treatment in view of easy controllability of the pretilt angle of an alignment film and a light aligning film prepared by irradiation with light in view of even alignment. Examples of a material generally used for the rubbed alignment film include polyvinyl alcohol and polyimide. Examples of the light aligning film are the same as those of an alignment film usable in formation of a retardation layer which will be hereinafter described.

Protective Layer of Linear Polarizing Layer

The linear polarizing layer may be provided with protective layers on the two sides thereof. The protective layers can be composed of optically transparent polymer films. However, since the optical characteristics of the layer disposed between the linear polarizing layer and the retardation layer have an influence on the polarization states of circular polarization images that enter eyes of a viewer as described above, the layer preferably exhibits low retardation, and such a layer is preferably a film exhibiting a retardation of 0 or a retardation substantially equal to 0. In particular, the protective layer disposed between the retardation layer and the linear polarizing layer preferably exhibits an Re of 0 to 10 nm. In addition, since the retardation Rth in the thickness direction also has an influence on the polarization states of circular polarization images, the protective layer disposed between the retardation layer and the linear polarizing layer preferably exhibits a low Rth, and the absolute value of the total Rth of the protective layer and the retardation layer is preferably not more than 20 nm.

Any material can be used for the polymer film which functions as the protective layer. The polymer film preferably has high optical characteristics such as optical transparency, mechanical strength, thermal stability, water-tightness, and isotropy, and any material which enables formation of a film which satisfies the above-mentioned optical characteristics can be used. Examples of such a material include polycarbonate polymers, polyester polymers such as polyethylene terephthalate and polyethylene naphthalate, acrylic polymers such as polymethyl methacrylate, and styrene polymers such as polystyrene and acrylonitrile-styrene copolymers (AS resins). Furthermore, other examples thereof include polyolefins such as polyethylene and polypropylene, polyolefin polymers such as ethylene-propylene copolymers, vinyl chloride polymers, amide polymers such as nylon and aromatic polyamide, imide polymers, sulfone polymers, polyether sulfone polymers, polyether ether ketone polymers, polyphenylene sulfide polymers, vinylidene chloride polymers, vinyl alcohol polymers, vinyl butyral polymers, acrylate polymers, polyoxymethylene polymers, epoxy polymers, and the mixtures thereof. The polymer film of the present invention may be in the form of a hard layer composed of acrylic, urethane, acrylic urethane, epoxy, or silicone UV curable or thermosetting resins.

Preferred examples of the material of the protective layer include thermoplastic norbornene reins. Examples of the thermoplastic norbornene reins include ZEONEX and ZEONOR (manufactured by ZEON Corporation) and ARTON (manufactured by JSR Corporation).

Preferred examples of the material for a film used as the protective layer include cellulose polymers (hereinafter referred to as cellulose acylate), such as triacetylcellulose used for transparent protective films of traditional polarizing plates. A cellulose acylate film usable as a protective film will be described below in detail, and the technical matter related thereto can be similarly applied to other polymer films.

Examples of the cellulose used as a starting material in preparation of cellulose acylate materials used for production of the cellulose acylate film include cotton linter and wood pulp (broadleaf pulp and coniferous pulp). Any cellulose acylate derived from such cellulose being the starting material may be used, and different cellulose acylates can be used in combination in some cases. The details of the cellulose being the starting material are disclosed by, for example, Marusawa., Uda. (1970). Plastic Zairyo Kouza (17), Cellulosic Resin. Nikkan Kogyo Shimbun Ltd. and Hatsumei Kyokai Disclosure Bulletin 2001-1745 (pp. 7-8), whereas the present invention should not be limited thereto.

The cellulose acylate is prepared by acylation of the hydroxyl groups contained in cellulose, and the substituents for acylation may be any acyl group having 2 to 22 carbon atoms. In the present invention, the hydroxyl groups contained in cellulose may be substituted with acyl groups for preparation of the cellulose acylate in any degree of substitution. The degree of bonding of acetic acids and/or fatty acids having 3 to 22 carbon atoms being the substituents for the hydroxyl groups of the cellulose is measured, and the degree of substitution can be determined through calculation using the results of the measurement. The measurement can be carried out in accordance with ASTM-D817-91.

The hydroxyl groups contained in cellulose may be substituted in any degree of substitution, and the degree of acyl substitution of the hydroxyl groups contained in cellulose is preferably from 2.50 to 3.00, more preferably 2.75 to 3.00, and further preferably 2.85 to 3.00.

Among acetic acids and/or the fatty acids having 3 to 22 carbon atoms being the substituents for the hydroxyl groups contained in cellulose, the acyl group having 2 to 22 carbon atoms may be any aliphatic or aryl group and may consist of a single group or a mixture of two or more different groups. Examples of the cellulose ester acylated therewith include alkyl carbonyl esters, alkenyl carbonyl esters, aromatic carbonyl esters, and aromatic alkyl carbonyl esters of cellulose, and each may have a group further substituted. Preferred examples of such an acyl group include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl groups. Of these, preferred are acetyl, propionyl, butanoyl, dodecanoyl, octadecanoyl, t-butanoyl, oleoyl, benzoyl, naphthylcarbonyl, and cinnamoyl groups, and more preferred are acetyl, propionyl, and butanoyl groups.

In the case where the above-mentioned acyl groups being the substituents for the hydroxyl groups of cellulose substantially comprise at least two of an acetyl group, a propionyl group, and a butanoyl group, the degree of total substitution with these substituents can range from 2.50 to 3.00 to reduce the optical anisotropy of the cellulose acylate film. The degree of acyl substitution ranges more preferably from 2.60 to 3.00, and further preferably 2.65 to 3.00. In the case where the above-mentioned acyl groups being substituents for the hydroxyl groups of cellulose are an acetyl group alone, the degree of total substitution with the substituents ranges preferably from 2.80 to 2.99, more preferably 2.85 to 2.95 in view of a reduction in the optical anisotropy of the cellulose acylate film, compatibility with other additives, and solubility in an organic solvent to be used.

The cellulose acylate preferably exhibits the viscosity average degree of polymerization of 180 to 700. Cellulose acetate preferably exhibits a viscosity average degree of polymerization of 180 to 550, more preferably 180 to 400, and further preferably from 180 to 350. An extraordinarily high degree of polymerization causes an increased viscosity of the dope solution of cellulose acylate, which makes film formation by casting difficult. An exceptionally low degree of polymerization causes low strength of a formed film. The average degree of polymerization can be measured, for example, by intrinsic viscometry developed by Uda et al. [Kazuo Uda., Hideo Saito (1962). Sen'i Gakkaishi, vol. 2, (No. 18), 105-120, the Society of Fiber Science and Technology, Japan]. The method is disclosed in detail in JP-A-9-95538.

The molecular weight distribution of the cellulose acylate can be evaluated through gel permeation chromatography, and its polydispersity index Mw/Mn (Mw: mass average molecular weight, Mn: number average molecular weight) is preferably small, in other words, its molecular weight dispersion is preferably narrow. Thus, the value of Mw/Mn ranges preferably from 1.0 to 3.0, more preferably 1.0 to 2.0, and further preferably 1.0 to 1.6.

Removal of the low-molecular-weight component decreases the viscosity relative to that of ordinary cellulose acylate while increasing the average molecular weight (degree of polymerization), and the embodiment is therefore still effective. The cellulose acylate containing a reduced amount of low-molecular-weight component can be prepared by removing the low-molecular-weight component from cellulose acylate synthesized in a usual manner. The low-molecular-weight component can be removed by washing the cellulose acylate with a proper organic solvent. In order to prepare a cellulose acylate containing a small amount of low-molecular-weight component, the amount of the sulfuric acid catalyst in acetylation is preferably adjusted to 0.5 to 25 parts by mass relative to 100 parts by mass of cellulose. At an amount of the sulfuric acid catalyst within the above range, a synthesized cellulose acylate exhibits a desirable molecular weight distribution (namely, uniform molecular weight distribution). In production of the cellulose acylate of the present invention, the sulfuric acid catalyst preferably has a moisture content of not more than 2% by mass, more preferably not more than 1% by mass, and further preferably not more than 0.7% by mass. In general, cellulose acylate contains moisture, and it is known that the moisture content thereof ranges from 2.5 to 5% by mass. In order to produce cellulose acylate having a moisture content within the above ranges in the present invention, the cellulose acylate needs to be dried, and any drying process can be employed which can decrease the moisture content in the cellulose acylate to a predetermined level. The synthesis of such cellulose acylate is disclosed in detail in Hatsumei Kyokai Disclosure Bulletin No. 2001-1745 (published on Mar. 15, 2001 by Hatsumei Kyokai) pp. 7-12.

The cellulose acylates may be used alone or in combination, provided that the cellulose acylates satisfy the requirements described above on the substituent, the degree of substitution, the degree of polymerization, and the molecular weight distribution.

The cellulose acylate may contain various additives (e.g., photoanisotropy-reducing compounds, wavelength dispersion adjusters, fine particles, plasticizers, UV inhibitors, antioxidants, releasing agents, and optical characteristics adjusters). In an embodiment in which the cellulose acylate film is formed through a solvent casting process, additives may be added at any time during a dope preparing process (process of preparing a cellulose acylate solution). The additives may be added at the final stage of the dope preparing process.

The amount of the additive is adjusted to produce a cellulose acylate film which satisfies the relationship: 0 Re(550) 10.

The protective layer preferably satisfies the relationship: −150 nm≦Rth(630)≦50 nm so that the sum of the Rth of the protective film and the Rth of the retardation layer can satisfies the relationship: |Rth|≦20 nm.

The cellulose acylate film used as the protective film preferably contains at least one compound which can reduce optical anisotropy, especially, a retardation Rth in the direction of film thickness. Such a compound can prevent the alignment of the molecules of the cellulose acylate contained in the film in the in-plane direction and the direction of the film thickness, and addition of the compound can sufficiently reduce optical anisotropy to produce a cellulose acylate film exhibiting low Re and Rth. In view of the production of such a cellulose acylate film, the photoanisotropy-reducing compound is advantageously selected from compounds which are highly compatible with the cellulose acylate and have neither a rod-like structure nor a planar structure. For example, if the compound has a plurality of planar functional groups such as aromatic groups, it is advantageous that the functional groups reside in different planes rather than in the same plane.

The photoanisotropy-reducing compound preferably exhibits an octanol-water partition coefficient (log P value) of 0 to 7. A compound exhibiting a log P value exceeding 7 has unsatisfactory compatibility with cellulose acylate, which readily makes the film cloudy and chalky. A compound exhibiting a log P value less than 0 has highly hydrophilic properties and therefore impairs the water-tightness of the cellulose acetate film in some cases. The log P value more preferably ranges from 1 to 6, further preferably 1.5 to 5.

The octanol-water partition coefficient (log P value) can be measured by a shake-flask method in accordance with JIS (Japanese Industrial Standard) Z7260-107 (2000). In place of the actual measurement, the octanol-water partition coefficient (log P value) may be estimated by any computational chemical method or experiential procedure. Preferred examples of the computational chemical methods include a Crippen's fragmentation method [J. Chem. Inf. Comput. Sci. (1987). 27, 21], a Viswanadhan's fragmentation method [J. Chem. Inf. Comput. Sci. (1989). 29, 163], and a Broto's fragmentation method [Eur. J. Med. Chem.—Chim. Theor. (1984). 19, 71]; and more preferred is a Crippen's fragmentation method [J. Chem. Inf. Comput. Sci. (1987). 27, 21]. If a compound exhibits different log P values depending on the measurements or computations used, the Crippen's fragmentation method is preferably used to determine whether the compound is within the scope of the present invention. The Log P value described herein is defined by the Crippen's fragmentation method [J. Chem. lnf. Comput. Sci. (1987). 27, 21.].

The photoanisotropy-reducing compound may or may not contain an aromatic group. The photoanisotropy-reducing compound preferably has a molecular weight of 150 to 3000, more preferably 170 to 2000, and further preferably 200 to 1000. The compound may have a specific monomer structure or may have an oligomer or polymer structure consisting of a plurality of such monomer units bonded, provided that its molecular weight is within the ranges described above.

The photoanisotropy-reducing compound is preferably in the form of a liquid at 25° C. or a solid having a melting point of 25 to 250° C., more preferably a liquid at 25° C. or a solid having a melting point of from 25 to 200° C. Preferably, the photoanisotropy-reducing compound does not volatile during a dope casting process and a drying process for formation of the cellulose acylate film.

The amount of the photoanisotropy-reducing compound preferably ranges from 0.01 to 30% by mass, more preferably 1 to 25% by mass, and further preferably 5 to 20% by mass relative to the amount of the cellulose acylate.

The photoanisotropy-reducing compound may be a single compound or a mixture of two or more different compounds with an appropriate mixing ratio.

The average content of the photoanisotropy-reducing compound in a region from at least one surface to a depth at 10% of the entire thickness of the cellulose acylate film preferably ranges from 80 to 99% of the average content of the compound in the central portion of the film. The amount of the photoanisotropy-reducing compound present in the film can be determined by measuring the amount of the compound in the surface region and the central portion of the film through a method using an infrared absorption spectrum as is disclosed in JP-A-8-57879.

Specific examples of the photoanisotropy-reducing compound which can be incorporated into the cellulose acylate film include, but are not limited to, compounds disclosed in paragraphs [0035] to [0058] of JP-A-2006-199855.

The film used as a protective layer provided at a viewing side is readily influenced by external light, especially, UV light. The film used as a protective layer therefore preferably contains a UV absorber. A preferred UV absorber absorbs UV light with wavelengths ranging from 200 to 400 nm and reduces both the |Re(400)-Re(700)| and |Rth(400)-Rth(700)| of the film. The amount of such a UV absorber preferably ranges from 0.01 to 30% by mass relative to the solid content of cellulose acylate.

Films which function as protective layers are required to have high light transmittance. In this regard, a high spectral transmittance is required for the compound absorbing UV light with wavelengths ranging from 200 to 400 nm and reducing both the |Re(400)-Re(700)| and |Rth(400)-Rth(700)| of the film, the compound being contained in the cellulose acylate. The UV absorber added to the cellulose acylate film used as a protective layer preferably exhibits a spectral transmittance of 45 to 95% at a wavelength of 380 nm and not more than 10% at a wavelength of 350 nm.

In view of volatility, the UV absorber preferably has a molecular weight of 250 to 1000, more preferably 260 to 800, further preferably 270 to 800, and even further preferably 300 to 800. The UV absorber may have a specific monomer structure or may have an oligomer or a polymer structure consisting of a plurality of such monomer units bonded, provided that its molecular weight is within the ranges described above.

Preferably, the UV absorber does not volatilize during a dope casting process and a drying process for formation of the cellulose acylate film.

Specific examples of the UV absorber which can be incorporated into the cellulose acylate film include compounds disclosed in paragraphs [0059] to [0135] of JP-A-2006-199855.

The cellulose acylate film used as a protective layer preferably contains fine particles as a matting agent. Examples of materials for usable fine particles includes silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate. Among these fine particles, preferred are fine particles containing silicon in terms of a reduction in turbidity, and especially preferred is silicon dioxide. The preferred fine particles of silicon dioxide preferably have an average primary particle size of not more than 20 nm and an apparent density of not less than 70 g/liter. More preferred are fine particles having an average primary particle size of 5 to 16 nm in terms of a reduction in a haze value. The apparent density is preferably from 90 to 200 g/liter, more preferably 100 to 200 g/liter. The fine particles preferably exhibit a larger apparent density, which enables a high-concentration dispersion to be produced and therefore contributes to satisfactory haze and quality of aggregates.

Such fine particles generally form secondary particles having an average particle size of 0.1 to 3.0 μm, and the fine particles are present in the form of aggregates of primary particles in the film and cause an uneven surface profile with a dimension of 0.1 to 3.0 μm on the film. The average secondary particle size is preferably in the range of 0.2 to 1.5 μm, more preferably 0.4 to 1.2 μm, and most preferably 0.6 to 1.1 μm. The primary or secondary particle size is defined through observation of the particles in the film and then determination of the diameters of the circles that circumscribe the particles with a scanning electronic microscope. The average particle size is determined through analysis of 200 different particles at different sites in the same manner to determine the average value of the analytical results.

Examples of the fine particles of silicon dioxide to be used include commercially available products such as AEROSILs R972, R972V, R974, R812, 200, 200V, 300, R202, OX50, and TT600 (manufactured by Nippon Aerosil Co., Ltd.). Examples of the fine particles of zirconium oxide to be used include commercially available products such as AEROSILs R976 and R811 (manufactured by Nippon Aerosil Co., Ltd.).

Among these commercially available products, particularly preferred are AEROSIL 200V and AEROSIL R972V which are the fine particles of silicone dioxide having an average primary particle size of not more than 20 nm and an apparent density of not less than 70 g/liter, which can noticeably decrease the friction coefficient while maintaining the low turbidity of the optical film.

In the present invention, various techniques can be employed to prepare a dispersion containing fine particles for formation of the cellulose acylate film containing particles having a small average secondary particle size. For example, a dispersing medium and fine particles are mixed while being stirred to preliminarily prepare a dispersion of the fine particles, the dispersion is added to a small amount of cellulose acylate solution separately prepared and then agitated for dissolution, and then the resulting dispersion was mixed with the main cellulose acylate solution (dope solution). This process is preferred because the fine particles of silicone dioxide are highly dispersed and are less likely to reaggregate. In another process, a small amount of cellulose ester is added to a solvent and then stirred for dissolution, fine particles are then added to the solution and then dispersed with a disperser to produce a fine-particle dispersion, and then the fine-particle dispersion is thoroughly mixed with a dope solution with an in-line mixer. In the case where the fine particles of silicon dioxide are mixed with a solvent to prepare a dispersion liquid, the concentration of the silicon dioxide ranges preferably from 5 to 30% by mass, more preferably from 10 to 25% by mass, and further preferably from 15 to 20% by mass, whereas the present invention should not be limited to these processes. A higher concentration of the dispersant preferably contributes to a reduction in the turbidity of the dispersion relative to the amount of the added dispersant, which leads to satisfactory haze and quality of aggregates. The content of the mat agent particles in the final dope solution of cellulose acylate preferably ranges from 0.01 to 1.0 g, more preferably 0.03 to 0.3 g, and most preferably 0.08 to 0.16 g per 1 m³.

Preferred examples of the solvent to be used include lower alcohols such as methyl alcohol, ethyl alcohol, propyl alcohol, isopropyl alcohol, and butyl alcohol. Any other solvent than the lower alcohols may be used, and the same solvent as used in the formation of the cellulose ester film can be used.

Various additives (e.g., plasticizers, UV inhibitors, antioxidants, releasing agents, and infrared absorbers) other than the photoanisotropy-reducing compound and the UV absorber may be added to the cellulose acylate film used as a protective layer, and the additives may be in the form of solid or oil. In other words, the additives may be added regardless of their melting points and boiling points. For instance, a mixture of UV absorbers having melting points of not more than 20° C. and not less than 20° C., respectively, may be used, and a mixture of plasticizers disclosed in JP-A-2001-151901 may be similarly used. In addition, examples of the infrared absorbers are disclosed in JP-A-2001-194522. The additives may be added at any time during the dope preparing process and added at the final stage of the dope preparing process. Furthermore, the amount of the additive is not specifically limited provided that the benefit of the additive can be developed. In the case where the cellulose acylate film has a multilayered structure, individual layers may contain different types or amounts of additives. The technique disclosed in JP-A-2001-151902 may be, for example, employed. The detail of the technique is disclosed in Hatsumei Kyokai Disclosure Bulletin No. 2001-1745 (published on Mar. 15, 2001 by Hatsumei Kyokai. pp. 16-22).

Retardation Layer

In the first embodiment of the present invention, the retardation layer is a patterned retardation layer being a quarter-wave plate and patterned in first and second domains with in-plane slow axes defining an angle of 90°. The quarter-wave plate preferably exhibits an in-plane retardation Re(550) at 550 nm satisfying the relationship: 100 nm≦Re(550)≦150 nm, more preferably 110 nm≦Re(550)≦140 nm, and further preferably 120 nm≦Re(550)≦140 nm at a wavelength of 550 nm.

In the second embodiment of the present invention, the retardation layer is a patterned retardation layer patterned in the first domain exhibiting an Re of 0 nm and the second domain exhibiting an Re corresponding to a half wavelength.

The patterned quarter-wave plate used in the first embodiment and the patterned retardation layer used in the second embodiment are formed by fixing the molecules of a composition containing a compound having refractive-index anisotropy in an alignment state. The patterned quarter-wave plate and the patterned retardation layer are preferably formed through application of such a composition by any one selecting from coating, spraying, and dropping so as to have a reduced thickness. In particular, a preferred fabrication process of the patterned quarter-wave plate and the patterned retardation layer involves applying a curable liquid crystal composition containing a liquid crystal compound having refractive-index anisotropy onto a surface of a predetermined member, aligning the molecules of the composition in a predetermined alignment state, and promoting a curing reaction to fix the alignment sate.

The retardation layer can be composed of a curable composition containing a liquid crystal compound, especially, a liquid crystal compound having at least one reactive group. The retardation layer composed of the curable composition containing the liquid crystal compound having at least one reactive group enables easy control of the direction of a slow axis by an alignment layer such as a photo-alignment layer which will be described later. Furthermore, such a retardation layer enables easy control of the direction of a slow axis by pattern exposure described below and easy development or cancellation of an in-plane retardation.

In general, liquid crystal compounds are classified into a rod type and a discotic type based on their shapes. Furthermore, each type includes a low-molecular type and a high-molecular type. The “high molecular type” generally means a polymer having a degree of polymerization of 100 or more (Kobunshi Butsuri Souten-i Dainamikusu (Polymer Physics and Phase Transition Dynamics), written by Masao Doi, p. 2, Iwanami Shoten, Publishers, 1992). In the present invention, any liquid crystal compound can be used, and can be a rod-like liquid crystal compound or a discotic liquid crystal compound. Furthermore, two or more rod-like liquid crystal compounds, two or more discotic liquid crystal compounds, or a mixture of rod-like and discotic liquid crystal compounds may be used. From the viewpoints of reducing changes in temperature and humidity, the optically-anisotropic layer is more preferably formed of a rod-like or discotic liquid crystal compound having one or more reactive groups. More preferably, at least one liquid crystal compound has two or more reactive groups in one liquid crystal molecule. A mixture of two or more liquid crystal compounds may be used. In such a case, at least one liquid crystal compound preferably has two or more reactive groups.

It is also preferred the liquid crystal compound have two or more reactive groups having different polymerization characteristics. In this case, a retardation layer containing a polymer having unreacted reactive groups can be produced through selective polymerization of the different reactive groups under controlled conditions. The difference in polymerization conditions may be a difference in wavelength region of ionizing radiation for polymerization immobilization or a difference in polymerization mechanism, but is preferably a difference in combination of a radical reactive group and a cationic reactive group, which is controllable by the type of a polymerization initiator. A combination of a radical reactive group of an acrylic and/or methacrylic group and a cationic reactive group of a vinyl ether, oxetane, and/or epoxy group facilitates the control of the reactivity and is therefore particularly preferred.

Examples of the rod-like liquid crystal compound preferably used include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans, and alkenylcyclohexyl benzonitriles. In addition to these low-molecular liquid crystal compounds, high-molecular liquid crystal compounds also can be used. The high-molecular liquid crystal compounds are polymerization products of low-molecular rod-like liquid crystal compounds having reactive groups. Particularly preferred examples of the low-molecular rod-like liquid crystal compounds having reactive groups are represented by the following Formula (I):

Q¹-L¹-A¹-L³-M-L⁴-A²-L²-Q² Formula (I):

where, Q¹ and Q² each independently represent a reactive group; L¹, L², L³, and L⁴ each independently represent a single bond or a divalent linker; A¹ and A² each independently represent a spacer having 2 to 20 carbon atoms; and M represents a mesogenic group.

Nonlimiting examples of the compound represented by Formula (I) are shown below. The compounds represented by Formula (I) can be synthesized by a method described in National Publication of International Patent Application No. Hei 11-513019 (WO97/00600).

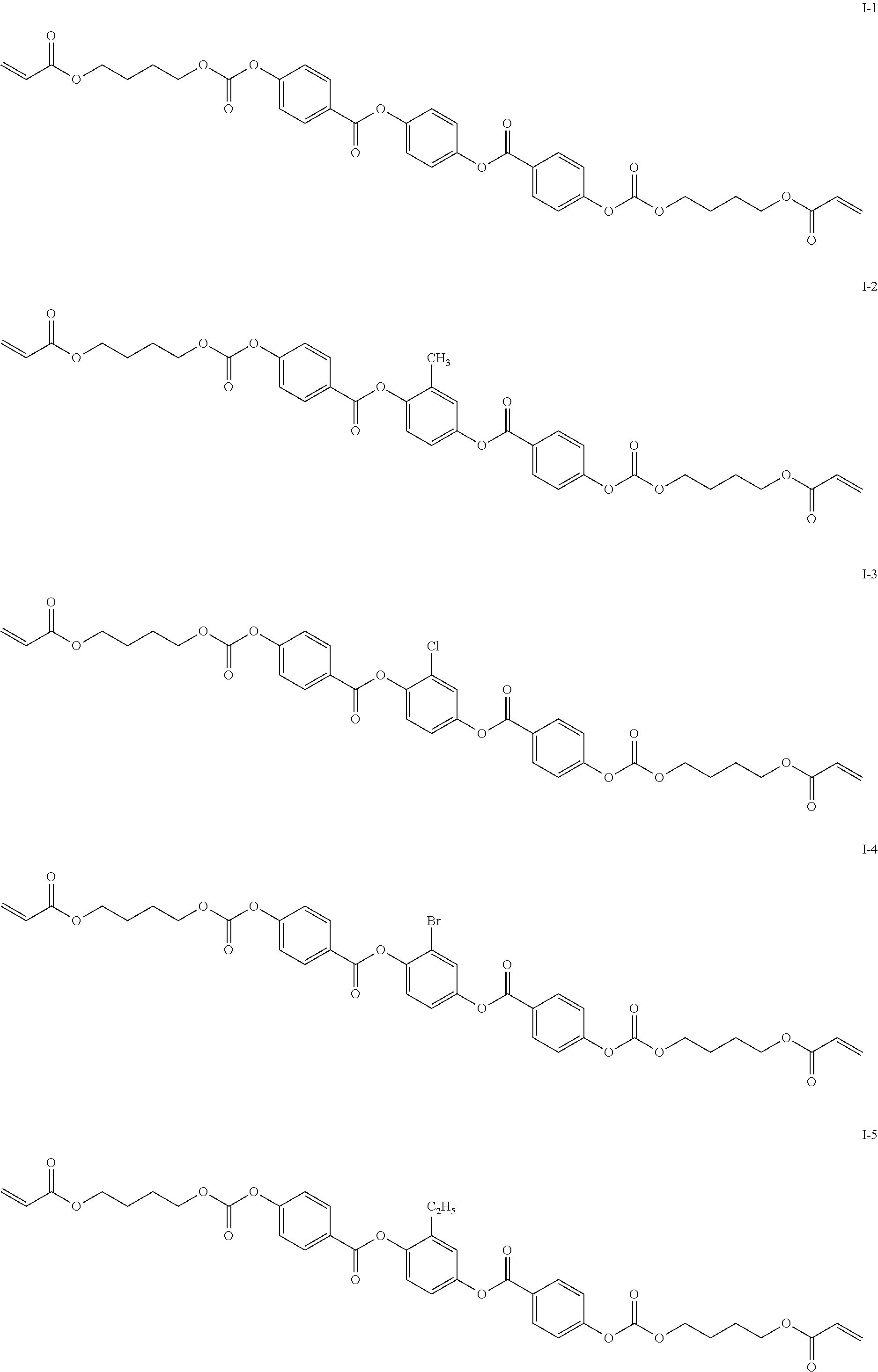

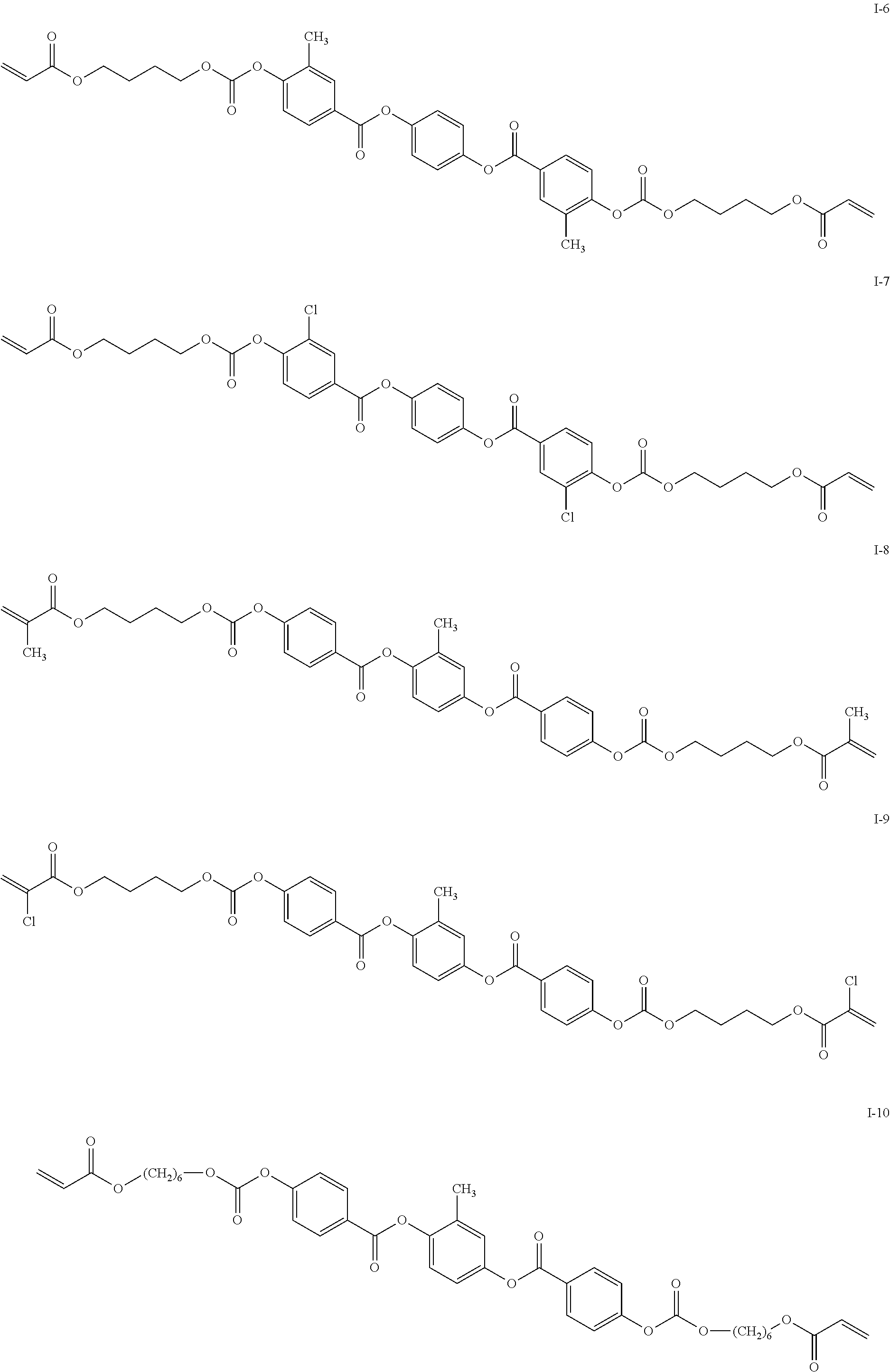

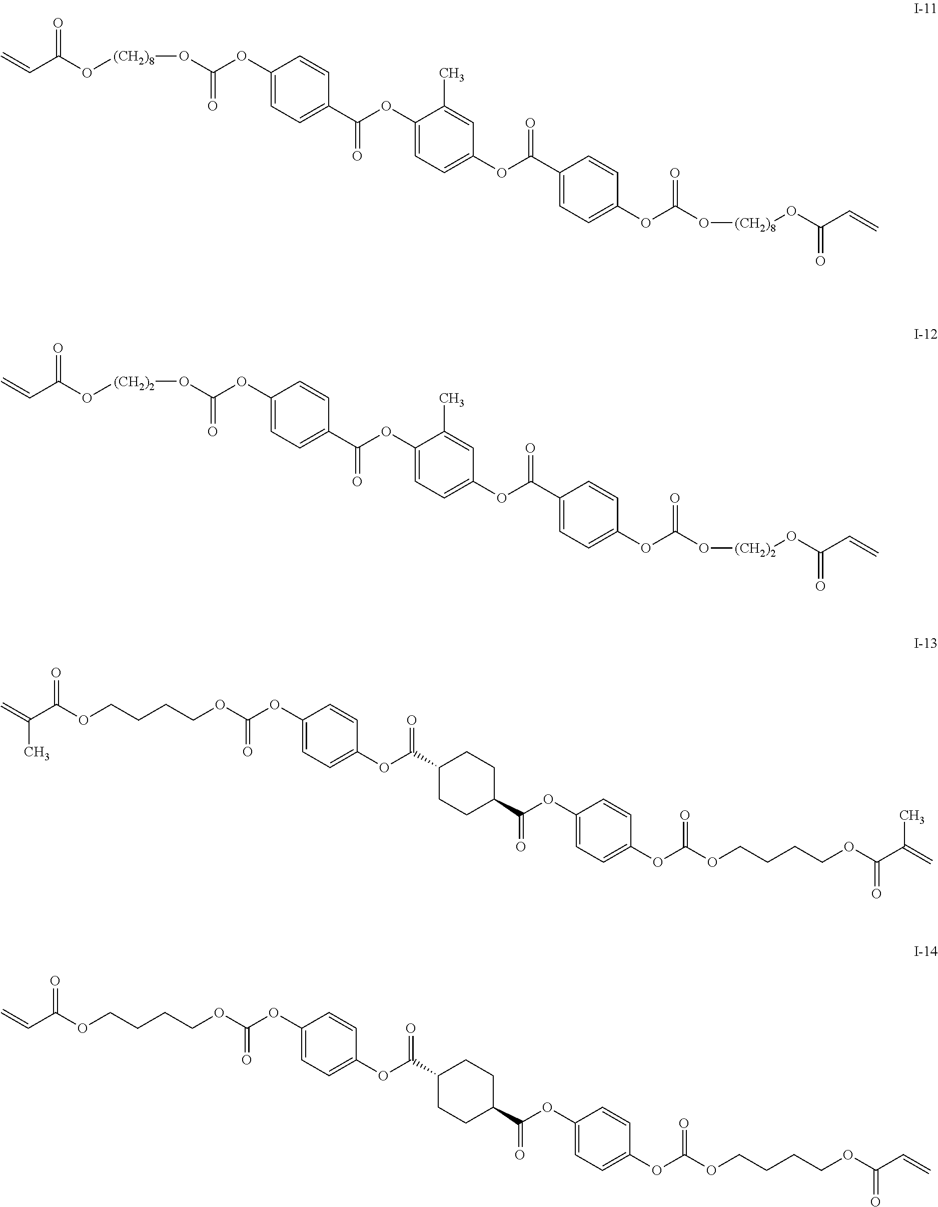

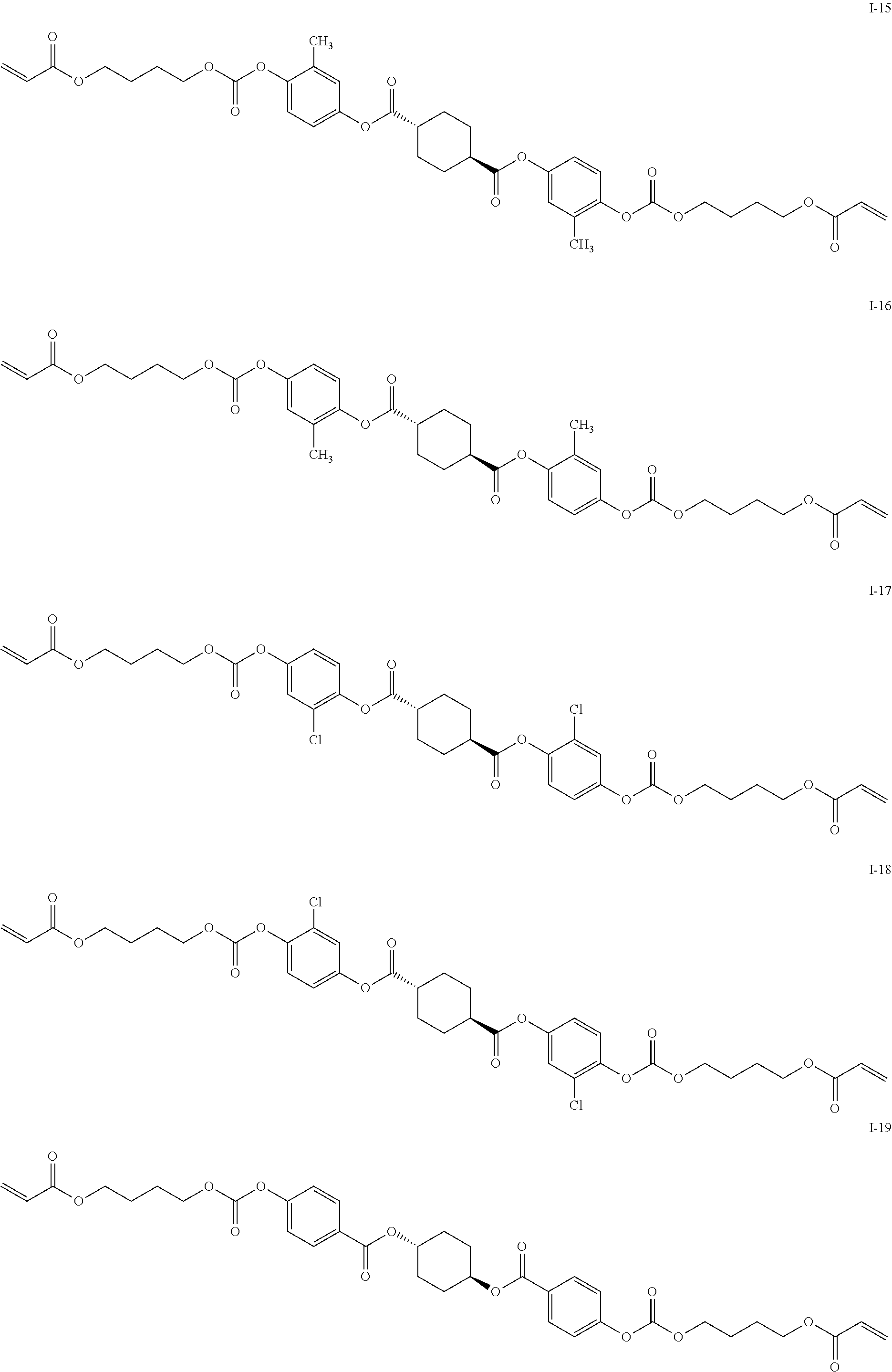

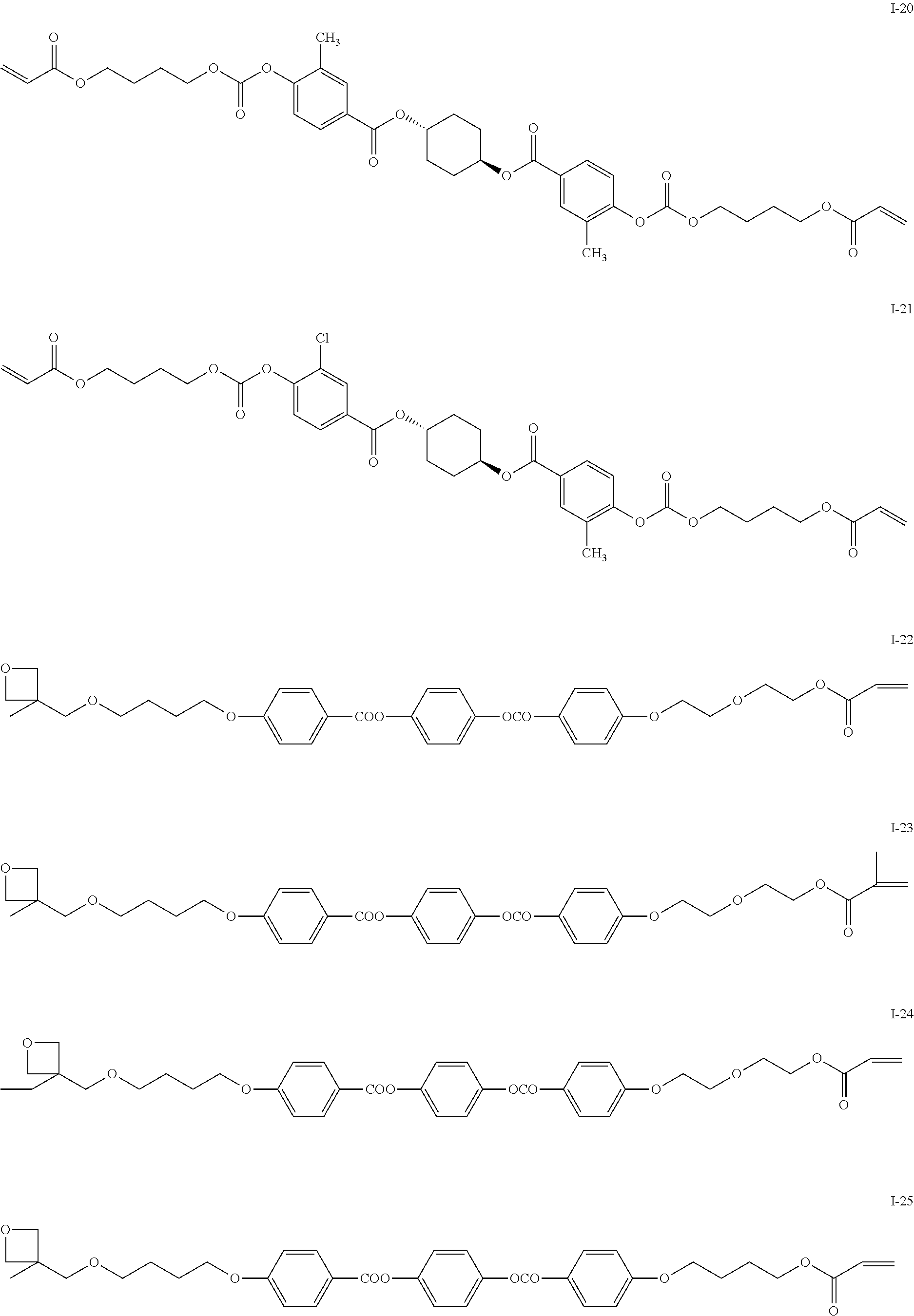

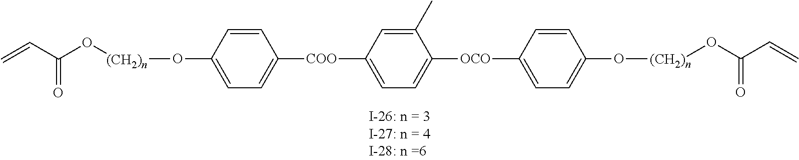

In general, the retardation of a rod-like liquid crystal decreases with an increase in wavelength. With a liquid crystal showing a retardation of 137.5 nm of λ/4 at a wavelength of G (550 nm), the retardation is lower than this value at a wavelength of R (600 nm) and is higher than it at a wavelength of B (450 nm). In order to solve this problem, the retardation layers used in the first and second embodiments are preferably composed of a rod-like liquid crystal satisfying a requirement: Δnd (450 nm)<Δnd (550 nm)<Δnd (650 nm), i.e., a rod-like liquid crystal in which the retardation shows reverse dispersion characteristics with respect to wavelength (increases in retardation with wavelength) in the visible light region. Examples of such a rod-like liquid crystal include compounds represented by Formulae (I) and (II) in JP-A-2007-279688.

In another embodiment of the present invention, discotic liquid crystal is used in the retardation layer. The retardation layer is preferably composed of a discotic liquid crystal compound having low molecular weight, such as a monomer or a polymer formed by polymerization (curing) of a polymerizable discotic liquid crystal compound. Examples of the discotic compound include benzene derivatives disclosed in the research report [C. Destrade, et al. (1981). Mol. Cryst, vol. 71, p. 111.], truxene derivatives disclosed in the research reports [C. Destrade, et al. (1985). Mol. Cryst, vol. 122, p. 141. and (1990). Physics Lettr A, vol. 78, p. 82.], cyclohexane derivatives disclosed in the research report [B. Kohne, et al. (1984). Angew. Chem., vol. 96, p. 70.], and azacrown or phenylacetylene macrocycles disclosed in the research reports [J. M. Lehn, et al. (1985). J. Chem. Commun, p. 1794. and J. Zhang, et al. (1994). J. Am. Chem. Soc, vol. 116, p. 2655]. These discotic compounds generally have a structure having a discotic core in the molecular center and substituent groups (L) radially extending therefrom, such as linear alkyl and alkoxy groups, and substituted benzoyloxy groups; and the discotic compounds include all compounds exhibiting liquid crystal properties and generally referred to as discotic liquid crystal. If a mass of such molecules are uniformly aligned, it exhibits a negative uniaxial property; however, the present invention should not be limited thereto. In the present invention, the final product from the discotic compounds can be any compound other than the above-described compounds. For example, the low-molecular-weight discotic liquid crystal compound having a thermoreactive or photoreactive group is polymerized or cross-linked by heat or light to form a polymer that does not behave as liquid crystal. Such a polymer can also be used in the present invention.

In the present invention, preferred discotic liquid crystal compounds are represented by Formula (III):

D(-L-P)ₙ Formula (III):

In Formula (III), D represents a discotic core, L represents a divalent linking group, P represents a polymerizable group, and n is an integer from 4 to 12.

Preferred examples of the discotic core D, the divalent linking group L, and the polymerizable group P in Formula (III) include D1 to D15, L1 to L25, and P1 to P18 disclosed in JP-A-2001-4837, respectively, and the entity on the discotic core D, the divalent linking group L, and the polymerizable group P in JP-A-2001-4837 is herein incorporated.

Preferred examples of the discotic compounds are as follows:

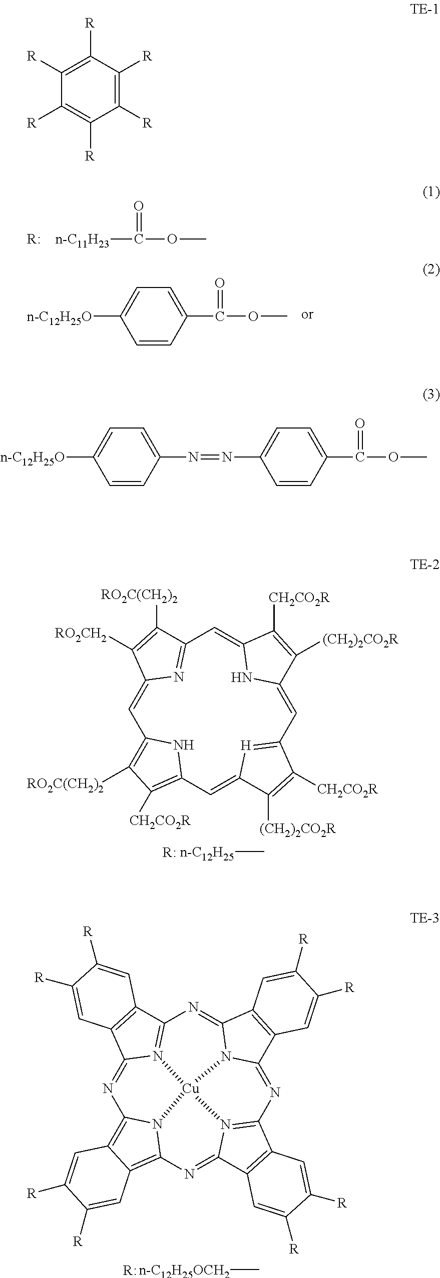

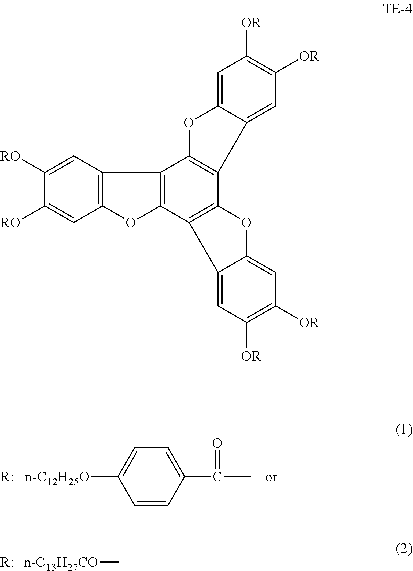

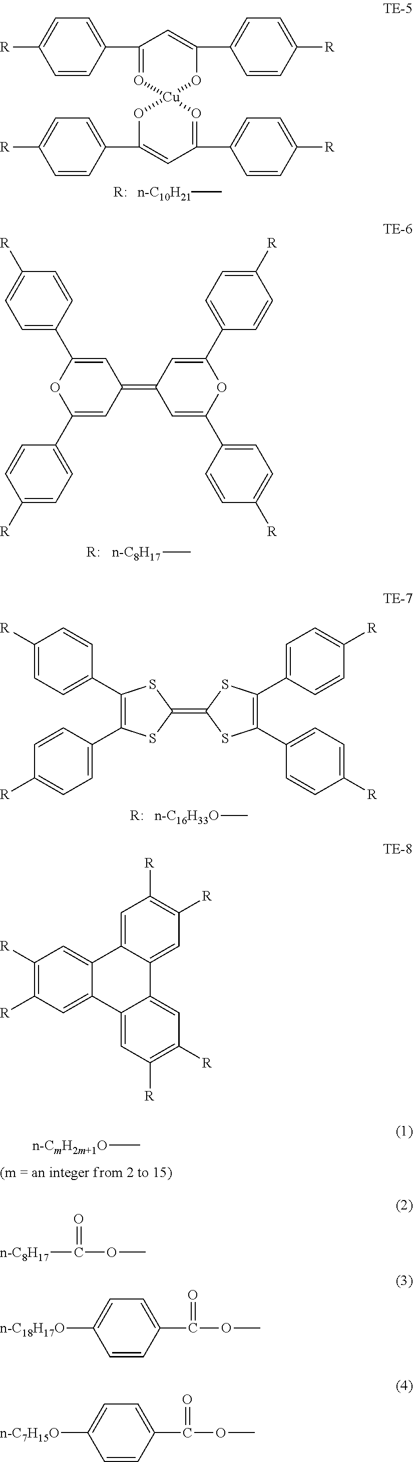

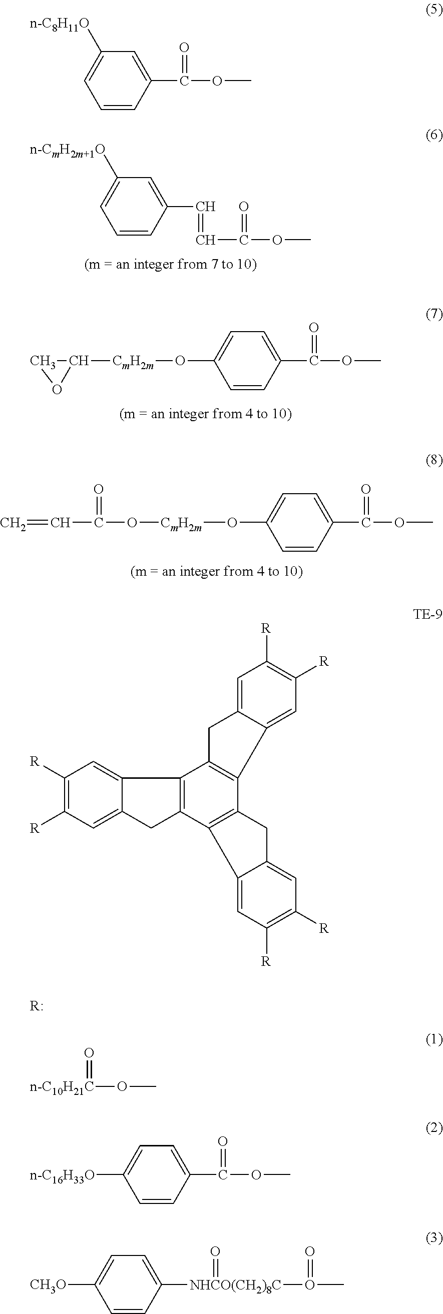

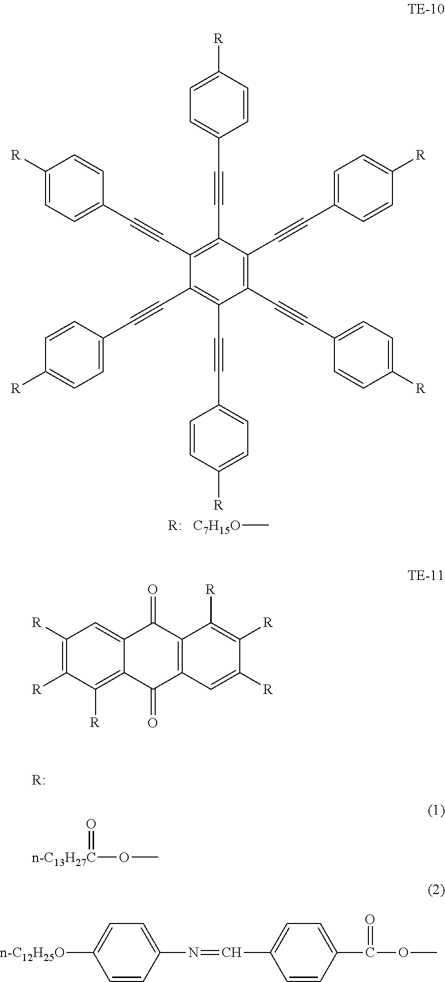

Especially preferred discotic liquid crystal usable as the primary component of the retardation layer is represented by Formula (II) or (III).

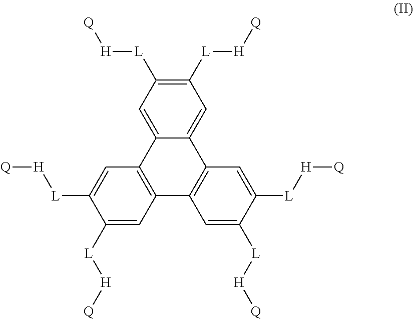

In the formula, the definitions of L, H and Q are same as those of L, H and Q in the formula (I) respectively; and the preferable examples thereof are same as those of L, H and Q in the formula (I) respectively.

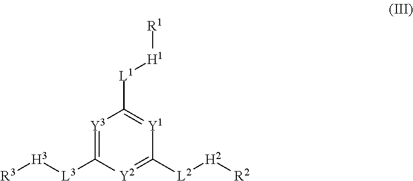

In the formula, the definitions of Y¹, Y² and Y³ are same as those of Y¹¹, Y¹² and Y¹³ in the formula (IV) described later respectively, and the preferable examples thereof are same as those of Y¹¹, Y¹² and Y¹³ in the formula (IV) respectively. Or the definitions of L¹, L², L³, H¹, H², H³, R¹, R² and R³ are same as those of L¹, L², L³, H¹, H², H³, R¹, R² and R³ in the formula (IV) described later respectively, and the preferable examples thereof are same as those of L¹, L², L³, H¹, H², H³, R¹, R² and R³ in the formula (IV) described later respectively.

The discotic liquid crystal having plural aromatic rings such as the compounds represented by formula (I), (II) or (III) may interact with the onium salt such as pyridium or imidazolium compound to be used as an alignment controlling agent by the π-π molecular interaction, thereby to achieve the vertical alignment. Especially, for example, the compound represented by the formula (II) in which L represents a divalent linking group containing at least one selected from *—CH═CH— and *—CC—, or the compound represented by formula (III) in which plural aromatic rings or heterocyclic rings are connected via a single bond to each other may keep the linearity of the molecule thereof since the free rotation of the bonding may be restricted strongly by the linking group. Therefore, the liquid crystallinity of the compound may be improved and the compound may achieve the more stable vertical alignment by the stronger intermolecular π-π interaction.

The discotic liquid crystal is preferably selected from the compounds represented by formula (IV)

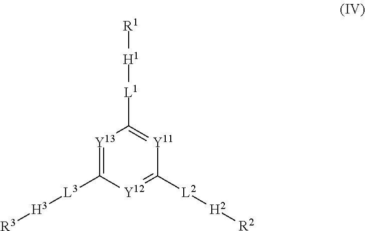

In the formula, Y¹¹, Y¹² and Y¹³ each independently represent a methine group or a nitrogen atom.

When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among those, preferred are an alkyl group, an alkoxy group, an alkoxycarbonyl group, an acyloxy group, a halogen atom and a cyano group; more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups, in terms of easiness in preparation of the compound.

In the formula, L¹, L² and L³ each independently represent a single bond or a bivalent linking group.

The bivalent linking group is preferably selected from —O—, —S—, —C(═O)—, NR⁷—, —CH═CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, or even more preferably a 6-membered group. The ring in the cyclic group may be a condensed ring. However, a monocyclic ring is preferred to a condensed ring for it. The ring in the cyclic group may be any of an aromatic ring, an aliphatic ring, or a heterocyclic ring. Examples of the aromatic ring are a benzene ring and a naphthalene ring. An example of the aliphatic ring is a cyclohexane ring. Examples of the heterocyclic ring are a pyridine ring and a pyrimidine ring. Preferably, the cyclic group contains an aromatic ring or a heterocyclic ring. According to the invention, the divalent cyclic group is preferably a divalent linking group consisting of a cyclic structure (but the cyclic structure may have any substituent(s)), and the same will be applied to the later.

Of the bivalent cyclic group represented by L¹, L² or L³, the benzene ring-having cyclic group is preferably a 1,4-phenylene group. The naphthalene ring-having cyclic group is preferably a naphthalene-1,5-diyl group or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, *—CE=CH—, *—C≡C—, *-“bivalent cyclic group”-, *—O—CO-“bivalent cyclic group”-, *—CO—O-“bivalent cyclic group”-, *—CH═CH-“bivalent cyclic group”-, *—C≡C-“bivalent cyclic group”-, *-“bivalent cyclic group”-O—CO—, *-“bivalent cyclic group”-CO—O—, *-“bivalent cyclic group”-CH═CH—, or *-“bivalent cyclic group”-C≡C—. More preferably, they are a single bond, *—CH═CH—, *—C≡C—, *—CH═CH-“bivalent cyclic group”- or *—C≡C-“bivalent cyclic group”-, even more preferably a single bond. In the examples, “*” indicates the position at which the group bonds to the 6-membered ring of formula (IV) that contains Y¹¹, Y¹² and Y¹³.

In the formula, H¹, H² and H³ each independently represent the following formula (IV-A) or (IV-B):

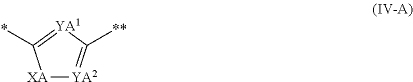

In formula (IV-A), YA¹ and YA² each independently represent a methine group or a nitrogen atom;

XA represents an oxygen atom, a sulfur atom, a methylene group or an imino group;

* indicates the position at which the formula bonds to any of L¹ to L³; and

** indicates the position at which the formula bonds to any of R¹ to R³.

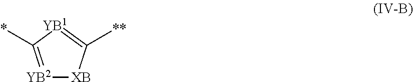

In formula (IV-B), YB¹ and YB² each independently represent a methine group or a nitrogen atom;

XB represents an oxygen atom, a sulfur atom, a methylene group or an imino group;

* indicates the position at which the formula bonds to any of L¹ to L³; and

** indicates the position at which the formula bonds to any of R¹ to R³.

In the formula, R¹, R² and R³ each independently represent the following formula (IV-R):

*—(-L²¹-Q²)ₙ₁-L²²-L²³-Q¹ (IV-R):

In formula (IV-R), * indicates the position at which the formula bonds to H¹, H² or H³ in formula (IV).

L²¹ represents a single bond or a bivalent linking group. When L²¹ is a bivalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, **—O—CO—, **—CO—O—, **—CH═CH— or **—C≡C— (in which ** indicates the left side of L²¹ in formula (IV-R)). More preferably it is a single bond.

In the formula, Q² represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, and a phenanthrene ring. An example of the aliphatic ring is a cyclohexane ring. Examples of the heterocyclic ring are a pyridine ring and a pyrimidine ring.

The benzene ring-having group for Q² is preferably a 1,4-phenylene group or a 1,3-phenylene group. The naphthalene ring-having group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, Q² is a 1,4-phenylene group, a naphthalene-2,6-diyl group, or a 1,4-cyclohexylene group.

In the formula, Q² may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, or more preferably 1 or 2.

In the formula, L²² represents **—O—, **—O—CO—, **—CO—O—, **—O—CO—O—, **—S—, **—NH—, **—SO₂—, **—CH₂—, **—CH═CH— or **—C≡C—, and “*” indicates the site bonding to the Q² side. Preferably, L²² represents **—O—, **—O—CO—, **—CO—O—, **—O—CO—O—, **—CH₂—, **—CH═CH— or **—C≡C—, or more preferably, L²² represents **—O—, **—O—CO—, **—CO—O—, **—O—CO—O—, or **—CH₂—. When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of the formula (IV) in solvent, and therefore the composition can be readily prepared as a coating liquid.

In the formula, L²³ is preferably a linking group selected from a group consisting of —O—, —C(═O)—, —CH₂—, —CH═CH— and a group formed by linking two or more of these. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizable group or a hydrogen atom. In case where the compound of formula (IV) is used in producing optical films of which the retardation is required not to change by heat, such as optical compensatory films, Q¹ is preferably a polymerizable group. The polymerization for the group is preferably addition polymerization (including ring-cleavage polymerization) or polycondensation. In other words, the polymerizable group preferably has a functional group that enables addition polymerization or polycondensation. Examples of the polymerizable group are shown below.

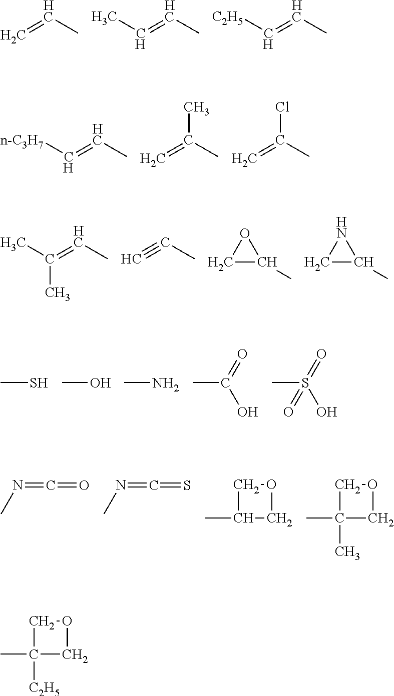

More preferably, the polymerizable group is addition-polymerizing functional group. The polymerizable group of the type is preferably a polymerizable ethylenic unsaturated group or a ring-cleavage polymerizable group.

Examples of the polymerizing ethylenic unsaturated group are the following (M-1) to (M-6):

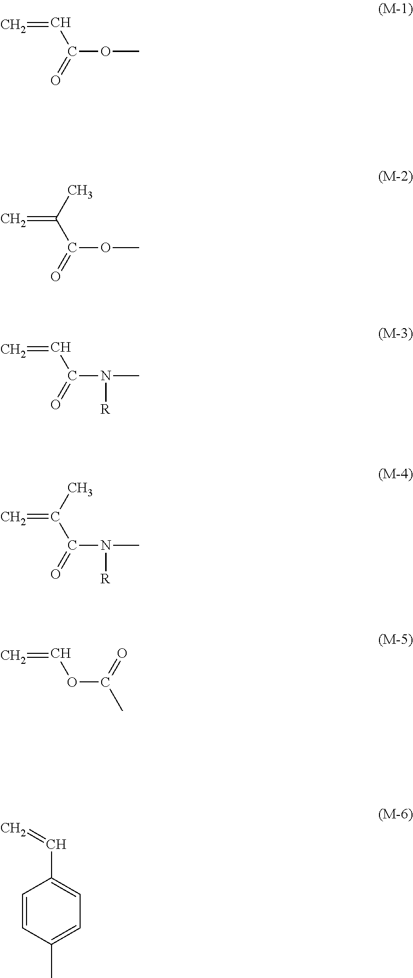

In formulae (M-3) and (M-4), R represents a hydrogen atom or an alkyl group. R is preferably a hydrogen atom or a methyl group.

Of formulae (M-1) to (M-6), preferred are formulae (M-1) and (M-2), and more preferred is formula (M-1).

The ring-cleavage polymerizable group is preferably a cyclic ether group, or more preferably an epoxy group or an oxetanyl group.

Among the compounds represented by formula (IV), the compounds represented by formula (IV′) are more preferable.

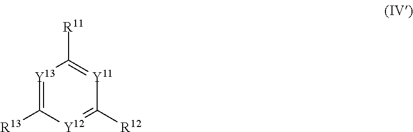

In the formula, Y¹¹, Y¹² and Y¹³ each independently represent a methine group or a nitrogen atom. Preferably, Y¹¹, Y¹² and Y¹³ are all methine groups, more preferably non-substituted methine groups.

In the formula, R¹¹, R¹² and R¹³ each independently represent the following formula represent the following formula (IV′-A), (IV′-B) or (IV′-C). When the small wavelength dispersion of birefringence is needed, preferably, R¹¹, R¹² and R¹³ each represent the following formula (IV′-A) or (IV′-C), more preferably the following formula (IV′-A). Preferably, R¹¹, R¹² and R¹³ are same (R¹¹═R¹²═R¹³).

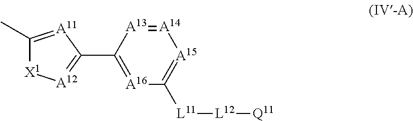

In formula (VI′-A), A¹¹, A¹², A¹³, A¹⁴, A¹⁵ and A¹⁶ each independently represent a methine group or a nitrogen atom.

Preferably, at least one of A¹¹ and A¹² is a nitrogen atom; more preferably the two are both nitrogen atoms.

Preferably, at least three of A¹³, A¹⁴, A¹⁵ and A¹⁶ are methine groups; more preferably, all of them are methine groups. Non-substituted methine is more preferable.

Examples of the substituent that the methine group represented by A¹¹, A¹², A¹³, A¹⁴, A¹⁵ or A¹⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X¹ represents an oxygen atom, a sulfur atom, a methylene group or an imino group, but is preferably an oxygen atom.

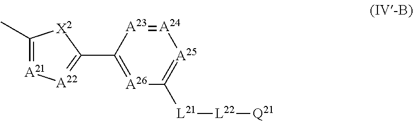

In formula (IV′-B), A²¹, A²², A²³, A²⁴, A²⁵ and A²⁶ each independently represent a methine group or a nitrogen atom.

Preferably, at least either of A²¹ or A²² is a nitrogen atom; more preferably the two are both nitrogen atoms.

Preferably, at least three of A²³, A²⁴, A²⁵ and A²⁶ are methine groups; more preferably, all of them are methine groups.

Examples of the substituent that the methine group represented by A²³, A²⁴, A²⁵ or A²⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X² represents an oxygen atom, a sulfur atom, a methylene group or an imino group, but is preferably an oxygen atom.

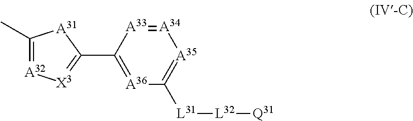

In formula (IV′-C), A³¹, A³², A³³, A³⁴, A³⁵ and A³⁶ each independently represent a methine group or a nitrogen atom.

Preferably, at least either of A³¹ or A³² is a nitrogen atom; more preferably the two are both nitrogen atoms.

Preferably, at least three of A³³, A³⁴, A³⁵ and A³⁶ are methine groups; more preferably, all of them are methine groups.

When A³³, A³⁴, A³⁵ and A³⁶ are methine groups, the hydrogen atom of the methine group may be substituted with a substituent. Examples of the substituent that the methine group may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X³ represents an oxygen atom, a sulfur atom, a methylene group or an imino group, but is preferably an oxygen atom.

L¹¹ in formula (IV′-A), L²¹ in formula (IV′-B) and L³¹ in formula (IV-C) each independently represent —O—, —O—CO—, —CO—O—, —O—CO—O—, —S—, —NH—, —SO₂—, —CH₂—, —CH═CH— or —C≡CC—; preferably —O—, —O—CO—, —CO—O—, —O—CO—O—, —CH₂—, —CH═CH— or —C≡C—; more preferably —O—, —O—CO—, —CO—O—, —O—CO—O— or —C≡C—. L¹¹ in formula (VI′-A) is especially preferable O—, —CO—O— or in terms of the small wavelength dispersion of birefringence; among these, —CO—O— is more preferable because the discotic nematic phase may be formed at a higher temperature. When above group has a hydrogen atom, then the hydrogen atom may be substituted with a substituent. Preferred examples of the substituent are a halogen atom, cyano, nitro, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

L¹² in formula (IV′-A), L²² in formula (IV′-B) and L³² in formula (IV′-C) each independently represent a bivalent linking group selected from —O—, —S—, —C(═O)—SO₂—, —NH—, —CH₂—, —CH═CH— and —C≡C—, and a group formed by linking two or more of these. The hydrogen atom in —NH—, —CH₂— and —CH═CH— may be substituted with a substituent. Preferred examples of the substituent are a halogen atom, cyano, nitro, hydroxy, carboxyl, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. More preferred are a halogen atom, hydroxy and an alkyl group having from 1 to 6 carbon atoms; and especially preferred are a halogen atom, methyl and ethyl.

Preferably, L¹², L²² and L³² each independently represent a bivalent linking group selected from —O—, —C(═O)—, —CH₂—, —CH═CH— and —C≡—, and a group formed by linking two or more of these.

Preferably, L¹², L²² and L³² each independently have from 1 to 20 carbon atoms, more preferably from 2 to 14 carbon atoms. Preferably, L¹², L²² and L³² each independently have from 1 to 16 (—CH₂—)'s, more preferably from 2 to 12 (—CH₂—)'s.

The number of carbon atoms constituting the L¹², L²² or L³² may influence both of the liquid crystal phase transition temperature and the solubility of the compound. Generally, the compound having the larger number of the carbon atoms has a lower phase transition temperature at which the phase transition from the discotic nematic phase (Nd phase) transits to the isotropic liquid occurs. Furthermore, generally, the solubility for solvent of the compound, having the larger number of the carbon atoms, is more improved.

Q¹¹ in formula (IV′-A), Q²¹ in formula (IV′-B) and Q³¹ in formula (IV′-C) each independently represent a polymerizable group or a hydrogen atom. Preferably, Q¹¹, Q²¹ and Q³¹ each represent a polymerizable group. The polymerization for the group is preferably addition polymerization (including ring-cleavage polymerization) or polycondensation. In other words, the polymerizing group preferably has a functional group that enables addition polymerization or polycondensation. Examples of the polymerizable group are same as those exemplified above.

Examples of the compound represented by formula (IV) include the compounds exemplified as “Compound 13“−”Compound 43”, described in JP-A-2006-76992, column 0052; and the compounds exemplified as “Compound 13”-“Compound 36”, described in JP-A-2007-2220, columns 0040-0063.

The compounds may be prepared according to any process. For example, the compounds may be prepared according to the method described in JP-A-2007-2220, columns 0064-0070.

The liquid-crystal phase that the liquid-crystal compound to be used in the invention expresses includes a columnar phase and a discotic nematic phase (ND phase). Of those liquid-crystal phases, preferred is a discotic nematic phase (ND phase) having a good mono-domain property.

Among the discotic liquid crystal compounds, the compounds forming the liquid crystal phase at a temperature of from 20 degrees Celsius to 300 degrees are preferable. The compounds forming the liquid crystal phase at a temperature of from 40 degrees Celsius to 280 degrees are more preferable, and the compounds forming the liquid crystal phase at a temperature of from 60 degrees Celsius to 250 degrees are even more preferable. The compound forming the liquid crystal phase at a temperature of 20 degrees Celsius to 300 degrees Celsius includes any compound of which the temperature range forming the liquid crystal phase resides including 20 degrees Celsius (for example the temperature range is from 10 degrees Celsius to 22 degrees Celsius), and includes also any compound of which the temperature range forming the liquid crystal phase resides including 300 degrees Celsius (for example, the temperature range is from 298 degrees Celsius to 310 degrees Celsius). The same will be applied to the temperature ranges of from 40 degrees Celsius to 280 degrees Celsius and of from 60 degrees Celsius to 250 degrees Celsius.

A preferred retardation layer is formed by applying a composition (e.g., coating solution) composed of a liquid crystal compound onto a surface of a photo-alignment layer or rubbed alignment layer which will be described later, aligning the molecules of the composition in a state of an intended liquid crystal phase, and then fixing the molecular alignment state by heating or exposing to ionizing radiation. Organic solvents are preferably used for preparation of the coating solution. Examples of the organic solvents include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform and dichloromethane), esters (e.g., methyl acetate and butyl acetate), ketones (e.g., acetone and methyl ethyl ketone), and ethers (e.g., tetrahydrofuran and 1,2-dimethoxyethane). Preferred are alkyl halides and ketones. Two or more organic solvents may be used in combination.

According to the embodiment employing any rod-like liquid crystal compound, it is preferable that the rod-like liquid crystal is aligned horizontally. It is to be understood that the term “horizontal alignment” in the specification means that the direction of long axis of a liquid crystalline molecule is parallel to the layer plane, wherein strict parallelness is not always necessary; and means, in this specification, that a tilt angle of the mean direction of long axes of liquid crystalline molecules with respect to the horizontal plane is smaller than 10°. The tilt angle is preferably from 0 to 5°, more preferably from 0 to 3°, even more preferably from 0 to 2°, or most preferably from 0 to 1°.

The composition preferably contains an additive capable of promoting the horizontal alignment of the liquid crystal, and examples of the additive include those described in JP-A-2009-223001, columns 0055-0063.

In the case where the discotic liquid crystal compound is used, the molecules of the compound are preferably aligned such that their discotic planes are orthogonal to a plane of the layer. Since the discotic liquid crystal represented by Formula (IV) has multiple aromatic rings in its molecules, strong intermolecular π-π interaction with pyridinium or imidazolium compounds is generated, which increases the tilt angle of the molecules of the discotic liquid crystal in the vicinity of the interface to the alignment film. Especially, since the discotic liquid crystal represented by Formula (IV′) and having multiple aromatic rings connected to each other via a single bond has a highly linear molecular structure that restricts the rotational degrees of freedom of molecules, stronger intermolecular π-π interaction with the pyridinium or imidazolium compounds is generated, which can increase the tilt angle of the molecules of the discotic liquid crystal in the vicinity of the interface to the alignment film to provide an orthogonal alignment state.

The aligned molecules of the liquid crystal compound is preferably fixed in the alignment state. The molecular alignment state is preferably fixed by the polymerization reaction between the reactive groups introduced into the liquid crystal compound. Examples of the polymerization reaction include a thermal polymerization reaction with a thermal polymerization initiator and a photopolymerization reaction with a photopolymerization initiator, and preferred is the photopolymerization reaction. The photopolymerization reaction may be any of radical polymerization and cationic polymerization. Examples of a radical photopolymerization initiator include α-carbonyl compounds (those disclosed in U.S. Pat. Nos. 2,367,661 and 2,367,670), acyloin ethers (those disclosed in U.S. Pat. No. 2,448,828), α-hydrocarbon-substituted aromatic acyloin compounds (those disclosed in U.S. Pat. No. 2,722,512), polynuclear quinone compounds (those disclosed in U.S. Pat. Nos. 3,046,127 and 2,951,758), combinations of triarylimidazole dimers and p-aminophenyl ketone (those disclosed in U.S. Pat. No. 3,549,367), acrydine and phenazine compounds (those disclosed in JP-A-60-105667 and U.S. Pat. No. 4,239,850), and oxadiazole compounds (those disclosed in U.S. Pat. No. 4,212,970). Examples of the cationic photopolymerization initiator include organic sulfonium salts, iodonium salts, and phosphonium salts, preferred are organic sulfonium salts, and more preferred are triphenylsulfonium salts. Preferred examples of the counter ion of these compounds include hexafluoroantimonate, and hexafluorophosphate.

The amount of the photopolymerization initiator is preferably from 0.01 to 20% by mass, more preferably 0.5 to 5% by mass relative to the solid content of the coating solution.

The liquid crystal compound is preferably irradiated with ultraviolet light for polymerization. The irradiation energy is preferably in the range of 10 mJ/cm² to 10 J/cm², more preferably 25 to 800 mJ/cm². The illuminance preferably ranges from 10 to 1000 mW/cm², more preferably 20 to 500 mW/cm², and further preferably 40 to 350 mW/cm². The peak wavelength of light preferably ranges from 250 to 450 nm, more preferably 300 to 410 nm. The irradiation with light may be carried out under an inert gas atmosphere, such as nitrogen, or thermal conditions to promote a photopolymerization reaction.

The retardation layer may exhibit an in-plane retardation developed or increased by photo alignment due to irradiation with polarized light. The irradiation with polarized light may be carried out also for a photopolymerization process to further fix molecular alignment, carried out prior to irradiation with non-polarized light for fixation of the molecular alignment, or carried out for photo alignment after irradiation with non-polarized light for preliminary fixation of the molecular alignment; preferred is carrying out the irradiation with polarized light alone or carrying out the irradiation with polarized light prior to irradiation with non-polarized light for further fixation of the molecular alignment. In the case where the irradiation with polarized light is carried out also for a photopolymerization process to fix the molecular alignment and a radical polymerization initiator is used as the polymerization initiator, the irradiation with polarized light is preferably carried out under an inert gas atmosphere at an oxygen concentration of not more than 0.5%. The irradiation energy preferably ranges from 20 mJ/cm² to 10 J/cm², more preferably 100 to 800 mJ/cm². The illuminance preferably ranges from 20 to 1000 mW/cm², more preferably 50 to 500 mW/cm², and further preferably 100 to 350 mW/cm². Any liquid crystal compound cured by the irradiation with polarized light can be used, and preferred is a liquid crystal compound having an ethylenically unsaturated group as a reactive group. The peak wavelength of light preferably ranges from 300 to 450 nm, more preferably 350 to 400 nm.

The retardation layer may be further irradiated with polarized light or non-polarized ultraviolet light after the first irradiation with polarized light (irradiation for optical alignment). The additional irradiation with polarized light or non-polarized ultraviolet light after the first irradiation with polarized light can enhance the reaction rate (post-curing) of the reactive groups, so that the adhesion is improved and the retardation layer can be therefore produced at a higher transportation speed. The post-curing may be carried out by irradiation with polarized or non-polarized light, and preferred is irradiation with polarized light. Two or more post-curing steps are preferably carried out by irradiation with polarized light alone, non-polarized light alone, or a combination of polarizing and non-polarized light. In the case of the combined irradiation with polarized and non-polarized light, irradiation with the polarized light is preferably followed by irradiation with the non-polarized light. Although the irradiation with UV light may be or may not be carried out under an inert gas atmosphere, the irradiation may be carried out preferably under an inert gas atmosphere at an oxygen concentration of not more than 0.5% in the case where a radical photopolymerization initiator is used as a photopolymerization initiator. The irradiation energy preferably ranges from 20 mJ/cm² to 10 J/cm², more preferably 100 to 800 mJ/cm². The illuminance preferably ranges from 20 to 1000 mW/cm², more preferably 50 to 500 mW/cm², and further preferably 100 to 350 mW/cm². The peak wavelength of light in the irradiation with polarized light is preferably from 300 to 450 nm, more preferably from 350 to 400 nm. The peak wavelength in the irradiation with non-polarized light preferably ranges from 200 to 450 nm, more preferably 250 to 400 nm.

It is also preferred that the liquid crystal compound has two or more types of reactive groups having different polymerization conditions. In such a case, a retardation layer composed of a polymer having an unreacted reactive group can be produced udder selected polymerization conditions to polymerize a limited type of reactive groups among the multiple types of reactive groups. The conditions especially suitable for polymerization to fix the molecules of liquid crystal compounds having radically reactive groups and cationically reactive groups (e.g., above-described I-22 to I-25) will now be described.

Only the photopolymerization initiator which acts on a reactive group to be polymerized is preferably used as a polymerization initiator. In particular, it is preferred that a radical photopolymerization initiator alone be used for selective polymerization of radically reactive groups or a cationic photopolymerization initiator alone be used for selective polymerization of cationically reactive groups. The content of the photopolymerization initiator is preferably in the range of 0.01 to 20% by mass, more preferably 0.1 to 8% by mass, and further preferably 0.5 to 4% by mass relative to the solid content in the coating solution.

Irradiation with light for the polymerization is preferably carried out with ultraviolet rays. In this case, extraordinarily large irradiation energy and/or illuminance may cause a non-selective reaction of both the radically reactive group and cationically reactive group. In this regard, the irradiation energy preferably ranges from 5 mJ/cm² to 500 mJ/cm², more preferably 10 to 400 mJ/cm², and further preferably 20 to 200 mJ/cm². The illuminance preferably ranges from 5 to 500 mW/cm², more preferably 10 to 300 mW/cm², and further preferably 20 to 100 mW/cm². The peak wavelength of light is preferably from 250 to 450 nm, more preferably from 300 to 410 nm.

Among the photopolymerization reactions, a reaction with a radical photopolymerization initiator is inhibited by oxygen, but a reaction with a cationic photopolymerization initiator is not inhibited by oxygen. Hence, in order to selectively react either one of a radically reactive group and a cationically reactive group in a liquid crystal compound, the irradiation with light is preferably carried out under an inert gas atmosphere, such as nitrogen gas, for a selective reaction with the radically reactive group and under an oxygen atmosphere (e.g., in air atmosphere) for a selective reaction with the cationically reactive group.

The photo-alignment layer is preferably used for formation of the quarter-wave plate used in the first embodiment. The photo-alignment layer is irradiated with light to develop an alignment-controlling function, and the direction of its alignment axis is determined depending on the direction of the irradiation with light. Thus, domains having alignment axes orthogonal to each other can be formed by pattern exposure, and then the molecules of rod-like liquid crystal is horizontally aligned to form the quarter-wave plate including domains with slow axes orthogonal to each other. Use of a rubbed alignment film subjected to mask rubbing enables the quarter-wave plate used in the first embodiment to be formed as in use of the light aligning film subjected to mask exposure.

The quarter-wave plate used in the first embodiment can be also formed through formation of a horizontal alignment film [e.g., alignment film to align the longitudinal direction of liquid crystal molecules in the direction of an alignment treatment (for instance, rubbing treatment)] and an orthogonal alignment film [e.g., alignment film to align the longitudinal direction of liquid crystal molecules in the direction orthogonal to the direction of an alignment treatment (for instance, rubbing treatment)] in a pattern and subsequent alignment of the molecules of a curable liquid crystal composition.

The horizontal alignment state and the orthogonal alignment state can be changed by exposure to a temperature change in some cases depending on the type of alignment film and the combination of an alignment-controlling agent and liquid crystal compound contained in the curable liquid crystal composition. Furthermore, some liquid crystal compounds can be modified between a horizontal alignment state and an orthogonal alignment state in the absence or presence of a certain alignment-controlling agent. The retardation layer including the first and second domains having in-plane slow axes orthogonal to each other can be also formed by utilizing these changes in the alignment state. Such changes in the alignment state are likely to occur in the case where the molecules of the discotic liquid crystal are aligned such that their discotic planes are orthogonal to a plane of the layer and in the case where the alignment film is primarily composed of modified or non-modified polyvinyl alcohol and contains an alignment-controlling agent being an onium salt (preferably pyridinium salt or imidazolium salt) having a certain length of aliphatic hydrocarbon group, the onium salt preferably exhibiting liquid crystal properties.

Photo-alignment materials usable for the light aligning film formed by irradiation with light are disclosed in many documents. Preferred examples of the materials usable for the light aligning film of the present invention include azo compounds disclosed in JP-A-2006-285197, JP-A-2007-76839, JP-A-2007-138138, JP-A-2007-94071, JP-A-2007-121721, JP-A-2007-140465, JP-A-2007-156439, JP-A-2007-133184, JP-A-2009-109831, and Japanese Patent Nos. 3883848 and 4151746; aromatic ester compounds disclosed in JP-A-2002-229039; maleimide- and/or alkenyl-substituted nadimide compounds having photo-alignment units as disclosed in JP-A-2002-265541 and JP-A-2002-317013; photocrosslinkable silane derivatives disclosed in Japanese Patent Nos. 4205195 and 4205198; and photocrosslinkable polyimides, polyamides, or esters disclosed in JP-A-2003-520878, JP-A-2004-529220, and Japanese Patent No. 4162850. Particularly preferred are azo compounds and photocrosslinkable polyimides, polyamides, or esters.

The light aligning film is formed from the material described above by irradiation with linearly polarized light or non-polarized light.

The term “irradiation with linearly polarized light” herein refers to a procedure to promote a photoreaction in the photo-alignment material. The wavelength of light to be used depends on the type of photo-alignment material to be used and is not specifically limited provided that the wavelength is essential to the photoreaction of the material. Light used for the irradiation preferably has a peak wavelength of 200 to 700 nm. More preferred is ultraviolet light having a peak wavelength of not more than 400 nm.

Any common light source can be used for the irradiation with light, and examples of such light sources include lamps (e.g., tungsten lamps, halogen lamps, xenon lamps, xenon flash lamps, mercury lamps, mercury xenon lamps, and carbon arc lamps), a variety of lasers (e.g., semiconductor lasers, helium-neon lasers, argon ion lasers, helium cadmium lasers, and YAG lasers), light-emitting diodes, and cathode-ray tubes.

Examples of a method for generating a linearly polarized light include methods involving use of a polarizing plate (e.g., an iodine polarizing plate, a dichroic dye polarizing plate, or a wire grid polarizing plate), methods involving use of a prism device (e.g., a Glan-Thompson prism) or use of a reflection-type polarizer utilizing the Brewster's angle, and methods involving use of light emitted from a laser light source and having polarization. In addition, a filter or a wavelength-converting device may be used to selectively expose the light aligning film to light having a necessary wavelength alone.

The irradiation time is preferably in the range of 1 to 60 minutes, more preferably 1 to 10 minutes.

In order to produce a patterned photo alignment layer, a film composed of a photo alignment material is subjected to pattern exposure. The pattern exposure is preferably carried out with a photomask having a shielding site and a transmissive site. For example, the exposure can be carried out with photomasks A and B illustrated in FIGS. 13A and 13B, respectively. Furthermore, a laser or an electron beam may be focused on a predetermined site for direct formation of the pattern without a mask.

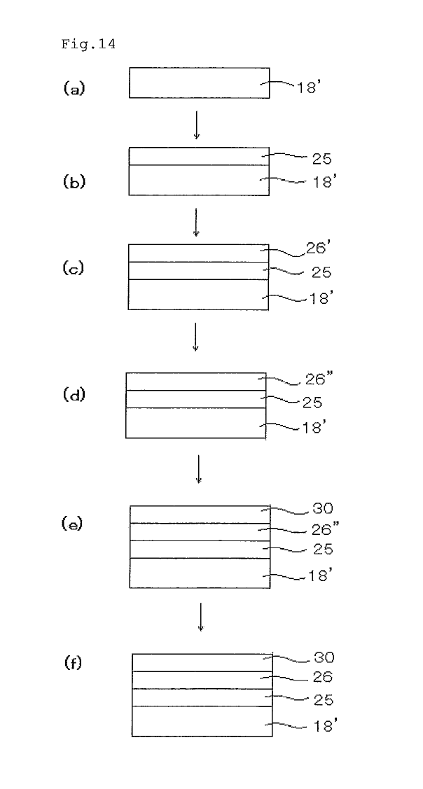

FIG. 14 schematically illustrates an exemplary process flow of forming a patterned retardation layer usable in the second embodiment.

A support 18′ such as a polyimide film is used (FIG. 14A). The support 18′ is optionally removable. In such a case, optical transparency is not essential for the support. A material for an alignment film is applied onto the support 18′ to form an alignment film 25 (FIG. 14B). The alignment film 25 may be a rubbed alignment film or an optical alignment film. In order to enhance removability, a release layer may be provided between the support 18′ and the alignment film 25. The alignment film 25 is optionally subjected to a treatment to develop alignment-controlling force (e.g., rubbing treatment or irradiation with linearly polarized light), and then a coating solution composed of a curable liquid crystal composition containing a liquid crystal compound having two different reactive groups (e.g., an oxetanyl group and a polymerizable ethylenically-unsaturated group) is applied onto the alignment film 25 to form a coating film 26′ (FIG. 14C). After the solvent contained in the coating film 26′ is removed, the liquid crystal molecules in the coating film 26′ are aligned in a predetermined alignment state. The coating film 26′ is then irradiated with ultraviolet rays to promote the reaction of only one of the reactive groups. This state is fixed to form a pre-retardation layer 26″ (FIG. 14D).

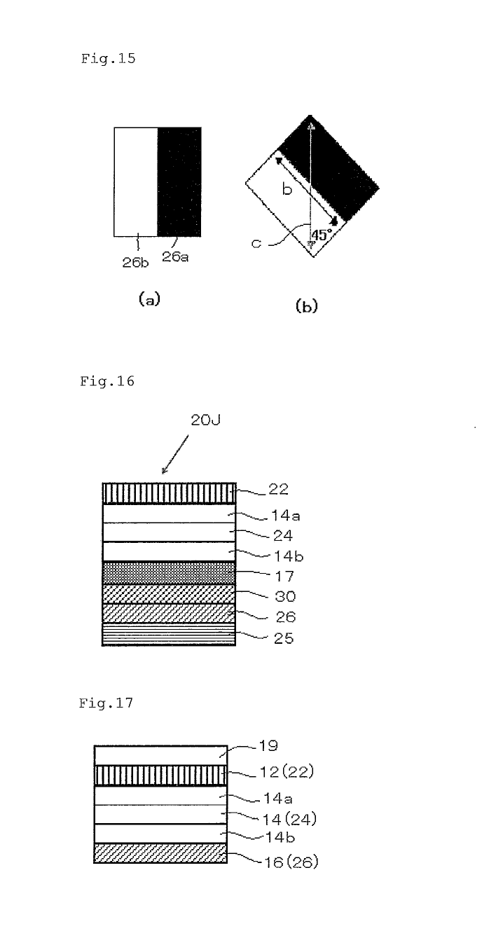

A composition containing a polymerization initiator which can promote the polymerization of the other reactive group is applied onto a surface of the pre-retardation layer 26″ to form a polymerization initiator-supplying layer 30 (FIG. 14E). The polymerization initiator contained in the polymerization initiator-supplying layer 30 can move to the pre-retardation layer 26″ disposed under the polymerization initiator-supplying layer 30. The laminate is irradiated with ultraviolet rays through an exposure mask having a shielding site and a transmissive site corresponding to a first domain 26a and a second domain 26b as illustrated in FIG. 15A, respectively, which enables only the transmissive site to be exposed to light. The exposure to light in the presence of the polymerization initiator which has penetrated from the polymerization initiator-supplying layer 30 promotes the reaction of the other one of the reactive groups contained in the liquid crystal compound at the site exposed to light, so that the molecular alignment state at the transmissive site is strongly fixed. The site exposed to light functions as the second domain 16b in which the molecules of the liquid crystal compound are in a predetermined alignment state and the in-plane retardation of a half wavelength is exhibited. On the other hand, in the liquid crystal compound at the shielding site not exposed to light, the other one of the reactive groups is not allowed to react while the reaction of one of the reactive groups has been promoted by the irradiation with light. Heating the shielding site to a temperature higher than the isotropic phase temperature to promote the reaction of the other one of the reactive groups enables the molecules at the shielding site to be fixed in the state of an isotropic phase, in other words, the first domain exhibiting an in-plane retardation of 0 nm is formed. In this manner, the patterned retardation layer 26 is formed (FIG. 14F).

Another exemplary process flow of forming the patterned retardation layer usable in the second embodiment of the present invention will now be described.

A transparent support 27a is used. A material for an alignment film is applied onto the transparent substrate 27a to form an alignment film 25a. The alignment film 25a may be a rubbed alignment film or a light aligning film. The alignment film 25a is optionally subjected to a treatment to develop alignment-controlling force (e.g., rubbing treatment or irradiation of linearly polarized light), and a coating solution composed of a curable liquid crystal composition containing a rod-like liquid crystal compound subjected to a treatment for horizontal molecular alignment or composed of a curable liquid crystal composition containing a discotic liquid crystal compound subjected to a treatment for orthogonal molecular alignment is applied onto the alignment film 25a to form a coating film 26a′. After the solvent contained in the coating film 26a′ is removed, the molecules in the coating film 26′ are aligned in a predetermined alignment state. The coating film 26a′ is then irradiated with ultraviolet rays through an exposure mask to promote the curing reaction of the irradiated site alone. This state is fixed to form a pre-retardation layer 26″.

The liquid crystal compound at the shielding site not exposed to light is not still cured. The shielding site is heated to a temperature higher than the isotropic phase temperature and then irradiated with ultraviolet rays, which can fix the molecules at the shielding site in the state of an isotropic phase, in other words, the domain exhibiting an in-plane retardation of 0 nm is formed. In this manner, the patterned retardation layer 26a is formed.

The domain exhibiting an in-plane retardation of 0 nm may also be formed by washing away non-cured liquid crystal compound at the shielding site not exposed to light with a solvent which can dissolve the liquid crystal compound (it may be an organic solvent or an aqueous solution, preferred is an alkaline or acidic aqueous solution). The patterned retardation layer 26 can also be formed in this manner.

FIG. 16 is a schematic cross-sectional view illustrating an exemplary printing sheet including the patterned retardation layer 26 formed in this manner according to the present invention. In FIG. 16, the same components as illustrated in FIGS. 3 and 14 are denoted by the same numerals, and repeated description thereof is omitted.

The surface of the polymerization initiator-supplying layer 30, which is included in the laminate formed through the process illustrated in FIGS. 14A to 14F and including the retardation layer 26, is bonded to the surface of the protective layer 14b with an adhesive layer 17 interposed therebetween, and then the support 18′ is separated, so that a printing sheet 20J illustrated in FIG. 16 is formed. The surface of the polymerization initiator-supplying layer 30 is bonded to the surface of the protective layer 14b such that the polarization axis c of the linear polarizing layer 24 and the in-plane axis c of the second domain 26b of the retardation layer 26 define an angle of 45° as illustrated in FIG. 15B.

Other Layers

The printing sheet of the present invention may optionally include other layers. Examples of such layers include a protective layer for protecting the linear polarizing layer and another adhesive layer for adhesion. The distance between an image receiving layer and a retardation layer has an effect on the occurrence of crosstalk or ghost images; hence, in the case where other layers are optionally disposed between the image receiving layer and the retardation layer, such layers preferably have thin thickness. For example, if an adhesive layer or a protective layer is disposed between the retardation layer and the image receiving layer in addition to the linear polarizing layer with an increase in the distance between the retardation layer and the image receiving layer, crosstalk occurs in the case where an image is obliquely observed in the direction not parallel to the boundary of each pattern of the retardation layer. The crosstalk occurring in the oblique observation of images can be reduced by sufficiently decreasing the ratio of the distance d between the retardation layer and the image receiving layer to the distance p between the boundaries of patterns. The ratio of the distance d to the distance p is preferably not more than 3, more preferably not more than 2, further preferably not more than 1, and still further preferably not more than 0.8. An extraordinarily large distance p between the boundaries of patterns causes deterioration of the quality of images. Accordingly, in order to decrease the ratio of the distance d to the distance p while maintaining the small distance p to some extent, the distance d between the retardation layer and the image receiving layer is preferably not more than 2 mm, more preferably not more than 1 mm, further preferably not more than 500 μm, even further preferably not more than 200 μm, and still further preferably not more than 100 μm. The distance d of not more than 20 μm can largely reduce the occurrence of crosstalk even if images are observed in an oblique direction.

In the first embodiment, the patterned quarter-wave plate and the patterned half-wave plate are preferably laminated as described above such that the reverse wavelength dispersion of retardation is exhibited. These layers are laminated such that the slow axis of the patterned quarter-wave plate and the transmission axis of the polarizing layer define an angle of ±15° and such that the slow axis of the patterned half-wave plate and the transmission axis of the polarizing layer define an angle of ±75°, which can provide further ideal circularly polarized light in a broad wavelength region in accordance with the principle disclosed in JP-A-10-68816 to prevent a hue change due to wavelength dispersion.

In another preferred embodiment, the half-wave plate is laminated on the patterned quarter-wave plate. These layers are laminated such that the slow axis of the patterned quarter-wave plate and the transmission axis of the polarizing layer define an angle of ±22.5° and such that the slow axis of the patterned half-wave plate and the transmission axis of the polarizing layer define an angle of 90°, which can provide further ideal circularly polarized light in a broad wavelength region to prevent a hue change due to wavelength dispersion. This configuration exhibits slightly unsatisfactory wavelength characteristics as compared with the configuration described above but can be produced through a simple process because the half-wave plate is not patterned.

A laminate of an increased number of half-wave plates at appropriate angles can further improve wavelength characteristics, but leads to increases in the amount of material and steps necessary for its production, resulting in an increase in production cost and the thickness of the printing sheet. Thus, a preferred embodiment is lamination of only the (patterned) half-wave plate.

In the second embodiment, the patterned half-wave plate is preferably laminated on the quarter-wave plate, so that the laminate can substantially function as a patterned quarter-wave plate. Laminating these layers such that the slow axis of the patterned half-wave plate and the slow axis of the quarter-wave plate define an angle of 45° enables light passing through the printing sheet to be circularly polarized, so that a user wearing circular polarizing glasses can visually observe stereoscopic images without crosstalk even if the user's face is laterally inclined.

In another preferred embodiment, the half-wave plate is laminated on the quarter-wave plate to impart a quarter-wave retardation to linearly polarized light passing through the patterned half-wave plate in a broad wavelength region. These layers are laminated such that the slow axis of the patterned half-wave plate and the slow axis of the half-wave plate define an angle of 15° and such that the slow axis of the patterned half-wave plate and the slow axis of the quarter-wave plate define an angle of 75°, which can provide further ideal circularly polarized light in a broader wavelength region as compared with the configuration described above in accordance with the principle disclosed in JP-A-10-68816 to prevent a hue change due to wavelength dispersion.

A laminate of an increased number of half-wave plates at appropriate angles can further improve wavelength characteristics, but leads to increases in the amount of material and steps necessary for its production, resulting in increases in production cost and the thickness of the printing sheet. Thus, a preferred embodiment is lamination of only the quarter-wave plate or lamination of the half-wave plate and quarter-wave plate.

Production of Printing Sheet

An exemplary manufacturing process of the printing sheet of the present invention will now be described.

The liquid crystal composition containing the dichroic dye is applied onto a surface of a polymer film, and then the molecules of the liquid crystal composition are fixed in a predetermined alignment state to produce a coating-type linear polarizing film. An alignment film is optionally formed on the polymer film, and the linear polarizing layer is formed thereon. Another polymer film may be laminated as a protective layer on the linear polarizing layer.

A photo alignment material is applied on the back surface of the polymer film (the side opposite to the linear polarizing film) to form a film, and then the laminate is subjected to pattern exposure to form a light aligning film having first and second photo alignment domains having alignment axes which define an angle of 90°.

A curable liquid crystal composition containing rod-like liquid crystal is applied onto a surface of the light aligning film, and then the molecules of the rod-like liquid crystal are horizontally aligned depending on the directions of the alignment axes of the first and second photo alignment domains to form a quarter-wave plate having first and second domains having slow axes which define an angle of 90°.

An optically transparent image receiving layer is provided on the surface of the linear polarizing layer, or on the surface of the polymer film if a polymer film is optionally provided as the protective film.

The printing sheet of the present invention can be also produced in the manner described below.

A laminate including a patterned retardation layer is produced through the process illustrated in FIGS. 14A to 14F.

The liquid crystal composition containing the dichroic dye is separately applied onto a surface of a polymer film, and then the molecules of the liquid crystal composition are fixed in a predetermined alignment state to produce a coating-type linear polarizing film. An alignment film is optionally formed on the polymer film, and the linear polarizing layer is formed thereon. Another polymer film may be laminated as a protective layer on the linear polarizing layer.

The back side of the polymer film (the side opposite to the linear polarizing film) is bonded to the exterior surface of the laminate including the patterned retardation layer (surface of the retardation layer or the polymerization initiator-supplying layer) with an adhesive layer interposed therebetween.

An optically transparent image receiving layer is provided on the surface of the linear polarizing layer or on the surface of the polymer film if a polymer film is optionally provided as the protective film.

The printing sheet of the present invention may have any thickness, and the thickness ranges preferably from 10 to 1000 more preferably 20 to 200 μm as in printing sheets generally used.

The printing sheet of the present invention preferably has optical transparency as a whole. In particular, the printing sheet preferably has an optical transparency of not less than 70%, more preferably not less than 80%, and further preferably not less than 90% as a whole.

In addition to the above-mentioned layers, the printing sheet of the present invention may optionally include other functional layers such as an oxygen barrier layer preventing the intrusion of oxygen, a hardcoat layer, and an antiglare layer. Furthermore, a transparent resin-cured layer formed by curing a transparent resin composition may be provided as a protective layer. These layers can, for example, be provided as a protective layer for the linear polarizing layer (in particular, a linear polarizing layer composed of a liquid crystal composition containing a dichroic dye) between the retardation layer and the linear polarizing layer.

### 2. Stereo Picture Print and Method of Manufacturing the Stereo Picture Print

The present invention also relates to a stereo picture print formed of the printing sheet of the invention, and a method of manufacturing the stereo picture print. The method of manufacturing the stereo picture print of the invention is now described.

An embodiment of a method of manufacturing the stereo picture print, which is formed of a printing sheet including an image receiving layer that can receive an image by silver halide photography, includes forming a left-eye image and a right-eye image having parallax by LightJet printing on positions corresponding to a first domain and a second domain, respectively, of a retardation layer of the printing sheet.

Any LightJet recorder is available without limitation in this embodiment. A variety of LightJet recorders can be used that record data with laser light on the basis of digital data.

A second embodiment of the method of manufacturing the stereo picture print of the invention includes overlaying a thermal transfer sheet containing a dye on a light-transmissive image receiving layer of the printing sheet of the invention; and heating the thermal transfer sheet with a thermal head generating heat controlled by electrical signals to form a left-eye image and a right-eye image having parallax onto positions corresponding to a first domain and a second domain, respectively, of the retardation layer of the printing sheet through transfer of the dye.

Any thermal transfer sheet (ink sheet) can be used without limitation in the second embodiment. The thermal transfer sheet typically has a dye layer containing a diffusion transfer dye on a support. Any appropriate ink sheet can be used. The thermal energy can be applied during thermal transfer by any ordinary means. For example, a thermal energy of about 5 to 100 mJ/mm² is applied through control of the recording time of a recorder such as a thermal printer (for example, Video Printer VY-100, available from Hitachi, Ltd), by which the desired end can be attained.

A third embodiment of the method of manufacturing the stereo picture print of the invention includes forming a left-eye image and a right-eye image having parallax onto the light-transmissive image receiving layer of the printing sheet of the invention by inkjetting, the positions of the left-eye image and the right-eye image corresponding to the first domain and the second domain, respectively, of the retardation layer of the printing sheet.

Any inkjet recorder provided with an inkjet head can be used without limitation in the third embodiment.

In an exemplary method of the embodiments, an image data processor digitalizes image data into left-eye image data and right-eye image data having parallax. Examples of the digitalized image data include data of images photographed with a digital camera, more specifically, digital data of images photographed with a digital camera having left and right, photographing lens systems. The image data processor is connected to the LightJet recorder in the first embodiment, the thermal printer in the second embodiment, and the inkjet recorder in the third embodiment, in which the laser drawing, activation of a thermal head, and activation of an inkjet head are controlled, respectively, in response to digital signals transmitted from the image data processor.

In the embodiments, images can be accurately formed in accordance with digital data at a high image density on the image receiving layer by LightJet printing, thermal transfer, or inkjetting; hence a left-eye image and a right-eye image having parallax can be formed onto positions corresponding to the first and second domains, respectively, of the retardation layer of the printing sheet. As a result, a stereo picture print having reduced crosstalk and ghost images can be manufactured.

An observer views the stereo picture print manufactured in accordance with each of the methods of the first and second embodiments through the retardation layer 16 (or 26). Thus, one image at a position corresponding to the first domain 16a (or 26a) is incident on an eye of the observer as a circularly (or linearly) polarized image in a direction determined by the slow axis a, and the other image at a position corresponding to the second domain 16b (or 26b) is incident on the other eye of the observer as a circularly (or linearly) polarized image in a direction determined by the slow axis b. The slow axes a and b are orthogonal to each other. When the observer views the image through circular (or linear) polarization glasses including left and right polarizing lenses, which have axes aligned in correspondence to the slow axes a and b, the circularly (or linearly) polarized images from the first and second domains 16a and 16b (or 26a and 26b) are incident on left and right eyes, respectively. Consequently, the observer perceives a stereo picture.

FIG. 17 illustrates an exemplary schematic sectional view of the stereo picture print of the invention manufactured by the above-described methods. The same components as those in FIG. 5 are designated by the same numerals, and detailed description thereof is omitted.

In the stereo picture print illustrated in FIG. 17, a left-eye image and a right-eye image having parallax are formed in accordance with the method of the first, second, or third embodiment on the image receiving layer 12 (or 22) of the printing sheet 10B (or 20B) in the embodiment illustrated in FIG. 5, and then a reflective layer 19 not cancelling polarized light is laminated on the image receiving layer 12 (or 22). The stereo picture print illustrated in FIG. 17 is in an embodiment where a stereo picture can be observed with reflection of ambient light. In another preferred embodiment of the stereo picture print of the invention, a stereo picture is observed with transmitted light without the laminated reflective layer 19.

The stereo picture print of the invention should not be limited to the above-described embodiments, and appropriate alterations or modifications thereof can be made without departing from the spirit of the invention. For example, as long as the quarter-wave layer 16 or the retardation layer 26 is located on an observer side with respect to the linearly polarizing layer 14 or 14′, the image receiving layer 12 or 22 having small depolarization due to scattering and/or other factors may be located at any position. In contrast, the image receiving layer 12 or 22 having large depolarization should not be located on an observer side with respect to the linearly polarizing layer 14 or 14′.

Reflective Layer:

Preferred examples of the reflective layer not cancelling polarized light usable in the embodiment include paper coated with a metal thin film, a metal thin-film mirror, a metal foil, and a metal flake floated in plastic.

### 3. Method of Displaying Stereo Picture Print

The present invention also relates to a method of displaying a stereo picture print of the invention for an observer. The method of providing a stereo picture of the present invention includes providing a stereo picture print of the invention, and displaying the stereo picture print for an observer wearing a polarizing glass for a left eye and a polarizing glass for a right eye, the polarizing glasses including circularly polarizing lenses reverse to each other or linearly polarizing lenses having orthogonal polarization axes.

The method of the invention can be used for indoor or outdoor advertising of commodities, for example.

The stereo picture print may be irradiated with light from, for example, an illuminator residing on an observer side or a back side in order to display a bright stereo picture print for the observer.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### 1. Example 1-1

### Production of Stereo Picture Printing Sheet

### (Preparation of Protective Layer)

The following composition was put into a mixing tank, and was stirred while being heated to dissolve the components, thereby a cellulose acylate solution A was prepared.

[Composition of Cellulose Acylate Solution A]

| | |
|---|---|
| Cellulose acetate with degree of acetylation of 2.86 | 100 parts by mass |
| Triphenyl phosphate (plasticizer) | 7.8 parts by mass |
| Biphenyl diphenyl phosphate (plasticizer) | 3.9 parts by mass |
| Methylene chloride (first solvent) | 300 parts by mass |
| Methanol (second solvent) | 54 parts by mass |
| 1-Butanol | 11 parts by mass |

The following composition was put into another mixing tank, and was stirred while being heated to dissolve the components, thereby an additive solution B was prepared.

[Composition of Additive Solution B]

| | |
|---|---|
| Compound B1 (Re reducer) | 40 parts by mass |
| Compound B2 | 4 parts by mass |
| (wavelength dispersion control agent) | |
| Methylene chloride (first solvent) | 80 parts by mass |
| Methanol (second solvent) | 20 parts by mass |

Compound B1 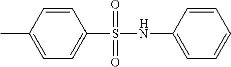 [SMILES: Cc1ccc(S(=O)(=O)Nc2ccccc2)cc1]
Compound B2

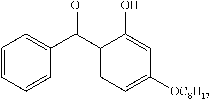

### [Preparation of Cellulose Acetate Protective Film]

To 477 parts by mass of the cellulose acylate solution A was added 40 parts by mass of the additive solution B. The mixture was then sufficiently stirred to prepare a dope. The dope was casted from a cast port onto a drum cooled at 0° C. The cast film was peeled at a solvent content of 70 mass %. The film was then fixed at its two lateral ends with a pin tenter as illustrated in FIG. 3 of JP-A-4-1009, and was dried at a constant width allowing a draw rate of 3% in a lateral direction (a direction perpendicular to a machine direction) at a solvent content of 3 to 5 mass %. The film was then conveyed through rolls of heat treatment equipment to be further dried, so that a cellulose acetate protective film 60 μm in thickness was prepared. The front Re of the protective film was 2.0 nm.

(Preparation of Linearly Polarizing Layer)

The cellulose acetate protective film was immersed in 1.5 N sodium hydroxide solution at 55° C. for 2 min. The film was then washed in a rinsing bath at room temperature, and was then neutralized with 0.1 N sulfuric acid at 30° C. The film was washed in a rinsing bath at room temperature again, and was further dried in hot air at 100° C. In this way, the surface of the cellulose acylate protective film was saponified.

A rolled polyvinyl alcohol film 80 μm in thickness was then continuously stretched to five times its original length in an iodine solution, and was then dried to prepare a linearly polarizing film. Two alkali-saponified, cellulose acylate protective films were bonded to two sides of the linearly polarizing film with an aqueous 3% polyvinyl alcohol (PVA-117H, available from Kuraray Co., Ltd.) solution as an adhesive agent, resulting in a linearly polarizing layer having two sides protected by the cellulose acylate protective film. Here, the cellulose acylate protective film on either side had a slow axis parallel to the transmission axis of the linearly polarizing film.

(Preparation of Quarter-Wave Layer)

### [Preparation of Light Aligning Film]

Aqueous solution of light aligning material E-1 (1%) having the following structure was applied by spin coating on the surface of the protective film for the linearly polarizing layer, and was dried at 100° C. for 1 min. The coating was irradiated with ultraviolet rays with an air-cooled metal halide lamp (available from Eye Graphics Co., Ltd.) at 160 W/cm in air. In this exposure, as illustrated in FIG. 13A, a wire grid polarizer (ProFlux PPL02, available from Moxtek, Inc.) was disposed in direction 1, and exposed through a mask A (a quartz exposure mask having an image pattern). In the subsequent exposure, as illustrated in FIG. 13B, the wire grid polarizer was disposed in direction 2, and exposed through a mask B. The distance between the surface of the exposure mask and the light aligning film was set to 200 μm. The ultraviolet rays had an illuminance of 100 mW/cm² and an irradiance of 1000 mJ/cm² in the UV-A region (integration of wavelength 380 to 320 nm).

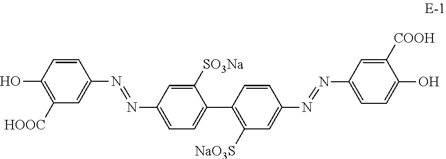

### [Preparation of Quarter-Wave Layer]

The following composition for a quarter-wave layer was prepared, and was then passed through a polypropylene filter having a pore size of 0.2 μm to yield a coating solution for a quarter-wave layer. The coating solution was applied, and dried for 2 min at a surface temperature of 105° C. into a liquid crystal phase. The coating was then cooled to 75° C. at which the liquid crystal was irradiated with ultraviolet rays with an air-cooled metal halide lamp (available from Eye Graphics Co., Ltd.) at 160 W/cm in air, so that the aligned liquid crystal was fixed. As a result, a quarter-wave layer 1.3 μm thickness, which was patterned to have slow axes defining ±45° with respect to the polarization axis of the linearly polarizing layer, was prepared. The quarter-wave layer had a tilt angle of substantially 1°, an Re of 138 nm, and an Rth of 13 nm in combination with the protective layer at a wavelength of 550 nm.

[Composition for Quarter-Wave Layer]

| | | |
|---|---|---|
| Rod-like liquid crystal I-27 | 100 | parts by mass |
| Horizontal alignment agent A | 0.3 | parts by mass |
| Photopolymerization initiator | 3.3 | parts by mass |
| (Irgacure 907, available from Ciba Specialty Chemicals Inc.) | | |
| Sensitizer | 1.1 | parts by mass |
| (KAYACURE-DETX, available from NIPPON KAYAKU Co., Ltd.) | | |
| Methyl ethyl ketone | 300 | parts by mass |

Rod-like liquid crystal I-27 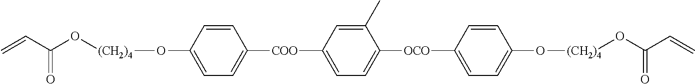
Horizontal alignment agent A

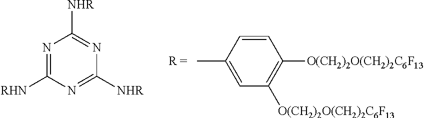

### (Production of Stereo Picture Printing Sheet)

### [Preparation of Image Receiving Layer]

The surface of the cellulose acetate protective film on a side opposite to the quarter-wave layer of the linearly polarizing layer was subjected to corona discharge treatment, and then a gelatinous undercoat layer containing sodium dodecylbenzenesulfonate was provided on the surface. An intermediate layer A having the following composition was formed on the gelatinous undercoat layer through bar coating and drying. A receiving layer A having the following composition was then formed on the intermediate layer A through bar coating and drying. The bar coating was performed at 40° C., and drying was performed at 50° C. for 16 hr for each layer. The coating density was 1.0 g/m² in the dried intermediate layer A and 3.0 g/m² in the dried receiving layer A.

[Intermediate Layer A]

| | |
|---|---|
| Polyester resin (Biron 200, available from Toyobo | 10 parts by mass |
| Co., Ltd.) | |
| Fluorescent brightener (Uvitex OB, available | 1 parts by mass |
| from Ciba Specialty Chemicals Inc.) | |
| Titanium oxide | 30 parts by mass |
| Methyl ethyl ketone/toluene (mass ratio 1/1) | 90 parts by mass |

### [Receiving Layer A]

| | |
|---|---|
| Polyester resin | 100 parts by mass |
| (resin described in Example 1-1 | |
| in JP-A-2-265789) | |
| Amino-modified silicone | 5 parts by mass |
| (X-22-3050C, available from | |
| Shin-Etsu Chemical Co., Ltd.) | |
| Epoxy-modified silicone | 5 parts by mass |
| (X-22-300E, available from | |
| Shin-Etsu Chemical Co., Ltd.) | |
| Methyl ethyl ketone/toluene | 400 parts by mass |
| (1/1 in mass ratio) | |

### (Stereo Picture Printing Sheet)

In this way, a stereo picture printing sheet was produced, which had a configuration similar to that illustrated in FIG. 6 except that the image receiving layer 12 was a laminate of the intermediate layer A and the receiving layer A, and the intermediate layer A was disposed adjacent to the protective layer 14a. With the stereo picture printing sheet, the cellulose acetate protective films (14a and 14b) were laminated on both sides of the linearly polarizing layer 14, the light aligning film 15 and the patterned quarter-wave layer 16 were laminated on a viewing side, and the image receiving layer 12 as the laminate of the intermediate layer A and the receiving layer A was disposed on a side opposite to the viewing side.

(Preparation of Stereo Picture Ink Sheet)

A polyester film (LUMIRROR, available from Toray Industries, Inc.) 6.0 μm in thickness was used as a base film. A heatproof slip layer 1 μm in thickness was provided on the back of the film, and yellow, magenta, and cyan compositions each having the following components were separately applied onto the surface of the film at a coating density at a dried state of 1 g/m².

Yellow Composition

| | |
|---|---|
| Dye (Macrolex Yellow 6G, availablefrom Bayer Ltd.) | 5.5 parts by mass |
| Polyvinyl butyral resin | 4.5 parts by mass |
| (Eslec BX-1 available from Sekisui Chemical Co., Ltd.) | |
| Methyl ethyl ketone/toluene (1/1 in mass ratio) | 90 parts by mass |

### Magenta Composition

| | |
|---|---|
| Magenta dye (Disperse Red 60) | 5.5 parts by mass |
| Polyvinyl butyral resin | 4.5 parts by mass |
| (Eslec BX-1 available from ) | |
| Sekisui Chemical Co., Ltd. | |
| Methyl ethyl ketone/toluene | 90 parts by mass |
| (1/1 in mass ratio) | |

### Cyan Composition

| | |
|---|---|
| Cyan dye (Solvent Blue 63) | 5.5 parts by mass |
| Polyvinyl butyral resin | 4.5 parts by mass |
| (Eslec BX-1 available from Sekisui Chemical Co., Ltd.) | |
| Methyl ethyl ketone/toluene (1/1 in mass ratio) | 90 parts by mass |

### [Production of Stereo Picture Print]

### (Formation of Right-Eye and Left-Eye Images)

The ink sheet and the printing sheet were shaped into a loadable form for a sublimation printer, DPB1500, available from Nidec Copal Corporation. Images were then output in a high-speed printing mode through pixel formation where each right-eye pixel was formed at a position corresponding to each right-eye region of the quarter-wave layer, and each left-eye pixel was formed at a position corresponding to each left-eye region thereof, so that a stereo picture print was produced.

[Observation of Stereo Picture]

An observer viewed the stereo picture print through circular polarization glasses and perceived a clear stereo picture without crosstalk and ghost images. The polarization glasses were composed of a left-eye circular polarization filter and a right-eye circular polarization filter, each filter including a laminate of a linear polarization filter and a quarter-wave retardation film, where the polarization axis of the linear polarization filter defined an angle of 45° with respect to the slow axis of the quarter-wave retardation film, and the polarization axes of the linear polarization filters for left and right eyes were orthogonal to each other.

### 2. Example 1-2

### [Production of Stereo Picture Printing Sheet]

### (Preparation of Image Receiving Layer)

The surface of the protective layer for the linearly polarizing layer prepared in Example 1-1 was subjected to corona discharge treatment, and then the following dispersion for forming an image receiving layer and PAC liquid were in-line mixed into coating densities of 183 g/m² and 11.4 g/m², respectively, and then the mixture was applied onto the surface of the protective layer with an extrusion die coater. The coating was then treated in a cold-wind dryer at 5° C. and 30% RH (wind velocity 3 to 8 m/sec) for 5 min, and was then dried therein with dry wind at 25° C. and 25% RH (wind velocity 3 to 8 m/sec) for 20 min. Consequently, an image receiving layer having a dried thickness of 30 μm was formed on the protective layer.

[Dispersion for Forming Image Receiving Layer]

According to the following composition of “silica dispersion”, fine silica particles were mixed with a dimethyl diallyl ammonium chloride polymer (SHAROLL DC902P) in deionized water, and then ZIRCOZOL ZA-30 was added to the mixture to form slurry. The slurry was dispersed by Altimizer available from Sugino Machinery Industries at 170 MPa to yield a silica dispersion having a median size (average particle size) of 120 nm.

According to the composition of the “dispersion for image receiving layer”, deionized water, a 7.5% boric acid solution, SC-505, a polyvinyl alcohol solution, and SUPERFLEX 650-5 were sequentially mixed into the above-described silica dispersion to yield a dispersion for image receiving layer.

### [Silica Dispersion]

| | | |
|---|---|---|
| (1) | Fine gas-phase silica particles | 15.0 parts by mass |
| | (AEROSIL300SF75, available from Japan Aerosil Co., Ltd.) | |
| (2) | Deionized water | 82.9 parts by mass |
| (3) | SHAROLL DC-902P (51.5% solution) | 1.31 parts by mass |
| | (dispersant available from Dai-ichi Kogyo Seiyaku Co., Ltd.) | |
| (4) | Zirconyl acetate | 0.81 parts by mass |
| | (ZIRCOZOL ZA-30 (50% solution), available from Daiichi Kigenso | |
| | Kagaku-Kogyo Co., Ltd.) | |

### [Dispersion for Forming Image Receiving Layer]

| | |
|---|---|
| (1) Silica dispersion | 59.5 parts by mass |
| (2) Deionized water | 7.8 parts by mass |
| (3) 7.5% boric acid solution (crosslinking agent) | 4.4 parts by mass |
| (4) Dimethylamine-epichlorohydrin-polyalkylene | 0.1 parts by mass |
| polyamine polycondensate (50% solution) | |
| (SC-505, available from Hymo Co, Ltd. ) | |
| (5) Polyvinyl alcohol solution | 26.0 parts by mass |
| (6) Cationically-modified polyurethane | 2.2 parts by mass |
| (SUPERFLEX 650-5 (25% liquid), available from | |
| DAI-CHI KOGYO SEIYAKU Co, Ltd.) | |

### [Polyvinyl Alcohol Solution]

| | | |
|---|---|---|
| (1) | Polyvinyl alcohol | 6.96 parts by mass |
| | (JM-33, available from Japan Vam & Poval Co., Ltd., degree of | |
| | saponification: 94.3 mol %, degree of polymerization: 3300) | |
| (2) | Polyoxyethylene lauryl ether | 0.23 parts by mass |
| | (surfactant EMULGEN 109P, available from Kao Corporation) | |
| (3) | Diethylene glycol monobutyl ether | 2.12 parts by mass |
| | (Butycenol 20P, available from Kyowa Hakko Chemicals Co., Ltd.) | |
| (4) | Deionized water | 90.69 parts by mass |

### [PAC Liquid]

| | | |
|---|---|---|
| (1) | Polyaluminum chloride solution | 20 parts by mass |
| | having a basicity of 83% | |
| | (ALFINE 83, available from Taimei | |
| | Chemical Co., Ltd.) | |
| (2) | Deionized water | 80 parts by mass |

In this way, a stereo picture printing sheet having the configuration illustrated in FIG. 6 was produced. With the stereo picture printing sheet, the cellulose acetate protective films (14a and 14b) were laminated on both sides of the linearly polarizing layer 14, the light aligning film 15 and the patterned quarter-wave layer 16 were laminated on a viewing side, and the image receiving layer 12 composed of the composition containing the inorganic fine particles and the water-soluble polymer was disposed on a side opposite to the viewing side.

[Production of Stereo Picture Print]

Right-eye data and left-eye data photographed with a digital camera having left and right, photographing lens systems were converted to digital data. Inkjet ink drops were then deposited onto the image receiving layer of the stereo picture printing sheet with a piezoelectric inkjet head, so that right-eye pixels and left-eye pixels were formed. Images were output through pixel formation where each right-eye pixel was formed at a position corresponding to each right-eye region of the quarter-wave layer, and each left-eye pixel was formed at a position corresponding to each left-eye region thereof.

[Observation of Stereo Picture]

An observer viewed the stereo picture print through circular polarization glasses and perceived a clear stereo picture without crosstalk and ghost images.

### 3. Example 1-3

### Production of Stereo Picture Printing Sheet

### (Preparation of Linearly Polarizing Layer)

An aqueous 4% polyvinyl alcohol (PVA-103, available from Kuraray Co., Ltd.) solution was applied onto the surface of the protective layer prepared in Example 1-1 with a #12 bar and dried at 80° C. for 5 min. The coating was then reciprocally rubbed three times at 400 rpm to yield a protective layer with a rubbing alignment film.

Yellow azo dye A2-3 (0.24 parts by mass, a compound represented by general formula (II)) having the following structure, 0.33 parts by mass of magenta azo dye A-46 (a compound represented by general formula (I)) having the following structure, 0.37 parts by mass of cyan azo dye A3-1 (a compound represented by general formula (III)) having the following structure, and 0.06 parts by mass of squarylium dye VI-5 having the following structure were mixed in 99 parts by mass of chloroform, and were stirred to be dissolved in the chloroform. The solution was then filtered to prepare a coating solution for a linearly polarizing layer. The coating solution was then applied onto the rubbing alignment film, and was spontaneously dried at room temperature to give a linearly polarizing layer. The linearly polarizing layer had a thickness of 0.4 μm and a dichroic ratio of 42. The composition for the linearly polarizing layer had a thermotropic liquid crystallinity having an isotropic phase transition temperature of 240° C.

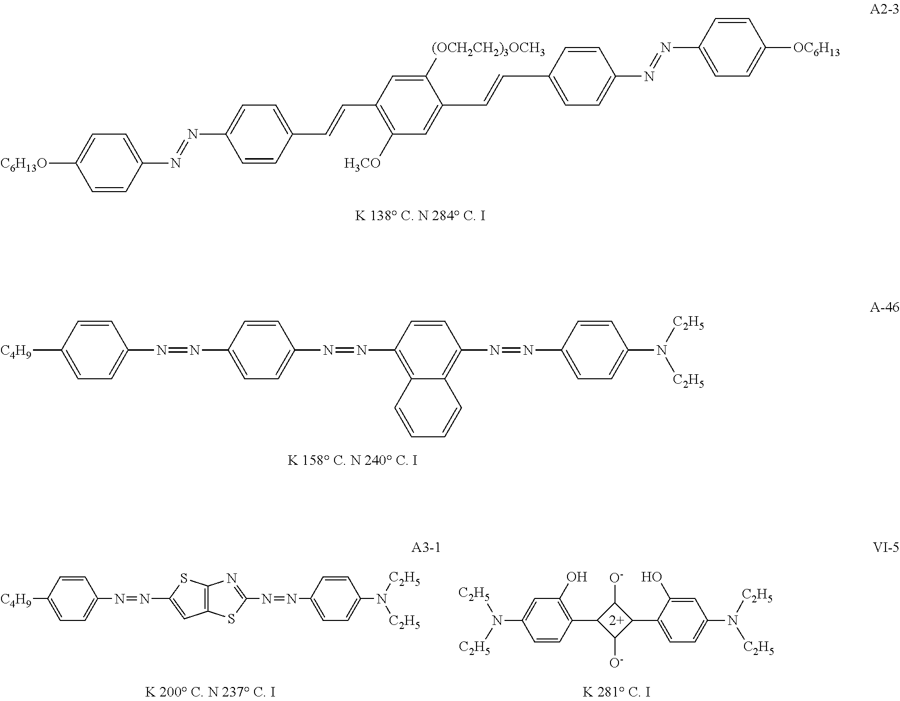

(Preparation of Coating Solution for Oxygen Insulation Layer)

The following composition was put into a mixing tank, and was stirred to prepare a coating solution for an oxygen insulation layer.

Polyvinyl alcohol (3.2 parts by mass, PVA-205, available from Kuraray Co., Ltd.), 1.5 parts by mass of polyvinylpyrrolidone (PVP K-30, available from Nippon Shokubai Co., Ltd.), 44 parts by mass of methanol, and 56 parts by mass of water were mixed and stirred. The mixture was passed through a polypropylene filter having a pore size of 0.4 μm to prepare the coating solution for an oxygen insulation layer.

(Preparation of Oxygen Insulation Layer)

The coating solution for an oxygen insulation layer was applied onto the above-described linearly polarizing layer and dried at 100° C. for 2 min to yield an oxygen insulation layer. The oxygen insulation layer had a thickness of 1 μm and a front Re of 0 nm.

(Preparation of Coating Solution for Transparent Resin Hardening Layer)

The following composition was put into a mixing tank, and was stirred to prepare a coating solution for a transparent resin hardening layer.

Poly(glycidyl methacrylate) having a mass-average molecular weight of 15000 (2.7 parts by mass), 7.3 parts by mass of methyl ethyl ketone, 5.0 parts by mass of cyclohexanone, and 0.5 parts by mass of photopolymerization initiator (Irgacure 184, available from Ciba Specialty Chemicals Inc.) were mixed in 7.5 parts by mass of trimethylolpropane tri-acrylate (Biscoat #295 available from Osaka Organic Chemical Industry, Ltd.), and the mixture was then stirred. The mixture was then passed through a polypropylene filter having a pore size of 0.4 μm to prepare the coating solution for a transparent resin hardening layer.

(Preparation of Transparent Resin Hardening Layer)

The coating solution for a transparent resin hardening layer was applied onto the above-described oxygen insulation layer and dried at 100° C. for 2 min. The coating was then polymerized by 5-J ultraviolet rays under a nitrogen atmosphere (oxygen concentration: 100 ppm or less), resulting in the formation of a laminate of the oxygen insulation layer 1 μm in thickness and the transparent resin hardening layer 2 μm in thickness which were sequentially laminated on the surface of the linearly polarizing layer 0.4 μm in thickness. The transparent resin hardening layer had a front Re of 0 nm.

(Preparation of Quarter-Wave Layer)

A quarter-wave layer was formed on the transparent resin hardening layer as in Example 1-1.

(Preparation of Image Receiving Layer)

An image receiving layer was formed on the surface of the protective layer on a side opposite to the linearly polarizing layer as in Example 1-2.

(Production of Stereo Picture Printing Sheet)

In this way, a stereo picture printing sheet having the configuration illustrated in FIG. 6 was produced, where the alignment film was disposed between the protective layer 14a and the linearly polarizing layer and the protective layer 14b was a laminate of the oxygen insulation layer and the transparent resin hardening layer. With the stereo picture printing sheet, the cellulose acetate protective film (14a) provided with the alignment film was disposed on one surface while the laminate (14b) of the oxygen insulation layer and the transparent resin hardening layer was disposed on the other surface of the coating-type linearly polarizing layer 12; and the light aligning film 15 and the patterned quarter-wave layer 16 were laminated on a viewing side while the image receiving layer 12 composed of a composition containing the inorganic fine particles and the water-soluble polymer was disposed on a side opposite to the viewing side.

[Production of Stereo Picture Print]

Right-eye pixels and left-eye pixels were formed as in Example 1-2.

After image formation, an aluminum reflective layer was laminated on the image receiving layer to yield a stereo picture print similar to that illustrated in FIG. 17.

[Observation of Stereo Picture]

An observer viewed the stereo picture print through circular polarization glasses and perceived a clear stereo picture without crosstalk and ghost images.

### 4. Example 1-4

### Production of Stereo Picture Print

A stereo picture print was produced as in Example 1-1 except that the additive B1 (Re reducer) and the additive B2 (wavelength dispersion control agent) were omitted from the additive solution B for preparation of the protective layer. The protective layer (cellulose acetate protective film) had a thickness of 200 μm, an Re value of 15 nm, and an Rth of 85 nm at 550 nm.

[Observation of Stereo Picture]

An observer viewed the stereo picture print through polarization glasses and perceived a stereo picture with some ghost images caused by the high Re of the protective layer.

### 5. Example 1-5

### Production of Stereo Picture Print

A stereo picture print was prepared as in Example 1-3 except that the aluminum reflective layer was not provided.

[Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the quarter-wave layer (the direction of the polarization axis c illustrated in FIG. 2), through circular polarization glasses, and perceived a stereo picture with slight crosstalk.

The observer also viewed the stereo picture print in Example 1-1 tilted in the same way, and did not perceive a stereo picture due to noticeable crosstalk in the print.

The coating-type polarizing film can exhibit a polarizing function despite its small thickness; hence, the stereo picture print in Example 1-1 may have a short distance of about 60 μm between the quarter-wave layer and the image receiving layer. In contrast, the stereo picture print in Example 1-1 has a stretched iodine polarizing film that is thick compared with the coating-type polarizing film. As a result, the stereo picture print has a relatively large distance of about 140 μm between the quarter-wave layer and the image receiving layer, leading to large parallax in the tilted stereo picture print, which may be a cause of the noticeable crosstalk.

### 6. Example 1-6

### Production of Stereo Picture Print

A stereo picture print was prepared as in Example 1-3 except that the composition for the linearly polarizing layer for preparation of the linearly polarizing layer was modified to the following composition. The linearly polarizing layer had a thickness of 0.4 μm and a dichroic ratio of 37.

[Composition for Linearly Polarizing Layer]

| | |
|---|---|
| (1) Yellow azo dye A2-3 | 0.2 parts by mass |
| (2) Magenta azo dye C-9 | 0.4 parts by mass |
| (3) Cyan azo dye A3-1 | 0.4 parts by mass |
| (4) Chloroform | 99 parts by mass |

C-9 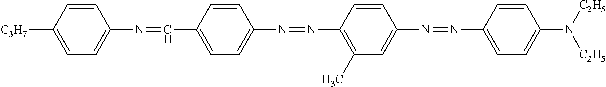
K 167° C. N 288° C. I

[Observation of Stereo Picture]

An observer viewed the stereo picture print through circular polarization glasses and perceived a clear stereo picture without crosstalk and ghost images.

### 7. Example 1-7

### Production of Stereo Picture Print

A stereo picture print was prepared as in Example 1-3 except that the composition for the linearly polarizing layer for preparation of the linearly polarizing layer was modified to the following composition. The linearly polarizing layer had a thickness of 0.8 μm and a dichroic ratio of 71.

[Composition for Linearly Polarizing Layer]

| | |
|---|---|
| (1) Magenta azo dye A-16 | 1.2 parts by mass |
| (2) Magenta azo dye B-4 | 0.8 parts by mass |
| (3) Chloroform | 98 parts by mass |

A-16 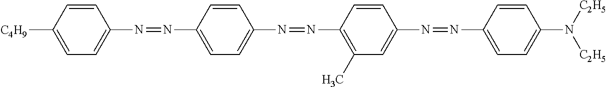
K 137° C. N 266° C. I
B-4 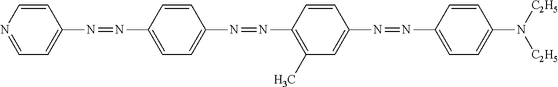 [SMILES: CCN(CC)c1ccc(N=Nc2ccc(N=Nc3ccc(N=Nc4ccncc4)cc3)c(C)c2)cc1]
K 235° C. N 240° C. I

[Observation of Stereo Picture]

An observer viewed the stereo picture print through circular polarization glasses and perceived a clear stereo picture without crosstalk and ghost images.

### 8. Example 1-8

A light aligning film and a quarter-wave layer were sequentially formed on the surface of the protective layer prepared in Example 1-1 as in Example 1-1. The quarter-wave layer had orthogonal slow axes, a tilt angle of substantially 1°, an Re of 138 nm, and a total Rth of 13 nm in combination with the protective layer at a wavelength of 550 nm. The thickness of the quarter-wave layer was 1.3 μm.

An aqueous 4% polyvinyl alcohol (PVA-103, available from Kuraray Co., Ltd.) solution was then applied onto the surface of the quarter-wave layer with a #12 bar and dried at 80° C. for 5 min. The coating was then reciprocally rubbed three times at 400 rpm in a direction defining ±45° with respect to the slow axes of the quarter-wave layer, so that a quarter-wave layer with a rubbing alignment film was prepared.

The coating solution for the linearly polarizing layer prepared in Example 1-3 was then applied onto the rubbing alignment film, and was then spontaneously dried at room temperature to give a linearly polarizing layer. The linearly polarizing layer had a thickness of 0.4 μm and a dichroic ratio of 42. The quarter-wave layer was patterned to have slow axes defining ±45° with respect to the polarization axis of the linearly polarizing layer.

The oxygen insulation layer and the transparent resin hardening layer were then sequentially formed onto the linearly polarizing layer as in Example 1-3. The thicknesses of the oxygen insulation layer and the transparent resin hardening layer were 1 μm and 2 μm, respectively. Each layer had a front Re of 0 nm.

An image receiving layer was formed on the surface of the transparent resin hardening layer, and then a stereo picture print was produced as in Example 1-3. The aluminum reflective layer was not formed.

[Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the patterned retardation layer (the direction of the polarization axis c illustrated in FIG. 2), through circular polarization glasses, and perceived a clear stereo picture with substantially no crosstalk.

The stereo picture print has the coating-type polarizing film that can exhibit a polarizing function despite its small thickness, and has an extremely short distance of about 5 μm or less between the patterned retardation layer and the image receiving layer, which may be a cause of the substantially no crosstalk.

### 9. Example 1-9

### Preparation of Stereo Picture Receiving Film

### (Preparation of Image Receiving Layer)

Among the following components, (1) fine precipitated silica particles, (2) deionized water, (3) “SHAROLL DC902P”, and (4) “ZA-30” were mixed. The mixture was then dispersed with an ultrasonic disperser (available from SMT Co., Ltd.), and the dispersion was held at 45° C. for 20 hr. After that, (5) boric acid, (6) polyvinyl alcohol solution, (7) SUPERFLEX 650, and (8) ethanol were mixed in the dispersion at 30° C. to give an image-receiving-layer coating solution A.

[Composition of Image-Receiving-Layer Coating Solution A]

| | | |
|---|---|---|
| (1) | Fine precipitated silica particles (inorganic fine particles) | 10.0 parts |
| | (mixture of P-78A (particle size 7.7 μm) and P-604 (particle size | |
| | 0.64 μm) (available from MIZUSAWA INDUSTRIAL CHEMICALS, | |
| | LTD) in a mass ratio of 75/25, hereinafter referred to as fine silica | |
| | particles) | |
| (2) | deionized water | 62.8 parts |
| (3) | SHAROLL DC-902P (51.5% aqueous solution) | 0.87 parts |
| | (dispersant, available from Dai-ichi Kogyo Seiyaku Co., Ltd.) | |
| (4) | ZA-30 (zirconyl acetate) | 0.54 parts |
| | (available from Daiichi Kigenso Kagaku-Kogyo Co., Ltd.) | |
| (5) | Boric acid (crosslinking agent) | 0.44 parts |
| (6) | Polyvinyl alcohol (water-soluble resin) solution | 34.9 parts |
| | Composition | |
| | PVA-235 | 2.43 parts |
| | (available from Kuraray Co., Ltd., degree of saponification: 88%, | |
| | degree of polymerization: 3500) | |
| | Polyoxyethylene lauryl ether | 0.08 parts |
| | (EMULGEN 109P (10% aqueous solution), surfactant with HLB value of | |
| | 13.6, available from Kao Corporation) | |
| | Diethylene glycol monobutyl ether | 0.74 parts |
| | (Butycenol 20P, available from Kyowa Hakko Chemicals Co., Ltd.) | |
| | Deionized water | 31.0 parts |
| (7) | SUPERFLEX 650 (25% aqueous dispersion) | 2.47 parts |
| | (available from DAI-CHI KOGYO SEIYAKU Co, Ltd.) | |
| (8) | Ethanol | 1.3 parts |

The image-receiving-layer coating solution A was applied onto a gelatinous-undercoated surface of a biaxially-drawn polyethylene terephthalate film 175 μM in thickness at a coating density of 204 mL/m². Immediately before the application, 8 mass % of polyaluminum chloride solution (ALFINE 83, available from Taimei Chemical Co., Ltd.) was mixed in the image-receiving-layer coating solution A at a coating density of 12.0 mL/m².

The film formed by coating was dried with a hot-wind dryer at 80° C. (wind velocity: 3 to 8 m/sec) until the content of the solid content of the film reached 20%. During this process, the film exhibited constant-rate drying. The film was immersed in a basic solution C having the following composition for 3 sec before exhibiting decreasing drying, so that 13 g/m² of the basic solution was deposited on the film. The film was further dried at 80° C. for 10 min. In this way, a stereo picture receiving film having a dried thickness of 33 μm was prepared.

[Composition of Basic Solution C]

| | | |
|---|---|---|
| (1) | Boric acid | 0.65 parts |
| (2) | Ammonium zirconium carbonate | 2.5 parts |
| | (ZIRCOZOL AC-7 (28% aqueous solution), available from | |
| | Daiichi Kigenso Kagaku-Kogyo Co., Ltd.) | |
| (3) | Ammonium carbonate | 3.5 parts |
| | (first grade, available from Kanto Chemical Co., Ltd) | |
| (4) | Deionized water | 63.3 parts |
| (5) | Polyoxyethylene lauryl ether (surfactant) | 30.0 parts |
| | (EMULGEN 109P (2% aqueous solution), HLB value: 13.6, | |
| | available from Kao Corporation) | |

### [Printing on Stereo Picture Receiving Film]

Right-eye data and left-eye data photographed with a digital camera having left and right, photographing lens systems were converted to digital data. Inkjet ink drops were then deposited onto the image receiving layer of the above-described stereo picture printing sheet with a piezoelectric inkjet head, so that right-eye pixels and left-eye pixels were formed. Images were output in the form of horizontal stripes of the right-eye pixels and the left-eye pixels alternated every 254 μm.

### [Production of Stereo Picture Print]

### [Preparation of Quarter-Wave Layer]

An aqueous 4% polyvinyl alcohol (“PVA-103”, available from Kuraray Co., Ltd.) solution was applied onto the surface of the cellulose acetate protective film prepared in Example 1-1 with a #12 bar, and was dried at 80° C. for 5 min. The coating was then rubbed reciprocally in one direction one time at 400 rpm to yield a transparent support with a rubbing alignment film.

The following composition for a quarter-wave layer was prepared, and was then passed through a polypropylene filter having a pore size of 0.2 μm to yield a coating solution for a quarter-wave layer. The coating solution was applied onto the rubbing alignment film, and was dried for 1 min at a surface temperature of 80° C. to uniformly align the liquid crystal phase. The coating was then cooled to room temperature. A mask having a horizontal stripe width of 254 μm was then disposed on a substrate on which the coating solution for a quarter-wave layer was applied, and the coating was irradiated with ultraviolet rays for 5 sec with an air-cooled metal halide lamp (available from Eye Graphics Co., Ltd.) at 20 mW/cm² in air, so that the aligned liquid crystal was fixed, resulting in the formation of a first retardation region. The coating was then heated to a surface temperature of 140° C. so that the liquid crystal was temporarily changed into an isotropic phase, and was then cooled to 100° C. at which the coating was then held for 1 min to uniformly align the liquid crystal. The coating was then cooled to room temperature. The entire surface of the coating was then irradiated with ultraviolet rays at 20 mW/cm² for 20 sec, so that the aligned liquid crystal was fixed, resulting in the formation of a second retardation region. In this way, a patterned quarter-wave layer having orthogonal slow axes was prepared. The quarter-wave layer had a thickness of 0.8 μm, a tilt angle of substantially 90°, an Re of 138 nm, and a total Rth of −36 nm in combination with the protective layer at a wavelength of 550 nm.

### [Composition for Quarter-Wave Layer]

| | | |
|---|---|---|
| Discotic liquid crystal E-1 | 100 | parts by mass |
| Alignment-film-interface alignment agent (II-1) | 1.0 | parts by mass |
| Air-interface alignment agent (P-1) | 0.4 | parts by mass |
| Photopolymerization initiator | 3.0 | parts by mass |
| (Irgacure 907, available from Ciba Specialty Chemicals Inc.) | | |
| Sensitizer | 1.0 | parts by mass |
| (KAYACURE DETX, available from NIPPON KAYAKU Co., Ltd.) | | |
| Methyl ethyl ketone | 300 | parts by mass |

Discotic liquid crystal E-1 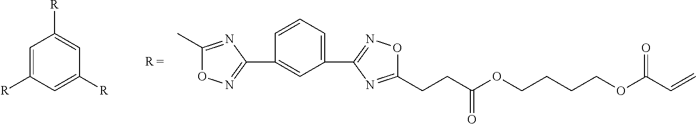
Alignment-film-interface alignment agent (II-1) 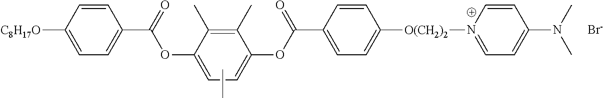
Air-interface alignment agent (P-1) 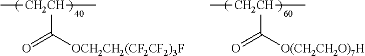
Mw. 39000

### [Preparation of Linearly Polarizing Layer]

A polyvinyl alcohol film 80 μm in thickness was stretched to five times its original length in an iodine aqueous solution, and was then dried to yield a linearly polarizing layer 30 μm in thickness.

[Lamination of Patterned Quarter-Wave Layer and Linearly Polarizing Layer]

The linearly polarizing layer was bonded to a quarter-wave layer side of the patterned quarter-wave layer with an adhesive agent. The alkali-saponified, cellulose acetate protective film prepared in Example 1-1 was then bonded to the other side of the linearly polarizing layer with an adhesive agent, resulting in lamination of the patterned quarter-wave layer and the linearly polarizing layer. Here, the polarization axis of the linearly polarizing layer defined an angle of ±45° with respect to the slow axes of the patterned quarter-wave layer. The thickness of the adhesive agent layer was 16 μm.

### [Lamination of Linearly Polarizing Layer and Stereo Picture Receiving Film]

The linearly polarizing layer with the patterned quarter-wave layer prepared as described above was bonded to the stereo picture receiving film with an adhesive agent. Here, the stripes of the patterned quarter-wave layer were aligned with the stripes printed on the stereo picture receiving film. The thickness of the adhesive agent layer was 16 μm.

In this way, a stereo picture print having a configuration similar to that illustrated in FIG. 8 was produced.

### [Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the patterned retardation layer (the direction of the polarization axis c illustrated in FIG. 2), through circular polarization glasses, and perceived a clear stereo picture with substantially no crosstalk.

The stereo picture print has a distance d of 122 μm between the patterned retardation layer and the image receiving layer, and a pattern width p of 254 μm, namely, has a relatively small d/p of 0.48, which may be a cause of the no crosstalk.

### 10. Example 1-10

### Preparation of Stereo Picture Receiving Film

A stereo picture receiving film was prepared, and data were printed on the stereo picture receiving film, as in Example 1-9.

### [Production of Stereo Picture Print]

### [Preparation of Quarter-Wave Layer]

### (1) Preparation of Parallel Alignment Film (First Alignment Film)

A solution of 4% polyvinyl alcohol “PVA-103” available from Kuraray Co., Ltd., (a liquid of 4.0 g of PVA-103 dissolved in 72 g of water and 24 g of methanol, viscosity 4.35 cp, surface tension 44.8 dyne) in water/methanol was applied onto the surface of the cellulose acetate protective film prepared in Example 1-1 with a #12 bar, and was dried at 80° C. for 5 min.

### (2) Preparation of Patterned Orthogonal Alignment Film (Second Alignment Film)

Polyacrylic acid (2.0 g, Mw: 25000) (available from Wako Pure Chemical Industries, Ltd.) was dissolved in a mixed solvent triethylamine (2.52 g), water (1.12 g), propanol (5.09 g), and 3-methoxy-1-butanol (5.09 g) to give a coating solution.

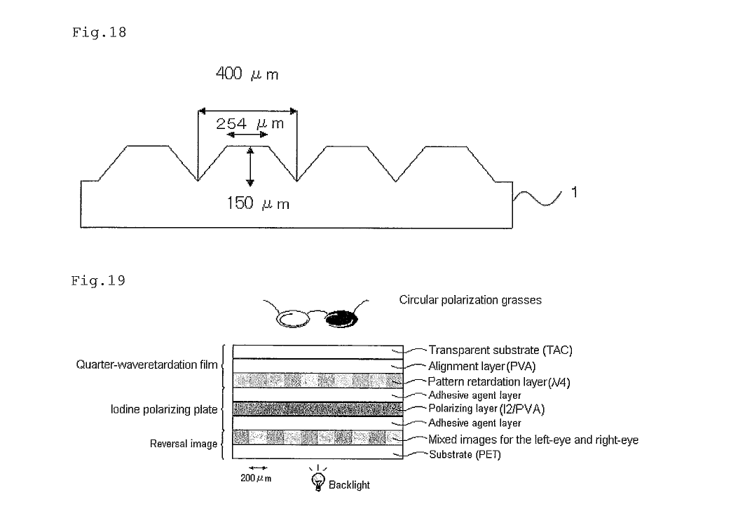

A synthetic-rubber flexographic plate having an irregular profile as illustrated in FIG. 18 was then prepared.

Flexiproof 100 (RK Print Coat Instruments Ltd., UK) was used as the flexographic press illustrated in FIG. 18. An anilox roller 13 with 400 cells per centimeter (3 cm³/m²) was used. The flexographic plate was attached to an impression cylinder of the Flexiproof 100 with a pressure-sensitive tape. The parallel alignment film was attached to an impressing roller, and the coating solution for the patterned orthogonal alignment film was then put into a doctor blade. An orthogonal alignment film pattern was then printed on the parallel alignment film at a printing rate of 30 m/min

### (3) Preparation of Rubbing Alignment Layer

The coating was dried at 80° C. for 5 min, and was then rubbed reciprocally in one direction one time at 1000 rpm to yield a rubbing alignment layer.

As in Example 1-9, a coating solution for a quarter-wave layer was prepared, applied, and dried for 1 min at a surface temperature of 110° C. into a liquid crystal phase. The coating was then cooled to 80° C. at which the coating was then irradiated with ultraviolet rays with an air-cooled metal halide lamp (available from Eye Graphics Co., Ltd.) at 160 W/cm in air, so that the aligned liquid crystal was fixed, resulting in the formation of a patterned quarter-wave layer 0.8 μm in thickness having orthogonal slow axes. The quarter-wave layer had a tilt angle of substantially 90°, an Re of 138 nm, and a total Rth of −36 nm in combination with the protective layer at a wavelength of 550 nm.

### [Preparation of Linearly Polarizing Layer]

A polyvinyl alcohol film 80 μm in thickness was stretched to five times its original length in an iodine aqueous solution, and was then dried to yield a linearly polarizing layer 30 μm in thickness.

### [Lamination of Patterned Quarter-Wave Layer and Linearly Polarizing Layer]

The linearly polarizing layer was bonded to a quarter-wave layer side of the patterned quarter-wave layer with an adhesive agent, resulting in lamination of the patterned quarter-wave layer and the linearly polarizing layer. Here, the polarization axis of the linearly polarizing layer defined an angle of ±45° with respect to the slow axes of the patterned quarter-wave layer. The thickness of the adhesive agent layer was 16 μm.

### [Lamination of Linearly Polarizing Layer and Stereo Picture Receiving Film]

The linearly polarizing layer with the patterned quarter-wave layer prepared as described above was bonded to the stereo picture receiving film with an adhesive agent. Here, the stripes of the patterned quarter-wave layer were aligned with the stripes printed on the stereo picture receiving film. The thickness of the adhesive agent layer was 16 μm.

In this way, a stereo picture print having a configuration similar to that illustrated in FIG. 9 was produced.

### [Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the patterned quarter-wave layer (the direction of the polarization axis c illustrated in FIG. 2), through circular polarization glasses, and perceived a clear stereo picture with substantially no crosstalk.

The stereo picture print has a distance d of 62 μm between the patterned quarter-wave layer and the image receiving layer, and a pattern width p of 254 μm, namely, has a small d/p of 0.24, which may be a cause of the substantially no crosstalk.

### 11. Example 1-11

### [Preparation of Stereo Picture Receiving Film]

A stereo picture receiving film was prepared, and data were printed on the stereo picture receiving film, as in Example 1-9.

### [Production of Stereo Picture Print]

### [Preparation of Linearly Polarizing Layer]

A solution of 4% polyvinyl alcohol “PVA-103” available from Kuraray Co., Ltd., (a liquid of 4.0 g of PVA-103 dissolved in 72 g of water and 24 g of methanol, viscosity 4.35 cp, surface tension 44.8 dyne) in water/methanol was applied onto the patterned quarter-wave layer prepared in Example 1-10 with a #12 bar, and was dried at 80° C. for 5 min. The coating was then reciprocally rubbed in one direction three times at 400 rpm to yield a patterned quarter-wave layer with a rubbing alignment layer. The alignment layer had a thickness of 0.9 μm, and was rubbed in a direction defining ±45° with respect to the slow axes of the patterned quarter-wave layer.

The coating solution for the linearly polarizing layer prepared in Example 1-2 was then applied onto the patterned quarter-wave layer with the rubbing alignment layer, and was spontaneously dried at room temperature to give a linearly polarizing layer laminated on the patterned quarter-wave layer. The linearly polarizing layer had a thickness of 0.4 μm and a dichroic ratio of 42. The polarization axis of the linearly polarizing layer defined an angle of ±45° with respect to the slow axes of the patterned quarter-wave layer.

[Lamination of Linearly Polarizing Layer and Stereo Picture Receiving Film]

The linearly polarizing layer with the patterned quarter-wave layer prepared as described above was bonded to the stereo picture receiving film with an adhesive agent. Here, the stripes of the patterned quarter-wave layer were aligned with the stripes printed on the stereo picture receiving film. The thickness of the adhesive agent layer was 16 μm.

In this way, a stereo picture print having a configuration similar to that illustrated in FIG. 11 was produced.

### [Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the patterned quarter-wave layer (the direction of the polarization axis c illustrated in FIG. 2), through circular polarization glasses, and perceived a clear stereo picture with substantially no crosstalk.

The stereo picture print has a distance d of 17.7 μm between the patterned quarter-wave layer and the image receiving layer, and a pattern width p of 254 μm, namely, has a d/p of 0.07, which may be a cause of the substantially no crosstalk.

### 12. Comparative Example 1-1

A laminate was prepared, which had the same configuration as that of the laminate prepared in Example 1-2 except that the image receiving layer 12 was not provided.

Images were formed on the surface of a cellulose acetate protective film laminated on a side opposite to a quarter-wave layer of a linearly polarizing layer by thermal transfer as in Example 1-1 and by inkjetting as in Example 1-2. The images each had a low density. In addition, dyes migrated on the cellulose acetate film. As a result, intended images were not formed. Consequently, an observer viewing the images through circular polarization glasses did not perceive a stereo picture.

### 13. Example 2-1

### [Production of Stereo Picture Printing Sheet]

### (Preparation of Protective Layer)

The following composition was put into a mixing tank, and was stirred while being heated to dissolve the components, thereby a cellulose acylate solution A was prepared.

### [Composition of Cellulose Acylate Solution A]

| | |
|---|---|
| Cellulose acetate with degree of acetylation of 2.86 | 100 parts |
| by mass | |
| Triphenyl phosphate (plasticizer) | 7.8 parts by mass |
| Biphenyl diphenyl phosphate (plasticizer) | 3.9 parts by mass |
| Methylene chloride (first solvent) | 300 parts by mass |
| Methanol (second solvent) | 54 parts by mass |
| 1-Butanol | 11 parts by mass |

The following composition was put into another mixing tank, and was stirred while being heated to dissolve the components, thereby an additive solution B was prepared.

[Composition of Additive Solution B]

| | |
|---|---|
| Compound B1 (Re reducer) | 40 parts by mass |
| Compound B2 (wavelength dispersion control agent) | 4 parts by mass |
| Methylene chloride (first solvent) | 80 parts by mass |
| Methanol (second solvent) | 20 parts by mass |

Compound B1 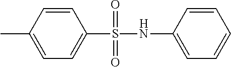 [SMILES: Cc1ccc(S(=O)(=O)Nc2ccccc2)cc1]
Compound B2

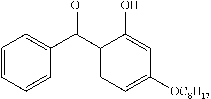

### [Preparation of Cellulose Acetate Protective Film]

To 477 parts by mass of the cellulose acylate solution A was added 40 parts by mass of the additive solution B. The mixture was then sufficiently stirred to prepare a dope. The dope was casted from a cast port onto a drum cooled at 0° C. The cast film was peeled at a solvent content of 70 mass %. The film was then fixed at its two lateral ends with a pin tenter as illustrated in FIG. 3 of JP-A-4-1009, and was dried at a constant width allowing a draw rate of 3% in a lateral direction (a direction perpendicular to a machine direction) at a solvent content of 3 to 5 mass %. The film was then conveyed through rolls of heat treatment equipment to be further dried, so that a cellulose acetate protective film 60 μm in thickness was prepared. The front Re of the protective film was 2.0 nm.

### (Preparation of Linearly Polarizing Layer)

The cellulose acetate protective film was immersed in 1.5 N sodium hydroxide solution at 55° C. for 2 min. The film was then washed in a rinsing bath at room temperature, and was then neutralized with 0.1 N sulfuric acid at 30° C. The film was washed in a rinsing bath at room temperature again, and was further dried in hot air at 100° C. In this way, the surface of the cellulose acylate protective film was saponified.

A rolled polyvinyl alcohol film 80 μm in thickness was then continuously stretched to five times its original length in an iodine solution, and was then dried to yield a linearly polarizing film. Two alkali-saponified, cellulose acylate protective films were bonded to two sides of the linearly polarizing film with an aqueous 3% polyvinyl alcohol (PVA-117H, available from Kuraray Co., Ltd.) solution as an adhesive agent, resulting in a linearly polarizing layer having two sides protected by the cellulose acylate protective film. Here, the cellulose acylate protective film on either side had a slow axis parallel to the transmission axis of the linearly polarizing film.

### (Preparation of Patterned Retardation Layer)

### [Preparation of Coating Solution CU-1 for Release Layer]

The following composition was prepared, and was then passed through a polypropylene filter having a pore size of 30 μm to yield a coating solution CU-1 for a release layer.

B-1 is a copolymer of methyl methacrylate, 2-ethylhexyl acrylate, benzyl methacrylate, and methacrylic acid, which has a proportion (molar ratio) of 55/30/10/5, a weight-average molecular weight of 100,000, and a Tg of about 70° C.

B-2 is a copolymer of styrene and acrylic acid, which has a proportion (molar ratio) of 65/35, a weight-average molecular weight of 10,000, and a Tg of about 100° C.

Composition of Coating Solution for Dynamic-Property Control Layer (%)

| | |
|---|---|
| Binder (B-1) | 5.89 |
| Binder (B-2) | 13.74 |
| BPE-500 (available from Shin-Nakamura Chemical Co., Ltd.) | 9.20 |
| MEGAFAC F-780-F (available from DIC Corporation) | 0.55 |
| Methanol | 11.22 |
| Propyleneglycol monomethylether acetate | 6.43 |
| Methyl ethyl ketone | 52.97 |

### [Preparation of Coating Solution AL-1 for Alignment Layer]

The following composition was prepared, and was then passed through a polypropylene filter having a pore size of 30 μm to yield a coating solution AL-1 for an alignment layer.

Composition of Coating Solution for Alignment Layer (%)

| | |
|---|---|
| Polyvinyl alcohol (PVA-205, available from Kuraray Co., Ltd.) | 3.21 |
| Polyvinylpyrrolidone (Luvitec K 30, available from BASF) | 1.48 |
| Distilled water | 52.10 |
| Methanol | 43.21 |

### [Preparation of Coating Solution LC-1 for Retardation Layer]

The following composition was prepared, and was then passed through a polypropylene filter having a pore size of 0.2 μm to yield a coating solution LC-1 for a retardation layer.

I-22 is a liquid crystal compound having two reactive groups, i.e., an acrylic group being a radical reactive group and an oxetanyl group being a cationic reactive group.

Composition of Coating Solution for Retardation Layer (%)

| | |
|---|---|
| Rod-like liquid crystal (I-22) | 32.59 |
| Horizontal alignment agent (LC-1-2) | 0.02 |
| Cationic photopolymerization initiator | 0.66 |
| (CP1100-P, available from San-Apro Ltd.) | |
| Polymerization initiator | 0.07 |
| (IRGANOX1076, available from Ciba Specialty Chemicals Inc.) | |
| Methyl ethyl ketone | 66.66 |

I-22 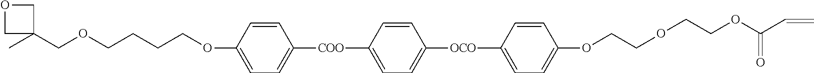
Horizontal alignment agent (LC-1-2)

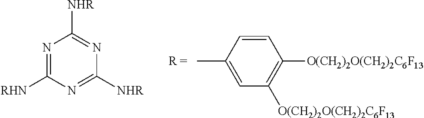

### (Preparation of Coating Solution AD-1 for Radical-Polymerization-Initiator Supply Layer)

The following composition was prepared, and was then passed through a polypropylene filter having a pore size of 0.2 μm to yield a coating solution AD-1 for a radical-polymerization-initiator supply layer.

B-3 is a copolymer of benzyl methacrylate, methacrylic acid, and methyl methacrylate, which has a proportion (molar ratio) of 35.9/22.4/41.7, and a weight-average molecular weight of 38,000.

2-Trichloromethyl-5-(p-styrylstyryl)-1,3,4-oxadiazole was used as RPI-1.

Composition of Coating Solution for Radical-Polymerization-Initiator Supply Layer (mass %)

| | |
|---|---|
| Binder (B-3) | 8.05 |
| KAYARAD DPHA (available from NIPPON KAYAKU Co., Ltd.) | 4.83 |
| Radical Photopolymerization initiator (RPI-1) | 0.12 |
| Hydroquinone monomethyl ether | 0.002 |
| MEGAFAC F-176PF (available from DIC Corporation) | 0.05 |
| Propyleneglycol monomethylether acetate | 34.80 |
| Methyl ethyl ketone | 50.538 |
| Methanol | 1.61 |

### [Preparation of Patterned Retardation Layer]

The coating solution CU-1 for a release layer and the coating solution AL-1 for an alignment layer were sequentially applied onto a provisional polyimide-film support 75 μm in thickness with a wire bar, and were dried. The dried thicknesses of the release layer and the alignment layer were 14.6 μm and 1.6 μm, respectively. The coating solution LC-1 for a retardation layer was then applied on the alignment layer with a wire bar, and was dried at a surface temperature of 90° C. for 2 min into a liquid crystal phase. The coating was then irradiated with ultraviolet rays with an air-cooled metal halide lamp (available from Eye Graphics Co., Ltd.) at 160 W/cm in air, so that the aligned liquid crystal was fixed, resulting in the formation of a retardation layer 3.2 μm in thickness. The ultraviolet rays had an illuminance of 100 mW/cm² and an irradiance of 80 mJ/cm² in the UV-A region (integration of wavelength 320 nm to 400 nm). The coating solution AD-1 for a radical-polymerization-initiator supply layer was further applied onto the retardation layer, and was dried to form a radical-polymerization-initiator supply layer 1.2 μm in thickness, which was then subjected to pattern exposure at a light exposure of 50 mJ/cm² through a mask aligner M-3L available from Mikasa Co., Ltd. and a photomask I. The radical-polymerization-initiator supply layer was then baked for 1 hr in a clean oven at 230° C., thereby an unexposed portion was thermally fixed to an isotropic phase, resulting in the formation of a patterned half-wave layer. The patterned half-wave layer had a retardation of 275 nm (half wavelength) in plane of the exposed portion and a retardation of 0 nm in plane of the unexposed portion, at a wavelength of 550 nm.

(Production of Stereo Picture Printing Sheet)

### [Lamination of Patterned Retardation Layer and Linearly Polarizing Layer]

The surface of the patterned retardation layer (the surface of the radical-polymerization-initiator supply layer) was bonded to the linearly polarizing layer with an adhesive sheet attached to the surface, and then the provisional polyimide-film support and the release layer were separated. In this bonding, as illustrated in FIG. 15b, the slow axis b of the second domain of the retardation layer defined an angle of 45° with respect to the polarization axis c of the linearly polarizing layer.

### [Preparation of Image Receiving Layer]

The surface of the cellulose acetate protective film on a side opposite to the retardation layer of the linearly polarizing layer was subjected to corona discharge treatment, and then a gelatinous undercoat layer containing sodium dodecylbenzenesulfonate was provided on the surface. An intermediate layer A having the following composition was formed on the gelatinous undercoat layer by bar coating and drying. A receiving layer A having the following composition was then formed on the intermediate layer A by bar coating and drying. The bar coating was performed at 40° C., and drying was performed at 50° C. for 16 hr for each layer. The coating density was 1.0 g/m² in the dried intermediate layer A and 3.0 g/m² in the dried receiving layer A.

### [Intermediate Layer A]

| | |
|---|---|
| Polyester resin (Biron 200, available | |
| from Toyobo Co., Ltd.) | 10 parts by mass |
| Fluorescent brightener | 1 parts by mass |
| (Uvitex OB, available from Ciba | |
| Specialty Chemicals Inc.) | |
| Titanium oxide | 30 parts by mass |
| Methyl ethyl ketone/toluene (mass ratio 1/1) | 90 parts by mass |

### [Receiving Layer A]

| | |
|---|---|
| Polyester resin | 100 parts by mass |
| (resin described in Example 2-1 in | |
| Japanese Unexamined Patent | |
| Application Publication No. 2-265789) | |
| Amino-modified silicone | 5 parts by mass |
| (X-22-3050C, available from Shin-Etsu | |
| Chemical Co., Ltd.) | |
| Epoxy-modified silicone | 5 parts by mass |
| (X-22-300E, available from Shin-Etsu | |
| Chemical Co., Ltd.) | |
| Methyl ethyl ketone/toluene (1/1 in mass ratio) | 400 parts by mass |

### [Stereo Picture Printing Sheet]

In this way, a stereo picture printing sheet was produced, which had a configuration similar to that illustrated in FIG. 16 except that the image receiving layer 22 was a laminate of the intermediate layer A and the receiving layer A, and the intermediate layer A was disposed adjacent to the protective layer 14a. Specifically, with the stereo picture printing sheet, the cellulose acetate protective films (14a and 14b) were laminated on both sides of the linearly polarizing layer 24, the adhesive layer 17, the initiator layer 30, the patterned retardation layer 26, and the alignment layer 25 were laminated on a viewing side, and the image receiving layer 22 being the laminate of the intermediate layer A and the receiving layer A was disposed on a side opposite to the viewing side.

### (Preparation of Stereo Picture Ink Sheet)

A polyester film (LUMIRROR, available from Toray Industries, Inc.) 6.0 μm in thickness was used as a base film. A heatproof slip layer 1 μm in thickness was provided on the back of the film, and yellow, magenta, and cyan compositions each having the following components were separately applied onto the surface of the film at a coating density at a dried state of 1 g/m².

Yellow composition

| | |
|---|---|
| Dye (Macrolex Yellow 6G, available from Bayer Ltd.) | 5.5 parts by mass |
| Polyvinyl butyral resin | 4.5 parts by mass |
| (Eslec BX-1 available from Sekisui Chemical Co.,Ltd.) | |
| Methyl ethyl ketone/toluene (1/1 in mass ratio) | 90 parts by mass |

Magenta composition

| | |
|---|---|
| Magenta dye (Disperse Red 60) | 5.5 parts by mass |
| Polyvinyl butyral resin | 4.5 parts by mass |
| (Eslec BX-1 available from | |
| Sekisui Chemical Co., Ltd.) | |
| Methyl ethyl ketone/toluene | 90 parts by mass |
| (1/1 in mass ratio) | |

Cyan composition

| | |
|---|---|
| Cyan dye (Solvent Blue 63) | 5.5 parts by mass |
| Polyvinyl butyral resin | 4.5 parts by mass |
| (Eslec BX-1 available from Sekisui Chemical Co., Ltd.) | |
| Methyl ethyl ketone/toluene (1/1 in mass ratio) | 90 parts by mass |

### [Production of Stereo Picture Print]

### (Formation of Right-Eye and Left-Eye Images)

The ink sheet and the printing sheet were shaped into a loadable form for a sublimation printer, DPB1500, available from Nidec Copal Corporation. Images were then output in a high-speed printing mode through pixel formation where each right-eye pixel was formed at a position corresponding to each right-eye region of the patterned half-wave layer, and each left-eye pixel was formed at a position corresponding to each left-eye region of the patterned retardation layer, so that a stereo picture print was produced. In this operation, if the right-eye pixel was formed at a position corresponding to the second domain having an Re of half wavelength, the left-eye pixel was formed at a position corresponding to the first domain having an Re of 0 nm. In contrast, if the right-eye pixel was formed at a position corresponding to the first domain having an Re of 0 nm, the left-eye pixel was formed at a position corresponding to the second domain having an Re of half wavelength.

### [Observation of Stereo Picture]

An observer viewed the stereo picture print through linear polarization glasses and perceived a clear stereo picture without crosstalk and ghost images. The polarization glasses were composed of a left-eye linear polarization filter and a right-eye linear polarization filter, of which the polarization axes were orthogonal to each other.

### 14. Example 2-2

### Production of Stereo Picture Printing Sheet

### (Preparation of Image Receiving Layer)

The surface of the protective layer for the linearly polarizing layer prepared in Example 2-1 was subjected to corona discharge treatment, and then the following dispersion for forming an image receiving layer and PAC liquid were in-line mixed into coating densities of 183 g/m² and 11.4 g/m², respectively, and then the mixture was applied onto the surface of the protective layer with an extrusion die coater. The coating was then treated in a cold-wind dryer at 5° C. and 30% RH (wind velocity 3 to 8 m/sec) for 5 min, and was then dried therein with dry wind at 25° C. and 25% RH (wind velocity 3 to 8 m/sec) for 20 min. Consequently, an image receiving layer having a dried thickness of 30 μm was formed on the protective layer.

### [Dispersion for Forming Image Receiving Layer]

According to the following composition of “silica dispersion”, fine silica particles were mixed with a dimethyl diallyl ammonium chloride polymer (SHAROLL DC902P) in deionized water, and then ZIRCOZOL ZA-30 was added to the mixture to form slurry. The slurry was dispersed by Altimizer available from Sugino Machinery Industries at 170 MPa to yield a silica dispersion having a median size (average particle size) of 120 nm.

According to the composition of the “dispersion for forming image receiving layer”, deionized water, a 7.5% boric acid solution, SC-505, a polyvinyl alcohol solution, and SUPERFLEX 650-5 were sequentially mixed into the above-described silica dispersion to yield a dispersion for forming image receiving layer.

### [Silica Dispersion]

| | |
|---|---|
| (1) Fine gas-phase silica particles | 15.0 parts by mass |
| (AEROSIL300SF75, available from | |
| Japan Aerosil Co., Ltd.) | |
| (2) Deionized water | 82.9 parts by mass |
| (3) SHAROLL DC-902P (51.5% | 1.31 parts by mass |
| solution) | |
| (dispersant available from Dai-ichi | |
| Kogyo Seiyaku Co., Ltd.) | |
| (4) Zirconyl acetate | 0.81 parts by mass |
| (ZIRCOZOL ZA-30 (50% | |
| solution), available from Daiichi | |
| Kigenso Kagaku-Kogyo Co., Ltd.) | |

### [Dispersion for Forming Image Receiving Layer]

| | |
|---|---|
| (1) Silica dispersion | 59.5 parts by mass |
| (2) Deionized water | 7.8 parts by mass |
| (3) 7.5% boric acid solution | 4.4 parts by mass |
| (crosslinking agent) | |
| (4) Dimethylamine-epichlorohydrin-polyalkylene | 0.1 parts by mass |
| polyamine polycondensate (50% solution) | |
| (SC-505, available from Hymo Co, Ltd.) | |
| (5) Polyvinyl alcohol solution | 26.0 parts by mass |
| (6) Cationically-modified polyurethane | 2.2 parts by mass |
| (SUPERFLEX 650-5 (25% liquid), | |
| available from DAI-CHI KOGYO | |
| SEIYAKU Co, Ltd.) | |

### [Polyvinyl Alcohol Solution]

| | |
|---|---|
| (1) Polyvinyl alcohol | 6.96 parts by mass |
| (JM-33, available from Japan | |
| Vam & Poval Co., Ltd., degree | |
| of saponification: 94.3 mol %, | |
| degree of polymerization: 3300) | |
| (2) Polyoxyethylene lauryl ether | 0.23 parts by mass |
| (surfactant EMULGEN 109P, | |
| available from Kao Corporation) | |
| (3) Diethylene glycol monobutyl ether | 2.12 parts by mass |
| (Butycenol 20P, available from | |
| Kyowa Hakko Chemicals Co., Ltd.) | |
| (4) Deionized water | 90.69 parts by mass |

### [PAC Liquid]

| | |
|---|---|
| (1)Polyaluminum chloride solution | 20 parts by mass |
| having a basicity of 83% | |
| (ALFINE 83, available from Taimei | |
| Chemical Co., Ltd.) | |
| (2) Deionized water | 80 parts by mass |

### (Stereo Picture Printing Sheet)

In this way, a stereo picture printing sheet having the configuration illustrated in FIG. 16 was produced. With the stereo picture printing sheet, the cellulose acetate protective films (14a and 14b) were laminated on both sides of the linearly polarizing layer 24, the light aligning film 25 and the patterned retardation layer 26 were laminated on a viewing side, and the image receiving layer 22 composed of the composition containing the inorganic fine particles and the water-soluble polymer was disposed on a side opposite to the viewing side.

### [Production of Stereo Picture Print]

Right-eye data and left-eye data photographed with a digital camera having left and right, photographing lens systems were converted to digital data. Inkjet ink drops were then deposited onto the image receiving layer of the stereo picture printing sheet produced in Example 2-2 with a piezoelectric inkjet head, so that right-eye pixels and left-eye pixels were formed. Images were output through pixel formation where each right-eye pixel was formed at a position corresponding to each right-eye region of the patterned retardation layer, and each left-eye pixel was formed at a position corresponding to each left-eye region thereof.

### [Observation of Stereo Picture]

An observer viewed the stereo picture print through linear polarization glasses and perceived a clear stereo picture without crosstalk and ghost images.

### 15. Example 2-3

### Production of Stereo Picture Printing Sheet

### (Preparation of Linearly Polarizing Layer)

An aqueous 4% polyvinyl alcohol (PVA-103, available from Kuraray Co., Ltd.) solution was applied onto the surface of the protective layer prepared in Example 2-1 with a #12 bar and dried at 80° C. for 5 min. The coating was then reciprocally rubbed three times at 400 rpm to yield a protective layer with a rubbing alignment film.

Yellow azo dye A2-3 (0.24 parts by mass, a compound represented by general formula (II)) having the following structure, 0.33 parts by mass of magenta azo dye A-46 (a compound represented by general formula (I)) having the following structure, 0.37 parts by mass of cyan azo dye A3-1 (a compound represented by general formula (III)) having the following structure, and 0.06 parts by mass of squarylium dye VI-5 having the following structure were mixed in 99 parts by mass of chloroform, and were stirred to be dissolved in the chloroform. The solution was then filtered to prepare a coating solution for a linearly polarizing layer. The coating solution was then applied onto the rubbing alignment film, and was spontaneously dried at room temperature to give a linearly polarizing layer. The linearly polarizing layer had a thickness of 0.4 μm and a dichroic ratio of 42. The composition for the linearly polarizing layer had a thermotropic liquid crystallinity having an isotropic phase transition temperature of 240° C.

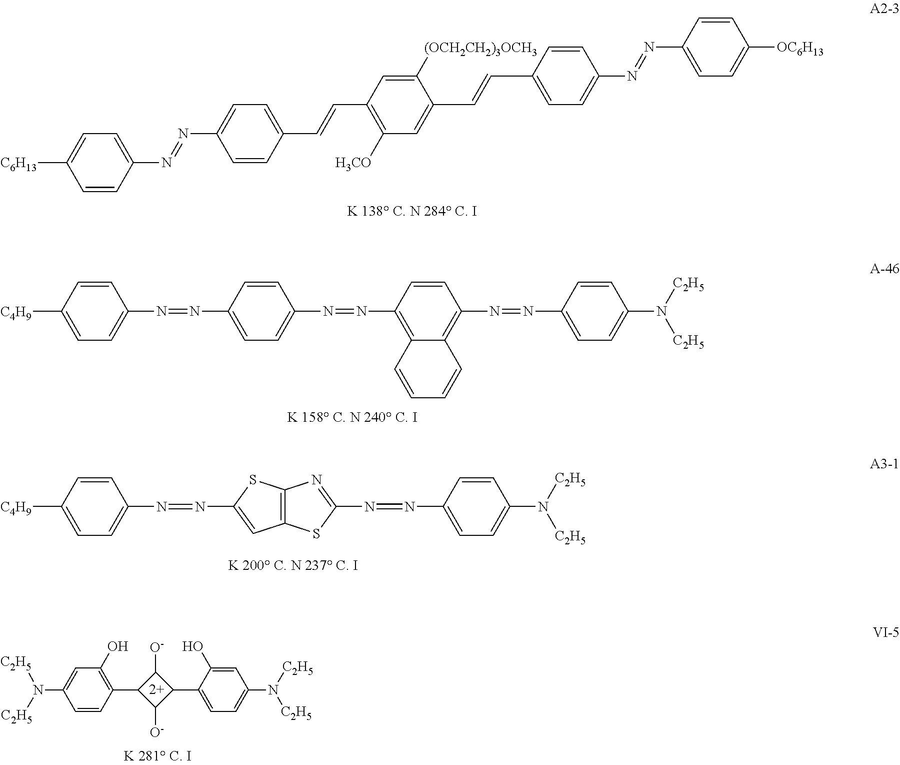

(Preparation of Coating Solution for Oxygen Insulation Layer)

The following composition was put into a mixing tank, and was stirred to prepare a coating solution for an oxygen insulation layer.

Polyvinyl alcohol (3.2 parts by mass, PVA-205, available from Kuraray Co., Ltd.), 1.5 parts by mass of polyvinylpyrrolidone (PVP K-30, available from Nippon Shokubai Co., Ltd.), 44 parts by mass of methanol, and 56 parts by mass of water were mixed and stirred. The mixture was passed through a polypropylene filter having a pore size of 0.4 μm to prepare the coating solution for an oxygen insulation layer.

### (Preparation of Oxygen Insulation Layer)

The coating solution for an oxygen insulation layer was applied onto the above-described linearly polarizing layer and dried at 100° C. for 2 min to yield an oxygen insulation layer. The oxygen insulation layer had a thickness of 1 μm and a front Re of 0 nm.

### (Preparation of Coating Solution for Transparent Resin Hardening Layer)

The following composition was put into a mixing tank, and was stirred to prepare a coating solution for a transparent resin hardening layer.

Poly(glycidyl methacrylate) having a mass-average molecular weight of 15000 (2.7 parts by mass), 7.3 parts by mass of methyl ethyl ketone, 5.0 parts by mass of cyclohexanone, and 0.5 parts by mass of photopolymerization initiator (Irgacure 184, available from Ciba Specialty Chemicals Inc.) were mixed in 7.5 parts by mass of trimethylolpropane tri-acrylate (Biscoat #295 available from Osaka Organic Chemical Industry, Ltd.), and the mixture was then stirred. The mixture was then passed through a polypropylene filter having a pore size of 0.4 μm to prepare the coating solution for a transparent resin hardening layer.

### (Preparation of Transparent Resin Hardening Layer)

The coating solution for a transparent resin hardening layer was applied onto the above-described oxygen insulation layer and dried at 100° C. for 2 min. The coating was then polymerized by 5-J ultraviolet rays under a nitrogen atmosphere (oxygen concentration: 100 ppm or less), resulting in the formation of a laminate of the oxygen insulation layer 1 μm in thickness and the transparent resin hardening layer 2 μm in thickness which were sequentially laminated on the surface of the linearly polarizing layer 0.4 μm in thickness. The transparent resin hardening layer had a front Re of 0 nm.

### (Preparation of Patterned Retardation Layer)

A patterned retardation layer was formed on the transparent resin hardening layer as in Example 2-1.

### (Preparation of Image Receiving Layer)

An image receiving layer was formed on the surface of the protective layer on a side opposite to the linearly polarizing layer as in Example 2-2.

### (Production of Stereo Picture Printing Sheet)

In this way, a stereo picture printing sheet having the configuration illustrated in FIG. 16 was produced, where the alignment film was disposed between the protective layer 14a and the linearly polarizing layer, and the protective layer 14b was a laminate of the oxygen insulation layer and the transparent resin hardening layer. With the stereo picture printing sheet, the cellulose acetate protective film (14a) provided with the alignment film was disposed on one surface while the laminate (14b) of the oxygen insulation layer and the transparent resin hardening layer was disposed on the other surface of the coating-type linearly polarizing layer 24; and the patterned retardation layer 26, and the alignment layer 25 and the initiator layer 30, which were used for formation of the patterned retardation layer 26, were provided on a viewing side while the image receiving layer 22 composed of a composition containing the inorganic fine particles and the water-soluble polymer was disposed on a side opposite to the viewing side.

### [Production of Stereo Picture Print]

Right-eye pixels and left-eye pixels were formed as in Example 2-2.

After image formation, an aluminum reflective layer was laminated on the image receiving layer to yield a stereo picture print similar to that illustrated in FIG. 17.

### [Observation of Stereo Picture]

An observer viewed the stereo picture print through linear polarization glasses and perceived a clear stereo picture without crosstalk and ghost images.

### 16. Example 2-4

### [Production of Stereo Picture Print]

A stereo picture print was produced as in Example 2-1 except that the additive B1 (Re reducer) and the additive B2 (wavelength dispersion control agent) were omitted from the additive solution B for preparation of the protective layer. The protective layer (cellulose acetate protective film) had a thickness of 200 μm, an Re value of 15 nm, and an Rth of 85 nm at 550 nm.

### [Observation of Stereo Picture]

An observer viewed the stereo picture print through polarization glasses and perceived a stereo picture with some ghost images caused by the high Re of the protective layer.

### 17. Example 2-5

### Observation of Stereo Picture

A stereo picture print was prepared as in Example 2-3 except that the aluminum reflective layer was not provided.

### [Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the patterned retardation layer (the direction of the polarization axis c illustrated in FIG. 4), through linear polarization glasses, and perceived a stereo picture with slight crosstalk.

The observer also viewed the stereo picture print in Example 2-1 tilted in the same way, and did not perceive a stereo picture due to noticeable crosstalk in the print.

The coating-type polarizing film can exhibit a polarizing function despite its small thickness; hence, the stereo picture print in Example 2-5 may have a short distance of about 60 μm between the patterned retardation layer and the image receiving layer. In contrast, the stereo picture print in Example 2-1 has a stretched iodine polarizing film that is thick compared with the coating-type polarizing film. As a result, the stereo picture print has a relatively large distance of about 140 μm between the patterned retardation layer and the image receiving layer, leading to large parallax in the tilted stereo picture print, which may be a cause of the noticeable crosstalk.

### 18. Example 2-6

### Production of Stereo Picture Print

A stereo picture print was prepared as in Example 2-3 except that the composition for the linearly polarizing layer for preparation of the linearly polarizing layer was modified to the following composition. The linearly polarizing layer had a thickness of 0.4 μm and a dichroic ratio of 37.

### [Composition for Linearly Polarizing Layer]

| | |
|---|---|
| (1) Yellow azo dye A2-3 | 0.2 parts by mass |
| (2) Magenta azo dye C-9 | 0.4 parts by mass |
| (3) Cyan azo dye A3-1 | 0.4 parts by mass |
| (4) Chloroform | 99 parts by mass |

C-9 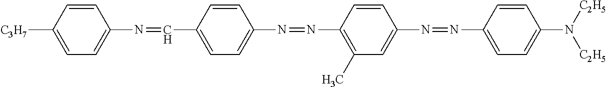
K 167° C. N 288° C. I

### [Observation of Stereo Picture]

An observer viewed the stereo picture print through linear polarization glasses and perceived a clear stereo picture without crosstalk and ghost images.

### 19. Example 2-7

### [Production of Stereo Picture Print]

A stereo picture print was prepared as in Example 2-3 except that the composition for the linearly polarizing layer for preparation of the linearly polarizing layer was modified to the following composition. The linearly polarizing layer had a thickness of 0.4 μm and a dichroic ratio of 30.

### [Composition for Linearly Polarizing Layer]

| | |
|---|---|
| (1) Yellow azo dye A2-3 | 0.15 parts by mass |
| (2) Magenta azo dye C-9 | 0.30 parts by mass |
| (3) Cyan azo dye A3-1 | 0.15 parts by mass |
| (4) Cyan azo dye A4-120 | 0.40 parts by mass |
| (5) Chloroform | 99 parts by mass |

### [Observation of Stereo Picture]

An observer viewed the stereo picture print through linear polarization glasses and perceived a clear stereo picture without crosstalk and ghost images.

### 20. Example 2-8

### Production of Stereo Picture Print

A stereo picture print was prepared as in Example 2-3 except that the composition for the linearly polarizing layer for preparation of the linearly polarizing layer was modified to the following composition. The linearly polarizing layer had a thickness of 0.8 μm and a dichroic ratio of 71.

### [Composition for Linearly Polarizing Layer]

| | |
|---|---|
| (1) Magenta azo dye A-16 | 1.2 parts by mass |
| (2) Magenta azo dye B-4 | 0.8 parts by mass |
| (3) Chloroform | 98 parts by mass |

A-16 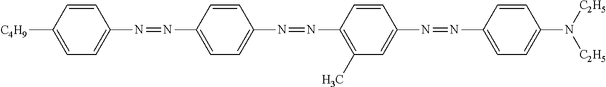
K 137° C. N 266° C. I
B-4 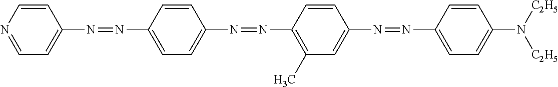 [SMILES: CCN(CC)c1ccc(N=Nc2ccc(N=Nc3ccc(N=Nc4ccncc4)cc3)c(C)c2)cc1]
K 235° C. N 240° C. I

### [Observation of Stereo Picture]

An observer viewed the stereo picture print through linear polarization glasses and perceived a clear stereo picture without crosstalk and ghost images.

### 21. Example 2-9

An aqueous 4% polyvinyl alcohol (PVA-103, available from Kuraray Co., Ltd.) solution was then applied onto the surface of the patterned retardation layer prepared in Example 2-1 with a #12 bar and dried at 80° C. for 5 min. The coating was then reciprocally rubbed three times at 400 rpm in a direction defining an angle of 45° with respect to the slow axis b of the second domain of the retardation layer, so that a retardation layer with a rubbing alignment film was prepared.

The coating solution for the linearly polarizing layer prepared in Example 2-3 was then applied onto the rubbing alignment film, and was then spontaneously dried at room temperature to give a linearly polarizing layer. The linearly polarizing layer had a thickness of 0.4 μm and a dichroic ratio of 42. The slow axis b of the second domain of the retardation layer defined an angle of 45° with respect to the polarization axis c of the linearly polarizing layer.

The oxygen insulation layer and the transparent resin hardening layer were then sequentially formed onto the linearly polarizing layer as in Example 2-3. The thicknesses of the oxygen insulation layer and the transparent resin hardening layer were 1 μm and 2 μm, respectively. Each layer had a front Re of 0 nm.

An image receiving layer was formed on the surface of the transparent resin hardening layer, and then a stereo picture print was produced as in Example 2-3. The aluminum reflective layer was not formed.

### [Observation of Stereo Picture]

An observer viewed the stereo picture print through linear polarization glasses and perceived a clear stereo picture without crosstalk and ghost images.

The observer viewed the stereo picture print, which was tilted by 30° toward a zero-degree direction of the patterned retardation layer (the direction of the polarization axis c illustrated in FIG. 4), through linear polarization glasses, and perceived a clear stereo picture with substantially no crosstalk.

The stereo picture print has the coating-type polarizing film that can exhibit a polarizing function despite its small thickness, and has an extremely short distance of about 5 μm or less between the patterned retardation layer and the image receiving layer, which may be a cause of the substantially no crosstalk.

### 22. Example 2-10

### Preparation of Stereo Picture Receiving Film

### (Preparation of Image Receiving Layer)

Among the following components, (1) fine precipitated silica particles, (2) deionized water, (3) “SHAROLL DC902P”, and (4) “ZA-30” were mixed. The mixture was then dispersed with an ultrasonic disperser (available from SMT Co., Ltd.), and the dispersion was held at 45° C. for 20 hr. After that, (5) boric acid, (6) polyvinyl alcohol solution, (7) SUPERFLEX 650, and (8) ethanol were mixed in the dispersion at 30° C. to give a coating solution A for an image receiving layer.

### [Composition of Coating Solution A for Image Receiving Layer]

| | |
|---|---|
| (1) Fine precipitated silica particles | 10.0 parts |
| (inorganic fine particles) (mixture of | |
| P-78A (particle size 7.7 μm) and | |
| P-604 (particle size 0.64 μm), available | |
| from MIZUSAWA INDUSTRIAL | |
| CHEMICALS, LTD, in a mass ratio | |
| of 75/25, hereinafter referred to as | |
| fine silica particles) | |
| (2) Deionized water | 62.8 parts |
| (3) SHAROLL DC-902P (51.5% | 0.87 parts |
| aqueous solution) (dispersant, available | |
| from Dai-ichi Kogyo Seiyaku Co., Ltd.) | |
| (4) ZA-30 (zirconyl acetate) | 0.54 parts |
| (available from Daiichi Kigenso | |
| Kagaku-Kogyo Co., Ltd.) | |
| (5) Boric acid (crosslinking agent) | 0.44 parts |
| (6) Polyvinyl alcohol (water-soluble | 34.9 parts |
| resin) solution | |
| Composition | |
| PVA-235 | 2.43 parts |
| (available from Kuraray Co., Ltd., | |
| degree of saponification: 88%, | |
| degree of polymerization: 3500) | |
| Polyoxyethylene lauryl ether | 0.08 parts |
| (EMULGEN 109P (10% aqueous solution), | |
| surfactant with HLB value of | |
| 13.6, available from Kao Corporation) | |
| Diethylene glycol monobutyl ether | 0.74 parts |
| (Butycenol 20P, available from Kyowa | |
| Hakko Chemicals Co., Ltd.) | |
| Deionized water | 31.0 parts |
| (7) SUPERFLEX 650 (25% aqueous | 2.47 parts |
| dispersion) (available from DAI-CHI | |
| KOGYO SEIYAKU Co, Ltd.) | |
| (8) Ethanol | 1.3 parts |

The coating solution A for an image receiving layer was applied onto a gelatinous-undercoated surface of a biaxially-drawn polyethylene terephthalate film 175 μm in thickness at a coating density of 204 mL/m². Immediately before the application, 8 mass % of polyaluminum chloride solution (ALFINE 83, available from Taimei Chemical Co., Ltd.) was mixed in the coating solution A for an image receiving layer at a coating density of 12.0 mL/m².

The film formed by coating was dried with a hot-wind dryer at 80° C. (wind velocity: 3 to 8 m/sec) until the content of the solid content of the film reached 20%. During this process, the film exhibited constant-rate drying. The film was immersed in a basic solution C having the following composition for 3 sec before exhibiting decreasing drying, so that 13 g/m² of the basic solution was deposited on the film. The film was further dried at 80° C. for 10 min.

In this way, a stereo picture receiving film having a dried thickness of 33 μm was prepared.

### [Composition of Basic Solution C]

| | |
|---|---|
| (1) Boric acid | 0.65 parts |
| (2) Ammonium zirconium carbonate | 2.5 parts |
| (ZIRCOZOL AC-7 (28% aqueous | |
| solution), available from Daiichi | |
| Kigenso Kagaku-Kogyo Co., Ltd.) | |
| (3) Ammonium carbonate | 3.5 parts |
| (first grade, available from Kanto | |
| Chemical Co., Ltd) | |
| (4) Deionized water | 63.3 parts |
| (5) Polyoxyethylene lauryl ether | 30.0 parts |
| (surfactant) (EMULGEN 109P | |
| (2% aqueous solution), HLB | |
| value: 13.6, available from | |
| Kao Corporation) | |

### [Printing on Stereo Picture Receiving Film]

Right-eye data and left-eye data photographed with a digital camera having left and right, photographing lens systems were converted to digital data. Inkjet ink drops were then deposited onto the image receiving layer of the above-described stereo picture receiving film with a piezoelectric inkjet head, so that right-eye pixels and left-eye pixels were formed. Images were output in the form of horizontal stripes of the right-eye pixels and the left-eye pixels alternated every 254 μm.

### [Production of Stereo Picture Print]

### [Preparation of Half-Wave Layer]

An aqueous 4% polyvinyl alcohol (“PVA-103”, available from Kuraray Co., Ltd.) solution was applied onto the surface of the cellulose acetate protective film prepared in Example 2-1 with a #12 bar, and was dried at 80° C. for 5 min. The coating was then rubbed reciprocally in one direction one time at 400 rpm to yield a transparent support with a rubbing alignment film. The thickness of the alignment layer was 0.9 μm.

The following composition for forming a retardation layer was prepared, and was then passed through a polypropylene filter having a pore size of 0.2 μm to yield a coating solution for a half-wave layer. The coating solution was applied onto the rubbing alignment film, and was dried for 1 min at a surface temperature of 80° C. to uniformly align the liquid crystal phase. The coating was then cooled to room temperature. A mask having a horizontal stripe width of 254 μm was then disposed on a substrate on which the coating solution for a half-wave layer was applied, and the coating was irradiated with ultraviolet rays for 5 sec with an air-cooled metal halide lamp (available from Eye Graphics Co., Ltd.) at 20 mW/cm² in air, so that the aligned liquid crystal was fixed, resulting in the formation of a first retardation region. The coating was then heated to a surface temperature of 140° C. so that the liquid crystal was temporarily changed into an isotropic phase. The entire surface of the coating was then irradiated with ultraviolet rays at 20 mW/cm² for 20 sec, so that the aligned liquid crystal was fixed, resulting in the formation of a second retardation region. In this way, a patterned half-wave layer was prepared. The half-wave layer had a thickness of 1.6 μm and a tilt angle of substantially 90°. At a wavelength of 550 nm, the first retardation region has an Re of 275 nm and a total Rth of −80 nm in combination with the protective layer, and the second retardation region has an Re of 0 nm and an Rth of 0 nm.

### [Composition for Forming Retardation Layer]

| | | |
|---|---|---|
| Discotic liquid crystal E-1 | 100 | parts by mass |
| Alignment-film-interface alignment agent (II-1) | 1.0 | parts by mass |
| Air-interface alignment agent (P-1) | 0.4 | parts by mass |
| Photopolymerization initiator | 3.0 | parts by mass |
| (Irgacure 907, available from Ciba Specialty Chemicals Inc.) | | |
| Sensitizer | 1.0 | parts by mass |
| (KAYACURE DETX, available from NIPPON KAYAKU Co., Ltd.) | | |
| Methyl ethyl ketone | 300 | parts by mass |

Discotic liquid crystal E-1 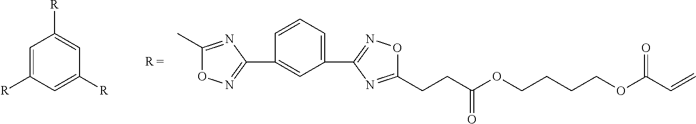
Alignment-film-interface alignment agent (II-1) 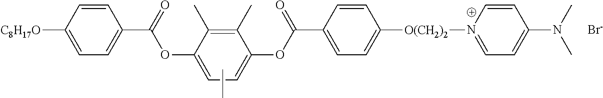
Air-interface alignment agent (P-1) 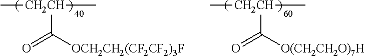
Mw. 39000

### [Preparation of Linearly Polarizing Layer]

A polyvinyl alcohol film 80 μm in thickness was stretched to five times its original length in an iodine aqueous solution, and was then dried to yield a linearly polarizing layer 30 μm in thickness.

### [Lamination of Patterned Half-Wave Layer and Linearly Polarizing Layer]

The linearly polarizing layer was bonded to a half-wave layer side of the patterned half-wave layer with an adhesive agent. The alkali-saponified, cellulose acetate protective film prepared in Example 2-1 was then bonded to the other side of the linearly polarizing layer with an adhesive agent, resulting in lamination of the patterned half-wave layer and the linearly polarizing layer. Here, the polarization axis of the linearly polarizing layer defined an angle of 45° with respect to the slow axis of the patterned half-wave layer. The thickness of the adhesive agent layer was 16 μm.

### [Lamination of Linearly Polarizing Layer and Stereo Picture Receiving Film]

The linearly polarizing layer with the patterned half-wave layer prepared as described above was bonded to the stereo picture receiving film with an adhesive agent. Here, the stripes of the patterned half-wave layer were aligned with the stripes printed on the stereo picture receiving film. The thickness of the adhesive agent layer was 16 μm.

In this way, a stereo picture print having the configuration illustrated in FIG. 8 was produced.

### [Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the patterned retardation layer (the direction of the polarization axis c illustrated in FIG. 4), through circular polarization glasses, and perceived a clear stereo picture with substantially no crosstalk.

The stereo picture print has a distance d of 122 μm between the patterned half-wave layer and the image receiving layer, and a pattern width p of 254 μm, namely, has a relatively small d/p of 0.48, which may be a cause of the substantially no crosstalk.

### 23. Example 2-11

### Preparation of Stereo Picture Printing Sheet

A stereo picture printing sheet was prepared, and data were printed on the stereo picture printing sheet, as in Example 2-10.

### [Production of Stereo Picture Print]

### [Preparation of Half-Wave Layer]

The coating solution for a half-wave layer prepared in Example 2-10 was applied onto the transparent support with the rubbing alignment layer prepared in Example 2-10. The coating was then dried for 1 min at a surface temperature of 80° C. to uniformly align the liquid crystal phase. The coating was then cooled to room temperature. A mask having a horizontal stripe width of 254 μm was then disposed on a substrate on which the coating solution for a half-wave layer was applied, and the coating was irradiated with ultraviolet rays for 5 sec with an air-cooled metal halide lamp (available from Eye Graphics Co., Ltd.) at 20 mW/cm² in air, so that the aligned liquid crystal was fixed, resulting in the formation of a first retardation region. An unirradiated portion of the coating was then washed away by ethanol solution to yield a patterned half-wave layer. The half-wave layer had a thickness of 1.6 μm and a tilt angle of substantially 90°. At a wavelength of 550 nm, the first retardation region has an Re of 275 nm and a total Rth of −80 nm in combination with the protective layer, and the washed region (the second retardation region) has an Re of 0 nm and an Rth of 0 nm.

### [Preparation of Linearly Polarizing Layer]

A polyvinyl alcohol film 80 μm in thickness was stretched to five times its original length in an iodine aqueous solution, and was then dried to yield a linearly polarizing layer 30 μm in thickness.

### [Lamination of Patterned Half-Wave Layer and Linearly Polarizing Layer]

The linearly polarizing layer was bonded to a half-wave layer side of the patterned half-wave layer with an adhesive agent, resulting in lamination of the patterned half-wave layer and the linearly polarizing layer. Here, the polarization axis of the linearly polarizing layer defined and angle of 45° with respect to the slow axis of the patterned half-wave layer. The thickness of the adhesive agent layer was 16 μm.

### [Lamination of Linearly Polarizing Layer and Stereo Picture Receiving Film]

The linearly polarizing layer with the patterned half-wave layer prepared as described above was bonded to the stereo picture receiving film with an adhesive agent. Here, the stripes of the patterned half-wave layer were aligned with the stripes printed on the stereo picture receiving film. The thickness of the adhesive agent layer was 16 μm.

In this way, a stereo picture print having the configuration illustrated in FIG. 9 was produced.

### [Observation of Stereo Picture]

An observer viewed the stereo picture print through circular polarization glasses and perceived a clear stereo picture without crosstalk and ghost images.

The observer viewed the stereo picture print, which was tilted by 30° toward a zero-degree direction of the patterned half-wave layer (the direction of the polarization axis c illustrated in FIG. 4), through circular polarization glasses, and perceived a clear stereo picture with substantially no crosstalk.

The stereo picture print has a distance d of 62 μm between the patterned half-wave layer and the image receiving layer, and a pattern width p of 254 namely, has a small d/p of 0.24, which may be a cause of the substantially no crosstalk.

### 24. Comparative Example 2-1

A laminate was prepared, which had the same configuration as that of the laminate prepared in Example 2-2 except that the image receiving layer 22 was not provided.

Images were formed on the surface of a cellulose acetate protective film laminated on a side opposite to a patterned retardation layer of a linearly polarizing layer by thermal transfer as in Example 2-1 and by inkjetting as in Example 2-2. The images each had a low density. In addition, dyes migrated on the cellulose acetate film. As a result, intended images were not formed. Consequently, an observer viewing the images through linear polarization glasses did not perceive a stereo picture.

### 25. Example 3-1

### Preparation of Stereo Picture Reversal Film

A reversal film (Fujichrome Velvia 50, available from FUJIFILM Corporation) was prepared.

Right-eye images and left-eye images were formed with a digital camera having left and right, photographing lens systems (FinePix Real 3D W1, available from FUJIFILM Corporation). Images were then created by alternating the right-eye images and the left-eye images every 200 μm with 3D imaging software (striper). The created image data was finally output onto the commercially available reversal film with Lightjet 2080 (resolution: 1016 dpi, reversal (RDP III)) to yield a transparent image for a three-dimensional stereograph (effective screen size: 178 mm×232 mm).

### [Preparation of Quarter-Wave Layer]

[Preparation of Transparent Support with Rubbing Alignment Film]

An aqueous 4% polyvinyl alcohol (PVA-103, available from Kuraray Co., Ltd.) solution was applied onto the surface of a commercially available, cellulose acetate film (Fujitac TD80UF, available from FUJIFILM Corporation, Re (550): 3 nm, Rth (630): 50 nm) with a #12 bar, and was dried at 80° C. for 5 min. The coating was then rubbed reciprocally in one direction three times at 400 rpm to yield a support with a rubbing alignment film. The thickness of the alignment film was 0.9 μm.

### [Preparation of Patterned Retardation Layer]

The following composition for forming a retardation layer was prepared, and was then passed through a polypropylene filter having a pore size of 0.2 μm to yield a coating solution for an optically anisotropic layer. The coating solution was applied onto the rubbing alignment film, and was dried for 1 min at a surface temperature of 80° C. to uniformly align the liquid crystal phase. The coating was then cooled to room temperature. A stripe mask having a pitch of 200 μm was then disposed on a substrate on which the coating solution for an optically anisotropic layer was applied, and the coating was irradiated with ultraviolet rays for 5 sec with an air-cooled metal halide lamp (available from Eye Graphics Co., Ltd.) at 20 mW/cm² in air, so that the aligned liquid crystal was fixed, resulting in the formation of a first retardation region. The coating was then heated to a surface temperature of 140° C. so that the liquid crystal phase was temporarily changed into an isotropic phase, and was then cooled to 100° C. at which the coating was then held for 1 min to uniformly align the liquid crystal. The coating was then cooled to room temperature. The entire surface of the coating was then irradiated with ultraviolet rays at 20 mW/cm² for 20 sec, so that the aligned liquid crystal was fixed, resulting in the formation of a second retardation region. In this way, a patterned retardation film 1 was prepared. The thickness of the retardation film 1 was 0.8 μm.

### [Composition for Forming Retardation Layer]

| | | |
|---|---|---|
| Discotic liquid crystal E-1 | 100 | parts by mass |
| Alignment-film-interface alignment agent (II-1) | 1.0 | parts by mass |
| Air-interface alignment agent (P-1) | 0.4 | parts by mass |
| Photopolymerization initiator | 3.0 | parts by mass |
| (Irgacure 907, available from Ciba Specialty Chemicals Inc.) | | |
| Sensitizer | 1.0 | parts by mass |
| (KAYACURE DETX, available from NIPPON KAYAKU Co., Ltd.) | | |
| Methyl ethyl ketone | 300 | parts by mass |

Discotic liquid crystal E-1 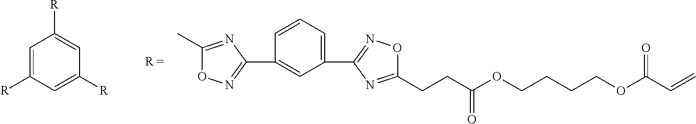
Alignment-film-interface alignment agent (II-1) 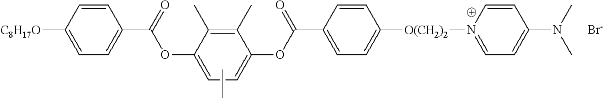
Air-interface alignment agent (P-1) 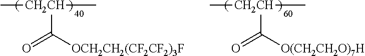
Mw. 39000

The patterned retardation layer was interposed between two orthogonally combined polarizing plates such that the slow axis of one of the first and second retardation regions was parallel to one of the polarization axes of the two polarizing plates. In addition, a sensitive color plate having a retardation of 530 nm was disposed on the retardation layer such that the slow axis of the sensitive color plate defined an angle of 45° with respect to each polarization axis of the polarizing plates. A state where the retardation layer was rotated +45°, and a state where the retardation layer was rotated −45° were observed with a polarization microscope (ECLIPE E600 W POL, available from NIKON CORPORATION). At the +45-degree rotation state, the slow axis of the first retardation region was parallel to the slow axis of the sensitive color plate; hence, the sensitive color plate had a retardation of larger than 530 nm, and its color varied to blue. In contrast, the slow axis of the second retardation region was perpendicular to the slow axis of the sensitive color plate; hence, the sensitive color plate had a retardation of smaller than 530 nm, and its color varied to yellow. At the −45 degree rotation state, a converse phenomenon occurred. These results revealed that the in-plane slow axes of the first and second retardation regions were orthogonal to each other.

### [Evaluation of Retardation Film]

With the patterned retardation film 1, a tilt angle of the discotic liquid crystal at an interface with the alignment film (an angle of a disc plane to a layer plane of a molecule), a tilt angle of the discotic liquid crystal at an interface with air, Re, and Rth were measured in accordance with the above-described procedure with KOBRA-21ADH (available from Oji Scientific Instruments). Table 1 shows the results. In Table 1, “perpendicular” refers to a tilt angle of 70° to 90°. In addition, with the patterned retardation film 1, the directions of the in-plane slow axes of the first and second retardation regions were determined in accordance with the above-described procedure with KOBRA-21ADH (available from Oji Scientific Instruments). Table 1 also shows the relationship between each direction of the in-plane slow axes of the first and second retardation regions and the rubbed direction of the alignment film.

TABLE 1

| | | Tilt angle | | Optical characteristics | |
|---|---|---|---|---|---|
| | Slow axis direction | Alignment film side | Air interface | Re | Rth |
| Patterned retardation film 1 | Orthogonal | Perpendicular | Perpendicular | 140 nm | −38 nm |
| | Parallel | Perpendicular | Perpendicular | 140 nm | −38 nm |

The results in Table 1 demonstrate that the patterned retardation film 1 contains the discotic liquid crystal fixed to a perpendicular alignment state, and functions as a quarter-wave film including the first and second retardation regions having orthogonal in-plane slow axes.

### [Preparation of Polarizing Film]

A rolled polyvinyl alcohol film 80 μm in thickness was continuously stretched to five times its original length in an iodine solution, and was then dried to yield a polarizing film 30 μm in thickness.

The patterned retardation film 1 prepared as described above was bonded to the polarizing film with an adhesive agent while being rotated by 45°. During the bonding, the patterned retardation film 1, the linearly polarizing layer, and the reversal image were bonded together with an adhesive agent while being illuminated by a backlight to be viewed by an observer wearing circular polarization glasses. The thickness of each adhesive agent layer was 16 μm.

In this way, a stereo picture print having a configuration as illustrated in FIG. 19 was produced.

### Experimental Evaluation

As illustrated in FIG. 19, an observer viewed the stereo picture print through circular polarization glasses for right and left eyes while illuminating the stereo picture print by a backlight, and perceived a clear stereo picture exhibiting a good sense of depth without crosstalk and ghost images.

Furthermore, the observer viewed the stereo picture print, which was tilted by 30° toward a zero-degree direction of the patterned quarter-wave layer (the direction of the polarization axis c illustrated in FIG. 2), through circular polarization glasses, and perceived a clear stereo picture with substantially no crosstalk.

The stereo picture print has a distance d of 62 μm between the patterned quarter-wave layer and the image receiving layer, and a pattern width p of 200 μm, namely, has a small d/p of 0.31, which may be a cause of the substantially no crosstalk. 26. Example 3-2: Example using quarter retardation by light aligning film

### [Production of Stereo Picture Printing Sheet]

### [Preparation of Stereo Picture Reversal Film]

A reversal film (Fujichrome Velvia 50, available from FUJIFILM Corporation) was prepared, and a 3D image was formed as in Example 3-1.

### (Preparation of Quarter-Wave Layer)

### [Preparation of Light Aligning Film]

Aqueous solution of light aligning material E-1 (1%) having the following structure was applied by spin coating on the surface of the protective film (thickness: 40 μm, front Re: 1 nm) for the linearly polarizing layer, and was dried at 100° C. for 1 min. The coating was irradiated with ultraviolet rays with an air-cooled metal halide lamp (available from Eye Graphics Co., Ltd.) at 160 W/cm² in air. In this exposure, as illustrated in FIG. 13A, a wire grid polarizer (ProFlux PPL02, available from Moxtek, Inc.) was disposed in direction 1, and exposed through a mask A (a quartz exposure mask having an image pattern). In the subsequent exposure, as illustrated in FIG. 13B, the wire grid polarizer was disposed in direction 2, and exposed through a mask B. The distance between the surface of the exposure mask and the light aligning film was set to 200 μm. The ultraviolet rays had an illuminance of 100 mW/cm² and an irradiance of 1000 mJ/cm² in the UV-A region (integration of wavelength 380 to 320 nm).

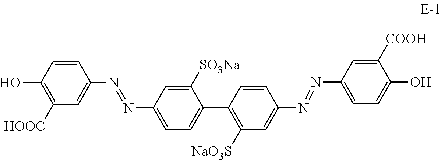

### [Preparation of Quarter-Wave Layer]

The following composition for a quarter-wave layer was prepared, and was then passed through a polypropylene filter having a pore size of 0.2 μm to yield a coating solution for a quarter-wave layer. The coating solution was applied, and dried for 2 min at a surface temperature of 105° C. into a liquid crystal phase. The coating was then cooled to 75° C. at which the liquid crystal was irradiated with ultraviolet rays with an air-cooled metal halide lamp (available from Eye Graphics Co., Ltd.) at 160 W/cm² in air, so that the aligned liquid crystal was fixed. As a result, a quarter-wave layer 1.3 μm in thickness, which was patterned to have slow axes defining ±45° with respect to the polarization axis of the linearly polarizing layer, was prepared. The quarter-wave layer had a tilt angle of substantially 1°, an Re of 138 nm, and a total Rth of 13 nm in combination with the protective layer at a wavelength of 550 nm.

### [Composition for Quarter-Wave Layer]

| | | |
|---|---|---|
| Rod-like liquid crystal I-27 | 100 | parts by mass |
| Horizontal alignment agent A | 0.3 | parts by mass |
| Photopolymerization initiator | 3.3 | parts by mass |
| (Irgacure 907, available from Ciba Specialty Chemicals Inc.) | | |
| Sensitizer | 1.1 | parts by mass |
| (KAYACURE-DETX, available from NIPPON KAYAKU Co., Ltd.) | | |
| Methyl ethyl ketone | 300 | parts by mass |

Rod-like liquid crystal I-27 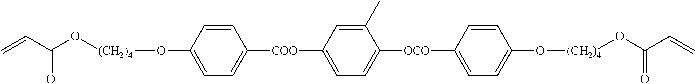
Horizontal alignment agent A 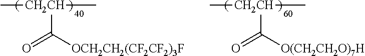
Mw. 39000

In this way, the laminate of the polarizing film and the patterned quarter-wave layer was bonded to the reversal image to yield a stereo picture print having a configuration as illustrated in FIG. 19, where the light aligning film was disposed between the patterned quarter-wave layer and the polarizing layer instead of the adhesive layer.

An observer viewed the stereo picture print through circular polarization glasses. The polarization glasses were composed of a left-eye circular polarization filter and a right-eye circular polarization filter, each filter including a laminate of a linear polarization filter and a quarter-wave retardation film, where the polarization axis of the linear polarization filter defined an angle of 45° with respect to the slow axis of the quarter-wave retardation film, and the polarization axes of the linear polarization filters for left and right eyes were orthogonal to each other.

The observer perceived a clear stereo picture exhibiting a good sense of depth without crosstalk and ghost images.

Furthermore, an observer viewed the stereo picture print, which was tilted by 30° toward a zero-degree direction of the patterned quarter-wave layer (the direction of the polarization axis c illustrated in FIG. 2), through circular polarization glasses, and perceived a clear stereo picture with substantially no crosstalk.

The stereo picture print has a distance d of 86 μm between the patterned quarter-wave layer and the image receiving layer, and a pattern width p of 200 μm, namely, has a relatively small d/p of 0.43, which may be a cause of the substantially no crosstalk.

### 27. Example 3-3

### Production of Stereo Picture Printing Sheet

### [Preparation of Stereo Picture Reversal Film]

A reversal film (Fujichrome Velvia 50, available from FUJIFILM Corporation) was prepared, and a 3D image was formed as in Example 3-1.

(Preparation of Protective Layer)

The following composition was put into a mixing tank, and was stirred while being heated to dissolve the components, thereby a cellulose acylate solution A was prepared.

### [Composition of Cellulose Acylate Solution A]

| | |
|---|---|
| Cellulose acetate with degree of | 100 parts by mass |
| acetylation of 2.86 | |
| Triphenyl phosphate (plasticizer) | 7.8 parts by mass |
| Biphenyl diphenyl phosphate | 3.9 parts by mass |
| (plasticizer) | |
| Methylene chloride (first solvent) | 300 parts by mass |
| Methanol (second solvent) | 54 parts by mass |
| 1-Butanol | 11 parts by mass |

The following composition was put into another mixing tank, and was stirred while being heated to dissolve the components, thereby an additive solution B was prepared.

### [Composition of Additive Solution B]

| | |
|---|---|
| Compound B1 (Re reducer) | 40 parts by mass |
| Compound B2 (wavelength dispersion control agent) | 4 parts by mass |
| Methylene chloride (first solvent) | 80 parts by mass |
| Methanol (second solvent) | 20 parts by mass |

Compound B1 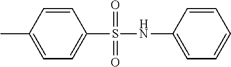 [SMILES: Cc1ccc(S(=O)(=O)Nc2ccccc2)cc1]
Compound B2

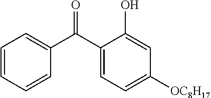

### [Preparation of Cellulose Acetate Protective Film]

To 477 parts by mass of the cellulose acylate solution A was added 40 parts by mass of the additive solution B. The mixture was then sufficiently stirred to prepare a dope. The dope was casted from a cast port onto a drum cooled at 0° C. The cast film was peeled at a solvent content of 70 mass %. The film was then fixed at its two lateral ends with a pin tenter as illustrated in FIG. 3 of JP-A-4-1009, and was dried at a constant width allowing a draw rate of 3% in a lateral direction (a direction perpendicular to a machine direction) at a solvent content of 3 to 5 mass %. The film was then conveyed through rolls of heat treatment equipment to be further dried, so that a cellulose acetate protective film 60 μm in thickness was prepared.

The front Re of the protective film was 2.0 nm.

### (Preparation of Linearly Polarizing Layer)

The cellulose acetate protective film was immersed in 1.5 N sodium hydroxide solution at 55° C. for 2 min. The film was then washed in a rinsing bath at room temperature, and was then neutralized with 0.1 N sulfuric acid at 30° C. The film was washed in a rinsing bath at room temperature again, and was further dried in hot air at 100° C. In this way, the surface of the cellulose acylate protective film was saponified.

A rolled polyvinyl alcohol film 80 μm in thickness was then continuously stretched to five times its original length in an iodine solution, and was then dried to yield a linearly polarizing film. Two alkali-saponified, cellulose acylate protective films were bonded to two sides of the linearly polarizing film with an aqueous 3% polyvinyl alcohol (PVA-117H, available from Kuraray Co., Ltd.) solution as an adhesive agent, resulting in a linearly polarizing layer having two sides protected by the cellulose acylate protective film. Here, the cellulose acylate protective film on either side had a slow axis parallel to the transmission axis of the linearly polarizing film.

### (Preparation of Patterned Retardation Layer)

### [Preparation of Coating Solution CU-1 for Release Layer]

The following composition was prepared, and was then passed through a polypropylene filter having a pore size of 30 μm to yield a coating solution CU-1 for a release layer.

B-1 is a copolymer of methyl methacrylate, 2-ethyl hexyl acrylate, benzyl methacrylate, and methacrylic acid, which has a proportion (molar ratio) of 55/30/10/5, a weight-average molecular weight of 100,000, and a Tg of about 70° C.

B-2 is a copolymer of styrene and acrylic acid, which has a proportion (molar ratio) of 65/35, a weight-average molecular weight of 10,000, and a Tg of about 100° C.

Composition of Coating Solution for Dynamic-Property Control Layer (%)

| | |
|---|---|
| Binder (B-1) | 5.89 |
| Binder (B-2) | 13.74 |
| BPE-500 (available from Shin- | 9.20 |
| Nakamura Chemical Co., Ltd.) | |
| MEGAFAC F-780-F (available | 0.55 |
| from DIC Corporation) | |
| Methanol | 11.22 |
| Propyleneglycol monomethylether | 6.43 |
| acetate | |
| Methyl ethyl ketone | 52.97 |

### [Preparation of Coating Solution AL-1 for Alignment Layer]

The following composition was prepared, and was then passed through a polypropylene filter having a pore size of 30 μm to yield a coating solution AL-1 for an alignment layer.

Composition of Coating Solution for Alignment Layer (%)

| | |
|---|---|
| Polyvinyl alcohol (PVA-205, available | 3.21 |
| from Kuraray Co., Ltd.) | |
| Polyvinylpyrrolidone (Luvitec K 30, | 1.48 |
| available from BASF) | |
| Distilled water | 52.10 |
| Methanol | 43.21 |

### [Preparation of Coating Solution LC-1 for Retardation Layer]

The following composition was prepared, and was then passed through a polypropylene filter having a pore size of 0.2 μm to yield a coating solution LC-1 for a retardation layer.

I-22 is a liquid crystal compound having two reactive groups, i.e., an acrylic group being a radical reactive group and an oxetanyl group being a cationic reactive group.

Composition of Coating Solution for Retardation Layer (%)

| | |
|---|---|
| Rod-like liquid crystal (I-22) | 32.59 |
| Horizontal alignment agent (LC-1-2) | 0.02 |
| Cationic photopolymerization initiator (CP1100-P, available from San-Apro Ltd.) | 0.66 |
| Polymerization initiator (IRGANOX1076, available from Ciba Speciality Chemicals Inc.) | 0.07 |
| Methyl ethyl ketone | 66.66 |

I-22 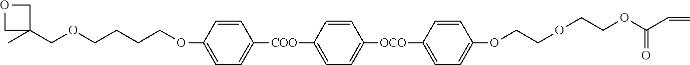
Horizontal alignment agent (LC-1-2)

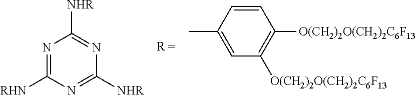

### (Preparation of Coating Solution AD-1 for Radical-Polymerization-Initiator Supply Layer)

The following composition was prepared, and was then passed through a polypropylene filter having a pore size of 0.2 μm to yield a coating solution AD-1 for a radical-polymerization-initiator supply layer.

B-3 is a copolymer of benzyl methacrylate, methacrylic acid, and methyl methacrylate, which has a proportion (molar ratio) of 35.9/22.4/41.7, and a weight-average molecular weight of 38,000.

2-Trichloromethyl-5-(p-styrylstyryl)-1,3,4-oxadiazole was used as RPI-1.

Composition of Coating Solution for Radical-Polymerization-Initiator Supply Layer (Mass %)

| | |
|---|---|
| Binder (B-3) | 8.05 |
| KAYARAD DPHA (available from | 4.83 |
| NIPPON KAYAKU Co., Ltd.) | |
| Radical Photopolymerization initiator | 0.12 |
| (RPI-1) | |
| Hydroquinone monomethyl ether | 0.002 |
| MEGAFAC F-176PF (available from | 0.05 |
| DIC Corporation) | |
| Propyleneglycol monomethylether | 34.80 |
| acetate | |
| Methyl ethyl ketone | 50.538 |
| Methanol | 1.61 |

### [Preparation of Patterned Retardation Layer]

The coating solution CU-1 for a release layer and the coating solution AL-1 for an alignment layer were sequentially applied onto a provisional polyimide-film support 75 μm in thickness with a wire bar, and were dried. The dried thicknesses of the release layer and the alignment layer were 14.6 μm and 1.6 μm, respectively. The coating solution LC-1 for a retardation layer was then applied on the alignment layer with a wire bar, and was dried at a surface temperature of 90° C. for 2 min into a liquid crystal phase. The coating was then irradiated with ultraviolet rays with an air-cooled metal halide lamp (available from Eye Graphics Co., Ltd.) at 160 W/cm² in air, so that the aligned liquid crystal was fixed, resulting in the formation of a retardation layer 3.2 μm in thickness. The ultraviolet rays had an illuminance of 100 mW/cm² and an irradiance of 80 mJ/cm² in the UV-A region (integration of wavelength 320 nm to 400 nm). The coating solution AD-1 for a radical-polymerization-initiator supply layer was further applied onto the retardation layer, and was dried to form a radical-polymerization-initiator supply layer 1.2 μm in thickness, which was then subjected to pattern exposure at a light exposure of 50 mJ/cm² through a mask aligner M-3L available from Mikasa Co. Ltd. and a photomask I. The radical-polymerization-initiator supply layer was then baked for 1 hr in a clean oven at 230° C., thereby an unexposed portion was thermally fixed to an isotropic phase, resulting in the formation of a patterned half-wave layer. The patterned half-wave layer had a retardation of 275 nm (half wavelength) in plane of the exposed portion, and a retardation of 0 nm in plane of the unexposed portion at a wavelength of 550 nm.

In this way, the laminate of the linearly polarizing film and the patterned half-wave layer was prepared. In the lamination, the absorption axis of the linearly polarizing film defined an angle of 45° with respect to the in-plane slow axis of the domain of the half-wave layer.

### [Production of Stereo Picture Print]

The laminate of the linearly polarizing film and the patterned half-wave layer was bonded to the reversal image. If the right-eye pixel was formed at a position corresponding to the second domain having an Re of half wavelength, the left-eye pixel was formed at a position corresponding to the first domain having an Re of 0 nm. In contrast, if the right-eye pixel was formed at a position corresponding to the first domain having an Re of 0 nm, the left-eye pixel was formed at a position corresponding to the second domain having an Re of half wavelength.

An observer viewed the stereo picture print through linear polarization glasses, and perceived a clear stereo picture exhibiting a good sense of depth without crosstalk and ghost images.

### 28. Example 3-4

### Production of Stereo Picture Print

A stereo picture print was produced as in Example 3-3 except that the additive B1 (Re reducer) and the additive B2 (wavelength dispersion control agent) were omitted from the additive solution B for preparation of the protective layer. The protective layer (cellulose acetate protective film) had a thickness of 200 μm, an Re value of 15 nm, and an Rth of 85 nm at 550 nm.

### [Observation of Stereo Picture]

An observer viewed the stereo picture print through polarization glasses and perceived a stereo picture with some ghost images caused by the high Re of the protective layer.

### 29. Example 3-5

### Preparation of Linearly Polarizing Layer

An aqueous 4% polyvinyl alcohol (PVA-103, available from Kuraray Co., Ltd.) solution was applied onto the back (a side on which the patterned quarter-wave layer was not provided) of the TAC film 80 μm in thickness as a support of the patterned retardation film 1 prepared in Example 3-1 with a #12 bar, and was dried at 80° C. for 5 min. The coating was then reciprocally rubbed three times at 400 rpm to yield a protective layer with a rubbing alignment film. The thickness of the alignment film was 0.5 μm.

Yellow azo dye A2-3 (0.24 parts by mass, a compound represented by general formula (II)) having the following structure, 0.33 parts by mass of magenta azo dye A-46 (a compound represented by general formula (I)) having the following structure, 0.37 parts by mass of cyan azo dye A3-1 (a compound represented by general formula (III)) having the following structure, and 0.06 parts by mass of squarylium dye VI-5 having the following structure were mixed in 99 parts by mass of chloroform, and were stirred to be dissolved in the chloroform. The solution was then filtered to prepare a coating solution for a linearly polarizing layer. The coating solution was then applied onto the rubbing alignment film, and was spontaneously dried at room temperature to give a linearly polarizing layer. The linearly polarizing layer had a thickness of 0.4 μm and a dichroic ratio of 42. The composition for the linearly polarizing layer had a thermotropic liquid crystallinity having an isotropic phase transition temperature of 240° C.

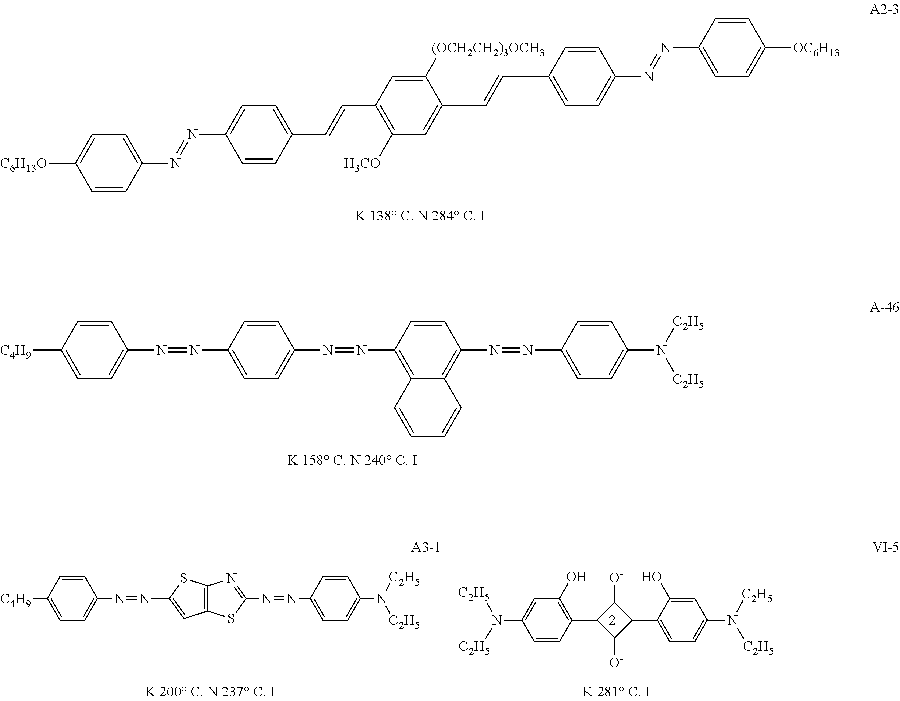

### (Preparation of Coating Solution for Oxygen Insulation Layer)

The following composition was put into a mixing tank, and was stirred to prepare a coating solution for an oxygen insulation layer.

Polyvinyl alcohol (3.2 parts by mass, PVA-205, available from Kuraray Co., Ltd.), 1.5 parts by mass of polyvinylpyrrolidone (PVP K-30, available from Nippon Shokubai Co., Ltd.), 44 parts by mass of methanol, and 56 parts by mass of water were mixed and stirred. The mixture was passed through a polypropylene filter having a pore size of 0.4 μm to prepare the coating solution for an oxygen insulation layer.

### (Preparation of Oxygen Insulation Layer)

The coating solution for an oxygen insulation layer was applied onto the above-described linearly polarizing layer and dried at 100° C. for 2 min to yield an oxygen insulation layer. The oxygen insulation layer had a thickness of 1 μm and a front Re of 0 nm.

(Preparation of Coating Solution for Transparent Resin Hardening Layer)

The following composition was put into a mixing tank, and was stirred to prepare a coating solution for a transparent resin hardening layer.

Poly(glycidyl methacrylate) having a mass-average molecular weight of 15000 (2.7 parts by mass), 7.3 parts by mass of methyl ethyl ketone, 5.0 parts by mass of cyclohexanone, and 0.5 parts by mass of photopolymerization initiator (Irgacure 184, available from Ciba Specialty Chemicals Inc.) were mixed in 7.5 parts by mass of trimethylolpropane tri-acrylate (Biscoat #295 available from Osaka Organic Chemical Industry, Ltd.), and the mixture was then stirred. The mixture was then passed through a polypropylene filter having a pore size of 0.4 μm to prepare the coating solution for a transparent resin hardening layer.

### (Preparation of Transparent Resin Hardening Layer)

The coating solution for a transparent resin hardening layer was applied onto the above-described oxygen insulation layer and dried at 100° C. for 2 min. The coating was then polymerized by 5-J ultraviolet rays under a nitrogen atmosphere (oxygen concentration: 100 ppm or less), resulting in the formation of a laminate of the oxygen insulation layer 1 μm in thickness and the transparent resin hardening layer 2 μm in thickness which were sequentially laminated on the surface of the linearly polarizing layer 0.4 μm in thickness. The transparent resin hardening layer had an in-plane retardation Re of 0 nm.

In this way, the laminate of the linearly polarizing layer and the patterned quarter-wave layer was prepared.

The laminate was bonded to the reversal image (produced as in Example 3-1) to yield a stereo picture print as in Example 3-1 except that the laminate was used.

An observer viewed the stereo picture print through circular polarization glasses, and perceived a clear stereo picture exhibiting a good sense of depth without crosstalk and ghost images, as in Example 3-1.

The observer viewed the stereo picture print, which was tilted by 30° toward a zero-degree direction of the patterned quarter-wave layer (the direction of the polarization axis c illustrated in FIG. 2), through circular polarization glasses, and perceived a clear stereo picture with substantially no crosstalk.

The stereo picture print has a distance d of 100.8 μm between the patterned quarter-wave layer and the image receiving layer, and a pattern width p of 200 μm, namely, has a relatively small d/p of 0.50, which may be a cause of the substantially no crosstalk.

Furthermore, the stereo picture print achieved a high dichroic ratio due to the thin, linearly polarizing film compared with the stereo picture print in Example 3-1, resulting in perception of a bright stereo picture.

### 30. Example 3-6

A stereo picture print was prepared as in Example 3-5 except that the composition for the linearly polarizing layer for preparation of the linearly polarizing layer was modified to the following composition. The linearly polarizing layer had a thickness of 0.4 μm and a dichroic ratio of 37.

### [Composition for Linearly Polarizing Layer]

| | |
|---|---|
| (1) Yellow azo dye A2-3 | 0.2 parts by mass |
| (2) Magenta azo dye C-9 | 0.4 parts by mass |
| (3) Cyan azo dye A3-1 | 0.4 parts by mass |
| (4) Chloroform | 99 parts by mass |

C-9 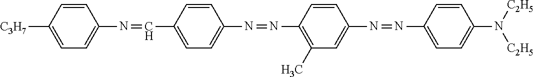
K 167° C. N 288° C. I

### [Observation of Stereo Picture]

An observer viewed the stereo picture print through circular polarization glasses and perceived a bright and clear stereo picture without crosstalk and ghost images, as in Example 3-5.

The observer viewed the stereo picture print, which was tilted by 30° toward a zero-degree direction of the patterned quarter-wave layer (the direction of the polarization axis c illustrated in FIG. 2), through circular polarization glasses, and perceived a clear stereo picture with substantially no crosstalk.

The stereo picture print has a distance d of 100.8 μm between the patterned quarter-wave layer and the image receiving layer, and a pattern width p of 200 μm, namely, has a relatively small d/p of 0.50, which may be a cause of the substantially no crosstalk.

### 31. Example 3-7

### Production of Stereo Picture Print

A stereo picture print was prepared as in Example 3-5 except that the composition for the linearly polarizing layer for preparation of the linearly polarizing layer was modified to the following composition. The linearly polarizing layer had a thickness of 0.8 μm and a dichroic ratio of 71.

[Composition for Linearly Polarizing Layer]

| | |
|---|---|
| (1) Magenta azo dye A-16 | 1.2 parts by mass |
| (2) Magenta azo dye B-4 | 0.8 parts by mass |
| (3) Chloroform | 98 parts by mass |

A-16 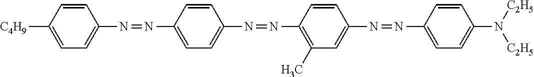
K 137° C. N 266° C. I
B-4 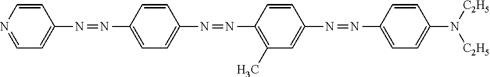 [SMILES: CCN(CC)c1ccc(N=Nc2ccc(N=Nc3ccc(N=Nc4ccncc4)cc3)c(C)c2)cc1]
K 235° C. N 240° C. I

### [Observation of Stereo Picture]

An observer viewed the stereo picture print through circular polarization glasses and perceived a bright and clear stereo picture without crosstalk and ghost images, as in Example 3-5.

The observer viewed the stereo picture print, which was tilted by 30° toward a zero-degree direction of the patterned quarter-wave layer (the direction of the polarization axis c illustrated in FIG. 2), through circular polarization glasses, and perceived a clear stereo picture with substantially no crosstalk.

The stereo picture print has a distance d of 101.2 μm between the patterned quarter-wave layer and the image receiving layer, and a pattern width p of 200 μm, namely, has a relatively small d/p of 0.50, which may be a cause of the substantially no crosstalk.

### 32. Example 3-8

### Production of Stereo Picture Print

A stereo picture print was prepared as in Example 3-2 except that a protective film having a thickness of 100 μm and a front Re of 1 nm was used.

[Observation of Stereo Picture]

An observer viewed the stereo picture print through circular polarization glasses and perceived a bright and clear stereo picture without crosstalk and ghost images, as in Example 3-2.

The observer viewed the stereo picture print, which was tilted by 30° toward a zero-degree direction of the patterned quarter-wave layer (the direction of the polarization axis c illustrated in FIG. 2), through circular polarization glasses, and perceived a stereo picture with some crosstalk.

The stereo picture print has a distance d of 146 μm between the patterned quarter-wave layer and the image receiving layer, and a pattern width p of 200 μm, namely, has a relatively large d/p of 0.73, which may be a cause of the crosstalk.

### 33. Example 3-9

### Production of Stereo Picture Print

A stereo picture print was prepared as in Example 3-2 except that a protective film having a thickness of 600 μm and a front Re of 1 nm was used.

### [Observation of Stereo Picture]

An observer viewed the stereo picture print through circular polarization glasses and perceived a bright and clear stereo picture without crosstalk and ghost images, as in Example 3-2.

The observer viewed the stereo picture print, which was tilted by 30° toward a zero-degree direction of the patterned quarter-wave layer (the direction of the polarization axis c illustrated in FIG. 2), through circular polarization glasses, and perceived a stereo picture with noticeable crosstalk.

The stereo picture print has a distance d of 646 μm between the patterned quarter-wave layer and the image receiving layer, and a pattern width p of 200 μm, namely, has a large d/p of 3.23, which may be a cause of the noticeable crosstalk.

### 34. Comparative Example 3-1

A laminate was prepared, which had the same configuration as that of the laminate prepared in Example 3-1 except that an emulsion layer was omitted from the reversal film, and only the support film was provided instead of the reversal film.

An observer viewed such a stereo picture print through circular polarization glasses as in Example 3-1 and did not perceive a stereo picture.
10A-10I, 20A-20J printing sheet for stereo picture
12, 22 light-transmissive image receiving layer
14, 24 linearly polarizing layer
14a, 14b protective layer 1 of linearly polarizing layer
15, 25 alignment layer
16 quarter-wavelength layer
17 adhesive agent layer
26 retardation layer
18 transparent support
18′ support
19 reflective layer
30 polymerization initiator-supplying layer

The present disclosure relates to the subject matter contained in Japanese Patent Application No. 122728/2010, filed on May 28, 2010, Japanese Patent Application No. 122729/2010, files on May 28, 2010, Japanese Patent Application No. 170602/2010, files on Jul. 29, 2010, and Japanese Patent Application No. 242855/2010 filed on October 28, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A printing sheet for printing a stereo picture comprising, in sequence:
a light-transmissive image receiving layer;
a linearly polarizing layer; and
a retardation layer,
wherein the retardation layer is formed by fixing in an aligned state a composition containing a compound having refractive index anisotropy and is patterned into a first domain and a second domain which have different in-plane slow axes or have different in-plane retardations.

2. The printing sheet according to claim 1, wherein the retardation layer is formed by applying the composition by any one of coating, blowing, and dropping.

3. The printing sheet according to claim 1, wherein the light-transmissive image receiving layer is formed by any one of coating, blowing, and dropping.

4. The printing sheet according to claim 1, wherein the light-transmissive image receiving layer is an image forming layer capable of receiving an image by silver halide photography, thermal transfer, or ink jetting.

5. The printing sheet according to claim 1, wherein the retardation layer comprises a quarter-wave plate, the in-plane slow axes of the first and second domains defining an angle of 90 degrees, each of the in-plane slow axes of the first and second domains and the polarization axis of the linearly polarizing layer defining an angle of ±45 degrees.

6. The printing sheet according to claim 1, wherein the in-plane retardation of the first domain of the retardation layer is 0, the in-plane retardation of the second domain of the retardation layer corresponds to a half wavelength, and the polarization axis of the linearly polarizing layer and the in-plain slow axis of the second domain define an angle of 45 degrees.

7. The printing sheet according to claim 1, wherein the linearly polarizing layer comprises a coat-type linearly polarizing layer formed by coating a liquid crystal composition containing a dichroic dye.

8. The printing sheet according to claim 1, wherein the retardation layer is obtained by curing a liquid crystal composition.

9. The retardation layer according to claim 8, wherein the retardation layer is obtained by curing a liquid crystal composition, and alignment of the liquid crystal is controlled by a pattern-exposed light aligning film.

10. The printing sheet according to claim 1, further comprising a protective layer between the linearly polarizing layer and the retardation layer, the protective layer protecting the linearly polarizing layer and having an in-plane retardation Re(550) at a wavelength of 550 nm of 0 to 10 nm.

11. The printing sheet according to claim 10, wherein absolute of the sum of the retardations Rth(550) in the thickness direction at a wavelength of 550 nm of the protective layer and the retardation layer is 20 nm or less.

12. The printing sheet according to claim 1, wherein the light-transmissive image receiving layer comprises an image receiving layer capable of receiving an image by silver halide photography and comprises a blue-sensitive emulsion layer, a green-sensitive emulsion layer, and a red-sensitive emulsion layer.

13. The printing sheet according to claim 1, wherein the light-transmissive image receiving layer comprises an image receiving layer capable of receiving an image by thermal transfer and at least one dye receiving polymer.

14. The printing sheet according to claim 1, wherein the light-transmissive image receiving layer comprises an image receiving layer capable of receiving an image by ink jetting and comprises a water-soluble polymer and an inorganic fine particle.

15. The printing sheet according to claim 1, wherein the linearly polarizing layer comprises at least one dichroic dye of the group consisting of dichroic dyes represented by Formulae (I), (II), (II), (IV), and (V): 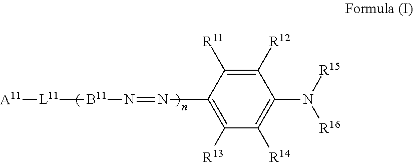
where R¹¹ to R¹⁴ each independently represent a hydrogen atom or a substituent; R¹⁵ and R¹⁶ each independently represent a hydrogen atom or an alkyl group that optionally has a substituent; L¹¹ represents —N═N—, —CH═N—, —N═CH—, —C(═O)O—, —OC(═O)—, or —CH═CH—; A¹¹ represents a phenyl group that optionally has a substituent, a naphthyl group that optionally has a substituent, or a divalent aryl hydrocarbon or divalent aryl heterocyclic group that optionally has a substituent; B¹¹ represents a divalent aryl hydrocarbon or divalent aryl heterocyclic group that optionally has a substituent; and n represents an integer of 1 to 5, where B¹¹'s may be the same or different when n is 2 or more; 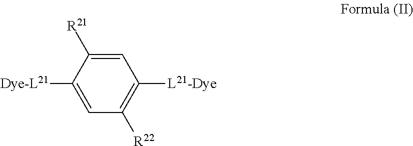
where R²¹ and R²² each represent a hydrogen atom, an alkyl group, an alkoxy group, or a substituent represented by -L²²-Y, provided that at least one of R²¹ and R²² represents a group other than an hydrogen atom; L²² represents an alkylene group, where one CH₂ group or two or more joining CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— where R represents a hydrogen atom or a C₁₋₄ alkyl group; Y represents a hydrogen atom, a hydroxy group, an alkoxy group, a carboxyl group, a halogen atom, or a polymerizable group; L²¹'s each represent a linker selected from the group consisting of an azo group (—N═N—), carbonyloxy group (—C(═O)O—), oxycarbonyl group (—O—C(═O)—), an imino group (—N═CH—), and vinylene group (—C═C—); Dye represents an azo dye residue represented by Formula (IIa): 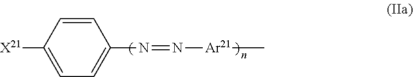
wherein * represents a linker to L²¹; X²¹ represents a hydroxyl group, a substituted or nonsubstituted alkyl group, a substituted or nonsubstituted alkoxy group, a nonsubstituted amino group, or a nono- or dialkylamino group; Ar²¹ represents an aryl hydrocarbon or aryl heterocyclic group that optionally has a substituent; n represents an integer of 1 to 3 where two Ar²¹'s may be the same or different when n is 2 or more; 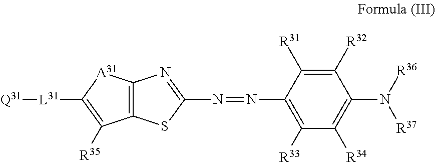
where R³¹ to R³⁵ each independently represent a hydrogen atom or a substituent; R³⁶ and R³⁷ each independently represent a hydrogen atom or an alkyl group that optionally has a substituent; Q³¹ represents an aryl hydrocarbon, aryl heterocyclic, or cyclohexane ring group that optionally has a substituent; L³¹ represents a divalent linker; and A³¹ represents an oxygen or sulfur atom; 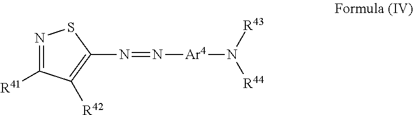
where R⁴¹ and R⁴² each represents a hydrogen atom or substituent or are optionally be joined to each other to form a ring; Ar⁴ represents a divalent aryl hydrocarbon or divalent aryl heterocyclic ring that is optionally substituted; R⁴³ and R⁴⁴ each represent a hydrogen atom or an alkyl group that is optionally substituted or are optionally be joined to each other to form a ring; and 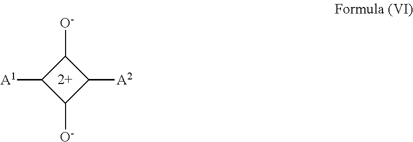
where A¹ and A² each independently represent a substituted or unsubstituted hydrocarbon or heterocyclic group.

16. The printing sheet according to claim 1, wherein the distance d between the retardation layer and the image receiving layer is 500 μm or less.

17. The printing sheet according to claim 1, wherein the ratio (d/p) of the distance d between the retardation layer and the image receiving layer to the distance p between pattern border lines of the first and second domains is 3 or less.

18. A stereo picture print comprising:
the printing sheet according to claim 1; and
a left-eye image and a right-eye image formed on the light-transmissive image receiving layer of the printing sheet, the left-eye image and the right-eye image having parallax,
pixels constituting the left-eye image and pixels constituting the left-eye image are formed positions corresponding to the first domain and the second domain, respectively, of the retardation layer of the printing sheet.

19. The stereo picture print according to claim 18, further comprising a reflective layer not cancelling unpolarized light, the reflective layer being disposed on a side opposite to a viewer side of an observer.

20. A method of manufacturing a stereo picture print, comprising:
forming a left-eye image and a right-eye image having parallax by LightJet printing on the light-transmissive image receiving layer according to claim 1 such that the left-eye image and the right-eye image correspond to positions of the first domain and the second domain, respectively, of the printing sheet.

21. A method of manufacturing a stereo picture print, comprising:
overlaying a thermal transfer sheet comprising a dye on the printing sheet according to claim 1;
heating the thermal transfer sheet with a thermal head generating heat controlled by electrical signals to transfer a left-eye image and a right-eye image having parallax onto positions corresponding to the first and second domain, respectively, of the retardation layer of the printing sheet through transfer of the dye.

22. A method of manufacturing a stereo image print, comprising:
forming a left-eye image and a right-eye image having parallax onto the light-transmissive image receiving layer of the printing sheet according to claim 1, the positions of the left-eye image and the right-eye image corresponding to the first domain and second domain, respectively, of the retardation layer of the printing sheet.

23. A method of providing a stereo picture, comprising:
providing a stereo picture print according to claim 18;
displaying the stereo picture print for an observer wearing a polarizing glass for a left eye and a polarizing glass for a right eye, the polarizing glasses comprising circularly polarizing lenses reverse to each other or linearly polarizing lenses having orthogonal polarization axes.
